(19) United States
(12) Patent Application Publication
(10) Pub. No.: US 2004/0018458 A1
(43) Pub. Date: Jan. 29, 2004

(54) Photothermographic material

(76) Inventor: Hajime Nakagawa, Kanagawa (JP)

Correspondence Address: Sheldon J. Moss, c/o Yumi Yerks, Apartment #412-North, 2111 Jefferson Davis Highway, Arlington, VA, 22202, US

(21) Appl. No.: 10/437,920

(22) Filed: May 15, 2003

(30) Foreign Application Priority Data
May 17, 2002 (JP) 2002-143410
Jun. 12, 2002 (JP) 2002-171913
Jun. 12, 2002 (JP) 2002-171914
Jun. 13, 2002 (JP) 2002-172635
Jun. 14, 2002 (JP) 2002-174715
Jun. 17, 2002 (JP) 2002-175678
Jul. 2, 2002 (JP) 2002-193341

(51) Int. Cl. G03C 1/498; G03C 1/295; G03C 1/14; G03C 1/30; G03C 1/815

(52) U.S. Cl. 430/619; 430/264; 430/510; 430/517; 430/522; 430/523; 430/531; 430/546; 430/566; 430/583; 430/584; 430/598; 430/607; 430/611; 430/622; 430/626; 430/628; 430/629; 430/944; 430/965

(57) ABSTRACT

The present invention provides a photothermographic material including a support having disposed on one surface of the support, at least one image forming layer containing a photosensitive silver halide, a non-photosensitive organic silver salt, a reducing agent, a development accelerator and a binder, and at least one protective layer on the identical surface, wherein 50% by mass or more of the binder contained in the image forming layer is a water soluble binder, and the reducing agent is contained in the form of a solid dispersion.

### BACKGROUND OF THE INVENTION

1. Field of the Invention

The present invention relates to a photothermographic material. More specifically, the invention relates to a photothermographic material that is suitable for use in medical diagnosis, industrial photography, printing and computer output microfilm.

2. Description of the Related Art

In recent years in the medical field and the printing field, adoption of a dry photographic development system has been strongly desired from the standpoints of environmental protection and conservation of space. In these fields, digitalization has remarkably progressed, and hence systems of inputting image information to a computer, storing the image information therein, optionally processing image informations needed, outputting the image information to a photosensitive material using a laser image setter or a laser imager by communicating the image information to a necessary location therefor, and then developing the material have rapidly become widespread. Thus, photosensitive materials which can be recorded on by irradiation with a laser having high light intensity and on which clear black images having high resolution and sharpness can be formed have been demanded. With respect to the digital imaging recording materials, various kinds of hard copying systems, such as ink jet printers and electrophotographic systems utilizing pigments and dyes have been distributed as general image forming systems. However, the materials are not yet satisfactory in view of image quality (sharpness, graininess, gradation and tone) for providing diagnostic ability necessary for medical images and recording speed (sensitivity), and they have not yet reached a level at which they can replace existent medical films containing silver salts, that are used in a conventional wet photosensitive development system.

On the other hand, photothermographic image forming systems utilizing organic silver salts are described in U.S. Pat. Nos. 3,152,904 and 3,457,075, and “Thermally Processed Silver Systems” written by D. H. Klosterboer (Imaging Processes and Materials) Neblette, 8th edition, edited by Sturge, V. Walworth, and A. Shepp, chapter 9, page 279, 1989).

When the photothermographic material is used, black silver images are formed through a redox reaction between a silver halide or a reducing silver salt (functioning as an oxidizing agent) and a reducing agent by heating to an elevated temperature (for example, 80° C. or higher) after imagewise exposure. The redox reaction is accelerated by a catalytic effect of latent images of silver halides formed by exposure. As a result, black silver images are formed in an exposed region. The photothermographic materials have been disclosed in many documents including U.S. Pat. No. 2,910,377 and Japanese Patent Appication Publication (JP-B) No. 43-4924.

The potothermographic material utilizing the organic silver salt is produced by applying a coating liquid containing the silver salt dissolved in an organic solvent followed by drying, or by applying an aqueous coating liquid containing microparticles of a water dispersible hydrophobic polymer as a main binder followed by drying. The latter method can be implemented using simple manufacturing equipment since a step of recoverying the solvent is not necessary, and this method is environmentally friendly because the organic solvent is not released into the environment. However, since a coexistent additive used in this method causes partial agglomeration of the aqueous dispersion of the polymer microparticles, the dispersion is unstable as the coating liquid thereby frequently causing layer surface defects during manufacture.

Use of gelatin as a binder for an image forming layer is described in Japanese Patent Application Laid-Open (JP-A) Nos. 8-95191 and 2002-62610. However, when photothermal development is conducted at an elevated temperature of 80° C. or higher using gelatin as the binder, agents that are necessary for a developing reaction are prevented from diffusing and from causing a reaction thereby severely suppressing development, since water is evaporated inhibiting molecular motion of the gelatin, and hence a rigid state is produced. Thus, sufficient image density is not obtained. It is usually effective to utilize a development accelerating means, but there is no known development accelerating means that is effectively operative in the system that uses gelatin as the binder. Further, since development accelerating means are generally associated with increased fogging, there is demand for development of another developing accelerating means which is accompanied by no disadvantageous increase in fogging.

Another problem associated with use of the water soluble polymer as the binder is that a film is low in strength and layer surface defects are likely to occur, since a content of additives such as a reducing agent or an anti-fogging agent is larger than a content of the water soluble polymer in existent wet-type developing materials. Accordingly, the physical strength of the film is further deteriorated with an increase in an addition amount of the additives such as the development accelerator.

As a means of improving the physical strength of the film, effecting crosslinking in the binder is known. Particularly, when gelatin is used as the binder, using functional groups, such as amino groups and carboxyl groups, in the binder to cause a reaction utilizing a crosslinking agent is known. It is particularly effective to cause a crosslinking reaction using the amino groups. Among such crosslinking agents, crosslinking agents having two or more vinyl sulfonic groups, chlorotriazine-based organic crosslinking agents or crosslinking agents utilizing a condensing reaction of carboxyl groups are known.

However, a problem occurs when the aforementioned crosslinkers are applied to the photothermographic material in which the water soluble polymer is included as the binder. That is, it has been found that phthalazine, which is used for accelerating photothermographic development and controlling a color tone of the developed silver, inhibits the crosslinking reaction. Particularly, when a vinyl sulfone-based crosslinking agent is used, the resultant effect is serious, and a countermeasure therefor has been demanded.

Still another problem associated with the photothermographic material is that color tones of dyes used for anti-halation or anti-irradiation are not good and a large amount of dye remains after the photothermographic development processing, thereby impairing the image quality, and furthermore the dyes are unstable in the film and denature during storage. Particularly, photothermographic materials that are sensitive to light in the near-infrared to infrared regions are required to exhibit high absorption in an exposed region and less sub-absorption in the visible region since dyes remain after the photothermographic development. Further, photothermographic materials used as intermediate recording materials for printing are required to exhibit less sub-absorption at 350 nm to 450 nm. Since near-infrared to infrared absorption dyes are generally poor in the storability, dyes having high fastness have been demanded.

As used for in the photothermographic materials, dyes having squarylium skeletons are described in JP-A Nos. 2-216140, WO95/23357, and JP-A Nos. 20-104779 and 12-265077. The photothermographic materials described in these patent publications are produced by dispersing organic silver salts and photosensitive silver halides in organic solvents and uniformly dissolving the dyes together with a reducing agent or the like using a binder, such as polyvinyl butyral, which is soluble in an organic solvent.

However, when the dyes are used in aqueous coating systems together with the water soluble binder, problems arise in that a spectral absorption range is broadened, an addition amount of dyes for obtaining necessary absorption is increased, and sub-absorption occurring in the visible region to near-ultraviolet region is increased.

### SUMMARY OF THE INVENTION

It is an object of the present invention to provide a photothermographic material capable of high image density and with less surface defects and having excellent productivity. Another object of the invention is to provide a photothermographic material exhibiting high sensitivity and strong film strength.

A first aspect of the invention provides a photothermographic material comprising a support having disposed on one surface thereof, an image forming layer containing a photosensitive silver halide, a non-photosensitive organic silver salt, a reducing agent and a binder, and at least one protective layer, wherein a development accelerator is contained in a layer at a side of the support at which the image forming layer is disposed, 50% by mass or more of the binder contained in the image forming layer is a water soluble binder, and the reducing agent is contained as a solid dispersion.

A second aspect of the invention provides a photothermographic material comprising a support having disposed on one surface thereof, at least one image forming layer containing a photosensitive silver halide, a non-photosensitive organic silver salt, a reducing agent and a binder, and at least one protective layer, wherein a development accelerator is contained in a layer at a side of the support at which the image forming layer is disposed, and 50% by mass or more of the binder contained in the image forming layer is a water soluble binder.

A third aspect of the invention provides a photothermographic material comprising a support having disposed on one surface thereof, an image forming layer containing a photosensitive silver halide, a non-photosensitive organic silver salt, a reducing agent and a binder, and at least one protective layer, wherein 50% by mass or more of the binder contained in the image forming layer is a water soluble binder, and wherein the material contains at least one of spectral sensitizing dyes represented by the following general formulae (D-a)-(D-d):

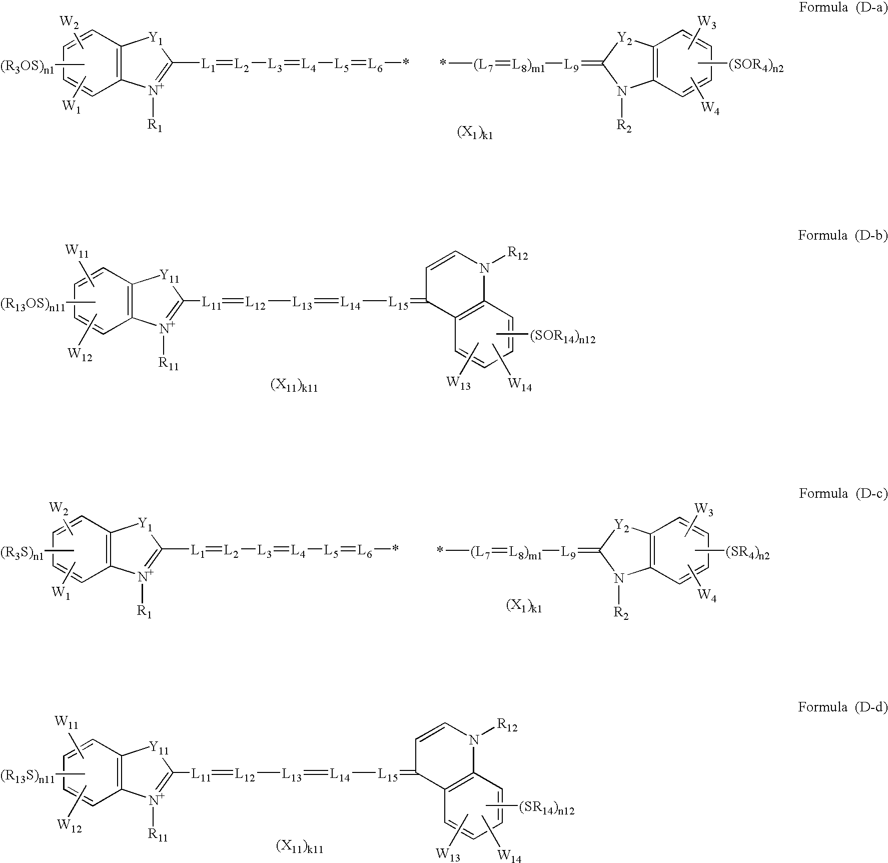

wherein, in the formulae, Y₁, Y₂ and Y₁₁ each represent an oxygen atom, a sulfur atom, a selenium atom or a group —CH═CH—; L₁-L₉ and L₁₁-L₁₅ each represent a methine group; R₁, R₂, R₁₁ and R₁₂ each represent an aliphatic group; R₃, R₄, R₁₃ and R₁₄ each represent a lower alkyl group, a cycloalkyl group, an alkenyl group, an aralkyl group, an aryl group or a heterocyclic group; W₁, W₂, W₃, W₄, W₁₁, W₁₂, W₁₃ and W₁₄ each represent a hydrogen atom or a substituent, represents a group of non-metal atoms necessary to form a condensed ring by linking between W₁ and W₂, W₃ and W₄, W₁₁ and W₁₂ or W₁₃ and W₁₄, or represents a group of non-metal atoms necessary to form a 5-membered or 6-membered condensed ring by linking between R₃ and W₁, R₃ and W₂, R₁₃ and W₁₁, R₁₃ and W₁₂, R₄ and W₃, R₄ and W₄, R₁₄ and W₁₃ or R₁₄ and W₁₄; X₁ and X₁₁ each represent an ion necessary to balance the charge in the molecule, k₁ and k₁₁ each represent the number of ions necessary to balance the charge in the molecule; m₁ represents 0 or 1; and n₁, n₂, n₁₁ and n₁₂ each represent 0, 1 or 2; and n₁, n₂, n₁₁ and n₁₂ do not all simultaneously represent 0.

### DESCRIPTION OF THE INVENTION

The present invention will now be described in detail below.

A photothermographic material according to the invention comprises a support having disposed on at least one surface thereof, an image forming layer containing a photosensitive silver halide, a non-photosensitive organic silver salt, a reducing agent and a binder. Further, in the photothermographic material, an intermediate layer or a surface protective layer may be disposed on the image forming layer, and a back layer or a back protective layer may be provided on an opposite surface of the support. Each of these layers may comprise a single layer or plural layers. Images can be formed on the photothermographic material according to the invention by conducting photothermographic development after exposure.

The photothermographic material according to the invention and a method of forming images using the photothermographic material will be described in detail below.

1. A Photothermographic Material

1-1. Binder

1) Water Soluble Binder for Use in the Invention

The binder used for the image forming layer in the invention comprises 50% by mass or more of a water soluble binder. As the water soluble binder, a transparent or semitransparent, generally colorless, natural resin, polymer and copolymer, a synthetic resin or polymer and copolymer, as well as other film forming polymers are preferred.

Specific examples of the water soluble binder include synthetic anionic polymers such as polyacrylic acid, acrylic acid copolymers, maleic acid copolymers, maleic acid monoester copolymers and acrylomethyl propane sulfonic acid copolymers, semi-synthetic anionic polymers such as carboxymethyl starch and carboxymethyl cellulose, anionic polymers such as alginic acid and pectinic acid, compounds described in JP-A No. 7-350753, conventionally known anionic, nonionic and cationic surfactants and known polymers such as polyvinyl alcohol, polyvinyl pyrrolidone, carboxymethyl cellulose, hydroxypropyl cellulose and hydroxypropyl methyl cellulose, or naturally occurring high molecular compounds such as gelatin. These water soluble binders may be properly selected and used. Preferred water soluble binders are a non-ionic water soluble polymer or an anionic water soluble polymer.

Examples of the non-ionic water soluble polymer include polyvinyl alcohol, a modified polyvinyl alcohol, polyacryl amide, dextran, polyethylene glycol, a polyethylene golycol/polypropylene glycol block copolymer.

As the natural polymer, gelatin is preferred. As gelatin, alkali treated gelatin, acid treated gelatin or carboxy modified gelatin treated with phthalic acid and the like are preferably used.

As the synthetic polymer, polyvinyl alcohols are preferred, and in particular, modified polyvinyl alcohols are preferred. As the polyvinyl alcohols, those having a saponification degree of 80 to 99.9% and a polymerization degree of 300 to 2400 are preferred. As the modified polyvinyl alcohol, copolymerization type modified polyvinyl alcohol, end thiol modified polyvinyl alcohol, end alkyl modified polyvinyl alcohol and the like are preferably used, with the alkyl modified polyvinyl alcohol being particularly preferred. Modification of the polyvinyl alcohol is described specifically in “Polyvinyl Alcohol—Developments”, edited by C. A. Finch, published by John Wily & Sons Ltd. (1992, pp. 77-156), in which copolymerization modification or chain transfer modification is mainly employed. Particularly preferred are end alkyl modified polyvinyl alcohols produced by chain transfer modification.

Other examples of the anionic water soluble polymer include poly(meth)acrylic acid, a copolymer of (meth)acrylic acid and (meth)acrylic acid ester, carboxy-modified polyvinyl alcohol and carboxymethyl cellulose.

The water soluble binder particularly preferable in the invention is gelatin and polyvinyl alcohol, with the most preferably being gelatin.

In the pesent invention, the water soluble binder is used preferably in an amount of by 50% by mass or more, more preferably 60% by mass or more and, most preferably 70% by mass or more relative to the binder employed in the image forming layer.

The water soluble binder of the invention may be used in combination of two or more kinds thereof.

2) Polymer Latex

In the invention, a latex is used preferably together with the water soluble binder. The latex means a dispersion in which fine particles of a water-insoluble and hydrophobic polymer are dispersed. The average grain size of the dispersed particles ranges from 1 to 50,000 nm, preferably from 5 to 1,000 nm, more preferably from 10 to 500 nm, and further preferably from 50 to 200 nm. There is no particular restriction to the grain size distribution of the dispersed particles, which may have a broad grain size distribution or have a grain size distribution of a monodispersion. Use of two or more kinds of materials having monodispersed grain size distribution in admixture is also preferred in view of controlling the properties of the coating solution.

As a preferred latex in the invention, hydrophobic polymers such as acrylic polymers, polyesters, rubbers (e.g., an SBR resin), polyurethanes, polyvinyl chlorides, polyvinyl acetates, polyvinylidene chlorides, and polyolefins may be used. These polymers may be linear polymers, branched polymers or crosslinked polymers and so-called homocopolymers in which single monomers are polymerized or copolymers in which two or more kinds of monomers are polymerized. The copolymers may be random copolymers or block copolymers. The molecular weight of these polymers ranges from 5,000 to 1,000,000, and preferably from 10,000 to 200,000 with respect to the number average molecular weight. The polymers having too small a molecular weight provide insufficient dynamic strength of the emulsion layer, whereas the polymers having too large a molecular weight provide poor depositing property and hence are not preferable. A latex containing a polymer capable of crosslinking is used particularly preferably.

Preferable examples of the polymer latex include the followings. These latexes are listed by representing starting monomers, in which each of numerical values in the blanket represents % by mass and a number average molecular weight is presented. In case where polyfunctional monomers are used, they are described as “crosslinking”, since the cross linking structure is formed and the concept of the molecular weight cannot be applied, and the description of the molecular weight is omitted. Tg represents a glass transition point.

P-1: -MMA (70)-EA(27)-MAA(3)-latex (molecular weight 37,000; Tg 61° C.)

P-2: -MMA (70)-2EHA(20)-St(5)-AA(5)-latex (molecular weight 40,000; Tg 59° C.)

P-3: -St(50)-Bu(47)-MAA(3)-latex (crosslinking; Tg −17° C.)

P-4: -St(68)-Bu(29)-AA(3)-latex (crosslinking; Tg 17° C.)

P-5: -St(71)-Bu(26)-AA(3)-latex (crosslinking; Tg 24° C.)

P-6: -St(70)-Bu(27)-IA(3)-latex (crosslinking),

P-7: -St(75)-Bu(24)-AA(1)-latex (crosslinking; Tg 29° C.).

P-8: -St(60)-Bu (35)-DVB-(3)-MAA(2) -latex (crosslinking),

P-9: -St(70)-Bu(25)-DVB-(2)-AA (3)-latex (crosslinking),

P-10: -VC(50)-MMA(20)-EA(29)-AN(5)-AA(5)-latex (molecular weight 80,000),

P-11: -VDC(85)-MMA(25)-EA(5)-MAA(5)-latex (molecular weight 67,000),

P-12: -ET(90)-MAA(10)-latex (molecular weight 12,000).

P-13: -St(70)-2EHA(27)-AA(3)-latex (molecular weight 130,000; Tg 43° C.)

P-14: -MMA(63)-EA(35)-AA(2)-latex (molecular weight 33,000; Tg 47° C.),

P-15: -St(70.5)-Bu(26.5)-AA(3)-latex (crosslinking; Tg 23° C.),

P-16: -St(69.5)-Bu(27.5)-AA (3) latex (crosslinking; Tg 20.5° C.).

The abbreviations for the above structure represent the following monomers. MMA; methyl methacrylate, EA; ethyl acrylate, MAA: methacrylic acid, 2EHA: 2-ethylhexylacrylate, St; styrene, Bu; butadiene, AA; acrylic acid, DVB; divinyl benzene, VC; vinyl chloride, AN; acrylonitrile, VDC; vinylidene chloride, Et; ethylene, IA; itaconic acid.

The polymer latexes listed above are commercially available and the following polymers may also be utilized. Such polymer latexes include CEBIAN A-4635, 4718 and 4601 (all manufactured by Dicel Chemical Industry Co. Ltd.), and Nipol Lx 811, 814,821,820 and 857 (all manufactured by Nippon Zeon Co.) as the example for acrylic polymer; INETEX ES 650, 611, 675 and 850 (all manufactured by Dainippon Ink Chemical Co.) WD-size, WMS (all manufactured by Eastman Chemical Co.) as the example for polyester; HYDRAN AP 10, 20, 30 and 40 (all manufactured by Dai Nippon Ink Chemical Co.) as the example for polyurethane; LACSTAR 7310K, 3307B, 4700H and 7132C (all manufactured by Dainippon Ink Chemical Co.), and Nipol Lx 416, 410, 438C and 2507 (all manufactured by Nippon Zeon Co.) as the example for rubbers; G 351, G576 (all manufactured by Nippon Zeon Co.) as the example for polyvinyl chloride; L 502, L513 (all manufactured by Asahi Kasei Industry Co.) as the example for polyvinylidene chloride; and CHEMIPAL S120, SA100 (all manufactured by Mitsui Petrochemical Co.) as the example for polyolefin.

The amount of the binder incorporated in the image forming layer (a weight ratio of the total binder/organic silver salt) in the invention ranges from 1/10 to 10/1, more preferably from 1/3 to 5/1, and further preferably from 1/1 to 3/1.

The image forming layer described above is usually a photosensitive layer (an emulsion layer) containing a photosensitive silver halide as the photosensitive silver salt, in which the weight ratio of the total binder/silver halide ranges from 400 to 5, and more preferably from 200 to 10.

The amount of the total binder contaained in the image forming layer of the invention ranges preferably from 0.2 to 30 g/m², more preferably from 1 to 15 g/m², and further preferably from 2 to 10 g/m². In the image forming layer of the invention, a crosslinker for crosslinking or a surfactant for improving the coatability may also be incorporated.

3) Solvent

In the invention, the solvent for a coating solution for the image forming layer is preferably an aqueous solvent containing 30% by mass or more of water. As the ingredient other than water, any water miscible organic solvent such as methyl alcohol, ethyl alcohol, isopropyl alcohol, methyl cellosolve, ethyl cellosolve, dimethyl formamide, or ethyl acetate may be used. The water content in the solvent of the coating solution is preferably 50% by mass or more, and more preferably 70% % by mass or more. Specific examples of the preferred solvent composition, in addition to water, include water/methyl alcohol=90/10, water/methyl alcohol=70/30, water/methyl alcohol/dimethyl formamide=80/15/5, water/methyl alcohol/ethyl cellosolve=85/10/5, and water/methyl alcohol/isopropyl alcohol=85/10/5 (% by mass).

1-2. Thermal Solvent

In the image forming layer of the invention, it is preferable to use a thermal solvent.

The thermal solvent is a compound capable of liquefying and accelerating photothermographic development and is preferably in a solid state at a normal temperature.

In the photothermographic material of the invention, it is preferred to contain a thermal solvent with a melting point from 50° C. to 200° C. The thermal solvent of the invention preferably has a polar group as a substituent. The thermal solvent preferably contains at least one substituent selected from hydroxyl group, carboxy group, amino group, amide group, sulfone amide group, phosphoric acid amide group, cyano group, imide group, ureido group, sulfoxide group, sulfone group, phosphin group, phosphin oxide group, or nitrogen-containing tetracylic group. Since the photothermographic development is a reducing reaction in which a carboxylic acid having relatively high polarity and silver ion transporting body are involved, it is preferred to form a reaction site having an appropriate polarity by the thermal solvent having the polar group.

The melting point of the thermal solvent of the invention is from 50° C. to 200° C. and preferably from 60° C. to 150° C.

Specific examples of the thermal solvent of the invention are show below but the invention is not restricted thereto. Each numerical values in the blanket shows a melting point. N-methyl-N-nitroso-p-toluene sulfoneamide (61° C.), 1,8-octanediol (62° C.), phenyl benzoate (67 to 71° C.), hydroquinone diethylether (67 to 73° C.), ε-caprolactam (68 to 70° C.), diphenyl phosphate (68 to 70° C.), (±)-2-hydroxyoctanoic acid, (68 to 71° C.), (±)-3-hydroxydodecanonic acid (68 to 71° C.), 5-chloro-2-methylbenzothiazole (68 to 71° C.), β-naphthyl acetate (68 to 71° C.), butyl alcohol (68 to 73° C.), (±)-2-hydroxydocanoic acid (69 to 72° C.), 2,2,2-trifluoroacetoamide (69 to 72° C.), pyrazole (69° C.), (±)-2-hydroxyundecanoic acid (70 to 73° C.), N,N-diphenylformamide (71 to 72° C.), dibenzyldisulfide (71 to 72° C.), (±)-3-hydroxyundecanoic acid (71 to 74° C.), 2,2′-dihydroxy-4-methoxybenzophenone (71 ° C.), 2,4-dinitrotoluene (71° C.), 2,4-dimethoxybenzaldehyde (71° C.), 2,6-di-t-butyl-4-methylphenol (71 ° C.), 2,6-dichloroaldehyde (71 ° C.), diphenylsulfoxide (71° C.), stearic acid (71° C.), 2,5-dimethoxynitrobenzene (72 to 73° C.), 1,10-decane diol (72 to 74° C.), (R)-(−)-3-hydroxytetradecanoic acid (72 to 75° C.), 2-tetradecylhexadecanoic acid (72 to 75° C.), 2-methoxy naphthalene (72 to 75° C.), methyl 3-hydroxy-2-naphthoate (72 to 76° C.), tristearin(73.5° C.), dotriacontane (74 to 75° C.), flavanone (74 to 78° C.), 2,5-diphenyloxazole (74° C.), 8-xylinol (74° C.), o-chlorobenzylalcohol (74° C.), oleic amide (75 to 76° C.), (±)-2-hydroxydodecanoic acid (75 to 78° C.), n-hexatriacontane (75 to 79° C.), iminodiacetonitrile (75 to 79° C.), p-chlorobenzylalcohol (75° C.), diphenyl phthalate (75° C.), N-methylbenzamide (76 to 78° C.), (±)-2-hydroxytridecanoic acid (76 to 79° C.), 1,3-diphenyl-1,3-propanedione (76 to 79° C.), N-methyl-p-toluenesulfone amide(76 to 79° C.), 3′-nitroacetophenone (76 to 80° C.), 4-phenylcyclohexanone (76 to 80° C.), eicosanoic acid (76° C.), 4-chlorobenzophenone (77 to 87° C.), (±)-3-hydroxytetradecanoic acid (77 to 80° C.), 2-hexadecyloctadecanoic acid (77 to 80° C.), p-nitrophenyl acetate (77 to 80° C.), 4′-nitroacetophenone (77 to 81° C.), 12-hydroxystearic acid (77° C.), α,α′-dibromo-m-xylene (77° C.), 9-methylanthracene (78 to 81° C.), 1,4-cyclohexanedione (78° C.), m-diethylaminophenol(78° C.), methyl m-nitrobenzoate (78° C.), (±)-2-hydroxytetradecanoic acid (79 to 82° C.), 1-(phenylsolfonyl)indole (79° C.), di-p-tolylmethane (79° C.), propionamide (79° C.), (±)-3-hydroxytridecanoic acid (80 to 83° C.), guaiacol glycerin ether (80 to 85° C.), octanoyl-N-methylglucamide (80 to 90° C.), o-fluoroacetoanilide (80° C.), acetoacetoanilide (80° C.), docosanoic acid (81 to 82° C.), p-bromobenzophenone (81° C.), triphenylphosphine (81° C.), dibenzofurane (82.8° C.), (±)-2-hydroxypentadecanoic acid (82 to 85° C.), 2-octadecyleicosanoic acid (82 to 85° C.), 1,12-dodecanediol (82° C.), methyl 3,4,5-trimethoxybenzoate (83° C.), p-chloronitrobenzene (83° C.), (±)-3-hydroxyhexadecanoic acid (84 to 88° C.), o-hydroxybenzylalcohol (84 to 86° C.), 1-triacontanol (84 to 88° C.), o-aminobenzylalcohol (84° C.), 4-methoxybenyzl acetate (84° C.), (±)-2-hydroxyhexadecanoic acid (85 to 88° C.), m-dimethylaminophenol (85° C.), p-dibromobenzene (86 to 87° C.), methyl 2,5-dihydroxybenzoate (86 to 88° C.), (±)-3-hydroxypentadecanoic acid (86 to 89° C.), 4-benzylbiphenyl (86° C.), p-fluorophenyl acetic acid (86° C.), 1,14-tetradecanediol (87 to 89° C.), 2,5-dimethyl-2,5-hexanediol (87 to 90° C.), p-pentylbenzoic acid (87 to 91° C.), α-(trichloromethyl)benzyl acetate (88 to 89° C.), 4,4′-dimethylbenzoin (88° C.), diphenyl carbonate (88° C.), m-dinitrobenzene (89.57° C.), (3R, 5R)-(+)-2,6-dimethyl-3,5-heptanediol (90 to 93° C.), (3S, 5S)-(−)-2,6-dimethyl-3,5-heptanediol (90 to 93° C.), cyclohexanoneoxime (90° C.), p-bromoiodobenzene (91 to 92° C.), 4,4′-dimethylbenzophenone (92 to 95° C.), triphenylmethane (92 to 95° C.), anilide stearate (92 to 96° C.), p-hydroxyphenylethanol (92° C.), monoethyl urea (92° C.), acenaphthylene (93.5 to 94.5° C.), m-hydroxyacetophenone (93 to 97° C.), xylitol (93 to 97° C.), p-iodophenol (93° C.), methyl p-nitrobenzoate (94 to 98° C.), p-nitrobenzylalcohol (94° C.), 1,2,4-triacetoxybenzene (95 to 100° C.), 3-acetylbenzonitrile (95 to 103° C.), ethyl 2-cyano-3,3-diphenylacrylate (95 to 97° C.), 16-hydroxyhexadecanoic acid (95 to 99° C.), D(−)-ribose (95° C.), o-benzoyl benzoic acid (95° C.), α,α′-dibromo-o-xylene (95° C.), benzyl (95° C.), iodoacetoamide (95° C.), n-propyl p-hydroxybenzoate (96 to 97° C.), n-propyl p-hydroxybenzoate (96 to 97° C.), flavon (96 to 97° C.), 2-deoxy-D-ribose (96 to 98° C.), lauryl gallate (96 to 99° C.), 1-naphthol (96° C.), 2,7-dimethylnaphthalene (96° C.), 2-chlorophenyl acetic acid (96° C.), acenaphthene (96° C.), dibenzyl terephthalte (96° C.), fumaronitrile (96° C.), 4′-amino-2′,5′-diethoxybenzanilide (97 to 100° C.), phenoxy acetic acid (97 to 100° C.), 2,5-dimethyl-3-hexine-2,5-diol (97° C.), D-solbitol (97° C.), m-aminobenzylalcohol (97° C.), diethyl acetoamide malonate (97° C.), 1,10-phenanthroline-hydrate (98 to 100° C.), 2-hydroxy-4-methoxy-4′-methylbenzophenone (98 to 100° C.), 2-bromo-4 ′-chloroacetophenone (98° C.), methylurea (98° C.), 4-phenoxyphthalonitrile (99 to 100° C.), o-methoxybenzoic acid (99 to 100° C.), p-butyl benzoic acid (99 to 100° C.), xanthene (99 to 100° C.), pentafluorobenzoic acid (99 to 101° C.), phenanthrene (99° C.), p-t-butylhpenol (100.4° C.), 9-fluorenylmethanol (100 to 101° C.), 1,3-dimethyl urea (100 to 102° C.), 4-acetoxyindol (100 to 102° C.), 1,3-cyclohxanedione (100° C.), stearic amide (100° C.), tri-m-tollylphosphine (100° C.), 4-biphenylmethanol (101 to 102° C.), 1,4-cyclohexanediol (cis-, trans-mixture) (101° C.), α,α′-dichloro-p-xylene (101° C.), 2-t-butylanthraquinone (102° C.), dimethyl fumalate (102° C.), 3,3-dimethylglutaric acid (103 to 104° C.), 2-hydroxy-3-methyl-2-cyclopentene-1-on (103° C.), 4-chloro-3-nitroaniline (103° C.), N,N-diphenylacetoamide (103° C.), 3(2)-t-butyl-4-hydroxyanisol (104 to 105° C.), 4,4′-dimethylbenzyl (104 to 105° C.), 2,2-bis(hydroxymethyl)-2,2′,2″-nitrilotriethanol (104° C.), m-trifluoromethyl benzoic acid (104° C.), 3-pentanol (105 to 108° C.), 2-methyl-1,4-naphthoquionone (105° C.), α,α,α′,α′-tetrabromo-m-xylene (105° C.), 4-chlorophenyl acetic acid (106° C.), 4,4′-difluorobenzophenone (107.5 to 108.5° C.), 2,4-dichloro-1-naphthol (107 to 108° C.), L-ascorbic acid palmitate (107 to 117° C.), 2,4-dimethoxybenoic acid (108 to 109° C.), o-trifluoromethyl benzoic acid (108 to 109° C.), p-hydroxyacetophenone (109° C.), dimethylsulfone (109° C.), 2,6-dimethylnaphthalene (110 to 111° C.), 2,3,5,6-tetramethyl-1,4-benzoquinone (110° C.), tridecanoic diacid (110° C.), triphenylchlromethane (110° C.), fluoranthene (110° C.), laurineamide (110° C.), 1,4-benzoquionene (111° C.), 3-benzylindole (111° C.), resorcinol (111° C.), 1-bromobutane (112.3° C.), 2,2-bis(bromomethyl)-1,3-propanediol (112 to 114° C.), p-ethylbenzoic acid (113.5° C.), 1,4-diacetoxy-2-methylnaphthalene (113° C.), 1-ethyl-2,3-piperazinedion (113° C.), 4-methyl-2-nitroaniline (113° C.), L-ascorbic acid dipalmitate (113° C.), o-phenoxybenzoic acid (113° C.), p-nitrophenol (113° C.), methyl(diphenyl)phosphine=oxide (113° C.), cholesterol acetate (114 to 115° C.), 2,6-dimethylbenzoic acid (114 to 116° C.), 3-nitrobenzonitrile (114° C.), m-nitroaniline (114° C.), ethyl α-D-glucoside (114° C.), acetoanilide (115 to 116° C.), (±)-2-phenoxypropionic acid (115° C.), 4-chloro-1-naphthol (116 to 117° C.), p-nitrophenylaceotnitrile (116 to 117° C.), ethyl p-hydroxybenzoate (116° C.), p-isopropylbenzoic acid (117 to 118° C.), D(+)-galactose (118 to 120° C.), o-dinitrobenzene (118° C.), benzyl p-benzyloxybenzoate (118° C.), 1,3,5-tribromobenzene (119° C.), 2,3-dimethoxybenzoic acid (120 to 122° C.), 4-chloro-2-methylphenoxyacetic acid (120° C.), meso-erythritol (121.5° C.), 9,10-dimethyl-1,2-benzanthracene (122 to 123° C.), 2-naphthol (122° C.), N-phenylglysine (122° C.), bis(4-hydroxy-3-methylphenyl) sulfide (122° C.), p-hydroxybenzylalcohol (124.5 to 125.5° C.), 2′,4′-dihydroxy-3′-propylacetophenone (124 to 127° C.), 1,1-bis(4-hydroxyphenyl)ethane (124° C.), m-fluorobenzoic acid (124° C.), diphenylsulfone (124° C.), 2,2-dimethyl-3-hydroxypropionic acid (125° C.), 3,4,5-trimethoxysinnamic acid (125° C.), o-fluorobenzoic acid (126.5° C.), isonitrosoacetophenone (126 to 128° C.), 5-methyl-1,3-cyclohexane dione (126° C.), 4-benzoyl butyric acid (127° C.), methyl p-hydroxybenzoate (127° C.), p-bromonitrobenzene (127° C.), 3,4-dihydroxyphenyl acetic acid (128 to 130° C.), 5α-cholestane-3-on (128 to 130° C.), 6-bromo-2-naphthol (128° C.), isobutylamide (128° C.), 1-naphthyl acetic acid (129° C.), 2,2-dimethyl-1,3-propane diol (129° C.), p-diiodobenzene (129° C.), dodecanoic diacid (129° C.), 4,4′-dimethoxybenzyl (131 to 133° C.), dimethlol urea (132.5° C.), o-ethoxybenzamide (132 to 134° C.), sebacic acid (132° C.), p-toluene sulfoneamide (134° C.), salcylanilide (135° C.), β-citosterol (136 to 137° C.), 1,2,4,5-tetrachlorobenzene (136° C.), 1,3-bis(1-hydroxy-1-methylethyl)benzene (137° C.), phthalonitrole (138° C.), 4-n-propyl benzoic acid (139° C.), 2,4-dichlorophenoxy acetic acid (140.5° C.), 2-naphthyl acetic acid (140° C.), methyl terephthalate (140° C.), 2,2-dimethyl succinic acid (141° C.), 2,6-dichlorobenzonitrile (142.5 to 143.5° C.), o-chlorobenzoic acid (142° C.), 1,2-bis(diphenylphosphino)ethane (143 to 144° C.), α,α,α-tribromomethylphenylsulfone (143° C.), D(+)-xylose (144 to 145° C.), phenyl urea (146° C.), n-propyl gallate (146° C.), 4,4′-dichlorobenzophenone (147 to 148° C.), 2′,4′-dihydroxyacetophenone (147° C.), cholesterol (148.5° C.), 2-methyl-1-pentanol (148° C.), 4,4′-dichlorodiphenylsulfone (148° C.), diglycolic acid (148° C.), adipic acid (149 to 150° C.), 2-deoxy-D-glucose (149° C.), diphenyl acetic acid (149° C.), o-bromobenzoic acid (150° C.).

In addition to the above, urea derivatives (e.g., dimethyl urea, dimethyl urea, and phenyl urea), amide derivatives (e.g., acetoamide, stearylamide, benzamide, p-toluamide, p-acetoxyethoxybenzamide, and p-butanoyloxyethoxybenzamide), sulfonamide derivatives (e.g., p-toluenesulfone amide), polyhydric alcohols (e.g., 1,6-hexanediol, pentaerythritol, and polyethylene glycol) are preferably used.

Among the thermal solvents described above, water insoluble solid thermal solvents are used particularly preferably. Among them, amide type thermal solvent or urea type thermal solvent is used preferably with a view point of coloring property.

Specific examples tehreof include the following:

Sol-1: p-(i)-propylbenzamide,

Sol-2: p-(n)-propylbenzamide,

Sol-3: p-(n)-butylbenzamide,

Sol-4: p-(t)-butylbenzamide,

Sol-5: p-(t)-amylbenzamide,

Sol-6: p-(n)-hexylbenzamide,

Sol-7: p-(n)-octylbenzamide,

Sol-8: p-(n)-allylbenzamide,

Sol-9: p-(n)-butoxybenzamide,

Sol-10: o-(n)-butoxybenzamide,

Sol-11: m-(n)-butoxybenzamide,

Sol-12: p-(n)-propoxybenzamide,

Sol-13: p-(n)-allyloxybenzamide,

Sol-14: 2,4-diethoxybenzamide

Sol-15: 2,4-dipropoxybenzamide

Sol-16: 3,5-dipropoxybenzamide

Sol-17: benzamide

Sol-18: p-toluamide,

Sol-19: p-(2-propanoyloxyethoxy)benzamide

Sol-20: p-(2-acetyloxyethoxy)benzamide,

Sol-21: p-butoxyphenyl urea

Sol-22: m-butoxyphenyl urea

Sol-23: p-methylphenyl urea

Sol-24: m-methylphenyl urea

Sol-25: m-(2-acetyoxyethoxy)phenyl urea

Sol-26: m-butanoyloxyphenyl urea

Sol-27: o-butoxyphenyl urea

Sol-28: m-(n)-butylphenyl urea

Sol-29: o-(n)-hexylbenzamide

Sol-30: p-(n)-hexylbenzamide

Additional examples of the thermal solvent include aliphatic carboxylic acids, aromatic carboxylic acids, thiols, thiocarbonyl compounds having an α-hydrogen, and imino group-containing compounds. The aliphatic carboxylic acids include, for example, acetic acid (melting point 16.6° C., temperature in the blanket hereinafter indicates melting point), butyric acid (−5.3° C.), succinic acid (188° C.), sebasic acid (134° C.), adipic acid (153° C.), oleic acid (13° C.), linolic acid (−5° C.), linolenic acid (−11° C.), tartaraic acid (205° C.), palmitic acid (63° C.), stearic acid (72° C.) and behenic acid (82° C.). Since they are generally less stable as silver salts as the number of carbon atoms is smaller, compounds having an appropriate member of carbon atoms (e.g., the number of carbon atoms ranging from 15 to 28) are preferred.

Examples of the aromatic carboxylic acids include benzoic acid derivatives, quinolic acid derivatives, naphthalenecarboxylic acid derivatives, salicylic acid derivatives, gallic acid derivatives (258° C.), tannic acid, phthalic acid (234° C.), phenylacetic acid derivatives and pyromellitic acid (279° C.).

Thiol or thiocarbonyl compounds having a-hydrogen include, for example, 3-mercapto-4-phenyl-1,2,4-triazole, 2-mercaptobenzimidazole, 2-mercapto-5-amionothiadiazole, 2-mercaptobenzothiazole, S-alkylthioglycolic acids (number of carbon atoms in the alkyl group: 12 to 23), dithiocarboxylic acids such as dithioacetic acid, thioamides such as thiostearoamide, mercapto compounds described in U.S. Pat. No. 4,123,274 such as 5-carboxy-1-methyl-2-phenyl-4-thiopyridone, mercaptotriazine, 2-mercaptobenzooxazole, mercaptooxathiozole or 3-amino-5-benzylthio-1,2,4-triazole.

Representative examples of the compounds containing the imino group include benzotriazole or derivatives thereof as described in JP-B Nos. 44-30270 or 45-18416 or derivatives thereof, for example, benzotriazole, alkyl substituted benzotriazoles such as methyl benzotriazole, halogen substituted benzotriazoles such as 5-chlorobenzotriazole, and carboimido benzotriazole such as butylcarboimide benzotriazole, nitrobenzotriazoles as described in JP-A No. 58-118639, sulfobenzotriazole, carboxybenzotriazole or salts thereof, or hydroxybenzotriazole as described in JP-A No. 58-115638, 1,2,4-triazole, 1H-tetrazole, carbazole, saccharine, imidazole and derivatives thereof as described in U.S. Pat. No. 4,220,709. It is necessary that the organic acid silver compounds are contained in an amount of about 5 to 70% by weight of the image forming layer, and the ratio is preferably from 10 to 60% by weight, and further preferably 20 to 55% by weight.

Examples of the thermal solvent usable in the invention can be properly selected from compounds described in pages 4 to 8 of JP-A No. 1-227150, compounds described in pages 4 to 6 of JP-A No. 63-15247, compounds described in pages 9 to 10 of JP-A No. 63-48543, compounds described in page 5 of JP-A No. 2-120739 and compounds described in page 5 of JP-A No. 2-123354.

The thermal solvent can be incorporated in any layer such as a photosensitive silver halide emulsion layer, an intermediate layer and a protective layer and the addition amount is usually from 10% by weight to 500% by weight, and more preferably 30% by weight to 300% by weight based on the binder.

The thermal solvent is most preferably incorporated to the image forming layer.

In the invention, the thermal solvent may be added to a coating solution by any method such as in the form of a solution, emulsified dispersion or dispersion of fine solid particles and may be contained in the photosensitive material.

Conventionally known emulsifying and dispersing methods include a method of dissolving using an oil such as dibutyl phthalate, tricresyl phosphate, glyceryl triacetate or diethyl phthalate, and an auxiliary solvent such as ethyl acetate or cyclohexanone to mechanically prepare an emulsified dispersion.

Further, the fine solid particle dispersing methods include, a method of preparing a solid dispersion by dispersing a powder of a thermal solvent into an appropriate solvent such as water using a ball mill, colloid mill, vibration ball mill, sand mill, jet mill, roller mill or ultrasonic waves. In this case, a protection colloid (e.g., polyvinyl alcohol), a surfactant (anionic surfactant such as sodium triisopropyl naphthalene sulfonate (mixture of those having different substitution positions for three isopropyl groups)) may be used. In the mills, beads such as zirconia beads are usually used as the dispersing medium, and Zr or the like eluted from the beads may sometimes contaminate the dispersion. Depending on the conditions, dispersing is usually conducted employing from 1 ppm to 1000 ppm. When the Zr is contained in the photosensitive material in an amount of 0.5 mg or less per mg of silver, it causes no practical problems.

It is preferred to incorporate an inhibitor (e.g., sodium benzoisothiazolinone) to the aqueous dispersion.

In the invention, the thermal solvent is preferably used as a solid dispersion.

1-3. Organic Silver Salt

The organic silver salt usable in the invention is a silver salt which is relatively stable to light but functions as silver ion sources when heated to 80° C. or higher in the presence of an exposed photosensitive silver halide and a reducing agent to form silver images. The organic silver salt may be any organic material which may supply silver ions that can be reduced by a reducing agent. Such non-photosensitive organic silver salts are described, for example, in column Nos. 0048 to 0049 of JP-A No. 10-62899, page 18, line 24 to page 19, line 37 of EP-A No. 0803764A1, EP-A No. 0962812A1, and JP-A Nos. 11-349591, 2000-7683 and 2000-72711. Silver salts of organic acids, particularly, silver salts of long-chained aliphatic carboxylic acids (number of carbon atoms of 10 to 30, and preferably 15 to 28) are particularly preferred. Preferred examples of the aliphatic silver salts include lignoceric acid, silver behenate, silver arachidonate, silver stearate, silver oleate, silver laurate, silver capronate, silver myristate, silver palmitate, erucic acid and the mixture thereof. In the invention, it is preferred to use the aliphatic acid silver salt having the silver behenate content, preferably of 50 mol % or more, more preferably of 85 mol % or more, and further preferably of 95 mol % or more. Further, it is preferred to use the aliphatic silver salt having an erucic acid content of 2 mol % or less, more preferably of 1 mol % or less, and further preferably of 0.1 mol % or less.

The shape of particles of an organic silver salt usable in the present invention is not particularly limited, and may be a needle, rod, plate or flake shape.

Preferably, a flaky organic silver salt is used in the present invention. Herein, flaky organic silver salts are defined as follows. If the salt is examined through an electron microscope and the shape of the particles is considered to be approximately a rectangular parallelepiped, its sides are named “a”, “b” and “c” in an order beginning with the shortest dimension (“c” may be equal to “b”), and the values of the two shortest sides “a” and “b” are used to calculate “x” by the following equation:

x=b/a

The value “x” is calculated for about 200 particles and if their mean value, x (mean)≧1.5, the particles are defined as flaky. Preferably, 30≧x (mean)≧1.5, and more preferably 20≧x (mean) ≧2.0. Incidentally, the particles are needle-shaped if 1≦x (mean)<1.5.

Side “a” of a flaky particle can be regarded as the thickness of a plate-shaped particle having a principal face defined by sides “b” and “c”. The mean value of “a” is preferably from 0.01 to 0.23 μm, and more preferably from 0.1 to 0.20 μm. The mean value of c/b is preferably from 1 to 6, more preferably from 1 to 4, and still more preferably from 1 to 3.

The particle sizes of the organic silver salt preferably have a monodispersed size distribution. In the monodispersed distribution, the standard deviation of the length of the minor axis or major axis of the particles divided by a length value of the minor axis or major axis, respectively, is preferably not more than 100%, more preferably not more than 80%, and still more preferably not more than 50%. The shape of particles of the salt can be determined from an observed image of a dispersion thereof through a transmission electron microscope. The particle size distribution of the salt can alternatively be determined by employing the standard deviation of the volume weighted mean diameter of the particles, and is monodispersed if a percentage obtained by dividing the standard deviation of the volume weighted mean diameter by the volume weighted mean diameter (coefficient of variation) is not more than 100%, more preferably not more than 80%, and still more preferably not more than 50%. The particle size (volume weighted mean diameter) can be determined, for example, by applying laser light to the organic silver salt dispersed in a liquid and determining an autocorrelation function of the variation of fluctuation of scattered light with time.

Known methods can be employed to prepare and disperse an organic silver salt usable in the present invention. Reference can be made to, for example, Japanese Patent Application Laid-Open No. 62899/1998, European Patent Laid-Open No. 0803763A1 and European Patent Laid-Open No.962812A1, JP-A Nos. 11-349591, 2000-7683, 2000-72711, Japanese Patent Application Nos. 11-348228 to 348230, 11-203413, 2000-90093, 2000-195621, 2000-191226, 2000-213813, 2000-214155, and 2000-191226.

A dispersion of the organic silver salt is preferably substantially free from any photosensitive silver salt, since fogging will be increased and its sensitivity will be greatly lowered. According to the present invention, an aqueous dispersion contains not more than 0.1 mol % of a photosensitive silver salt per 1 mol % of the organic silver salt, and photosensitive silver salt should not be added thereto.

According to the present invention, the photosensitive material can be prepared by mixing an aqueous dispersion of an organic silver salt with an aqueous dispersion of a photosensitive silver salt in a ratio depending on the purpose for which it will be used, preferably employing 1 to 30 mol %, more preferably 2 to 20 mol %, and still more preferably 3 to 15 mol % of the photosensitive silver salt relative to the organic silver salt. It is preferable, for obtaining a material having controlled photographic properties, to mix two or more kinds of aqueous dispersions of organic silver salts with two or more kinds of aqueous dispersions of photosensitive silver salts.

The organic silver salt in the invention can be used by a desired amount and it is, preferably, from 0.1 to 5.0 g/m², more preferably, 0.3 to 3.0 g/m² and, further preferably, 0.5 to 2.0 g/m² as a total coating amount of silver also including the silver halide. Particularly, for improving the image preservation property, the entire coating amount of silver is preferably 1.8 g/m² or less and, more preferably, 1.6 g/m². A sufficient image density can be obtained also at such a low silver content by using a preferred reducing agent of the invention.

1-4. Development Accelerator

In the photothermographic material according to the invention, a development accelerator is used preferably.

The development accelerator used in the invention is a compound capable of increasing the sensitivity (logarithmic sensitivity based on the exposure amount that provides an optical density of 1.0) by 0.05 or more, as compared to unsubstituted cases, in a photothermographic material containing at least a photosensitive silver halide, a non-photosensitive organic silver salt, a reducing agent and a binder on one identical surface of the support, when the compound is substituted by 10 molar % based on the reducing agent (hereinafter referred to as a main reducing agent).

As the development accelerator, a compound capable of increasing the sensitivity by 0.05 or more when substituted by 5 mol % is preferred and a compound capable of increasing the sensitivity by 0.05 or more when substituted by 2 mol % is further preferred.

As the development accelerator, any compound can be used insofar as it increases the sensitivity when substituted for the main reducing agent as described above in the photothermographic development. Among them, use of so-called reducing compounds is preferred. Specifically, compounds such as aminophenols, p-phenylenediamines, sulfoneamide phenols, carbonamide phenols, 1-phenyl-t-pyrazolidones, ascorbic acid, hydrazines, phenols, and naphthols can be used. Among them, sulfoneamide phenols (for example, compounds represented by the general formula (1) described in JP-A No. 10-221806 and compounds represented by the formula (A) described in JP-A No. 2000-267222) and hydrazines are preferred.

Particularly preferred compounds include those compounds represented by the following general formulae (1), (5) and (6).

<Compound Represented by the General Formula (1)>

The most preferred compound for the development accelerator used in the invention is a hydrazine derivative represented by the following general formula (1).

Q¹-NHNH—R¹ General formula (1)

In the general formula (1), Q¹ represents a 5 to 7-membered unsaturated ring which is bonded via a carbon atom to NHNH—R¹, and R¹ represents a carbamoyl group, an acyl group, an alkoxycarbonyl group, an aryloxy carbonyl group, a sulfonyl group or a sulfamoyl group.

The compound represented by the general formula (1) is to be described specifically.

The photothermographic material according to the invention preferably has the reducing compound represented by the general formula (1) on the support, at a surface identical to that for the photosensitive silver halide and a non-photosensitive organic silver salt that can be reduced.

The reducing compound represented by the general formula (1) is a developing agent collectively referred to as a hydrazine-based developing agent. In the formula, Q¹ represents a 5 to 7-membered unsaturated ring which is bonded via a carbon atom to NHNH—R¹, and R¹ represents a carbamoyl group, an acyl group, an alkoxycarbonyl group, an aryloxy carbonyl group, a sulfonyl group or a sulfamoyl group.

Preferred examples of the 5 to 7-membered unsaturated ring represented by Q¹ include benzene ring, pyridine ring, pyrazine ring, pyrimidine ring, pyridazine ring, 1,2,4-triazine ring, 1,3,5-triazine ring, pyrrole ring, imidazole ring, pyrazole ring, 1,2,3-triazole ring, 1,2,4-triazole ring, tetrazole ring, 1,3,4-thiadiazole ring, 1,2,4-thiadiazole ring, 1,2,5-thiadiazole ring, 1,3,4-oxathiazole ring, 1,2,4-oxathiazole ring, 1,2,5-oxathiazole ring, thiazole ring, oxazole ring, isothiazole ring, isooxazole ring and thiophene ring, and a condensed ring in which the aforementioned rings are condensed to each other is also preferred.

The ring described above may have a substituent and in a case where it has two or more substituents, the substituents may be the same or different from each other. Examples of the substituent include a halogen atom, alkyl group, aryl group, carbonamide group, alkylsulfoneamide group, arylsulfoneamide group, alkoxy group, aryloxy group, alkylthio group, arylthio group, carbamoyl group, sulfamoyl group, cyano group, alkylsulfonyl group, arylsulfonyl group, alkoxycarbonyl group, aryloxycarbonyl group and acyl group.

In a case where the substituent is a group capable of being substituted, it may further has a substituent. The example of the preferred substituent include a halogen atom, alkyl group, aryl group, carbonamide group, alkylsulfone amide group, arylsulfone amide group, alkoxy group, aryloxy group, alkylthio group, arylthio group, acyl group, alkoxycarbonyl group, aryloxycarbonyl group, carbamoyl group, cyano group, sulfamoyl group, alkylsulfonyl group, arylsulfonyl group and acyloxy group.

The carbamoyl group represented by R¹ has preferably 1 to 50 carbon atoms, and more preferably 6 to 40 carbon atoms, illustrative examples thereof include non-substituted carbamoyl group, methylcarbamoyl group, N-ethylcarbamoyl group, N-propylcarbamoyl group, N-sec-butylcarbamoyl group, N-octylcarbamoyl group, N-cyclohexylcarbamoyl group, N-tert-butylcarbamoyl group, N-dodecylcarbamoyl group, N-(3-dedecyloxypropyl)carbamoyl group, N-octadecylcarbamoyl group, N-[3-(2,4-tert-pentylphenoxy)propyl]carbamoyl group, N-(2-hexyldecyl)carbamoyl group, N-phenylcarbamoyl group, N-(4-dodecyloxyphenyl)carbamoyl group, N-(2-chloro-5-dedecyloxycarbonyphneyl)carbamoyl group, N-naphthylcarbamoyl group, N-3-pyridylcarbamoyl group and N-benzylcarbamoyl group.

The acyl group represented by R¹ has preferably 1 to 50 carbon atoms, and more preferably 6 to 40 carbon atoms, and representative examples thereof include formyl group, acetyl group, 2-methylpropanoyl group, cyclohexylcarbonyl group, octanoyl group, 2-hexyldecanoyl group, dodecanoyl group, chloroacetyl group, trifluoroacetyl group, benzoyl group, 4-dedecyloxygenzoyl group and 2-hydroxymethylbenzoyl group.

The alkoxycarbonyl group represented by R¹ has preferably 2 to 50 carbon atoms, and more preferably 6 to 40 carbon atoms, and specific examples thereof include methoxycarbonyl group, ethoxycarbonyl group, isobutylcarbonyl group, cyclohesyloxycarbonyl group, dodecyloxycarbonyl group and benzyoxycarbonyl group.

The aryloxy carbonyl group represented by R¹ has preferably 7 to 50 carbon atoms, and more preferably 7 to 40 carbon atoms, and illustrative examples thereog include phenoxycarbonyl group, 4-octyloxyphenoxycarbonyl group, 2-hydroxymethylphenoxycarbonyl group, and 4-dodecyloxypnenoxycarbonyl group.

The sulfonyl group represented by R¹ has preferably 1 to 50 carbon atoms, and more preferably 6 to 40 carbon atoms, and representative examples thereof include methylsulfonyl group, butylsulfonyl group, octylsulfonyl group, 2-hexadecylsulfonyl group, 3-dodecyloxypropylsulfonyl group, 2-octyloxy-5-tert-octylphenylsulfonyl group, and 4-dedecyloxyphenylsulfonyl group.

The sulfamoyl group represented by R¹ has preferably 0 to 50 carbon atoms, and more preferably 6 to 40 carbon atoms, and specific examples thereof include non-substituted sulfamoyl group, N-ethylsulfamoyl group, N-(2-ethylhexyl) sulfamoyl group, N-decylsulfamoyl group, N-hexadecylsulfamoyl group, N-{3-(2-ethylhexyloxy)propyl}sulfamoyl group, N-(2-chloro-5-dodecyloxycarbonylphenyl)sulfamoyl group and N-(2-tetradecyloxyphenyl)sulfamoyl group.

The group represented by R¹ may further have those groups mentioned as the examples of the substituent on the 5 to 7-membered unsaturated ring represented by Q¹ at the substituent position, and in a case where two or more substituents are present, the substituents may be the same or different from each other.

Among the compound represented by the general formula (1), those in which Q¹ is a 5- or 6-membered unsaturated ring are preferred, and Q¹ is more preferably a benzene ring, pyrimidine ring, 1,2,3-triazole ring, 1,2,4-triazole ring, tetrazole ring, 1,3,4-thiadiazole ring, 1,2,4-thiodiazole ring, 1,3,4-oxathiazole ring, 1,2,4-oxadiazole ring, thiazole ring, oxazole ring, isothiazole ring, isooxazole ring or a ring in which the aforementioned ring is condensed with a benzene ring or an unsaturated hetero ring, with a quinazoline ring being particularly preferred. Q¹ preferably has at least one electron attractive substituent and the preferred examples of the substituent include a fluoroalkyl group (e.g., trifluoromethyl group, pentafluoroethyl group, 1,1,-difluoroethyl group, difluoromethyl group, fluoromethyl group, heptafluoropropyl group, pentafluorophenyl group), cyano group, halogen atom (fluorine, chlorine, bromine, iodine), acyl group, alkoxycarbonyl group, carbamoyl group, alkylsulfonyl group, and arylsulfonyl group, and trifluorophenyl group can be mentioned as the particularly preferred substituent.

R¹ is preferably a carbamoyl group, and particularly preferably, a substituted carbamoyl group wherein R¹ is represented by —C═O—NH—R¹¹ in which R¹¹ represents an alkyl group or an aryl group having 1 to 10 carbon atoms.

Specific examples of the reducing compound represented by the general formula (1) are shown below, however, the compounds usable in the invention are not restricted thereto.

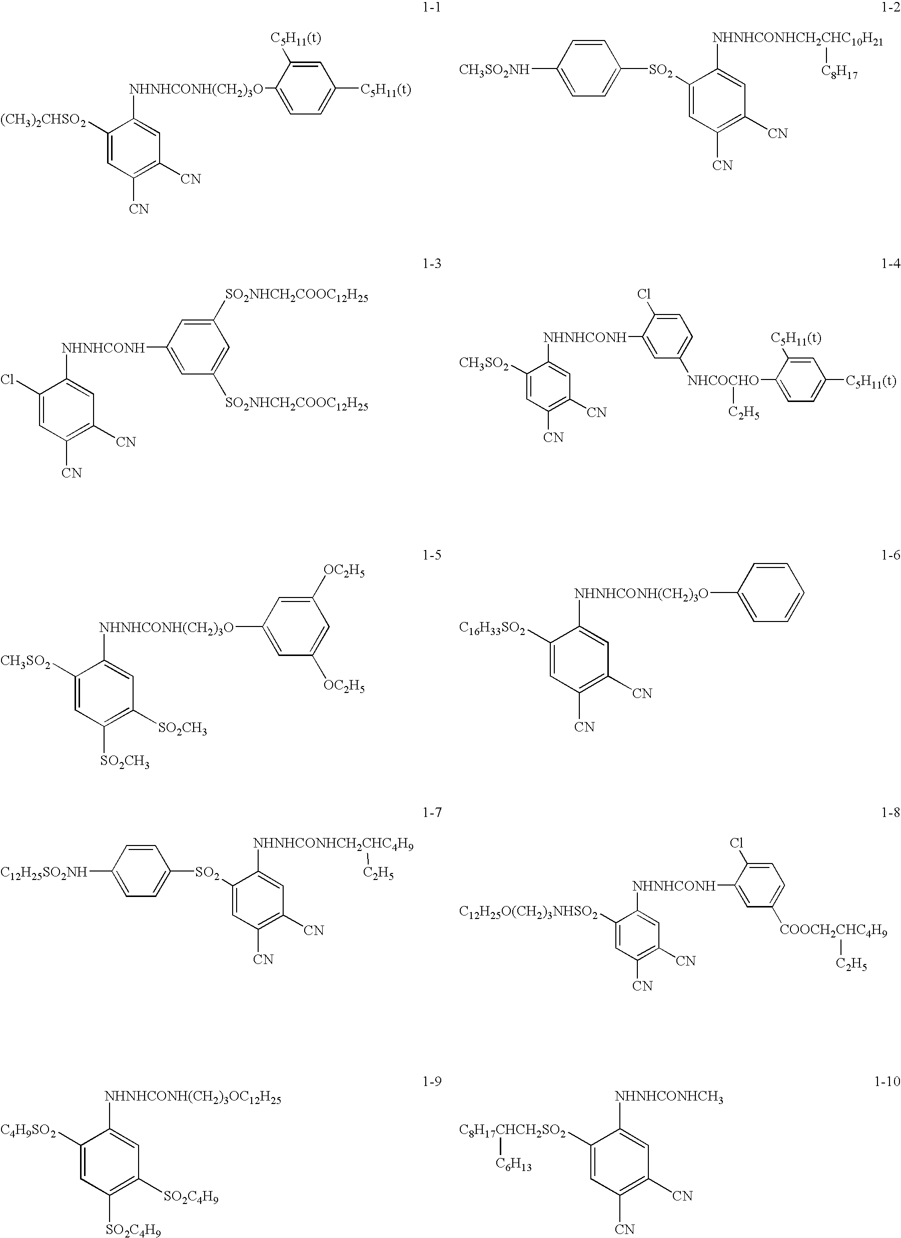

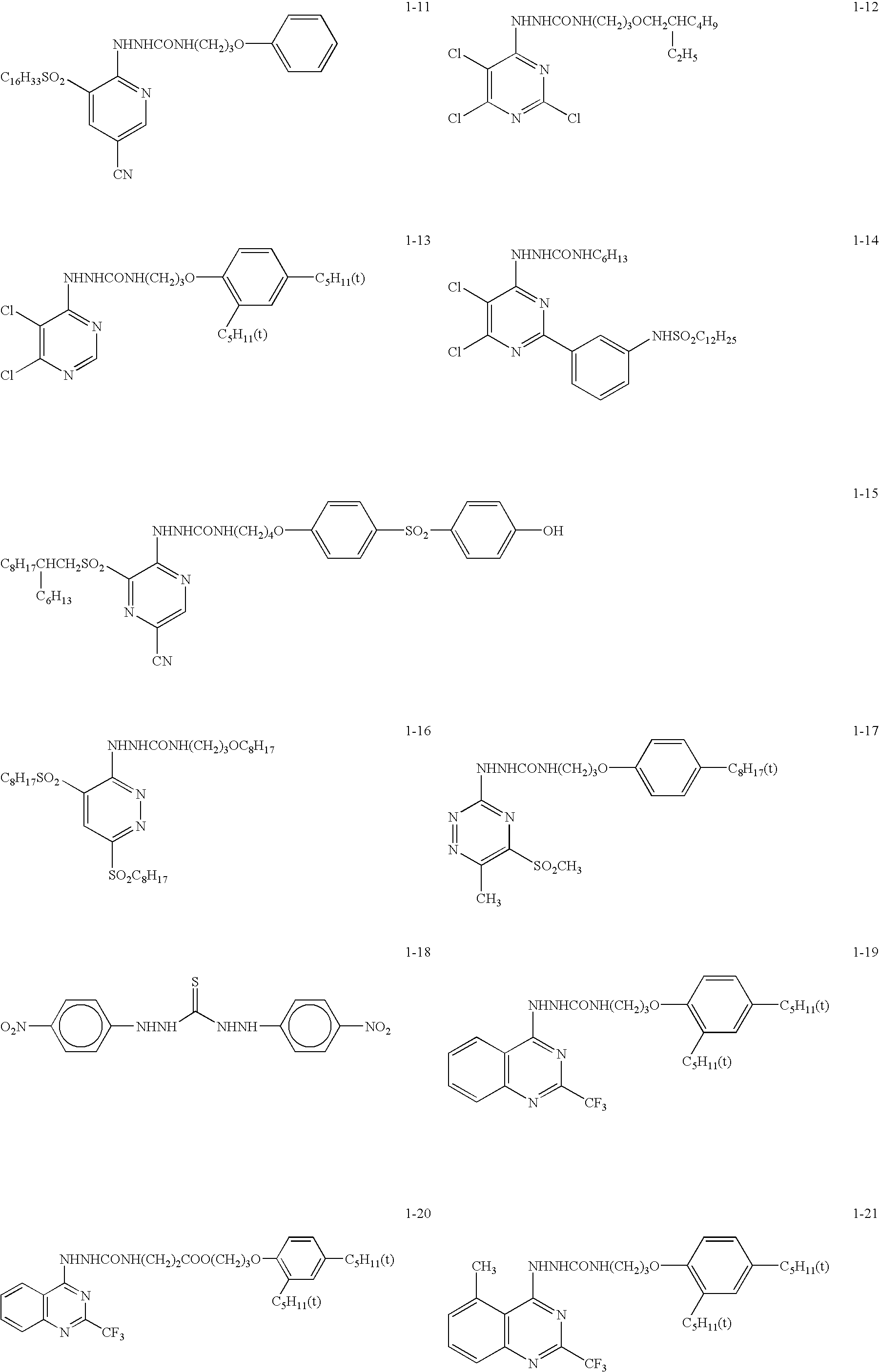

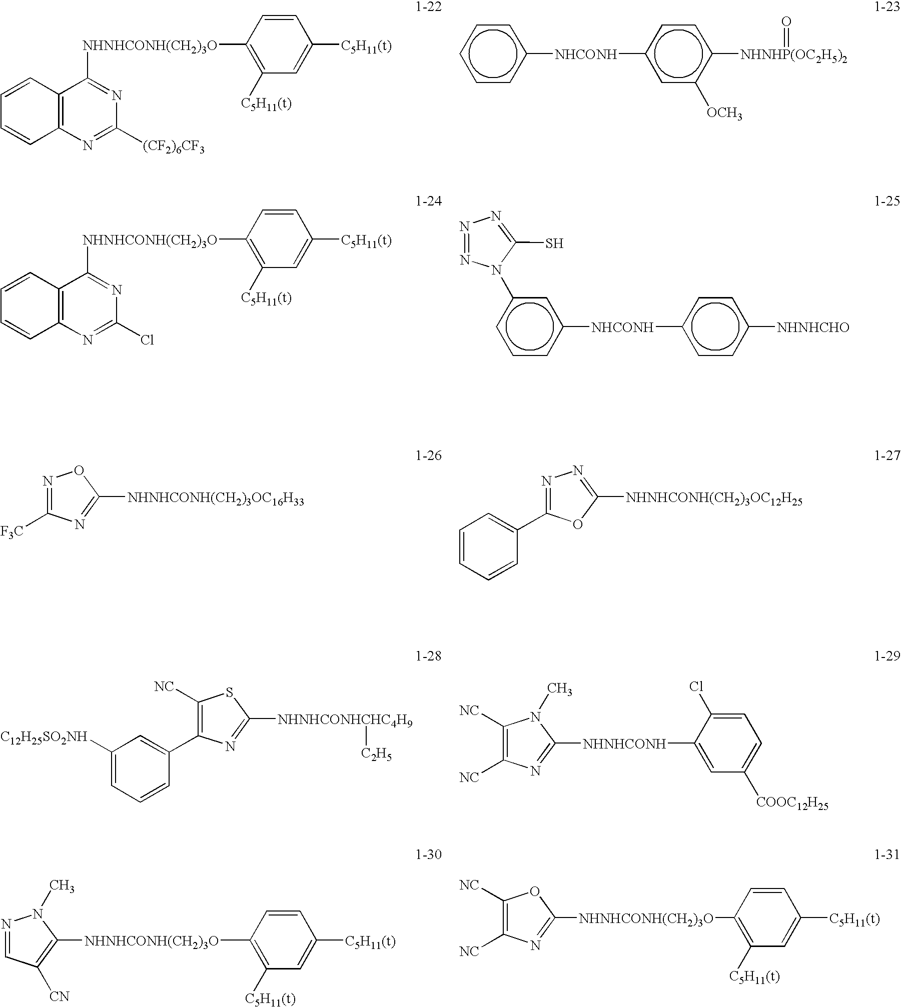

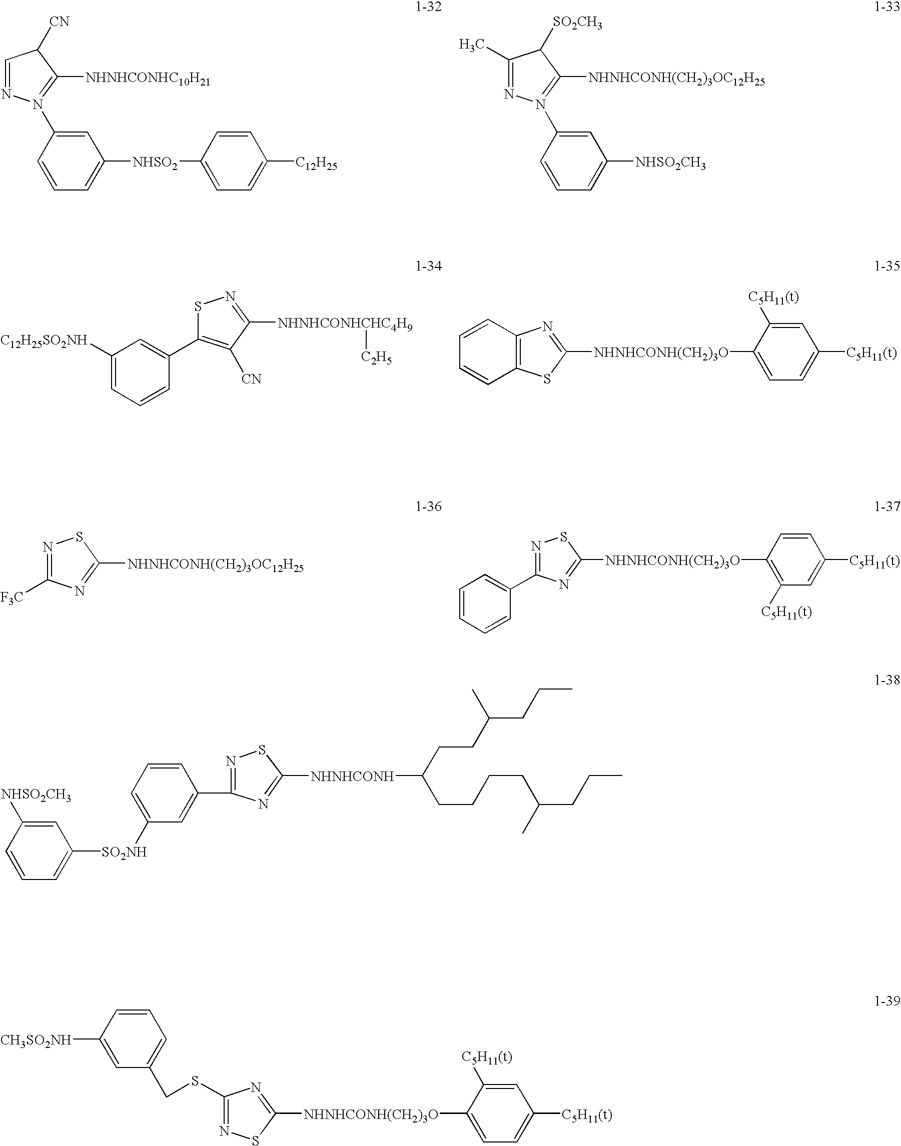

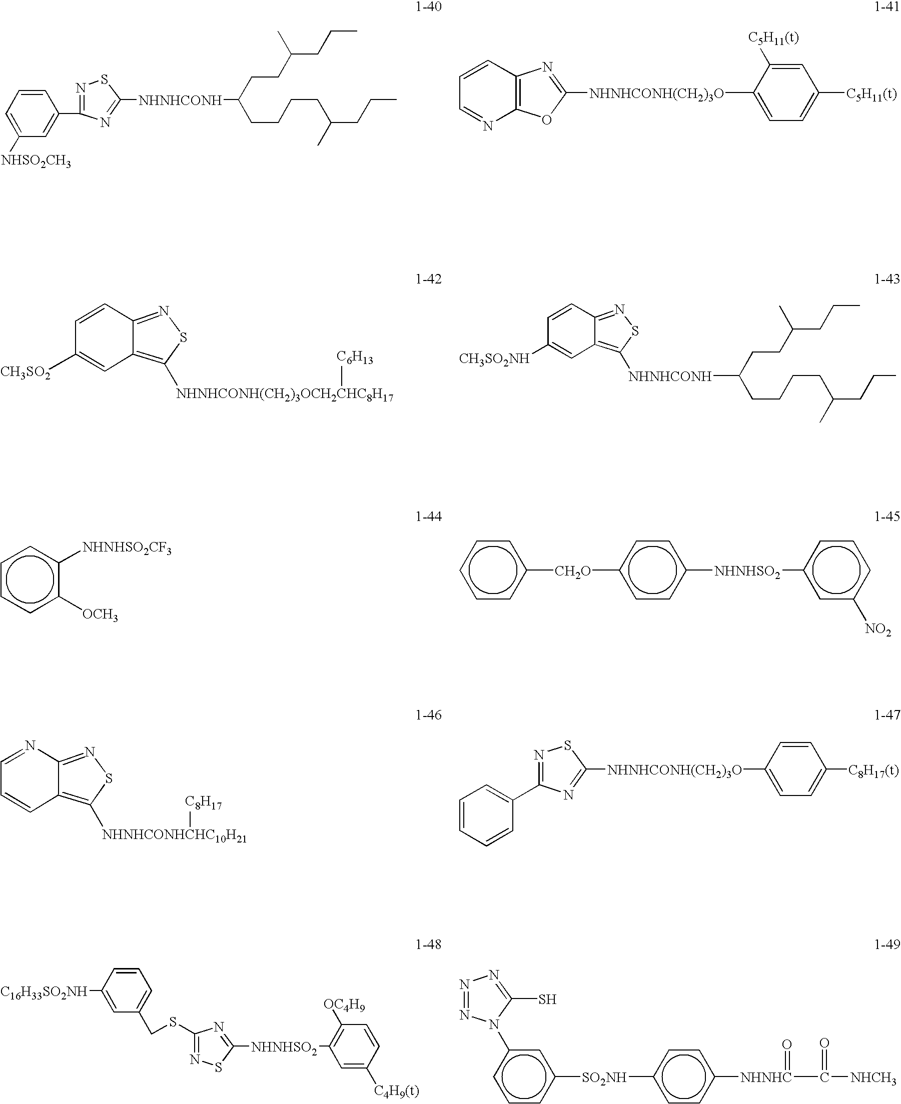

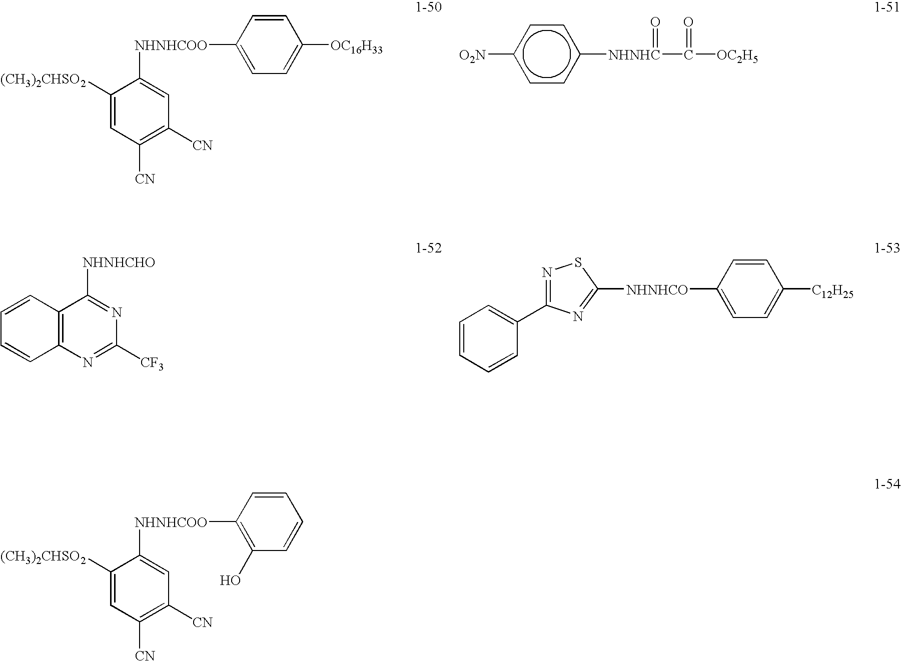

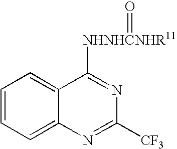

| Compound No. | R¹¹ |
|---|---|
| 1-55 | CH₃ |
| 1-56 | C₂H₅ |
| 1-57 | (n) C₃H₇ |
| 1-58 | (i) C₃H₇ |
| 1-59 | (n) C₄H₉ |
| 1-60 | (i) C₄H₉ |
| 1-61 | (sec) C₄H₉ |
| 1-62 | (t) C₄H₉ |
| 1-63 | (n) C₅H₁₁ |
| 1-64 | (t) C₅H₁₁ |
| 1-65 | (n) C₆H₁₃ |
| 1-66 | 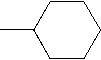 |
| 1-67 | (n) C₈H₁₇ |
| 1-68 | (t) C₈H₁₇ |
| 1-69 | 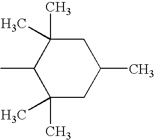 |
| 1-70 | 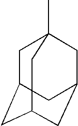 |
| 1-71 | 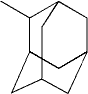 |
| 1-72 | 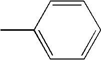 |
| 1-73 | 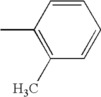 |
| 1-74 | 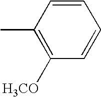 |
| 1-75 | 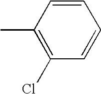 |
| 1-76 | 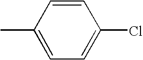 |
| 1-77 | 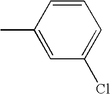 |
| 1-78 | 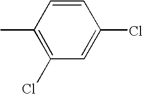 |
| 1-79 | 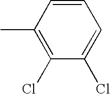 |
| 1-80 | 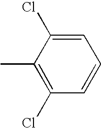 |
| 1-81 | 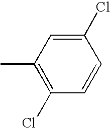 |
| 1-82 | 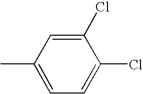 |
| 1-83 | 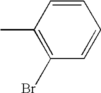 |
| 1-84 | 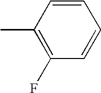 |
| 1-85 | 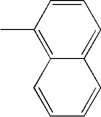 |
| 1-86 | 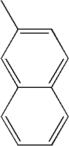 |
| 1-87 | 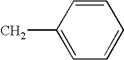 |
| 1-88 | 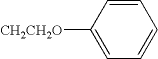 |
| 1-89 | CH₂CH₂OCH₂CH₃ |
| 1-90 | CH₂CH₂OCH₃ |

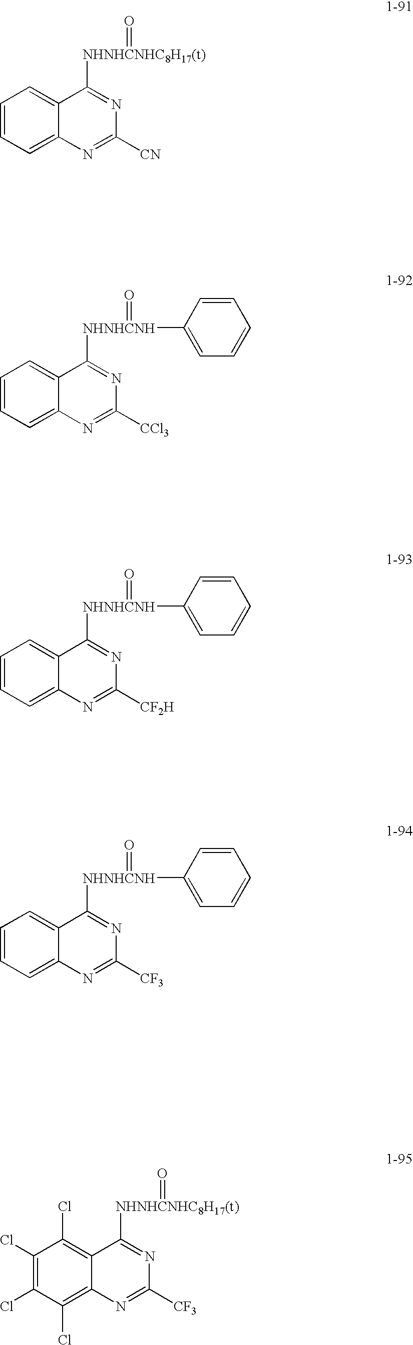

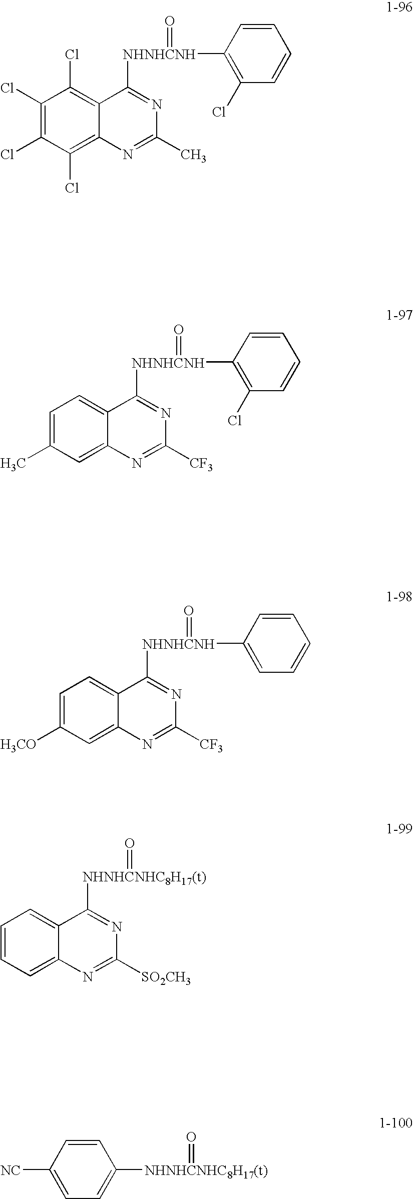

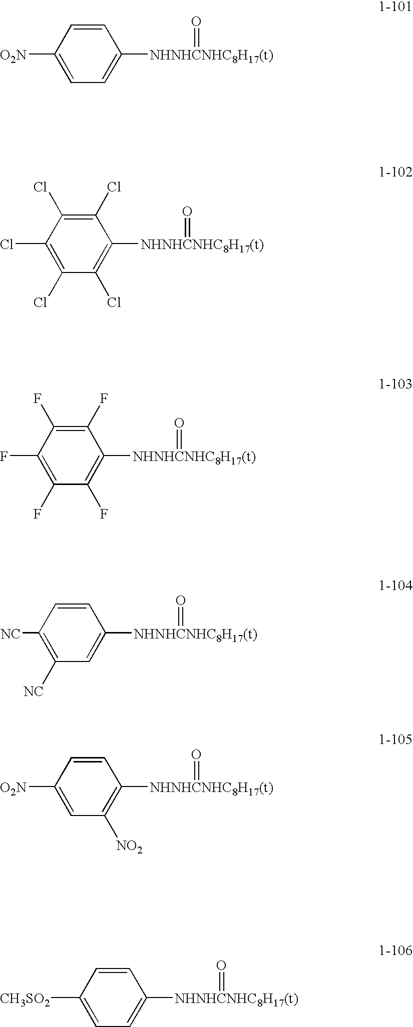

Synthesis for the reducing compounds represented by the general formula (1) may be implemented in accordance with the methods as described, for example, in JP-A Nos. 9-152702, 8-286340, 9-152700, 9-152701, 9-152703 and 9-152704.

The addition amount of the reducing compound represented by the general formula (1) may vary within a wide range, and it is preferably 0.01 to 100 molar times, and more preferably 0. to 10 molar times based on the silver ions.

The reducing compound represented by the general formula (1) may be added to the coating solution by any method such as in the form of solution, powder, solid dispersion of fine particles, emulsion and oil protect dispersion. Particularly, it is preferably added as solid fine particles in a case of using together with the polymer latex of the invention. The solid dispersion of fine particles can be conducted by known particulating means (e.g., ball mill, vibration ball mill, sand mill, colloid mill, jet mill and roller mill), pulverization using the sand mill being particularly preferred. Further, a dispersing aid may also be used when the fine solid particles are dispersed.

<Compound Represented by the General Formulae (5) and (6)>

The compounds represented by the general formula (5) and (6) are described below.

In the general formulae (5) and (6), X¹¹ and X² each independently represent a hydrogen atom or a substituent. Examples of the substituent represented by X¹¹ and X² include a halogen atom (e.g., fluorine atom, chlorine atom, bromine atom and iodine atom), an aryl group (having carbon atoms of preferably 6 to 30, more preferably 6 to 20, and further preferably 6 to 12, for example, phenyl group, p-methylphenyl group, and naphthyl group), alkoxy group (having carbon atoms of preferably, 1 to 20, more preferably 1 to 12, and further preferably, 1 to 8, for example, methoxy group, ethoxy group and butoxy group), aryloxy group (having carbon atoms of preferably 6 to 20, more preferably 6 to 16, and further preferably 6 to 12, for example, phenyloxy group and 2-naphthyloxy group), alkylthio group (having carbon atoms of preferably 1 to 20, more preferably 1 to 16, and further preferably 1 to 12, for example, methylthio group, ethylthio group and butylthio group), arylthio group (having carbon atoms of preferably of 6 to 20, more preferably 6 to 16, and further preferably 6 to 12, for example, phenylthio group, and naphthylthio group), acyloxy group (having carbon atoms of preferably 1 to 20, more preferably 2 to 16, and further preferably 2 to 10, for example, acetoxy group, and benzoyloxy group), acylamino groups (having carbon atoms of preferably 2 to 20, more preferably 2 to 16, and further preferably 2 to 10, for example, N-methylacetylamino group and benzoylamino group), sulfonylamino group (having carbon atoms of preferably 1 to 20, more preferably 1 to 16, and further preferably 1 to 12, for example, methanesulfonylamino group and benzenesulfonylamino group), carbamoyl group (having carbon atoms of preferably 1 to 20, more preferably 1 to 16, and further preferably 1 to 12, for example, carmoyl group, N,N-diethylcarbamoyl group and N-phenylcarbamoyl group), acyl group (having carbon atoms of preferably 2 to 20, more preferably 2 to 16, and further preferably 2 to 12, for example, acetyl group, benzoyl group, formyl group, pivaloyl group), alkoxycarbonyl group (having carbon atoms of preferably 2 to 20, more preferably 2 to 16, and further preferably 2 to 12, for example, methoxycarbonyl group), sulfo group and sulfonyl group (having carbon atoms of preferably 1 to 20, more preferably 1 to 16, and further preferably 1 to 12. For example, mesyl group and tosyl group), sulfonyloxy group (having carbon atoms of preferably 1 to 20, more preferably 1 to 16, and further preferably 1 to 12, for example, methanesulfonyloxy group and benzenesyulfonyloxy group), azo group, heterocyclic group, heterocyclic mercapto group and cyano group. The heterocyclic group as used herein refers to a saturated or unsaturated heterocyclic group, and can include, for example, pyridyl group, quinolyl group, quinoxalinyl group, pyradinyl group, benzotriazolyl group, pyrazolyl group, imidazolyl group, benzoimidazolyl group, tetrazolyl group, hydantoin- 1-yl group, succinimide group and phthalimide group.

The substituent represented by X¹¹ and X² in the general formula (5) or general formula (6) is preferably an alkoxy group or an aryloxy group. The substituent represented by X¹¹ and X² may be further substituted with another substituent and any conventionally known substituent may be used insofar as it does not impair the photographic performance.

In the general formulae (5) and (6), R² to R⁴ each independently represent a hydrogen atom or a substituent. m and p each independently represent an inter of 0 to 4, and n represents an integer of 0 to 2.

As the substituent represented by R² to R⁴, any substituent may be used so long as it does not adversely affect the photographic property. For example, it may be a halogen atom (e.g., fluorine atom, chlorine atom, bromine atom or iodine atom), linear, branched, or cyclic alkyl group or combination thereof (having carbon atoms of preferably 1 to 20, more preferably 1 to 16, and further preferably 1 to 13, for example, methyl group, ethyl group, n-propyl group, isopropyl group, sec-butyl group, tert-butyl group, tert-octyl group, n-amyl group, tert-amyl group, n-dodecyl group, n-tridecyl group and cyclohexyl group), alkenyl group (having carbon atoms of preferably 2 to 20, more preferably 2 to 16, and further preferably 2 to 12, for example, vinyl group, aryl group, 2-butenyl group and 3-pentenyl group), aryl group (having carbon atoms of preferably 6 to 30, more preferably 6 to 20, and further preferably 6 to 12, for example, phenyl group, p-methyl group and naphthyl group), alkoxy group (having carbon atoms of, preferably, 1 to 20, more preferably, 1 to 16 and, further preferably, 1 to 12, for example, methoxy group, ethoxy group, propoxy group and butoxy group), aryloxy group (having carbon atoms of preferably 6 to 30, more preferably 6 to 20, and further preferably 6 to 12, for example, phenyloxy group and 2-naphthyloxy group), acyloxy group (having carbon atoms of preferably 2 to 20, more preferably 2 to 16, and further preferably 2 to 12, for example, acetoxy group and benzoyloxy group), amino group (having carbon atoms of preferably 0 to 20, more preferably 1 to 16, and further preferably 1 to 12, for example, dimethylamino group, diethylamino group, dibutylamino group and anilino group), acylamino group (having carbon atoms of preferably 2 to 20, more preferably 2 to 16, and further preferably 2 to 13. for example, acetylamino group, tridecanoylamino group and benzoylamino group), sulfonylamino groups (having carbon atoms of preferably 1 to 20, more preferably 1 to 16, and further preferably 1 to 12. For example, methanesulfonylamino group, butanesulfonylamino group and benzenesulfonylamino group), ureido group (having carbon atoms of preferably 1 to 20, more preferably 1 to 16, and further preferably 1 to 12, for example, ureido group, methylureido group and phenylureido group), carbamate group (having carbon atoms of preferably 2 to 20, more preferably 2 to 16, and further preferably 2 to 12, for example, methoxycarbonylamino and phenyloxycarbonylamino) carboxyl group, carbamoyl group (having carbon atoms of preferably 1 to 20, more preferably 1 to 16, and further preferably 1 to 12, for example, carbamoyl group, N,N-diethylcarbamoyl group, N-dodecylcarbamoyl group and N-phenylcarbamoyl group), alkoxycarbonyl group (having carbon atoms of preferably 2 to 20, more preferably 2 to 16, and further preferably 2 to 12, for example, methoxycarbonyl group, ethoxycarbonyl group, and butoxycarbonyl group), acyl group (having carbon atoms of preferably 2 to 20, more preferably 2 to 16, and further preferably 2 to 12, for example, acetyl group, benzoyl group, formyl group and pivaroyl group), sulfo group, sulfonyl group (having carbon atoms of preferably 1 to 20, more preferably 1 to 16, and further preferably 1 to 12, for example, mesyl group and tosyl group), sulfamoyl group (having carbon atoms of preferably 0 to 20, more preferably 0 to 16, and further preferably 0 to 12, for example, sulfamoyl group, methylsulfamoyl group, dimethylsulfamoyl group, and phenylsulfamoyl group), cyano group, nitro group, hydroxyl group, mercapto group, alkylthio groups (having carbon atoms of preferably 1 to 20, more preferably 1 to 16, and further preferably 1 to 12, for example, methylthio group and butylthio group, heterocyclic ring (having carbon atoms of preferably 2 to 20, more preferably 2 to 16, and further preferably 2 to 12. For example, pyrimidyl group, imidazoyl group and pyrrolidyl group). The substituent described above may be further substituted with an additional substituent.

Preferred substituent represented by R² to R⁴, among them, are a halogen atom, an alkyl group, aryl group, alkoxy group, aryloxy group, acyloxy group, anilino group, acylamino group, sulfonylamino group, carboxyl group, carbamoyl group, acyl group, sulfo group, sulfonyl group, sulfamoyl group, cyano group, hydroxyl group, mercapto group, alkylthio group and heterocyclic ring.

The compound represented by the general formula (6) has, further preferably, at 2-position, a carbamoyl group (having carbon atoms of preferably 1 to 20, more preferably 1 to 16, and further preferably 1 to 12, for example, carbamoyl group, N,N-diethylarbamoyl group, N-dodecylcarbamoyl group, N-phenylcarbamoyl group, N-(2-chlorophenyl)carbamoyl group, N-(4-chlorophenyl)carbamoyl group, N-dichlorophenyl) (2,4-dichlorophenyl)carbamoyl group and N-(3,4-carbamoyl group), and has, particularly preferably, at 2-position, acylcarbamoyl group (having carbon atoms of preferably 7 to 20, more preferably 7 to 16, and further preferably 7 to 12, for example, N-phenylcarbamoyl group, N-(2-chlorophenyl)carbamoyl group, N-(4-chlorophenyl) carbamoyl group, N-(2,4-dichlorophenyl)carbamoyl group and N-(3,4-dichlorophenyl)carbamoyl group).

Specific examples of the compound represented by the general formula (6) are shown below, however, the compounds used in the invention are not restricted thereto.

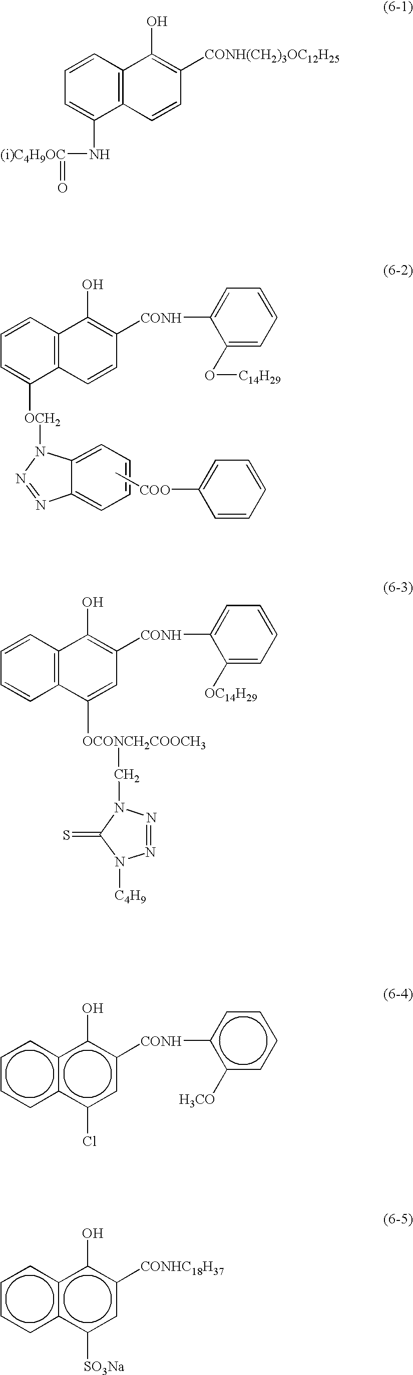

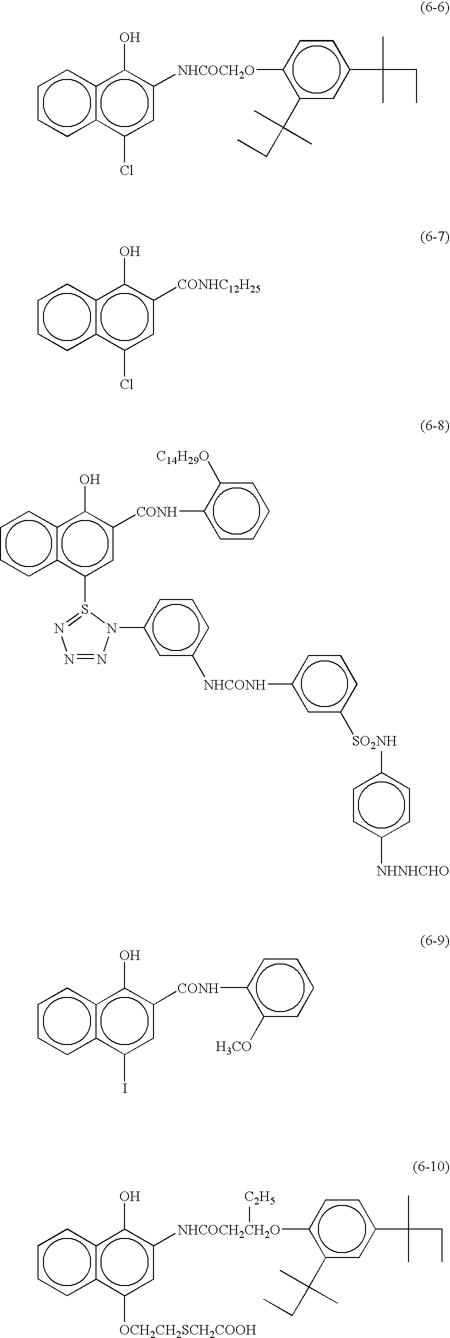

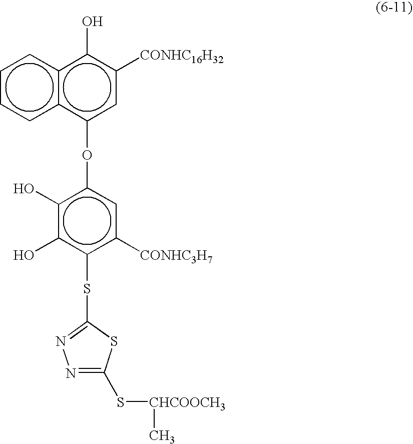

The compounds represented by the general formulae (5) and (6) used in the invention may readily be synthesized by methods known in the field of photography.

The compound represented by the general formulae (5) and (6) of the invention can be used being dissolved for example, in water or an appropriate organic solvent, for example, alcohols (methanol, ethanol, propanol, fluorinated alcohol), ketones (acetone and methyl ethyl ketone), dimethylformamide, dimethylsufloxide or methyl cello solve.

Alternatively, the compared may be dissolved by a well-known emulsifying dispersion method by using an oil such as dibutyl phthalate, tricresyl phosphate, glyceryl triacetate, and diethyl phthalate, and an auxiliary solvent such as ethyl acetate or cyclohexanone and mechanically preparing an emulsified dispersion for use. Alternatively, a powder of the compound may be used by being dispersed in water in accordance with a well-known solid dispersing method using a ball mill, colloid mill, sand grinder mill, MANTONGORIN, micro fluidizer or ultrasonic waves.

The compound represented by the general formulae (5) and (6) according to the invention may be added to any layer disposed on the support so long as it is provided at one identical surface to a photosensitive silver halide and an organic silver salt that may be reduced and it is preferably added to a layer containing a photosensitive silver halide or a layer adjacent thereto.

The addition amount of the compound represented by the general formula (5) and (6) used in the invention is preferably from 0.2 to 200 mmol, more preferably, 0.3 to 100 mmol, and further preferably 0.5 to 30 mmol per one mol of silver. The compound represented by the formula (5) and (6) of the invention may be used alone or in combination of two or more thereof. Particularly, combined use of the compound of the general formula (1) and the compound of the general formula (6) is preferred.

<Description for General Formula (2) or (3)>

The compound having the general formula (5) is further preferably represented by the following general formula (2) or (3).

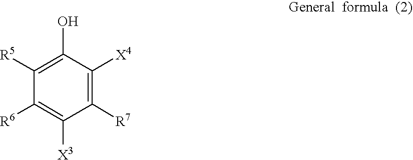

In the general formula (2), R⁵, R⁶, R⁷, X³ and X⁴ each independently represent a hydrogen atom; a halogen atom; or a substituent bonded to a benzene ring via a carbon atom, oxygen atom, nitrogen atom, sulfur atom or phosphorus atom. However, at least one of X³ and X⁴ is a group represented by —NR⁸R⁹. R⁸ and R⁹ each independently represent, a hydrogen atom, alkyl group, alkenyl group, alkinyl group, aryl group, heterocyclic group or a group represented by —C(═O)—R, —C(═O)—C(═)—R, —SO₂—R, —SO—R, —P(═O)(R)₂ or —C—(═NR′)—R. R, R′ each independently represent a group selected from a hydrogen atom, an alkyl group, aryl group, heterocyclic group, amino group, alkoxy group, and aryloxy group. Adjacent groups of the substituents described above may be bonded with each other to form a ring.

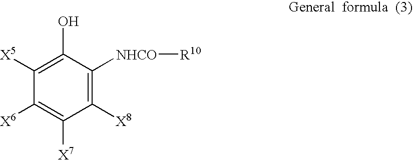

In the general formula (3), X⁵ represents a substituent, and X⁶ to X⁸ each independently represent a hydrogen atom or a substituent. However, X⁵ to X⁸ are not hydroxyl groups and X⁷ is not a sulfoneamide group. The substituents represented by X⁵ to X⁸ may be bonded with each other to form a ring. R¹⁰ represents a hydrogen atom, an alkyl group, aryl group, heterocyclic group, amino group or alkoxy group.

The development accelerator of the general formula (2) is described below.

R⁵, R⁶, R⁷ each independently represent a hydrogen atom; a halogen atom; or a substituent bonded ith a benzene ring via a carbon atom, oxygen atom, nitrogen atom, sulfur atom or phosphorus atom. Non-limiting specific examples of the substituent bonded via the carbon atom with the benzene ring are linear, branched or cyclic alkyl group (including, for example, methyl group, ethyl group, isopropyl group, tert-butyl group, n-octyl group, tert-amyl group, 1,3-tetramethylbutyl group, and cyclohexylg group), alkenyl groups (e.g., vinyl group, allyl group, 2-butenyl group and 3-pentenyl group), alkinyl group (including, for example, propagyl group and 3-pentinyl group), aryl group (including, for example, phenyl group, p-methylphenyl group, and naphthyl group), acyl group (including, for example, acetyl group, benzoyl group, formyl group and pivaroyl group), alkoxycarbonyl group (including, for example, methoxycarbonyl group, and ethoxycarbonyl group), aryloxycarbonyl group (including, for example, phenoxycarbonyl group), carbamoyl group (including, for example, carbamoyl group, diethylcarbamoyl group and phenylcarbamoyl group), cyano group, carboxyl group and heterocyclic group (including, for example, 3-pyrazolyl group).

Non-limitating specific examples of the substituent bonded via the oxygen atom with the benzene ring are hydroxyl group, alkoxy group (including, for example, methoxy group, ethoxy group and butoxy group), aryloxy group (including, for example, phenyloxy group, and 2-naphthyloxy group), heterocyclic group (including, for example, 4-pyridyloxy group), acyloxy group (including, for example, acetoxy group and benzoyloxy group). Specific non-limiting examples of the substituent bonded via the nitrogen atom with the benzene ring are amino group (including, for example, amino group, methylamino group, dimethylamino group, diethylamino group and dibenzylamino group), nitro group, hydrazido group, heterocyclic group (including, for example, 1-imidazolyl group, and morpholyl group), acylamino group (including, for example, acetylamino group and benzoyl amino group), alkoxycarbonylamino group (including, for example, methoxycarbonylamino group), aryloxycarbonylamino group (including, for example, phenyloxycarbonylamino group), sulfonylamino group (including, for example, methanesulfonylamino group, and benzene sulfonylamino group), sulfamoyl group (including, for example, sulfamoyl group, methylsulfamoyl group, dimethylsulfamoyl group and phenylsulfamoyl group), ureido group (including, for example, ureido group, methylureido group, and phenyl ureido group), phosphorylamino group (including, for example, diethylphosphorylamino group), imide group (including, for example, succinimide, phthalimide and trifluoromethane sulfone imide). Specific non-limiting examples of the substituent bonded by way of the sulfur atom with the benzene ring are mercapto group, disulfide group, sulfo group, sulfino group, sulfonylthio group, thiosulfonyl group, alkylthio group (including, for example, methylthio group and ethylthio group), arylthio group (including, for example, phenylthio group), sulfonyl group (including, for example, mesyl group, tosyl group and phenylsulfonyl group), sulfinyl group (including, for example, methanesulfinyl group and benzenesulfinyl group), and heterocyclic thio group (including, for example, 2-imidazolylthio group). Specific non-limiting examples for the substituent bonded via the phosphorus atom with the benzene ring are phosphate ester group (including, for example, diethylphosphate and diphenylphosphates).

Preferred R⁵, R⁶ and R⁷ include a hydrogen atom, a halogen atom, linear, branched or cyclic alkyl group, aryl group, acyl group, alkoxycarbonyl group, aryloxycarbonyl group, cyano group, carboxyl group, heterocyclic group, hydroxyl group, alkoxy group, aryloxy group, heterocyclicoxy group, acyloxy group, amino group, nitro group, acylamino group, alkoxycarbonylamino group, aryloxycarbonylamino group, sulfonylamino group, imide group, sulfamoyl group, carbamoyl group, ureido group, mercapto group, disulfide group, sulfo group, sulfino group, alkylthio group, arylthio group, sulfonyl group, sulfinyl group, and heterocyclicthio group. More preferred R⁵, R⁶, and R⁷ include a hydrogen atom, halogen atom, a linear or branched or cyclic alkyl group, aryl group, acyl group, alkoxycarbonyl group, aryloxycarbonyl group, cyano group, carboxyl group, heterocyclic group, hydroxyl group, alkoxy group, aryloxy group, acyloxy group, amino group, nitro group, acylamino group, alkoxycarbonylamino group, aryloxycarbonylamino group, sulfonylamino group, imide group, carbamoyl group, mercapto group, sulfo group, alkylthio group, arylthio group and sulfonyl group.

Particularly preferred R⁵, R⁶ and R⁷ include a hydrogen atom, a halogen atom, a linear, branched or cyclic alkyl group, aryl group, acyl group, alkoxycarbonyl group, aryloxycarbonyl group, cyano group, carboxyl group, acyloxy group, acylamino group, alkoxycarbonylamino group, aryloxycarbonylamino group, sulfonylamino group, carbamoyl group, sulfo group, alkylsulfonyl group, and arylsulfonyl group.

X³and X⁴ each represent a hydrogen atom; a halogen atom; or a substituent bonded with the benzene ring via a carbon atom, oxygen atom, nitrogen atom, sulfur atom or phosphorus atom. Specific non-limiting examples for the substituent bonded via the carbon atom with the benzene ring are a linear, branched or cyclic alkyl group (e.g., methyl, ethyl group, iso-propyl group, tert-butyl group, n-octyl group, tert-amyl group, 1,3-tetramethylbutyl group, and cyclohexyl group), alkenyl group (e.g., vinyl group, allyl group, 2-butenyl group, and 3-pentenyl group), alkinyl group (e.g., propargyl group, and 3-pentinyl group), aryl group (e.g., phenyl group, p-methylphenyl group, and naphthyl group), acyl group (e.g., acetyl group, benzoyl group, formyl group, and pivaroyl group), alkoxycarbonyl group (for example, methoxycarbonyl group, and ethoxycarbonyl group), aryloxycarbonyl group (e.g., phenoxy carbonyl group), cyano group, carboxyl group, heterocyclic group (e.g., 3-pyrazolyl group), carbamoyl group (e.g., carbamoyl group, diethylcarbamoyl group, phenylcarbamoyl group). Specific non-limiting examples for the substituent bonded via the oxygen atom with the benzene ring include hydroxyl group, alkoxy group (for example, methoxy group, ethoxy group, and butoxy group), aryloxy group (e.g., phenyloxy group, and 2-naphthyloxy group), heterocyclicoxy group (e.g., 4-pyridyloxy group), and acyloxy group (e.g., acetoxy group, and benzoyloxy group).

Specific non-limiting examples for the substituent bonded via the nitrogen atom with the benzene ring include an amino group (e.g., amino group, methylamino group, dimethylamino group, diethylamino group, and dibenzylamino group), nitro group, hydroxame group, hydrazino group, heterocyclic group (e.g., 1-imidazolyl group, and morpholyl group), acylamino group (e.g., acetylamino group, and benzoylamino group), alkoxycarbonylamino group (e.g., methoxycarbonylamino group), aryloxocarbonylamino group (e.g., phenoloxycarbonylamono group), sulfonylamino group (e.g., methanesulfonylamino group, and benzenesulfonylamino group), sulfamoyl group (e.g., sulfamoyl group, methylsulfamoyl group, dimethylsulfamoyl group, and phenylsulfamoyl group), phosphorylamino group (e.g., diethylphosphorylamino group). Specific non-limiting examples for the substituent bonded via the sulfur atom with the benzene ring include mercapto group, disulfide group, sulfo group, sulfino group, sulfonylthio group, thiosulfonyl group, alkylthio group (e.g., methylthio group, and ethylthio group), arylthio group (for example, phenylthio group), sulfonyl group (for example, mesyl group, tosyl group, and phenylsulfonyl group), sulfinyl group (e.g., methanesulfinyl group, and benzenesulfinyl group), heterocyclicthio group (for example, 2-imidazolylthio group). Specific non-limiting examples for the substituent bonded via the phosphorus atom with the benzene ring include phosphate ester group (e.g., diethyl phosphate group and diphenyl phosphate group).

Preferred X³ and X⁴ include a hydrogen atom, a halogen atom, a linear, branched or cyclic alkyl group, aryl group, acyl group, alkoxycarbonyl group, aryloxycarbonyl group, cyano group, carboxyl group, heterocyclic group, hydroxyl group, alkoxy group, aryloxy group, heterocyclicoxy group, acyloxy group, amino group, nitro group, acylamino group, alkoxycarbonylamino group, aryloxycarbonylamino group, sulfonylamino group, imide group, sulfamoyl group, carbamoyl group, ureido group, mercapto group, disulfide group, sulfo group, alkylthio group, arylthio group, sulfonyl group, and heterocyclic group. More preferred X¹, X² can include a hydrogen atom, a halogen atom, a linear or branched or cyclic alkyl group, aryl group, acyl group, alkoxycarbonyl group, aryloxycarbonyl group, cyano group, carboxyl group, hydroxyl group, alkoxy group, aryloxy group, acyloxy group, amino group, acylamino group, alkoxycarbonylamino group, aryloxycarbonylamino group, sulfonylamino group, imide group, carbamoyl group, sulfo group, and arylsulfonyl group.

Particularly preferred X³ and X⁴ include a hydrogen atom, a halogen atom, a linear, branched or cyclic alkyl group, aryl group, acyl group, alkoxycarbonyl group, aryloxycarbonyl group, cyano group, carboxyl group, alkoxy group, aryloxy group, acyloxy group, acylamino group, alkoxycarbonylamino group, aryloxycarbonylamino group, sulfonylamino group, carbamoyl group, mercapto group and alkylthio group.

At least one of X³ and X⁴ is a group represented by —NR⁸R⁹. R⁸ and R⁹ each independently represent a hydrogen atom, an alkyl group, alkenyl group, alkyl group, aryl group, heterocyclic group or a group represented by —C(═O)—R, —C(═O)—C(═O)—R, —SO₂—R, —SO—R, —P(═O)(R)₂ and —C—(═NR′)—R. R and R′ each independently represent a group selected from a hydrogen atom, an alkyl group, aryl group, heterocyclic group, amino group, alkoxy group, and aryloxy group. When R⁸ and R⁹ each represent a hydrogen atom, an alkyl group, alkenyl group, alkinyl group, aryl group and heterocyclic group, they represent, for example, a linear, branched or cyclic alkyl group (e.g., methyl group, ethyl group, iso-propyl group, tert-butyl group, n-octyl group, tert-amyl group, 1,3-tetramethylbutyl group, and cyclohexyl group), alkenyl group (e.g., vinyl group, aryl group, 2-butenyl group, 3-pentenyl group), alkinyl group (e.g., propargyl group, and 3-pentenyl group), aryl group (e.g., phenyl group, p-methylphenyl group, and naphthyl group), heterocyclic group (e.g., 2-imidazolyl group and 1-pyrazolyl group).

In a case where R⁸ and R⁹ is a group represented by —C(═O)—R, —C(═O)—C(═O)—R, —SO₂—R, —SO—R, —P(═O)(R)₂ and —C—(═NR′)—R, R and R′ each independently represent, for example, a hydrogen atom, an alkyl group (e.g., methyl group, ethyl group, iso-propyl group, tert-butyl group, n-octyl group, tert-amyl group, 1,3-tetramethylbutyl group, and cyclohexyl group), aryl group (e.g., phenyl group, p-methylphenyl group, and naphthyl group), heterocyclic group (e.g., 4-pyridyl group, 2-thienyl group, and 1-methyl-2-pyrrolyl group), amino group (e.g., amino group, dimethylamino group, diphenylamino group, phenylamino group, and 2-pyridylamino group), alkoxy group (e.g., methoxy group, ethoxy group, and cyclohexyloxy group), and aryloxy group (e.g., phenoxy group, and 2-naphthoxy group).

Preferred R8 and R⁹ can include a hydrogen atom, a linear, branched or cyclic alkyl group, aryl group, acyl group, alkoxycarbonyl group, aryloxycarbonyl group, sulfamoyl group, carbamoyl group, sulfonyl group, and sulfinyl group. More preferred R⁸ and R⁹ include a hydrogen atom, a linear, branched or cyclic alkyl group, aryl group, acyl group, and sulfonyl group. Further, in a particularly preferred combination, one of R⁸ and R⁹ is a hydrogen atom and the other is an alkylsulfonyl group, or arylsulfonyl group. The substituent may further be substituted with the substituent described above. Further, when the substituent carries a hydrogen atom having high acidity, its proton may be dissociated to form a salt. As the pair cation, metal ion, ammonium ion or phosphonium ion is used. The state in which the active hydrogen is dissociated provides an effective countermeasure to a case where the volatility of the compound during development poses a problem. In R⁵, R⁶, R⁷, X³ and X⁴, each of adjacent groups may be joined with each other to form a ring.

The compounds represented by the general formula (2) used in the invention are shown below. However the compounds used in the invention are not restricted thereto.

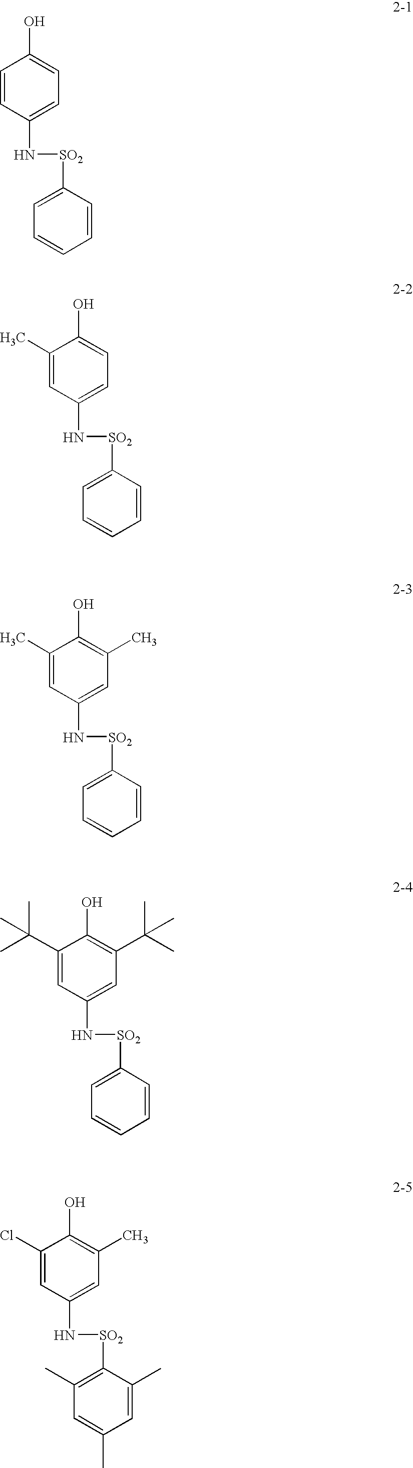

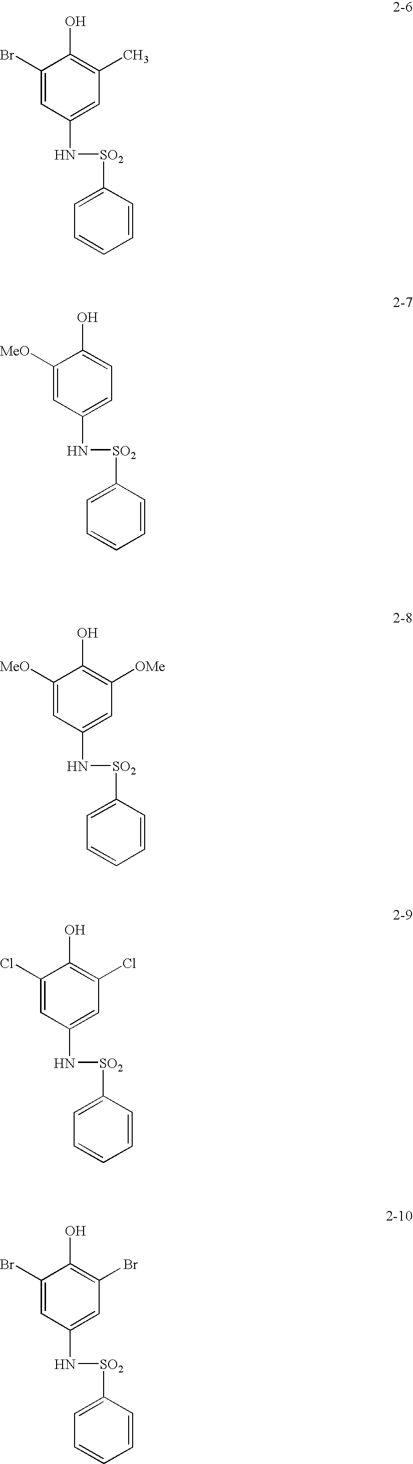

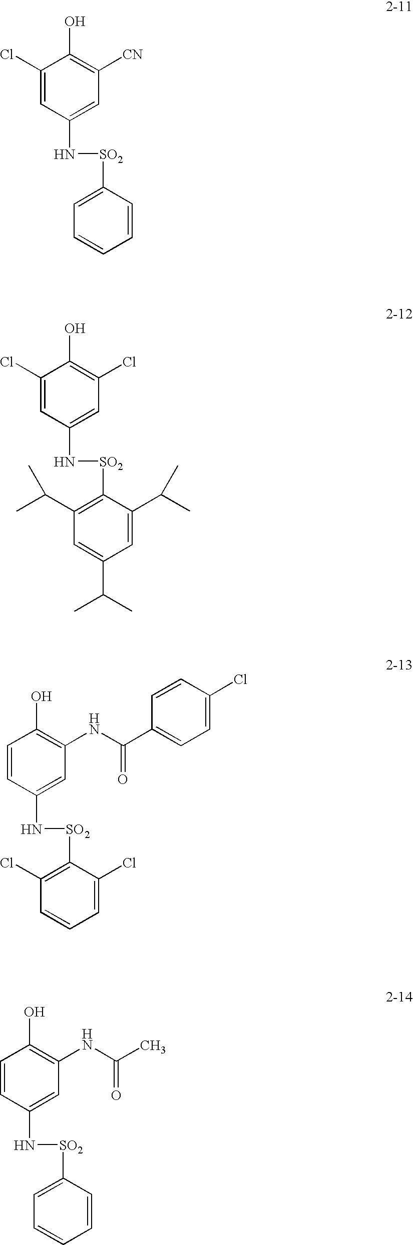

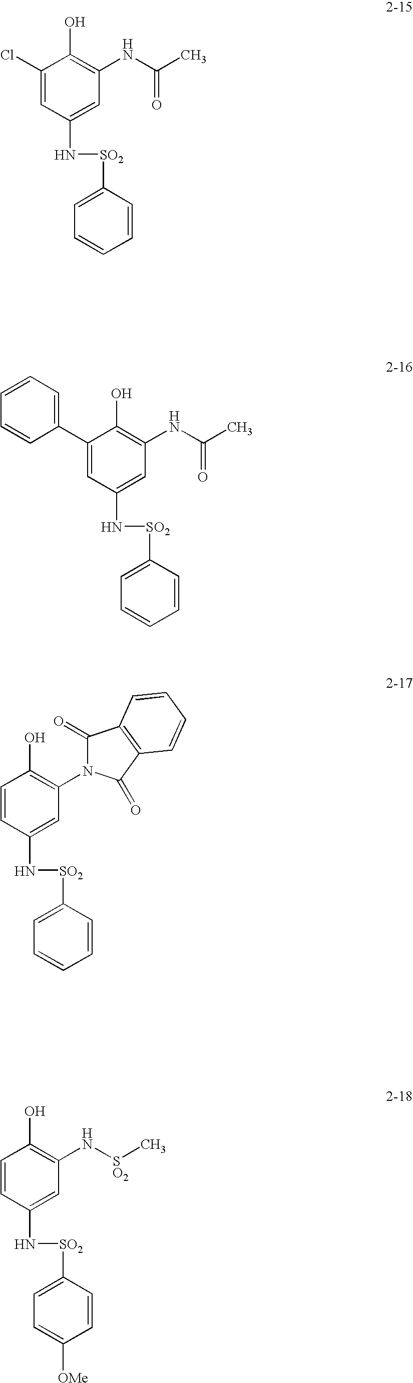

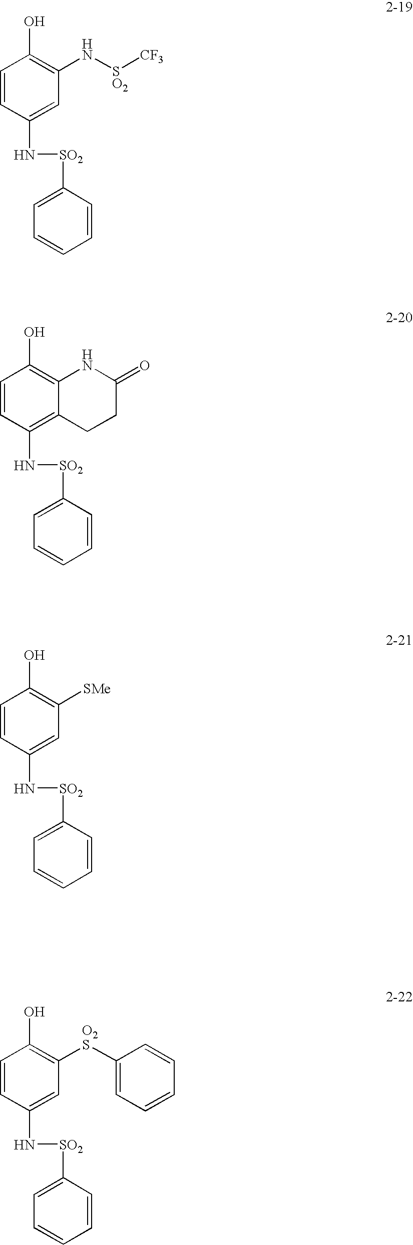

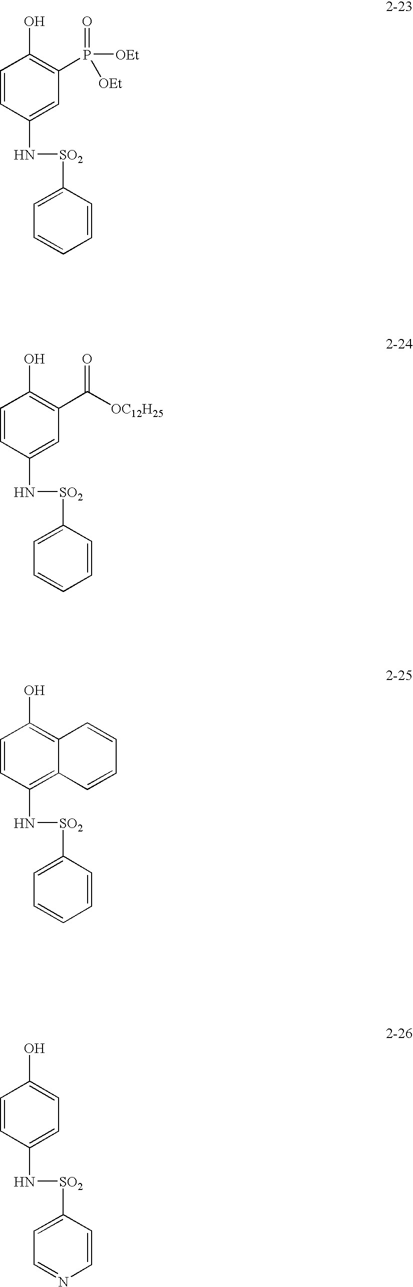

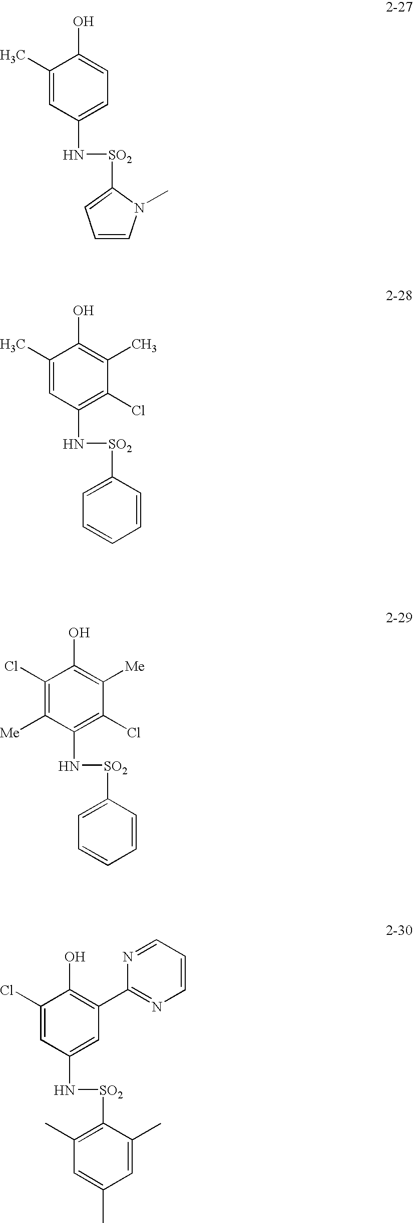

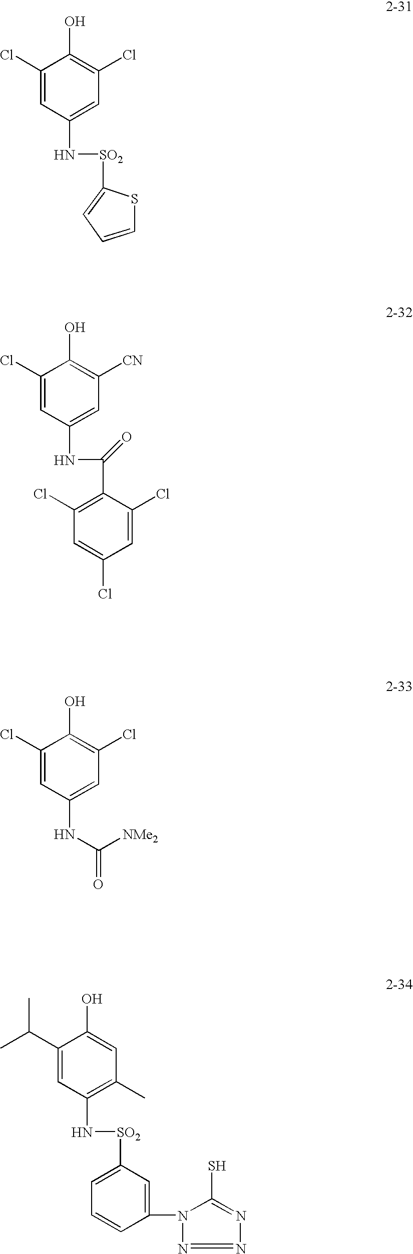

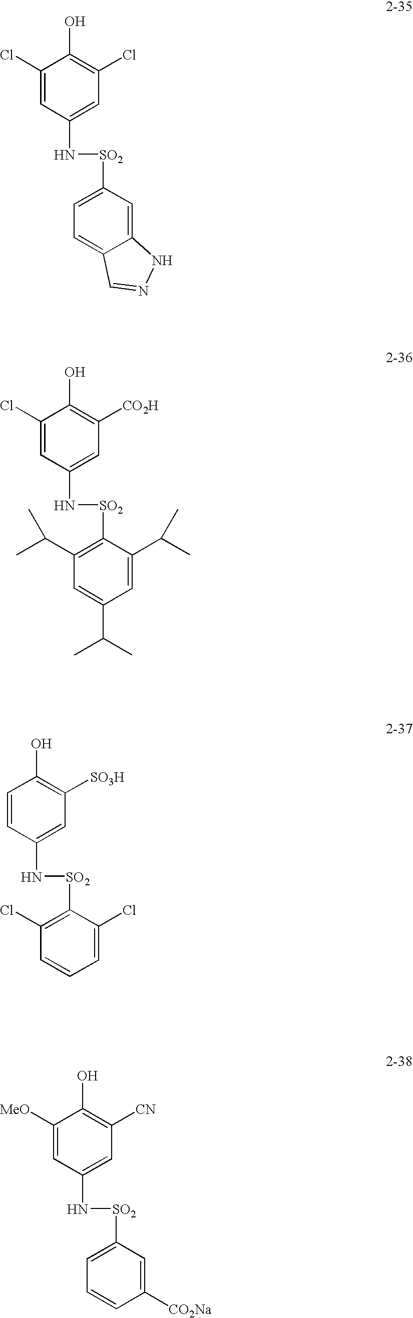

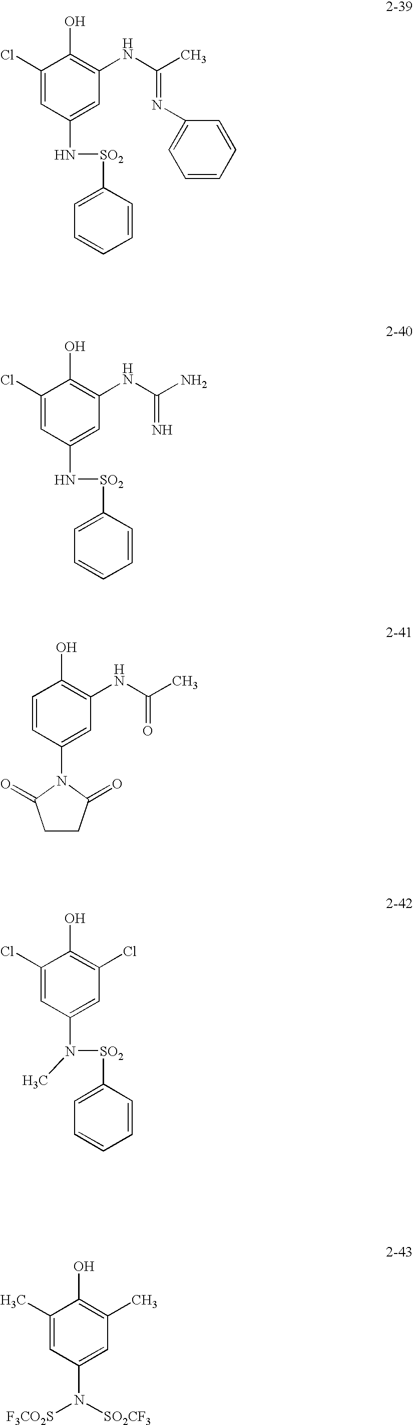

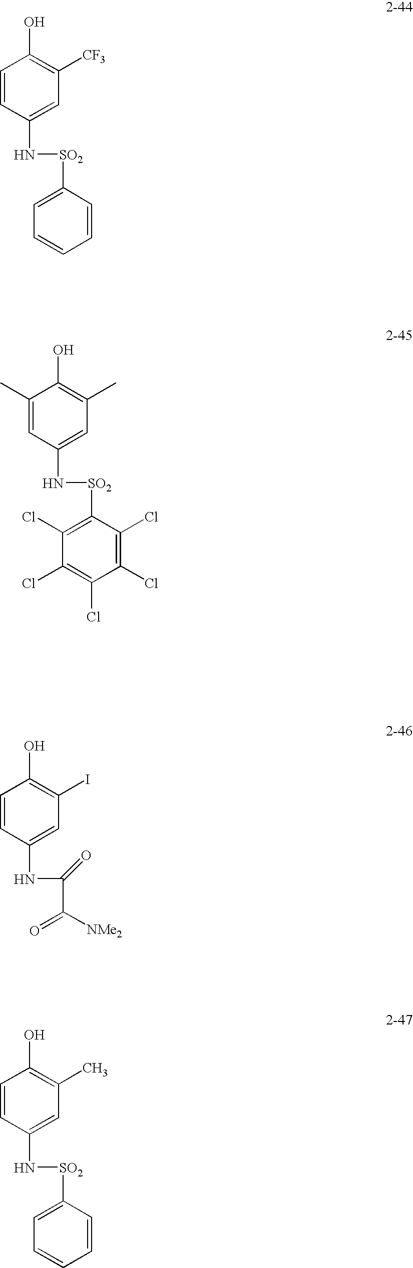

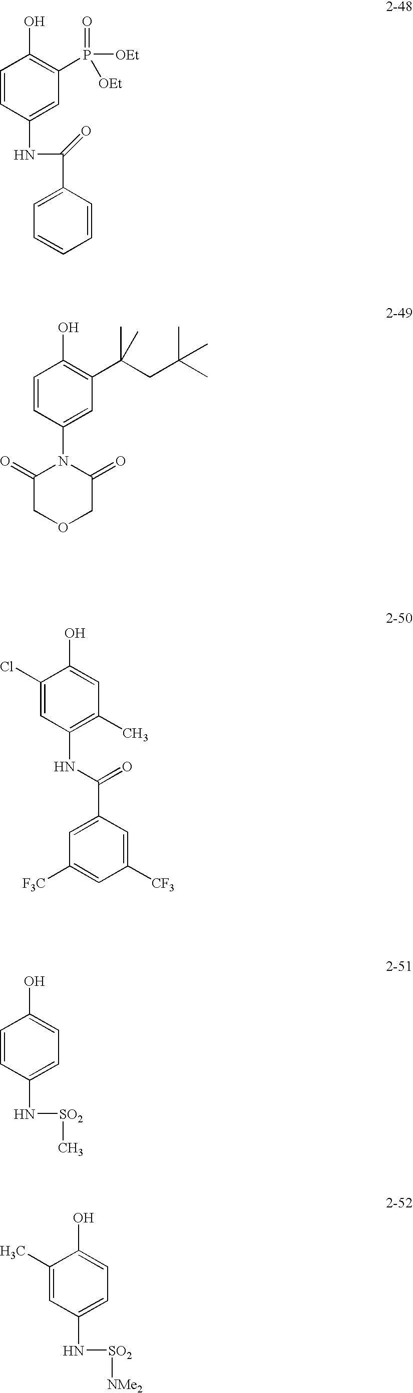

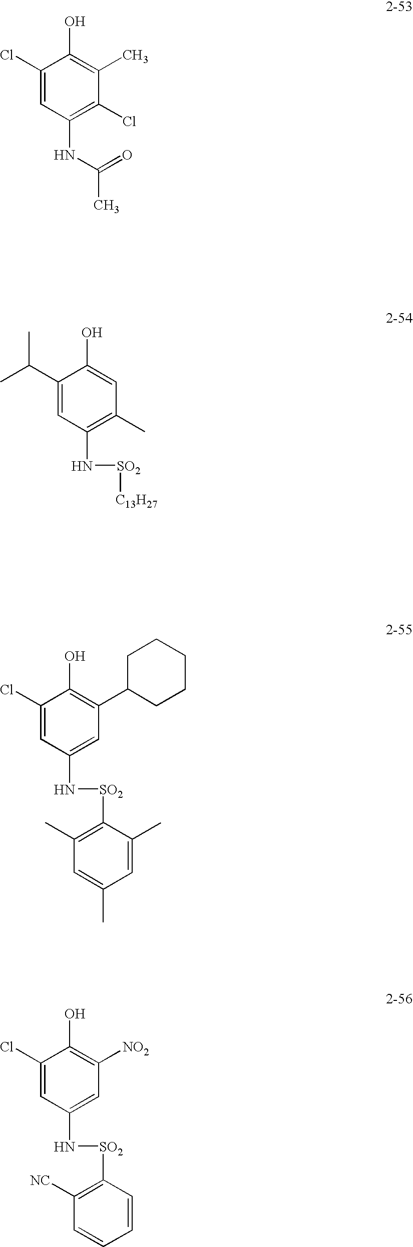

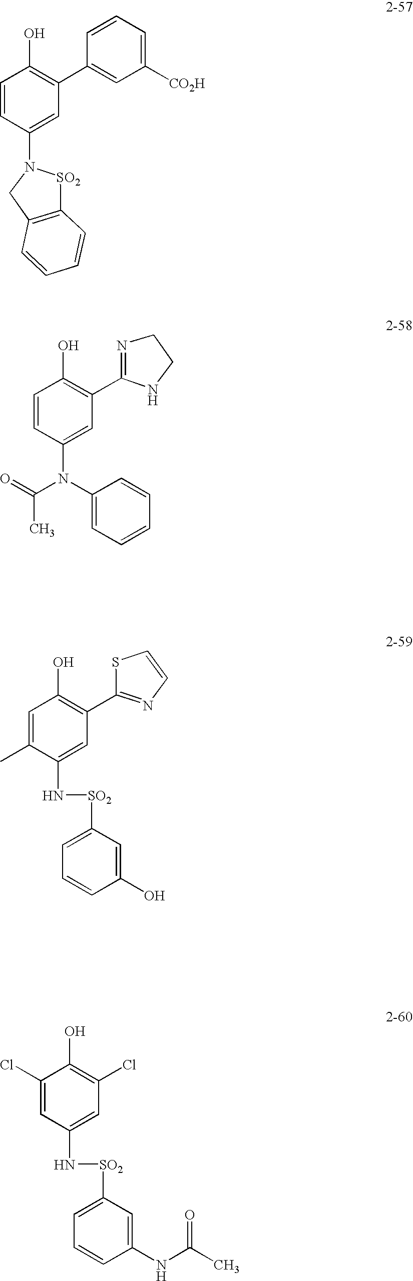

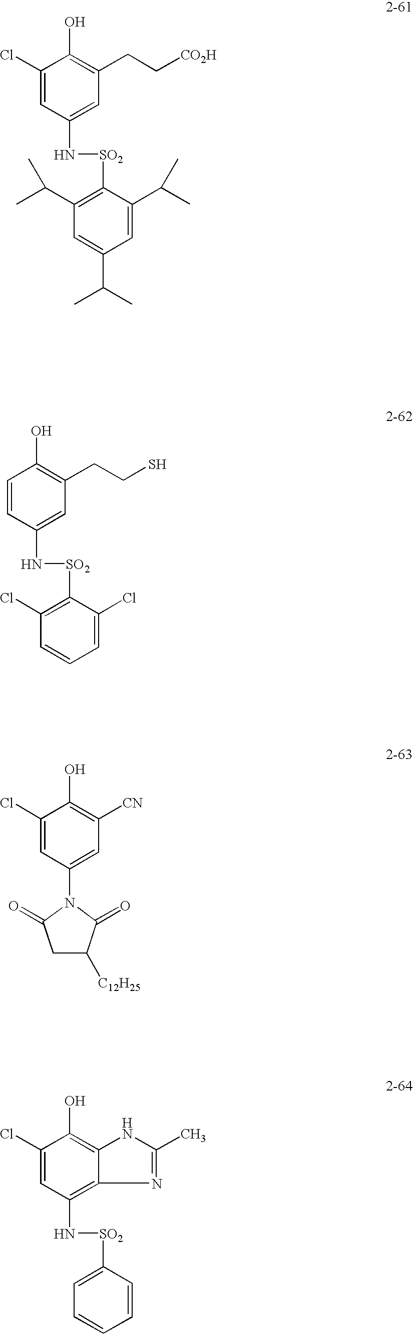

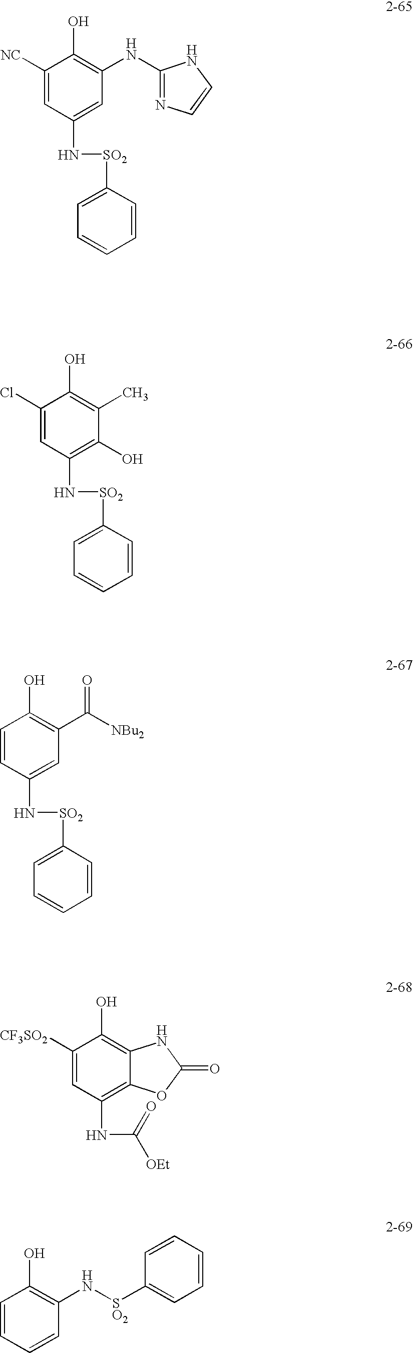

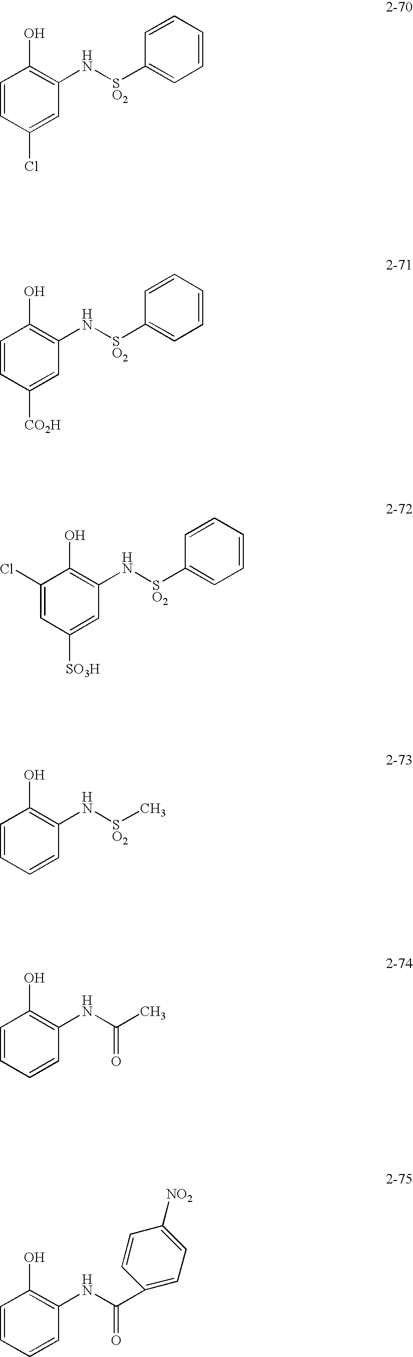

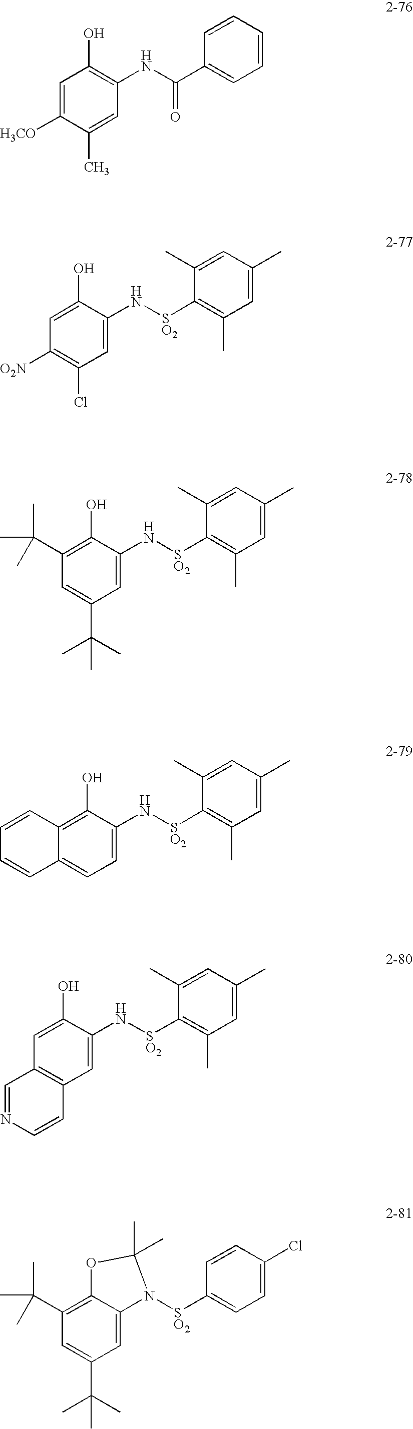

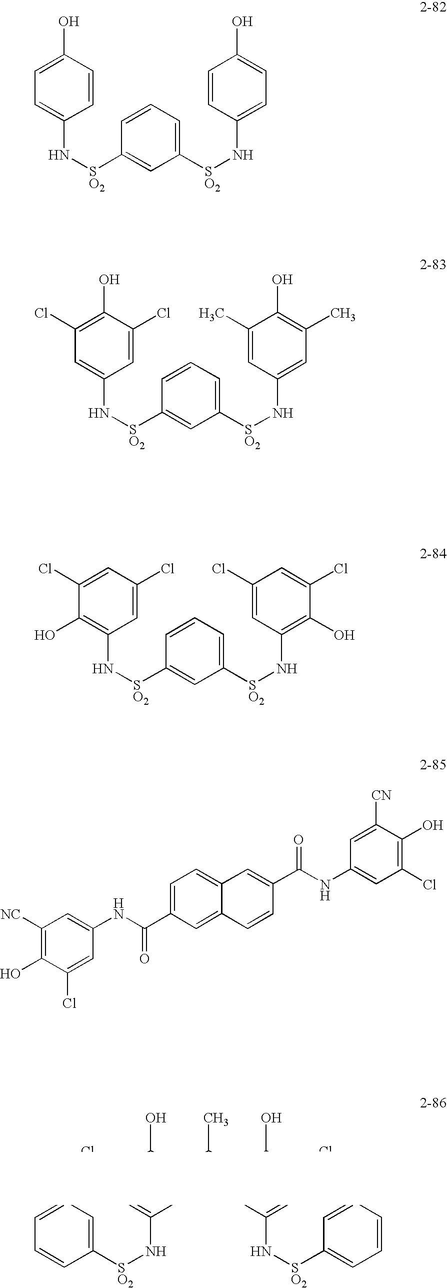

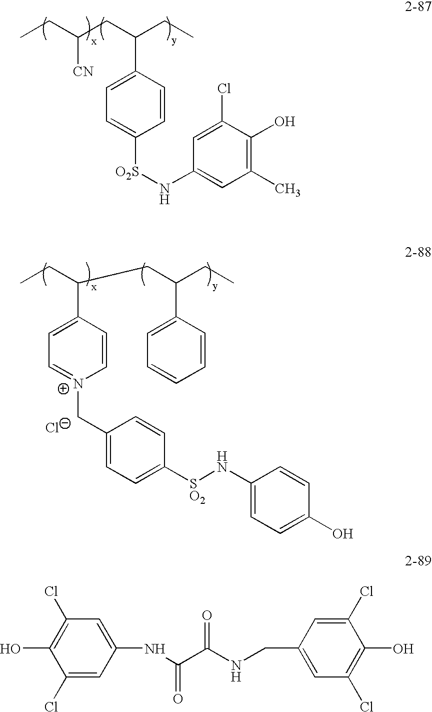

The development accelerator of the general formula (3) is described below.

In the general formula (3), X⁵ represents a substituent with which the benzene ring is substituted. It is to be noted that X⁵ is not a hydroxyl group. Specific examples of the substituent include a halogen atom, alkyl group (including cycloalkyl group, and bicycloalkyl group), alkenyl group (including cycloalkenyl group, and bicycloalkenyl group), alkinyl group, aryl group, heterocyclic group, cyano group, nitro group, carboxyl group, alkoxy group, aryloxy group, silyloxy group, heterocyclicoxy group, acyloxy group, carbamoyloxy group, alkoxycarbonyloxy group, aryloxycarbonyloxy group, acylamino group, aminocarbonylamino group, alkoxycarbonylamino group, aryloxycarbonylamino group, sulfamoylamino group, alkyl and arylsulfonylamino group, mercapto group, alkylthio group, arylthio group, heterocyclicthio group, sulfamoyl group, sulfo group, alkyl and arylsulfinyl group, alkyl and arylsulfonyl group, acyl group, aryloxycarbonyl group, alkoxycarbonyl group, carbamoyl group, aryl and heterocyclic azo group, imide group, phosphino group, phosphinyl group, phosphinyloxy group, phosphynylamino group, and silyl group.

More specifically, it represents a halogen atom (fluorine atom, chlorine atom, bromine atom and iodine atom), and alkyl group (representing linear, branched or cyclic substituted or unsubstituted alkyl group. They include alkyl group (preferably, alkyl group of 1 to 30 carbon atoms, e.g., methyl group, ethyl group, n-propyl group, isopropyl group, tert-butyl group, n-octyl group, eicosyl group, 2-chloroethyl group, 2-cyanoethyl group, and 2-ethylhexyl group), cycloalkyl group (preferably, substituted or not-substituted cycloalkyl group of 3 to 30 carbon atoms, e.g., cyclohexyl group, cyclopentyl group, and 4-n-dodecylcyclohexyl group), bicycloalkyl group (preferably, substituted or unsubstituted bicycloalkyl groups of 5 to 30 carbon atoms, that is, a monovalent group formed by removing one hydrogen atom from a bicycloalkane having 5 to 30 carbon atoms. For example, bicyclo[1,2,2]heptane-2-yl group and bicyclo[2,2,2]octane-3-yl group), and further, tricyclo structure with more ring structure. The alkyl group in the substituent to be described below (for example, alkyl group in the alkylthio group) also represents the alkyl group of such a concept], and alkenyl group [representing linear, branched or cyclic substituted or unsubstituted alkenyl group including alkenyl group (preferably, substituted or unsubstituted alkenyl group having 2 to 30 carbon atoms, e.g., vinyl group, aryl group, prehnyl group, geranyl group, and oleyl group), cycloalkenyl group (preferably, a substituted or unsubstituted cycloalkenyl group of 3 to 30 carbon atoms, that is, a monovalent group formed by removing one hydrogen atom from a cycloalkene of 3 to 30 carbon atoms. For example, 2-cyclopentene-1-yl group, and 2-cyclohexene- 1-yl group), bicyclolakenyl group (substituted or unsubstituted bicycloalkenyl group, preferably substituted or unsubstituted bicycloalkenyl group of 5 to 30 carbon atoms, that is, a monovalent group formed by removing one hydrogen atom from a bicycloalkene having one double bond, including, for example, bicyclo[2,2,1]hepto-2-en-1-yl group, and bicyclo[2,2,2]octo-2-en-4-yl group], alkinyl group (preferably, a substituted or not substituted alkinyl group of 2 to 30 carbon atoms, for example, ethinyl group, propargyl group, trimethylsilylethinyl group): aryl group (preferably, a substituted or unsubstituted aryl group of 6 to 30 carbon atoms, e.g., phenyl group, p-tolyl group, naphthyl group, m-chlorophenyl group, and o-hexadecanoylaminophenyl group), heterocyclic group (preferably, a monovalent group formed by removing one hydrogen atom from a 5- or 6-membered substituted or unsubstituted aromatic or non-aromatic heterocyclic compound, and further preferably, a 5- or 6-membered aromatic heterocyclic ring having 3 to 30 carbon atoms, e.g., 2-furyl group, 2-thienyl group, 2-pyrimidinyl group, 2-benzothiazolyl group), cyano group, nitro group, and carboxyl group, alkoxy group (preferably, a substituted or unsubstituted alkoxy group of 1 to 30 carbon atoms, e.g., methoxy group, ethoxy group, isopropoxy group, tert-butoxy group, n-octyloxy group, and 2-ethoxymethoxy group), aryloxy group (preferably, a substituted or unsubstituted aryloxy group of 6 to 30 carbon atoms, e.g., phenoxy group, 2-methylphenoxy group, 4-tert-butylphenoxy group, 3-nitrophenoxy group, and 2-tetradecanoylaminophenoxy group), silyloxy group (preferably, a silyloxy group having 3 to 20 carbon atoms, e.g., trimethylsilyloxy group, and tert-butydimethylsilyloxy group), heterocyclicoxy group (preferably, substituted or unsubstituted heterocyclicoxy groups having 2 to 30 carbon atoms, e.g., 1-phenyltetrazole-5-oxy group, and 2-tetrahydropyranyloxy group), acyoxy group (preferably, formyloxy group, substituted or unsubstituted alkylcarbonyloxy group having 2 to 30 carbon atoms, substituted or unsubstituted arylcarbonyloxy group having 6 to 30 carbon atoms, e.g., formyloxy group, acetyloxy group, pivaroyloxy group, stearoyloxy group, benzoyloxy group, and p-methoxyphenylcarbonyloxy group), carbamoyloxy group (preferably, a substituted or unsubstituted carbamoyloxy group haaving 1 to 30 carbon atoms, e.g., N,N-dimethylcarbamoyloxy group, N,N-diethylcarbamoyloxy group, morpholinocarbonyoxy group, N,N-di-n-octylaminocarbonyloxy group, and N-n-octylcarbamoyloxy group), alkoxycarbonyloxy group (preferably, a substituted or unsubstituted alkoxycarbonyloxy group having 2 to 30 carbon atoms, e.g., methoxycarbonyloxy group, ethoxycarbnyloxy group, tert-butoxycarbonyloxy group, and n-octylcarbonyloxy group), aryloxycarbonyoxy groups (preferably, a substituted or unsubstituted alyloxycarbonyloxy group having 7 to 30 carbon atoms, e.g., phenoxyarbonyloxy group, p-methoxyphenoxycarbonyloxy group, and p-n-hexadecyloxyphenoxycarbonyloxy group), acylamino group (preferably, formylamino group, substituted or unsubstituted alkylcarbonylamino group having 1 to 30 carbon atoms, substituted or unsubstituted arylcarbonylamino group having 6 to 30 carbon atoms, e.g., formylamino group, acetylamino group, pivaroylamino group, lauroylamino group, benzoylamino group, and 3,4,5-tri-n-octyloxyphenylcarbonylamino group), aminocarbonylamino group (preferably, a substituted or unsubstituted aminocarbonylamino group having 1 to 30 carbon atoms, e.g., carbamoylamino group, N,N-dimethylaminocarbonylamino group, N,N-diethylaminocarbonylamino group, and morpholinocarbonylamino group), alkoxycarboxyamino group (preferably, a substituted or unsubstituted alkoxycarbonylamino group having 2 to 30 carbon atoms, e.g., methoxycarbonylamino group, ethoxycarbonylamino group, tert-butoxycarbonylamino group, n-octadecyloxycarbonylamino group, and N-methyl-methoxycarbonylamino group), aryloxycarbonylamino group (preferably, a substituted or unsubstituted aylroxycarbonylamino group having 7 to 30 carbon atoms, e.g., phenoxycarbonylamino group, p-chlorophenoxycarbonylamino group, m-n-octyloxyphenoxycarbonylamino group), sulfamoylamino group (preferably, a substituted or unsubstituted sulfamoylamino group having 0 to 30 carbon atoms, e.g., a sulfamoylamino group, and N,N-dimethylaminosulfonylamino group, N-n-octylaminosulfonylamino group), alkyl and arylsulfonylamino group (preferably, a substituted or insubstituted alkylsulfonylamino group having 1 to 30 carbon atoms, and a substituted or unsubstituted arylsulfonylamino group having 6 to 30 carbon atoms, e.g., methylsulfonylamino group, butylsulfonylamino group, phenylsulfonylamino group, 2,3,5-trichlorophenylsulfonylamino group, and p-methylphenylsulfonylamino group), mercapto group, alkylthio group (preferably, a substituted or unsubstituted alkylthio group haaving 1 to 30 carbon atoms, e.g., methylthio group, ethylthio group, and n-hexadecylthio group), arylthio group (preferably, a substituted or unsubstituted arylthio group having 6 to 30 carbon atoms, e.g., phenylthio group, p-chlorophenylthio group and m-methoxyphenylthio group), heterocyclicthio group (preferably, a substituted or unsubstituted heterocyclicthio group having 2 to 30 carbon atoms, e.g., 2-benzothiazolylthio group, and 1-phenyltetrazol-5-yl-thio group), sulfamoyl (preferably, a substituted or unsubstituted sulfamoyl group having 0 to 30 carbon atoms, e.g., N-ethylsulfamoyl group, N-(3-dodecyloxypropyl)sulfamoyl group, N,N-dimethylsulfamoyl group, N-acetylsulfamoyl group, N-benzoylsulfamoyl group, and N-(N′-phenylcarbamoyl)sulfamoyl group), sulfo group, alkyl and arylsulfinyl groups (preferably, a substituted or not substituted alkylsulfinyl group having 1 to 30 carbon atoms, substituted or unsubstituted arylsulfinyl group having 6 to 30 carbon atoms, e.g., methylsulfinyl group, ethylsulfinyl group, phenylsulfinyl group, and p-methylphenyl sulfinyl group), alkyl and arylsufonyl groups (preferably, a substituted or unsubstituted alkylsulfonyl group having 1 to 30 carbon atoms and a substituted or unsubstituted arylsulfonyl group having 6 to 30 carbon atoms, e.g., methylsulfonyl group, ethylsulfonyl group, phenylsulfonyl group, and p-methylphenylsulfonyl group), acyl group (preferably, formyl group, substituted or unsubstituted alkylcarbonyl group having 2 to 30 carbon atoms, substituted or unsubstituted arylcarbonyl group having 7 to 30 carbon atoms, substituted or unsubstituted heterocyclic carbonyl group havcing 4 to 30 carbon atoms bonded via a carbon atom with the carbonyl group, e.g., acetyl group, pivaloyl group, 2-chloroacetyl group, stearoyl group, benzoyl group, p-n-octyloxyphenylcarbonyl group, 2-pyridylcarbonyl group, and 2-furylcarbonyl group), aryloxycarbonyl group (preferably, a substituted or unsubstituted aryloxycarbonyl group having 7 to 30 carbon atoms, e.g., phenoxycarbonyl group, o-chlorophenoxycarbonyl group, m-nitrophenoxycarbonyl group, and p-tert-butylphenoxycarbonyl group), alkoxycarbonyl group (preferably, a substituted or unsubstituted alkoxycarbonyl group having 2 to 30 carbon atoms, e.g., methoxyarbonyl group, ethoxycarbonyl group, tert-butoxycarbonyl group, n-octadecyloxycarbonyl group), carbamoyl group (preferably, a substituted or unsubstituted carbamoyl group having 1 to 30 carbon atoms, e.g., carbamoyl group, N-methylcarbamoyl group, N,N-dimethylcarbamoyl group, N,N-di-n-octylcarbamoyl group, and N-(methylsulfonyl)carbamoyl group), aryl and heterocyclic azo groups (preferably, a substituted or unsubstituted aryl azo group having 6 to 30 carbon atoms, a substituted or unsubstituted heterocyclic azo group having 3 to 30 carbon atoms, e.g., phenyl azo group, p-chlorophenyl azo group, and 5-ethylchio-1,3,4-thiadiazole-2-yl azo group), imide group (preferably, N-succinic imide group, and N-phthalimide group), phosphino group (preferably, a substituted or unsubstituted phosphino group haaving 2 to 30 carbon atoms, e.g., dimethyl phosphino group, diphenyl phosphino group, and methylphenoxy phospino group), phosphinyl group (preferably, a substituted or unsubstituted phosphinyl group having 2 to 30 carbon atoms, e.g., phosphinyl group, dioctyloxy phosphynyl group, and diethoxyphenyl group), phosphinyloxy group (preferably, a substituted or unsubstituted phosphinyloxy group having 2 to 30 carbon atoms, e.g., diphenoxy phosphinyloxy group, and dioctyloxy phosphinyloxy group), phosphinylamino group (preferably, a substituted or unsubstituted phosphinylamino group having 2 to 30 carbon atoms, e.g., dimethoxyphosphinylamino group, and dimethylaminophosphinylamino group), silyl group (preferably, a substituted or unsubstituted silyl group having 3 to 30 carbon atoms, e.g., trimethylsilyl group, tert-butyldimethylsilyl group, and phenyldimethylsilyl group).

Preferred substituents represented by X⁵ include a halogen atom (fluorine atom, chlorine atom, bromine atom, iodine atom, preferably, chlorine atom and bromine atom), acylamino group (preferably, those having 1 to 20 carbon atoms, more preferably 1 to 14 carbon atoms, and particularly preferably 1 to 8 carbon atoms, e.g., formylamino group, acetylamino group, and benzoylamino group), alkyl group (having preferably 1 to 20 carbon atoms, more preferably 1 to 14 carbon atoms, and particularly preferably 1 to 8 carbon atoms, e.g., methyl group, ethyl group, isopropyl group, and cyclohexyl group), aryl group (having preferably 6 to 20 carbon atoms, more preferably 6 to 14 carbon atoms, and particularly preferably 6 to 8 carbon atoms, e.g., phenyl group, naphthyl group, and p-methylphenyl group), alkoxy group (having preferably 1 to 20 carbon atoms, more preferably 1 to 14 carbon atoms, and particularly preferably 1 to 8 carbon atoms, e.g., methoxy group and ethoxy group), aryloxy group (having preferably 6 to 20 carbon atoms, more preferably 6 to 14 carbon atoms, and particularly preferably 6 to 8 carbon atoms, e.g., phenoxy group, and 2-naphthyloxy group), acyloxy group (having preferably 1 to 20 carbon atoms, more preferably 1 to 14 carbon atoms, and particularly preferably 1 to 8 carbon atoms, e.g., acetoxy group and benzoyloxy group), sulfonylamino group (having preferably 1 to 20 carbon atoms, more preferably 1 to 14 carbon atoms, and particularly preferably 1 to 8 carbon atoms, e.g., methane sulfonylamino group and benzene sulfonylamino group), carbamoyl group (having preferably 1 to 20 carbon atoms, more preferably 1 to 14 carbon atoms, and particularly preferably 1 to 8 carbon atoms, e.g., carbamoyl group, N,N-dimethylcarbamoyl group and N-phenylcarbamoyl group), acyl group (having preferably 1 to 20 carbon atoms, more preferably 1 to 14 carbon atoms, and particularly preferably 1 to 8 carbon atoms, e.g., formyl group, acetyl group, and benzoyl group), alkoxycarbonyl group (having preferably 2 to 20 carbon atoms, more preferably 2 to 16 carbon atoms, and further preferably 2 to 12 carbon atoms, e.g., methoxycarbonyl group, ethoxycarbonyl group, and butoxycarbonyl group), aryloxycarbonyl group (having preferably 6 to 20 carbon atoms, more preferably 6 to 16 carbon atoms, and further preferably 6 to 12 carbon atoms, e.g., phenoxycarbonyl group and 2-naphthyloxy carbonyl group), cyano group and nitro group, with the halogen atom, acylamino group and alkyl group being more preferred and the chlorine atom and bromine atom being particularly preferred.

In the general formula (3), X⁷ represents a hydrogen atom or a substituent, with a proviso that X⁷ does not represent the hydroxyl group or sulfoneamide group. Specific examples of the substituent include those substituents mentioned as examples for X⁵ in the general formula (3) (excluding sulfoneamide group). Preferred X⁷ include a hydrogen atom, a halogen atom (chlorine atom, bromine atom, and iodine atom, chlorine atom, with bromine atom being preferred), acylamino group (having preferably 1 to 20 carbon atoms, more preferably 1 to 14 carbon atoms, and particularly preferably 1 to 8 carbon atoms, e.g., formylamino group, acetylamino group, and benzoylamino group), alkyl group (having preferably 1 to 20 carbon atoms, more preferably 1 to 14 carbon atoms, and particularly preferably 1 to 8 carbon atoms, e.g., methyl group, ethyl group, isopropyl group, and cyclohexyl group), aryl group (having preferably 6 to 20 carbon atoms, more preferably 6 to 14 carbon atoms, and particularly preferably 6 to 8 carbon atoms, e.g., phenyl group, naphthyl group, and p-methylphenyl group), alkoxy group (having preferably 1 to 20 carbon atoms, more preferably 1 to 14 carbon atoms, and particularly preferably 1 to 8 carbon atoms, e.g., methoxy group and ethoxy group, aryloxy group (having preferably 6 to 20 carbon atoms, more preferably 6 to 14 carbon atoms, and particularly preferably 6 to 8 carbon atoms, e.g., phenoxy group and 2-naphthyloxy group), acyloxy group (having preferably 1 to 20 carbon atoms, more preferably 1 to 14 carbon atoms, and particularly preferably 1 to 8 carbon atoms, e.g., acetoxy group and benzoyloxy group), carbamoyl group (having preferably 1 to 20 carbon atoms, more preferably 1 to 14 carbon atoms, and particularly preferably 1 to 8 carbon atoms, e.g., carbamoyl group, N,N-dimethylcarbamoyl group, and N-phenylcarbamoyl group), acyl group (having preferably 1 to 20 carbon atoms, more preferably 1 to 14 carbon atoms, and particularly preferably 1 to 8 carbon atoms, e.g., formyl group, acetyl group, and benzoyl group), alkoxycarbonyl group (having preferably 2 to 20 carbon atoms, more preferably 2 to 16 carbon atoms, and particularly preferably 2 to 12 carbon atoms, e.g., methoxycarbonyl group, ethoxycarbonyl group, and butoxycarbonyl group), aryloxycarbonyl group (having preferably 6 to 20 carbon atoms, more preferably 6 to 16 carbon atoms, and particularly preferably 6 to 12 carbon atoms, e.g., phenoxycarbonyl group and 2-naphthyloxycarbonyl group), cyano group, and nitro group, with the halogen atom, acylamino group, and alkyl group being preferred and the chlorine atom or bromine being particularly preferred.

At least one of the substituents represented by X⁵ and X⁷ is preferably an electron attractive group. The electron attractive group is a substituent having a positive σₚ value for the Hammett's substituent constant. Specific examples thereof include a halogen atom, cyano group, nitro group, alkoxycarbonyl group, aryloxycarbonyl group, imino group, imino group substituted with N atom, thiocarbonyl group, perflouroalkyl group, sulfoneamide group, formyl group, phosphoryl group, carboxyl group, carbamoyl group, acyl group, sulfo group (or salt thereof), alkylsulfonyl group, arylsulfonyl group, sulfamoyl group, acyloxy group, acylthio group, sulfonyloxy group, heterocyclic group or aryl group substituted with the electron attractive group described above. More preferably, both of X¹ and X³ are electron attractive groups, and further preferably, both of them are halogen atoms, and particularly preferably, both of them are chlorine atoms or bromine atoms.

In the general formula (3), X⁶ and X⁸ each represent a hydrogen atom or a substituent, with a proviso that X⁶ and X⁸ are not a hydroxyl group. Specific examples of the substituent include the substituents described as the examples of X⁵ in the general formula (3). Preferred X⁶ and X⁸ include a hydrogen atom, halogen atom (fluorine atom, chlorine atom, bromine atom, iodine atom, preferably chlorine atom and bromine atom), acylamino group (having preferably 1 to 20 carbon atoms, more preferably, 1 to 14 carbon atoms, and particularly preferably 1 to 8 carbon atoms, e.g., formylamino group, acetylamino group, and benzoylamino group), alkyl group (having preferably 1 to 20 carbon atoms, more preferably 1 to 14 carbon atoms, and particularly preferably 1 to 8 carbon atoms, e.g., methyl group, ethyl group, isopropyl group, and cyclohexyl group), aryl group (having preferably 6 to 20 carbon atoms, more preferably 6 to 14 carbon atoms, and particularly preferably 6 to 8 carbon atoms, e.g., phenyl group, naphthyl group, and p-methylphenyl group), alkoxy group (having preferably 1 to 20 carbon atoms, more preferably 1 to 14 carbon atoms, and particularly preferably 1 to 8 carbon atoms, e.g., methoxy group and ethoxy group), aryloxy group (having preferably 6 to 20 carbon atoms, more preferably 6 to 14 carbon atoms, and particularly preferably 6 to 8 carbon atoms, e.g., phenoxy group and 2-naphthyloxy group), acyloxy group (having preferably 1 to 20 carbon atoms, more preferably 1 to 14 carbon atoms and, particularly preferably 1 to 8 carbon atoms, e.g., acetoxy group and benzoyloxy group), sulfonylamino group (having, preferably, 1 to 20 carbon atoms, more preferably, 1 to 14 carbon atoms, and particularly preferably 1 to 8 carbon atoms, e.g., methane sulfonylamino group and benzene sulfonylamino group), carbamoyl group (having preferably 1 to 20 carbon atoms, more preferably 1 to 14 carbon atoms, and particularly preferably 1 to 8 carbon atoms, e.g., carbamoyl group, N,N-dimethylcarbamoyl group, and N-phenylcarbamoyl group), acyl group (having preferably 1 to 20 carbon atoms, more preferably 1 to 14 carbon atoms, and particularly preferably 1 to 8 carbon atoms, e.g., formyl group, acetyl group and benzoyl group), alkoxycarbonyl group (having preferably 2 to 20 carbon atoms, more preferably 2 to 16 carbon atoms, and particularly preferably 2 to 12 carbon atoms, e.g., methoxycarbonyl group, ethoxy carbonyl group and butoxy carbonyl group), aryloxycarbonyl group (having preferably 6 to 20 carbon atoms, more preferably 6 to 16 carbon atoms, and particularly preferably 6 to 12 carbon atoms, e.g., phenoxycarbonyl group and 2-naphthyloxy carbonyl group), cyano group, and nitro group. The hydrogen atom, alkyl group, aryl group, halogen atom and acylamino group are more preferred, and the hydrogen atom, methyl group and ethyl group are particularly preferred.

X⁵- X⁸ may further be substituted, and specific examples for the substituent include those substituents described as examples for X⁵ in the general formula (3). Further, X⁵ to X⁸ may be bonded with each other to form a ring.

In the general formula (3), examples of R¹⁰ include a hydrogen atom, an alkyl group (having preferably 1 to 20 carbon atoms, more preferably 1 to 14 carbon atoms, and particularly preferably 1 to 7 carbon atoms, e.g., methyl group, ethyl group, isopropyl group, and cyclohexyl group), aryl group (having preferably 6 to 20 carbon atoms, more preferably 6 to 14 carbon atoms, and particularly preferably 6 to 8 carbon atoms, e.g., phenyl group, naphthyl group, and p-methylphenyl group), heterocyclic group (e.g., pyridyl group, imidazolyl group and pyrrolydyl group), amino group (having preferably 0 to 20 carbon atoms, more preferably 0 to 14 carbon atoms, and particularly preferably 0 to 8 carbon atoms, e.g., amino group, methylamino group, N,N-dimethylamino group, and N-phenylamino group), and alkoxy group (having preferably 1 to 20 carbon atoms, more preferably 1 to 14 carbon atoms, and particularly preferably 1 to 8 carbon atoms, e.g., methoxy group, and ethoxy group). Preferred are hydrogen atom, aryl group, heterocyclic group, amino group, alkoxy group, alkyl group having 1 to 7 carbon atoms, further preferred are aryl group or alkyl group of 1 to 7 carbon atoms, and particularly preferred is an aryl group. R¹⁰ may further be substituted, and specific examples of the substituent include those substituent described as examples for X⁵ in the general formula (3).

In the combination of X⁵ to X⁸ and R¹⁰, it is preferred that at least one of X⁵ and X⁷ is a halogen atom, X⁶ and X⁸ are a hydrogen atom or alkyl group and R¹⁰ is an aryl group or an alkyl group having 1 to 7 carbon atoms. Further preferred combination is that both of X⁵ and X⁷ are chlorine atoms or bromine atoms, X⁶ is a hydrogen atom or an alkyl group, X⁸ is a hydrogen atom and R¹⁰ is an aryl group.

A preferred range for the total molecular weight of the compound represented by the general formula (3) is from 170 to 800, and more preferably 220 to 650, and particularly preferably 220 to 500.

Specific examples for the compound represented by the general formula (3) are shown below, however, the compounds of the general formula (3) usable in the invention are not restricted thereto.

(Specific Examples for General Formula (3))

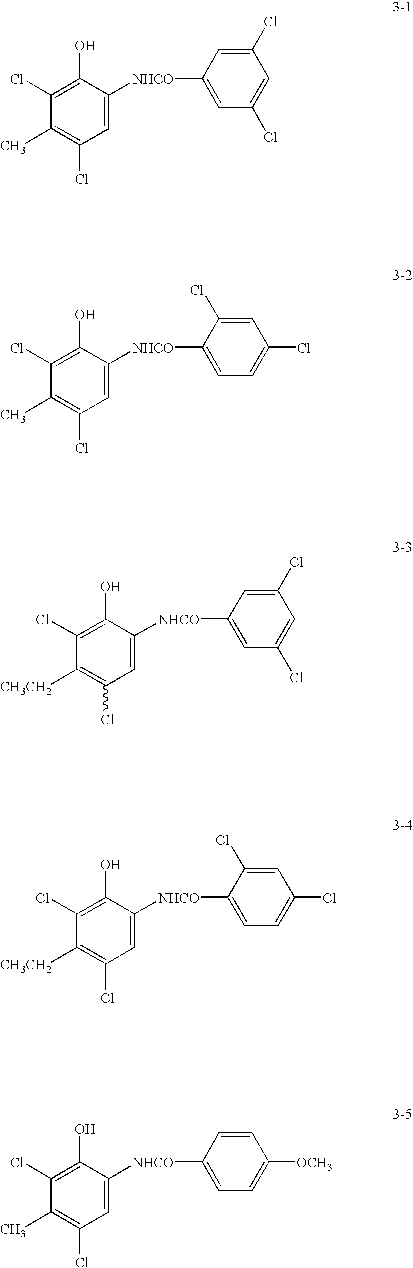

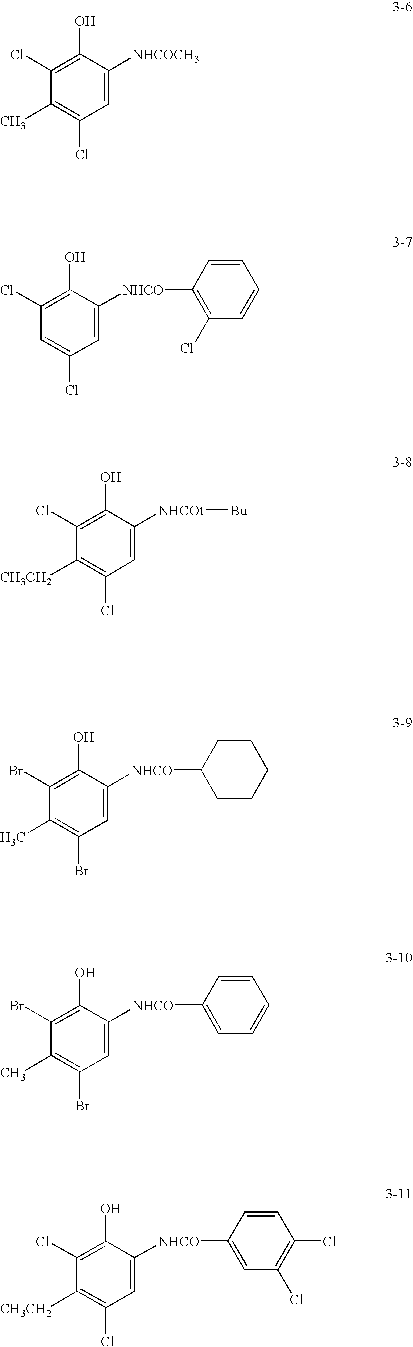

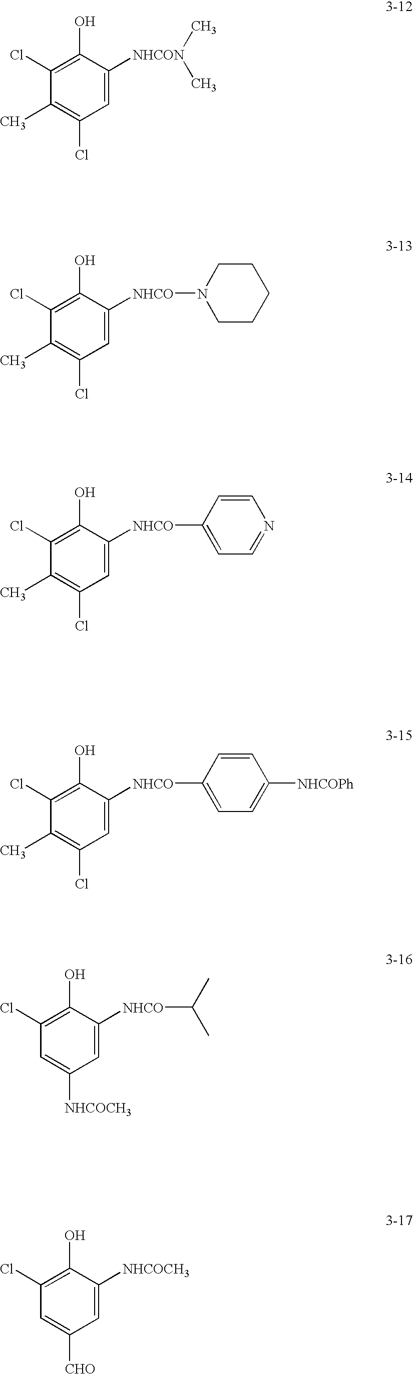

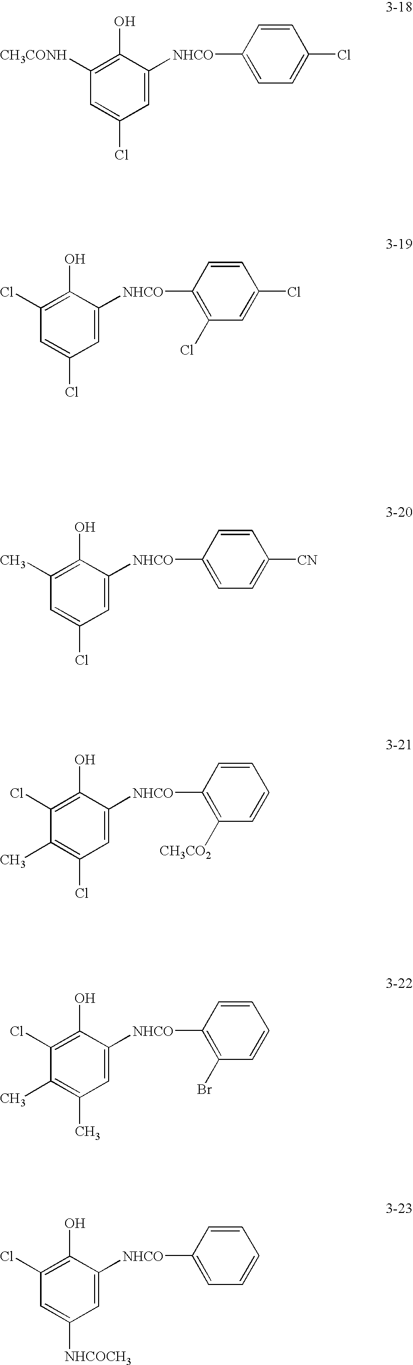

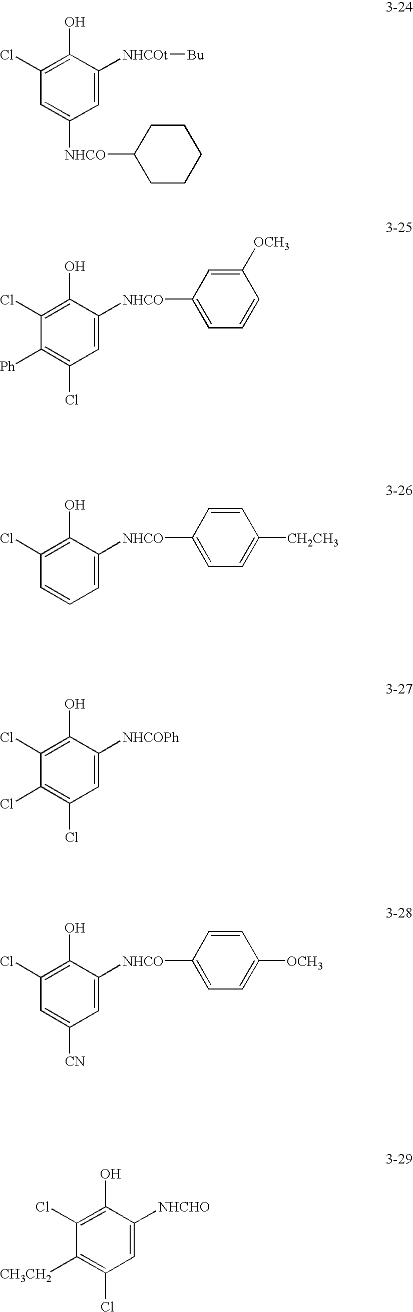

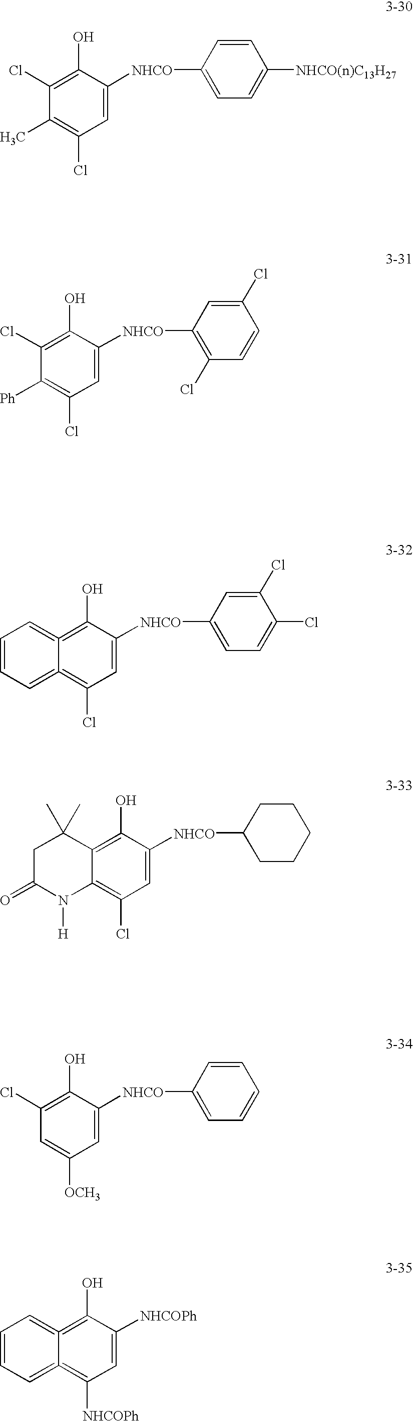

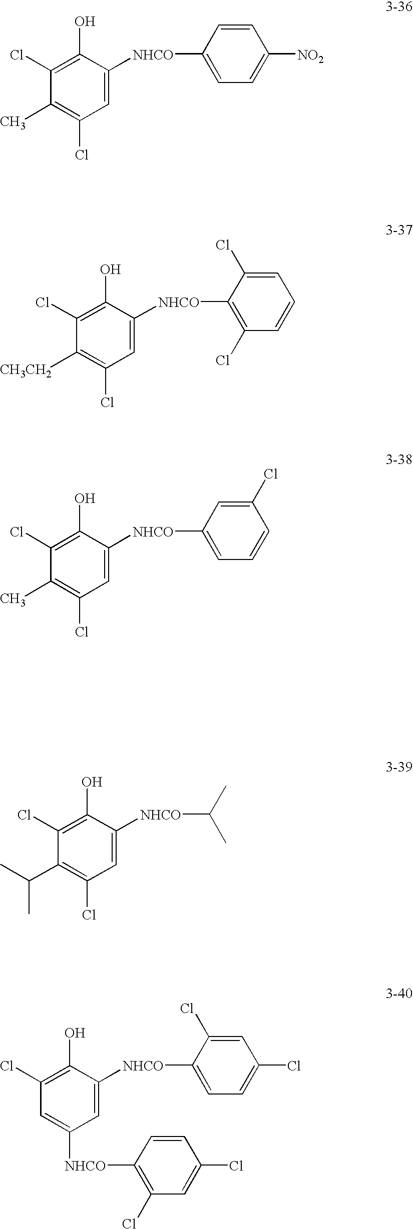

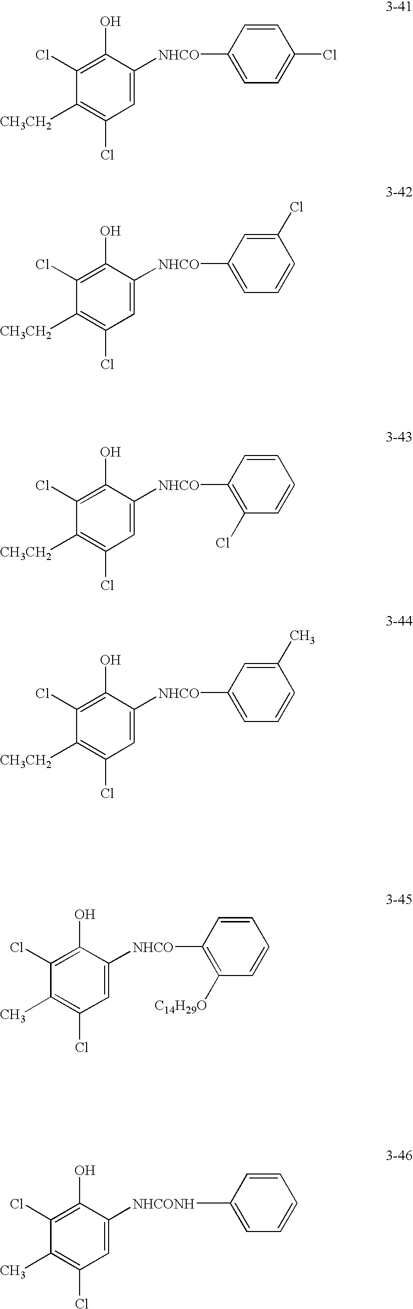

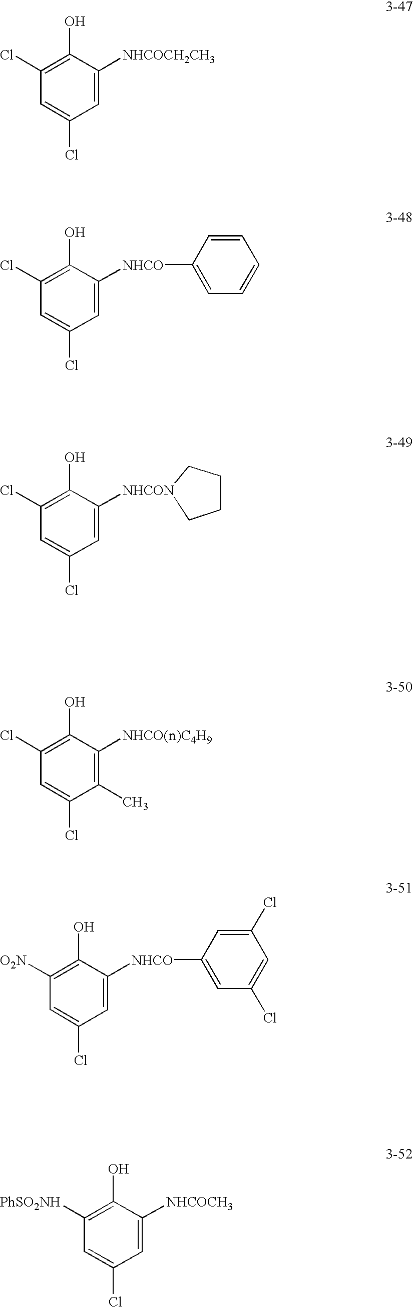

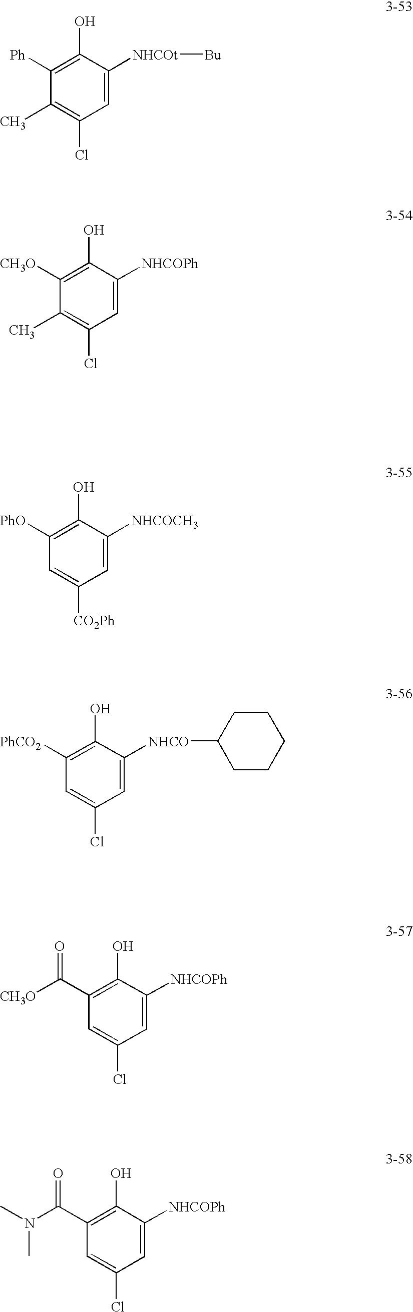

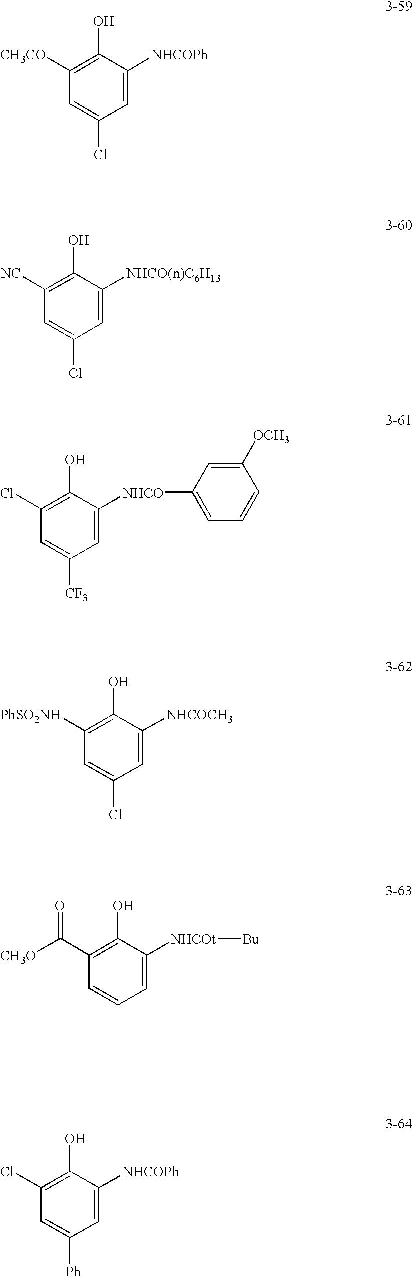

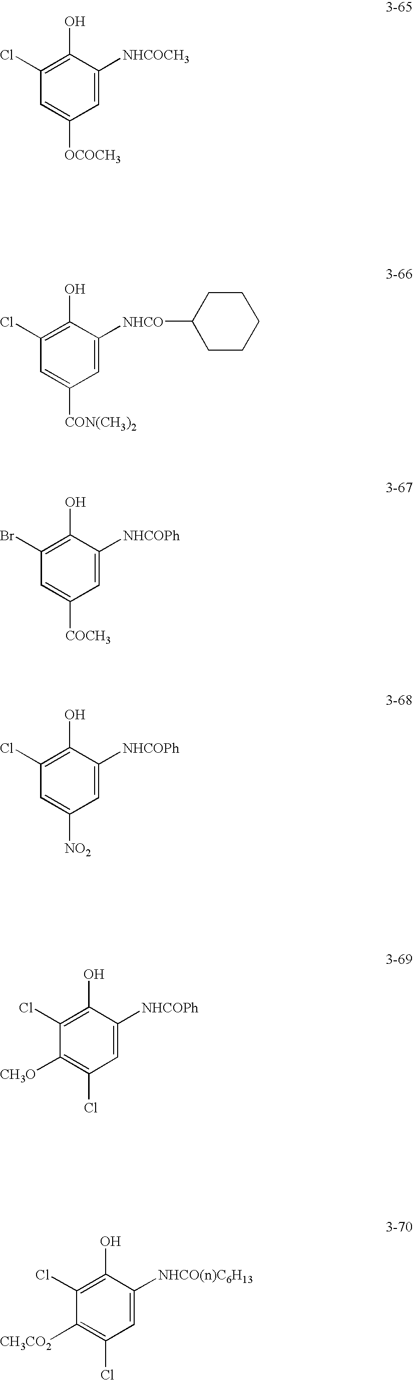

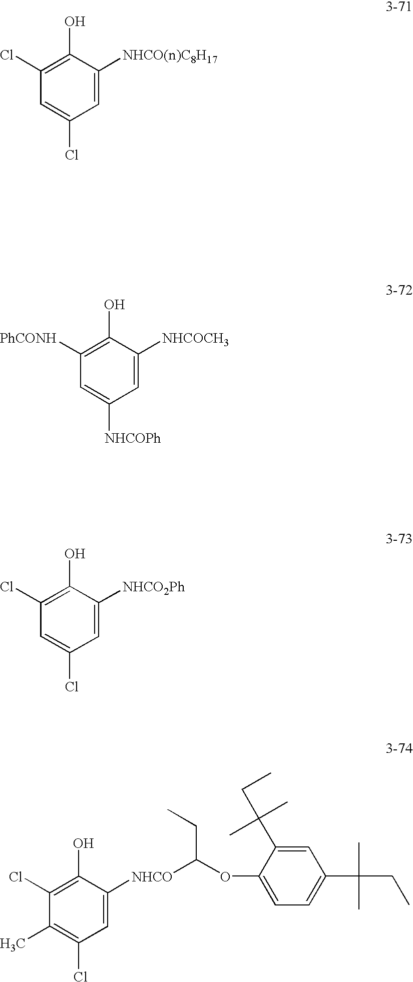

<Development Accelerator of General Formula (4)>

The compound of the general formula (6) is represented further preferably by the following general formula (4).

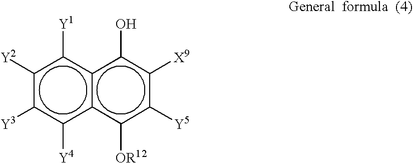

In the general formula (4), R¹² represents an alkyl group, aryl group, alkenyl group or alkinyl group, X⁹ represents an acyl group, alkoxycarbonyl group, carbamoyl group, sulfonyl group or sulfamoyl group. Y¹ to Y⁵ each independently represent a hydrogen atom or a substituent.

In the general formula (4), R¹² represents an alkyl group, aryl group, alkenyl group or alkinyl group.

The alkyl group represented by R¹² is preferably a linear, branched, or cyclic alkyl group, preferably having 1 to 20, more preferably 1 to 16, and further preferably 1 to 13 carbon atoms or a combination thereof and include, for example, methyl group, ethyl group, n-propyl group, isopropyl group, n-butyl group, sec-butyl group, t-butyl group, n-hexyl group, cyclohexyl group, n-octyl group, t-octyl group, n-amyl group, t-amyl group, n-decyl group, n-dodecyl group, n-tridecyl group, benzyl group and phenetyl group.

The aryl group represented by R¹² has carbon atoms of preferably 6 to 30, more preferably 6 to 20, and further preferably 6 to 12 and include, e.g., phenyl group, 4-methylphenyl group, 2-chlorophenyl group, 4-chlorophenyl group, 2,4-dichlorophenyl group, 3,4-dichlorophenyl group, 2-methoxyphenyl group, 4-methoxyphenyl group, 4-hexyloxyphenyl group, 2-dodecyloxyphenyl group, and naphthyl group.

The alkenyl group represented by R¹² has carbon atoms of preferably 2 to 30, more preferably 2 to 20, and further preferably 2 to 12 and include, for example, vinyl group, aryl group, propenyl group, butenyl group, and cyclohexenyl group.

The alkinyl group represented by R¹² has carbon atoms of preferably 2 to 30, more preferably 2 to 20, and further preferably 2 to 12 and include, for example, ethynyl group and propinyl group.

R¹² may have a further substituent and examples of preferred substituents include those groups represented by Y¹-Y⁵ in the compound of the general formula (4) to be described later.

R¹² further preferably represents an alkyl group or aryl group, and particularly preferably represents the alkyl group.

In the compound of the general formula (4), X⁹ represents an acyl group, alkoxycarbonyl group, carbamoyl group, sulfonyl group or sulfamoyl group.

The acyl group represented by X⁹ has carbon atoms of preferably 2 to 20, more preferably 2 to 16, and further preferably 2 to 12 and include, for example, acetyl, propionyl, butyryl, valeryl, hexanoyl, myristylyl, palmitoyl, stearyl, oleyl, acryloyl, cyclehexanecarbonyl, banzoyl, formyl, and pivaloyl.

The alkoxycarbonyl group represented by X⁹ has carbon atoms of preferably 2 to 20, more preferably 2 to 16, and further preferably 2 to 12 and include, for example, methoxycarbonyl, ethoxycarbonyl, butoxycarbonyl, and phenoxycarbonyl.

The carbamoyl group represented by X⁹ has carbon atoms of preferably 1 to 20, more preferably 1 to 16, and further preferably 1 to 12 and include, for example, carbamoyl, N,N-diethylcarbamoyl, N-dodecylcarbamoyl, N-decylcarbamoyl, N-hexadecylcarbamoyl, N-phenylcarbamoyl, N-(2-chlorophenyl)carbamoyl, N-(4-chlorophenyl)carbamoyl, N-(2,4-dichlorophenyl) carbamoyl, N-(3,4-dichlorophenyl)carbamoyl, N-pentachlorophenylcarbamoyl, N-(2-methoxyphenyl)carbamoyl, N-(4-methoxyphenyl)carbamoyl, N-(2,4 -dimethoxyphenyl)carbamoyl, N-(2-dodecyloxyphenyl)carbamoyl, and N-(4-dodecyloxyphenyl)carbamoyl.

The sulfonyl group represented by X⁹ has carbon atoms of preferably 1 to 20, more preferably 1 to 16, and further preferably 1 to 12 and include, for example, mesyl, ethanesulfonyl, cyclohexanesulfonyl, benzenesulfonyl, tosyl, and 4-chlorobenzenesulfonyl.

The sulfamoyl group represented by X⁹ has carbon atoms of preferably 0 to 20, more preferably 0 to 16, and further preferably 0 to 12 and include, for example, sulfamoyl, methylsulfamoyl, dimethylsulfamoyl, and phenylsulfamoyl.

X⁹ may have a further substituent and examples of preferred substituent include, those groups represented by Y¹ to Y⁵ to be described later.

X⁹ preferably represents a carbamoyl group and, further preferably represents an alkylcarbamoyl group or arylcarbamoyl group and, particularly preferably represents an arylcarbamoyl group.

Y¹ to Y⁵ each independently represent a hydrogen atom or a substituent.

As the substituent represented by Y¹ to Y⁵, any substituent may be used so long as it does not adversely affect the photographic property. For example, the substituted include, a halogen atom (e.g., fluorine atom, chlorine atom, bromine atom and iodine atom), a linear, branched, or cyclic alkyl group or a combination thereof (having carbon atoms of preferably 1 to 20 carbon atoms, more preferably 1 to 16 carbon atoms, and particularly preferably 1 to 13 and include, for example, methyl group, ethyl group, n-propyl group, isopropyl group, sec-butyl group, t-butyl group, t-octyl group, n-amyl group, t-amyl group, n-dodecyl group, n-tridecyl group, and cyclohexyl group), alkenyl group (having carbon atoms of preferably 2 to 20 carbon atoms, more preferably 2 to 16 carbon atoms, and particularly preferably 2 to 12 and include, for example, vinyl group, allyl group, 2-butenyl group, and 3-pentenyl group), aryl group (having carbon atoms of preferably 6 to 30 carbon atoms, more preferably 6 to 20 carbon atoms, and particularly preferably 6 to 12 and include, for example, phenyl group, p-methylphenyl group, and naphthyl group), alkoxy group (having carbon atoms of preferably 1 to 20 carbon atoms, more preferably 1 to 16 carbon atoms, and particularly preferably 1 to 12 and include, for example, methoxy group, ethoxy group, propoxy group and butoxy group), aryloxy group (having carbon atoms of preferably 6 to 30 carbon atoms, more preferably 6 to 20 carbon atoms, and particularly preferably 6 to 12 and include, for example, phenyloxy group and 2-naphthyloxy group), acyloxy group (having carbon atoms of preferably 2 to 20 carbon atoms, more preferably 2 to 16 carbon atoms, and particularly preferably 2 to 12) and include, for example, acetoxy group and benzoyloxy group), amino group (having carbon atoms of preferably 0 to 20 carbon atoms, more preferably 1 to 16 carbon atoms, and particularly preferably 1 to 12) and include, for example, dimethylamino group, diethylamino group, dibutylamino group, and anilino group), acylamino group (having carbon atoms of preferably 2 to 20 carbon atoms, more preferably 2 to 16 carbon atoms, and particularly preferably 2 to 13) and include, for example, acetylamino group, tridecanoylamino group and benzoylamino group), sulfonylamino group (having carbon atoms of preferably 1 to 20 carbon atoms, more preferably 1 to 16 carbon atoms, and particularly preferably 1 to 12) and include, for example, methane sulfonylamino group, butane sulfonylamino group, and benzene sulfonylamino group), ureido group (having carbon atoms of preferably 1 to 20 carbon atoms, more preferably 1 to 16 carbon atoms, and particularly preferably 1 to 12 and include, for example, ureido group, methylureigo group, and phenylureido group), carbamate group (having carbon atoms of preferably 2 to 20 carbon atoms, more preferably 2 to 16 carbon atoms, and particularly preferably 2 to 12) and include, for example, methoxycarbonylamino group and phenyloxycarbonylamino group), carboxyl group, carbamoyl group (having preferably I to 20 carbon atoms, more preferably 1 to 16 carbon atoms, and particularly preferably 1 to 12) and include, for example, carbamoyl group, N,N-diethylcarbamoyl group, N-dodecylcarbamoyl group and N-phenylcarbamoyl group), alkoxycarbonyl group (having carbon atoms of preferably 2 to 20 carbon atoms, more preferably 2 to 16 carbon atoms, and particularly preferably 2 to 12) and include, for example, methoxycarbonyl group, ethoxycarbonyl group, and butoxycarbonyl group), acyl group (having carbon atoms of preferably 2 to 20 carbon atoms, more preferably 2 to 16 carbon atoms, and particularly preferably 2 to 12) and include, for example, acetyl, benzoyl, formyl, and pivaloyl), sulfo group, sulfonyl group (having carbon atoms of preferably 1 to 20, more preferably 1 to 16, and particularly preferably 1 to 12) and include, for example, mesyl group, and tosyl group), sulfamoyl group (having carbon atoms of preferably 0 to 20, more preferably 0 to 16, and particularly preferably 0 to 12) and include, for example, sulfamoyl group, methylsulfamoyl group, dimethylsulfamoyl group, and phenylsulfamoyl group), cyano group, nitro group, hydroxyl group, mercapto group, alkylthio group (having carbon atoms of preferably 1 to 20, more preferably 1 to 16, and particularly preferably 1 to 12) and include, for example, methylthio group and butylthio group), heterocyclic group (having carbon atoms of preferably 2 to 20, more preferably 2 to 16, and particularly preferably 2 to 12) and include, for example, pyridyl group, imidazoyl group, and pyrrolidyl group). The substituent described above may further be substituted with other substituent.

Preferred substituent represented by Y¹ to Y⁵, among those described above, are a halogen atom, an alkyl group, aryl group, alkoxy group, aryloxy group, acyloxy group, anilino group, acylamino group, sulfonylamino group, carboxyl group, carbamoyl group, acyl group, sulfo group, sulfonyl group, sulfamoyl group, cyano group, hydroxyl group, mercapto group, alkylthio group, and heterocyclic group.

In the compounds represented by the general formula (4), a combination in which R¹² is an alkyl group, X⁹ is a carbamoyl group and Y¹ to Y⁵ are hydrogen atoms is preferred.

Specific examples of the compounds represented by the general formula (4) are shown below, but the compounds used in the invention are not restricted thereto.

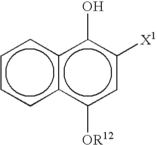

| Compound | X¹ | R¹² |
|---|---|---|
| 4-1 | CONHC₆H₅ | CH₃ |
| 4-2 | ″ | C₂H₅ |
| 4-3 | ″ | C₃H₇ |
| 4-4 | ″ | (i) C₃H₇ |
| 4-5 | ″ | C₄H₉ |
| 4-6 | ″ | C₅H₁₁ |
| 4-7 | ″ | C₆H₁₃ |
| 4-8 | ″ | C—C₆H₁₁ |
| 4-9 | ″ | C₁₀H₂₁ |
| 4-10 | ″ | C₁₂H₂₅ |
| 4-11 | ″ | C₁₆H₃₃ |
| 4-12 | ″ | CH₂C₆H₅ |
| 4-13 | ″ | (CH₂)₂C₆H₅ |
| 4-14 | ″ | (CH₂)₂NHSO₂CH₃ |
| 4-15 | ″ | (CH₂)₂OCH₂CH₃ |
| 4-16 | ″ | (CH₂)₂O(CH₂)₂OH |
| 4-17 | ″ | (CH₂)₂OCH₂CO₂H |
| 4-18 | ″ | C₈H₁₇ |
| 4-19 | ″ | (CH₂)₂SO₂CH₃ |
| 4-20 | ″ | (CH₂)₂SO₂CH₂CH₃ |
| 4-21 | ″ | (CH₂)₂O(CH₂)₂OCH₂CH₃ |
| 4-22 | ″ | 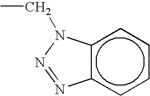 |
| 4-23 | ″ | 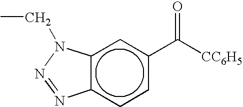 |
| 4-24 | ″ | C₆H₅ |
| 4-25 | ″ | p-CH₃—C₆H₄ |
| 4-26 | ″ | p-Cl—C₆H₄ |
| 4-27 | ″ | 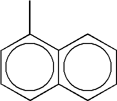 |
| 4-28 | ″ | 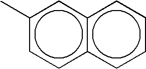 |
| 4-29 | CONH-2-Cl—C₆H₄ | CH₃ |
| 4-30 | ″ | C₄H₉ |
| 4-31 | ″ | C₆H₁₃ |
| 4-32 | ″ | CH₂CH₂C₆H₅ |
| 4-33 | ″ | C₁₂H₂₅ |
| 4-34 | CONH-4-Cl—C₆H₄ | C₄H₉ |
| 4-35 | ″ | C₆H₁₃ |
| 4-36 | ″ | C₈H₁₇ |
| 4-37 | ″ | CH₂CH₂C₆H₅ |
| 4-38 | ″ | C₁₀H₂₅ |
| 4-39 | 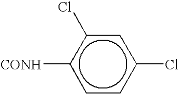 | CH₃ |
| 4-40 | ″ | C₄H₉ |
| 4-41 | ″ | C₆H₁₃ |
| 4-42 | ″ | C₈H₁₇ |
| 4-43 | ″ | CH₂CH₂C₆H₅ |
| 4-44 | ″ | C₁₀H₂₁ |
| 4-45 | 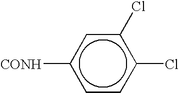 | CH═CHCH₃ |
| 4-46 | ″ | C₄H₉ |
| 4-47 | ″ | C₆H₁₃ |
| 4-48 | ″ | C≡CH |
| 4-49 | ″ | C₈H₁₇ |
| 4-50 | ″ | CH₂CH₂C₆H₅ |
| 4-51 | ″ | CH₂C₆H₅ |
| 4-52 | ″ | C₆H₅ |
| 4-53 | ″ | CH₂CH₂SO₂CH₃ |
| 4-54 | 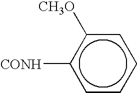 | C₆H₁₃ |
| 4-55 | ″ | CH₂CH₂C₆H₅ |
| 4-56 | ″ | C₄H₉ |
| 4-57 | CONHCH₃ | C₆H₁₃ |
| 4-58 | CONHC₄H₉ | ″ |
| 4-59 | CONHC₆H₁₃ | ″ |
| 4-60 | CONHC₁₀H₂₁ | ″ |
| 4-61 | CONHC₁₂H₂₅ | ″ |
| 4-62 | CONHC₁₆H₃₃ | ″ |
| 4-63 | 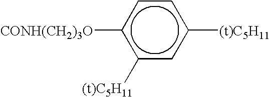 | ″ |
| 4-64 | CONH(CH₂)₃OC₁₂H₂₅ | ″ |
| 4-65 | 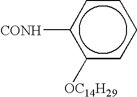 | ″ |
| 4-66 | CONHCH₂C₆H₅ | ″ |
| 4-67 | 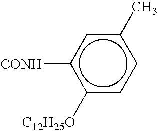 | ″ |
| 4-68 | 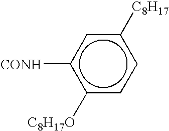 | ″ |
| 4-69 | CONH-(t)C₄H₉ | ″ |
| 4-70 | CONH-(t)C₈H₁₇ | ″ |
| 4-71 | CON(C₂H₅)₂ | C₆H₁₃ |
| 4-72 | 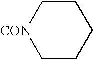 | ″ |
| 4-73 | 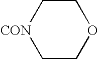 | ″ |
| 4-74 | 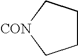 | ″ |
| 4-75 | CONHC₄H₉ | (CH₂)₂C₆H₅ |
| 4-76 | CONHC₁₀H₂₁ | ″ |
| 4-77 | CONHC₁₂H₂₅ | ″ |
| 4-78 | CONH-(t)C₄H₉ | ″ |
| 4-79 | CONH-(t)C₈H₁₇ | ″ |
| 4-80 | CONHCH₃ | ″ |
| 4-81 | 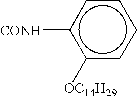 | ″ |
| 4-82 | CON(C₂H₅)₂ | ″ |
| 4-83 | 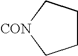 | ″ |
| 4-84 | CONHCH₂C₆H₅ | ″ |

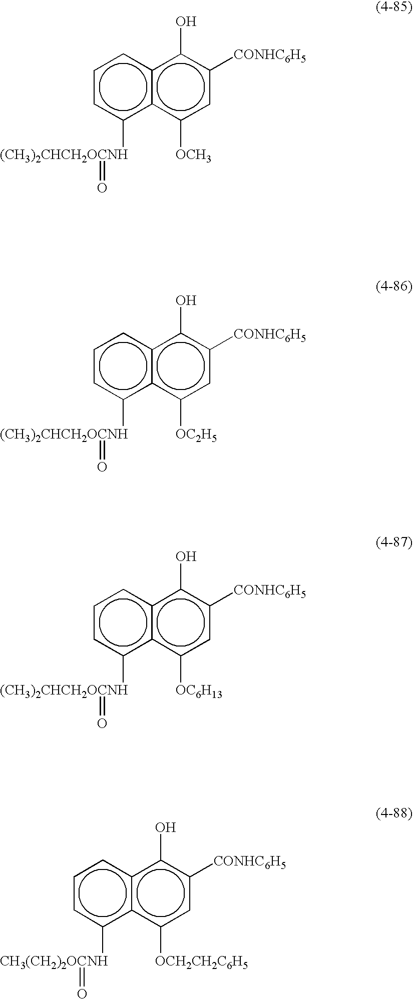

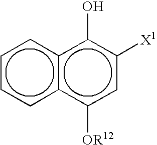

| Compound | X¹ | R¹² |
|---|---|---|
| 4-89 | COCH₃ | C₆H₁₃ |
| 4-90 | COC₂H₅ | ″ |
| 4-91 | COC₇H₁₅ | ″ |
| 4-92 | COC₁₁H₂₃ | ″ |
| 4-93 | COCH₃ | (CH₂)₂C₆H₅ |
| 4-94 | COC₂H₅ | ″ |
| 4-95 | COC₇H₁₅ | ″ |
| 4-96 | COC₁₁H₂₃ | ″ |
| 4-97 | COCH₃ | CH₃ |
| 4-98 | ″ | C₄H₉ |
| 4-99 | ″ | C₆H₅ |
| 4-100 | ″ | CH₂C₆H₅ |
| 4-101 | ″ | C₁₀H₂₁ |
| 4-102 | ″ | C₁₂H₂₅ |
| 4-103 | ″ | C₁₆H₃₃ |
| 4-104 | CO₂C₆H₅ | C₆H₅ |
| 4-105 | ″ | CH₃ |
| 4-106 | ″ | C₂H₅ |
| 4-107 | ″ | C₄H₉ |
| 4-108 | ″ | C₆H₁₃ |
| 4-109 | ″ | C₁₀H₂₁ |
| 4-110 | ″ | CH₂C₆H₅ |
| 4-111 | ″ | (CH₂)₂C₆H₅ |
| 4-112 | ″ | C₁₂H₂₅ |
| 4-113 | ″ | C₁₆H₃₃ |
| 4-114 | CO₂C₆H₅ | (CH₂)₂SO₂CH₃ |
| 4-115 | ″ | (CH₂)₂SO₂NHCH₃ |
| 4-116 | ″ | (CH₂)₂NHSO₂C₂H₅ |
| 4-117 | CO₂CH₃ | CH₃ |
| 4-118 | ″ | C₄H₉ |
| 4-119 | CO₂C₂H₅ | C₆H₁₃ |
| 4-120 | ″ | (CH₂)₂C₆H₅ |
| 4-121 | ″ | C₁₂H₂₅ |
| 4-122 | CO₂C₁₂H₂₅ | CH₃ |
| 4-123 | ″ | C₄H₉ |
| 4-124 | ″ | C₆H₁₃ |
| 4-125 | ″ | (CH₂)₂C₆H₅ |
| 4-126 | ″ | (CH₂)₂SO₂CH₃ |
| 4-127 | ″ | CH═CHCH₃ |
| 4-128 | ″ | CH₂CH═CH₂ |
| 4-129 | ″ | C≡CCH₃ |
| 4-130 | ″ | C—C₆H₁₁ |
| 4-131 | ″ | C₆H₅ |
| 4-132 | SO₂CH₃ | C₄H₉ |
| 4-133 | ″ | C₆H₁₃ |
| 4-134 | ″ | C₆H₅ |
| 4-135 | ″ | CH₃ |
| 4-136 | ″ | (CH₂)₂C₆H₅ |
| 4-137 | ″ | CH₂C₆H₅ |
| 4-138 | SO₂C₆H₅ | C₄H₉ |
| 4-139 | ″ | C₆H₁₃ |
| 4-140 | ″ | CH₁₃ |
| 4-141 | ″ | (CH₂)₂C₆H₅ |
| 4-142 | ″ | C₁₂H₂₅ |
| 4-143 | SO₂NHC₆H₅ | C₆H₅ |
| 4-144 | SO₂NHCH₃ | ″ |
| 4-145 | SO₂NHC₂H₅ | ″ |
| 4-146 | SO₂NHC₆H₁₃ | ″ |
| 4-147 | SO₂NHC₄H₉ | ″ |
| 4-148 | SO₂NH-(t)C₄H₉ | ″ |
| 4-149 | SO₂NH-(t)C₈H₁₇ | ″ |
| 4-150 | SO₂NHC₆H₅ | C₆H₁₃ |
| 4-151 | SO₂NHCH₃ | ″ |
| 4-152 | SO₂NHC₂H₅ | ″ |
| 4-153 | SO₂NHC₄H₉ | ″ |
| 4-154 | SO₂NH-(t)C₄H₉ | ″ |
| 4-155 | SO₂NH-(t)C₈H₁₇ | ″ |
| 4-156 | SO₂NHC₆H₁₃ | (CH₂)₂C₆H₅ |
| 4-157 | SO₂NHC₆H₅ | ″ |
| 4-158 | SO₂NHCH₃ | ″ |
| 4-159 | SO₂NH-(t)C₈H₁₇ | ″ |

The reducing compounds represented by the general formulae (2)—(6) may be added to the coating liquid by any method such as in the form of a solution, powder, solid dispersion of fine particles, emulsion and oil protective dispersion. Particularly, in a case of using together with the polymer latex of the invention, it is preferably added as solid fine particles. The finely particulate solid dispersion of fine particles can be conducted by known fine pulverizing means (e.g., ball mill, vibration ball mill, sand mill, colloid mill, jet mill, and roller mill). Among them, pulverization using the sand mill is preferred. Further, a dispersing aid may also be used for the solid dispersion of fine particles.

Among them, particularly preferred development accelerators used in the invention are those shown below.

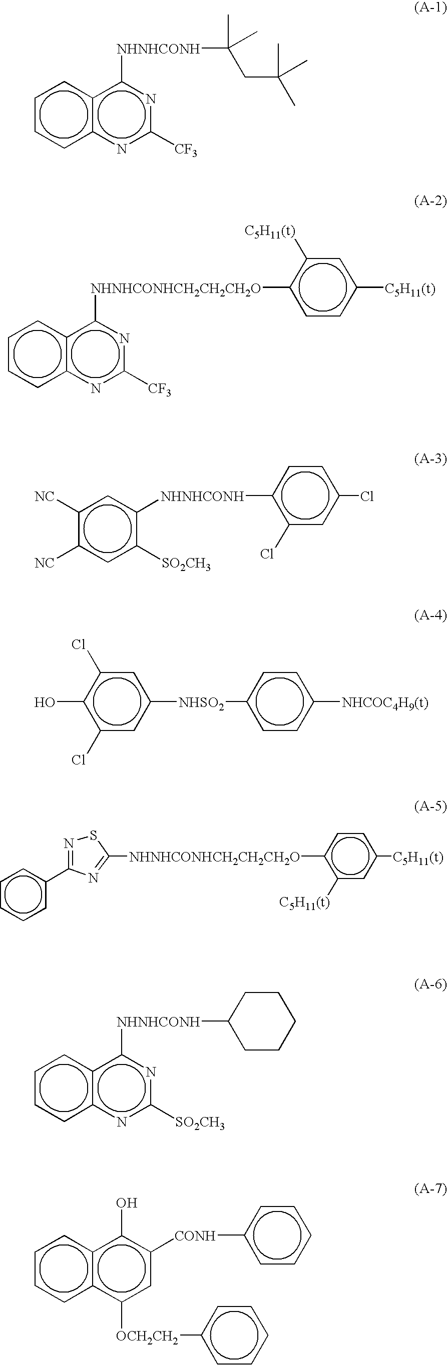

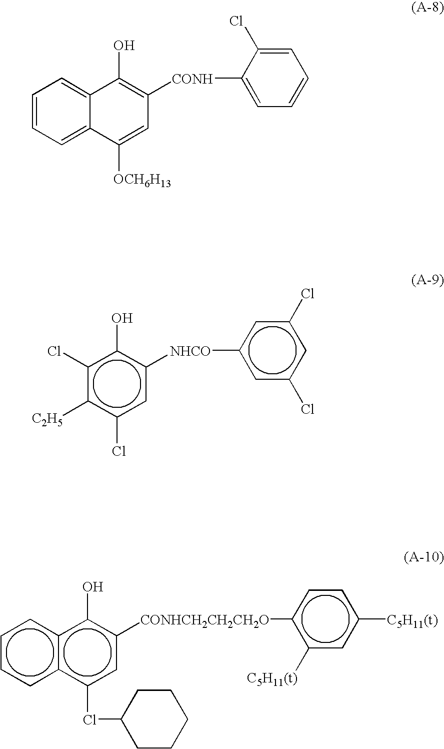

1-5 Compound of the General Formula (I)

The photothermographic material of the invention preferably contains the compound represented by the following general formula (I).

The compound of the general formula (I) is specifically described below.

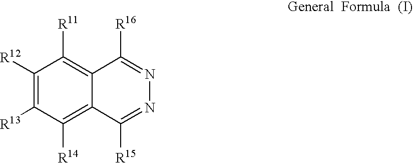

R¹¹, R¹², R¹³, R¹⁴, R¹⁵ and R¹⁶ each independently represent, a hydrogen atom or a monovalent substituent and the substituent may be bonded with each other to form a ring. However, all of R¹¹, R¹², R¹³, R¹⁴, R¹⁵ and R¹⁶ are not hydrogen atoms simultaneously. The substituent may include, for example, alkyl group (having carbon atoms of preferably 1 to 20, further preferably 1 to 12, and particularly preferably 1 to 8 including, e.g., methyl, ethyl, n-propyl, iso-propyl, n-butyl, sec-butyl, iso-butyl, tert-butyl, n-pentyl, tert-pentyl, n-hexyl, n-octyl, n-decyl, n-hexadecyl, cyclopropyl, cyclopentyl, cyclohexyl, and benzyl groups), alkenyl group (having carbon atoms of preferably 2 to 20, further preferably 2 to 12, and particularly preferably 2 to 8 including, e.g., vinyl, aryl, 2-butenyl, and 3-pentenyl groups), alkinyl group (having carbon atoms of preferably 2 to 20, further preferably 2 to 12 and, particularly preferably 2 to 8 including, e.g., propargyl and 3-pentinyl groups), aryl group (having carbon atoms of preferably 6 to 30, further preferably 6 to 20, and particularly preferably 6 to 12 including, e.g., phenyl, p-methylphenyl and naphthyl groups), amino group (having carbon atoms of preferably 0 to 20, further preferably 0 to 10, and particularly preferably 0 to 6 including, e.g., amino, methylamino, dimethylamino, diethylamino, and dibenzylamino groups), alkoxy group (having carbon atoms of preferably 1 to 20, further preferably 1 to 12, and particularly preferably 1 to 8 including, e.g., methoxy, ethoxy, isopropoxy, and butoxy groups), aryloxy group (having carbon atoms of preferably 6 to 20, further preferably 6 to 16, and particularly preferably 6 to 12 including, e.g., phenyloxy and 2-naphthyloxy groups), acyl group (having carbon atoms of preferably 1 to 20, further preferably 1 to 16, and particularly preferably 1 to 12 including, e.g., acetyl, benzoyl, formyl, and pivaloyl groups), alkoxycarbonyl group (having carbon atoms of preferably 2 to 20, further preferably 2 to 16, and particularly preferably 2 to 12 including, e.g., methoxycarbonyl and ethoxycarbonyl groups), aryloxycarbonyl group (having carbon atoms of preferably 7 to 20, further preferably 7 to 16, and particularly preferably 7 to 10 including, e.g., phenyloxycarbonyl group), acyloxy group (having carbon atoms of preferably 2 to 20, further preferably 2 to 16, and particularly preferably 2 to 10 including, e.g., acetoxy and benzoyloxy groups), acylamino group (having carbon atoms of preferably 2 to 20, further preferably 2 to 16, and particularly preferably 2 to 10 including, e.g., acetylamino and benzoylamino groups), alkoxycarbonylamino group (having carbon atoms of preferably 2 to 20, further preferably 2 to 16, and particularly preferably 2 to 12 including, e.g., methoxycarbonyl amino group), aryloxycarbonylamino group (having carbon atoms of preferably 7 to 20, further preferably 7 to 16, and particularly preferably 7 to 12 including, e.g., phenyloxycarbonylamino group), sulfonylamino group (having carbon atoms of preferably 1 to 20, further preferably 1 to 16, and particularly preferably 1 to 12 including, e.g., methane sulfonylamino and benzene sulfonylamino groups), sulfamoyl group (having carbon atoms of preferably 0 to 20, further preferably 0 to 16, and particularly preferably 0 to 12 including, e.g., sulfamoyl, methylsulfamoyl, dimethylsulfamoyl, and phenylsulfamoyl groups), carbamoyl group (having carbon atoms of preferably 1 to 20, further preferably 1 to 16, and particularly preferably 1 to 12 including, e.g., carbamoyl, methylcarbamoyl, diethylcarbamoyl and phenylcarbamoyl), alkylthio group (having carbon atoms of preferably 1 to 20, further preferably 1 to 16, and particularly preferably 1 to 12 including, e.g., methylthio, and ethylthio groups), arylthio group (having carbon atoms of preferably 6 to 20, further preferably 6 to 16, and particularly preferably 6 to 12 including, e.g., phenylthio group), sulfonyl group (having carbon atoms of preferably 1 to 20, further preferably 1 to 16, and particularly preferably 1 to 12 including, e.g., mesyl and tosyl groups), sulfinyl group (having carbon atoms of preferably 1 to 20, further preferably 1 to 16, and particularly preferably 1 to 12 including, e.g., methane sulfinyl and benzene sulfinyl groups), ureido group (having carbon atoms of preferably 1 to 20, further preferably 1 to 16, and particularly preferably 1 to 12 including, e.g., ureido, methylureido and phenyl ureido groups), phosphoric acid amide group (having carbon atoms of preferably 1 to 20, further preferably 1 to 16, and particularly preferably 1 to 12 including, e.g., diethyl phosphoric amide and phenyl phosphoric amide groups), hydroxyl group, mercapto group, halogen atom (e.g., fluorine atom, chlorine atom, bromine atom, and iodine atom), cyano group, sulfo group, carboxyl group, nitro group, hydroxamic group, sulfino group, hydrazino group, and heterocyclic group (e.g., imigazolyl, pyridyl, furyl, piperidyl, morpholino, and thienyl). The substituent described above may further be substituted, and the substituent capable of forming a salt may form a salt. A ring formed by bonding R¹¹ to R¹⁶ may include, for example, a dioxolane ring and benzene ring.

In the compound of the general formula (I) in the invention, R¹¹, R¹², R¹³, and R¹⁴ each represent, preferably, a hydrogen atom, an alkyl group, aryl group, halogen atom and acyl group, more preferably, hydrogen atom, alkyl group, aryl group and acyl group, particularly preferably, hydrogen atom, and alkyl group. Each of R¹⁵ and R¹⁶ is, preferably, a hydrogen atom.

The compound represented by the general formula (I) of the invention may readily be synthesized by those skilled in the art using known methods described, for example, in R. G. ElderField, “Heterocylcic Compounds”, John Wiley and Sons, Vols. 1-9 (1950-1967) and A. R, Kartritzky “Comprehensive Heterocyclic Chemistry”, Pergamon Press, (1984).

Specific examples of the compound represented by the general formula (I) are to be described below, however, the invention is not restricted thereto.

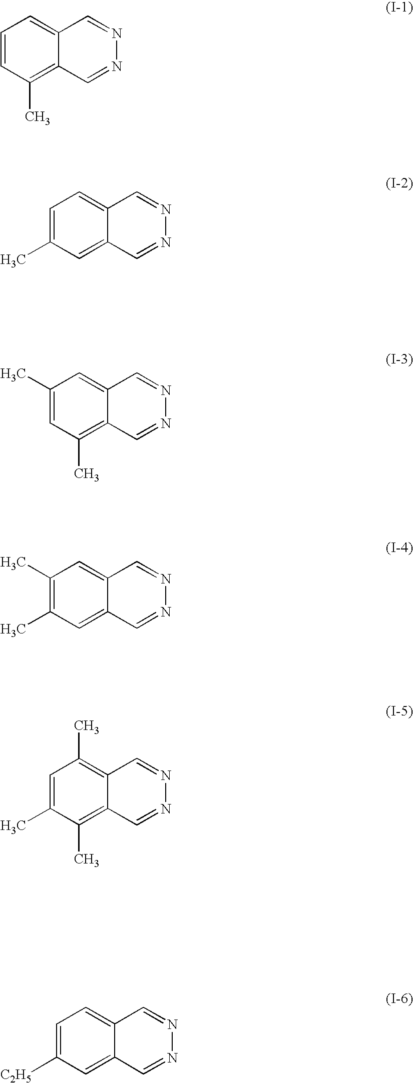

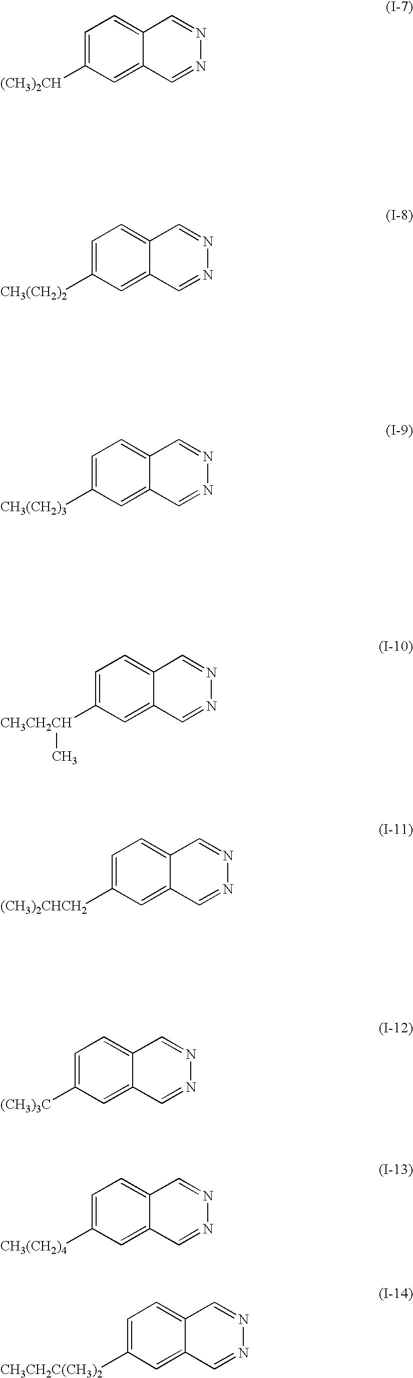

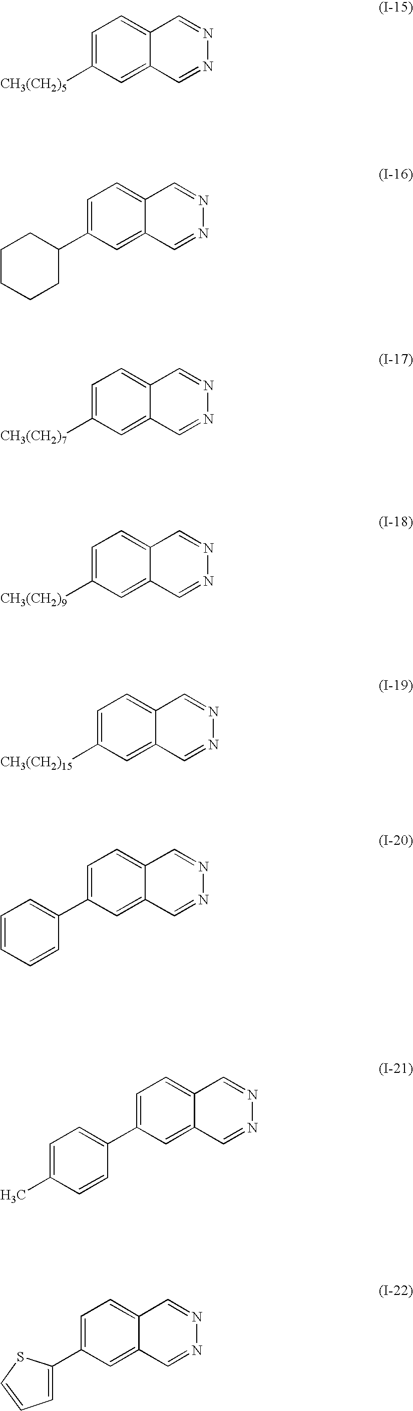

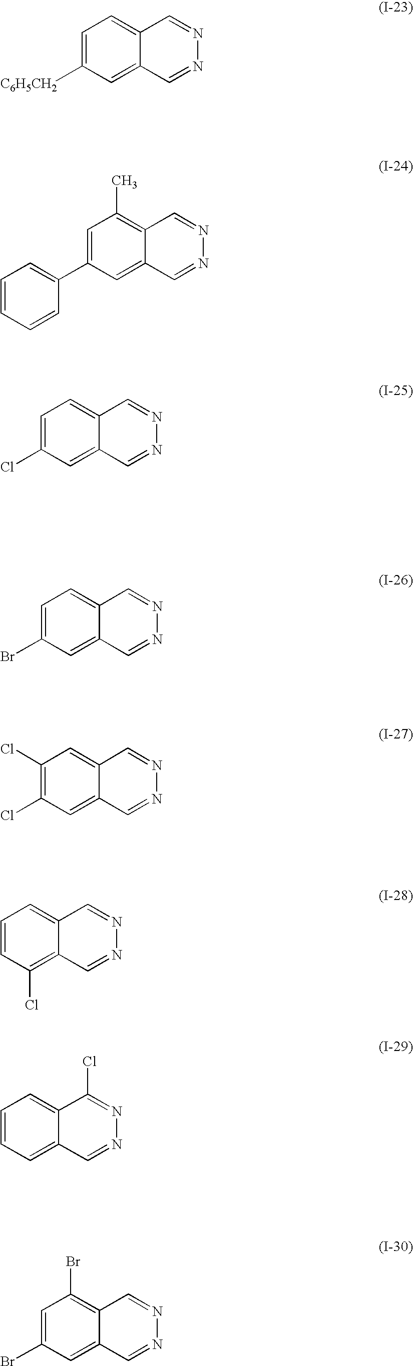

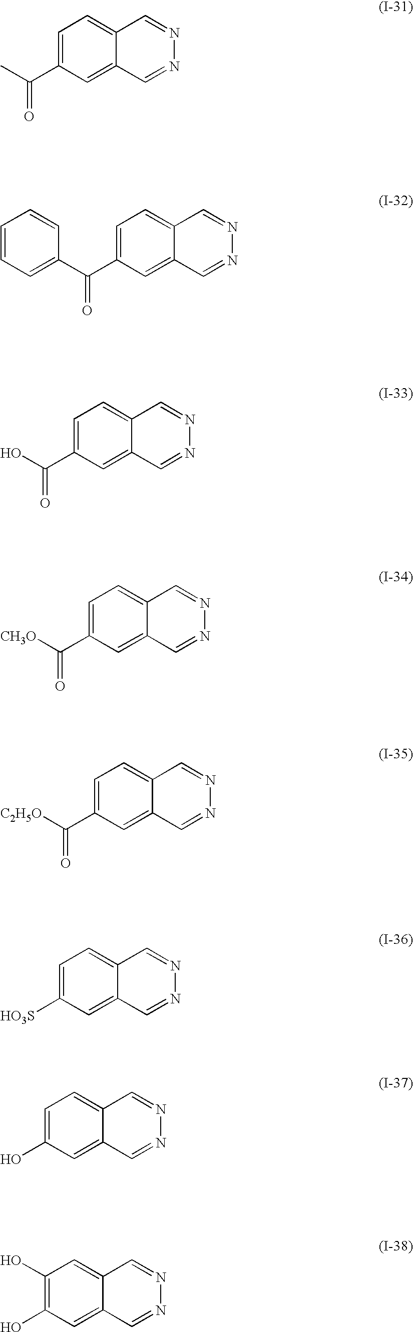

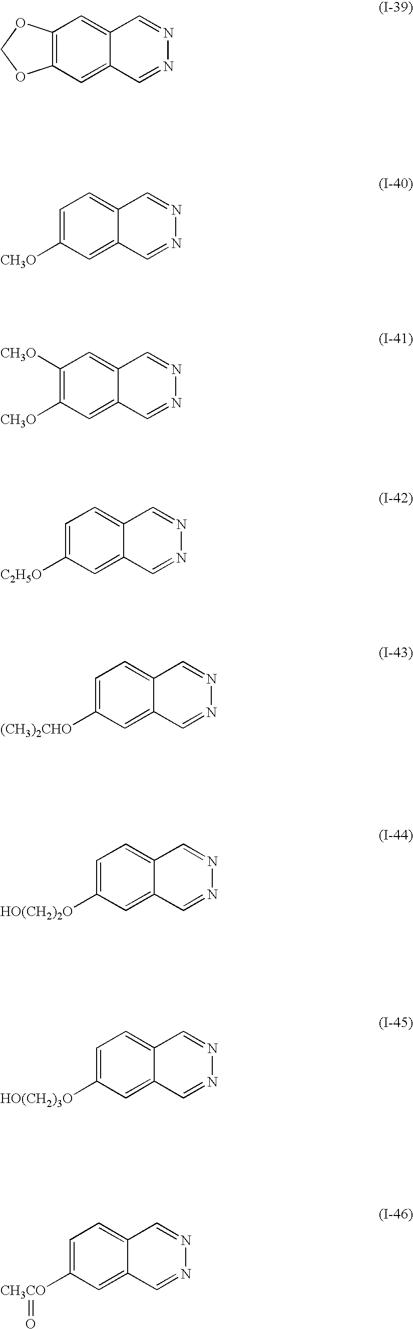

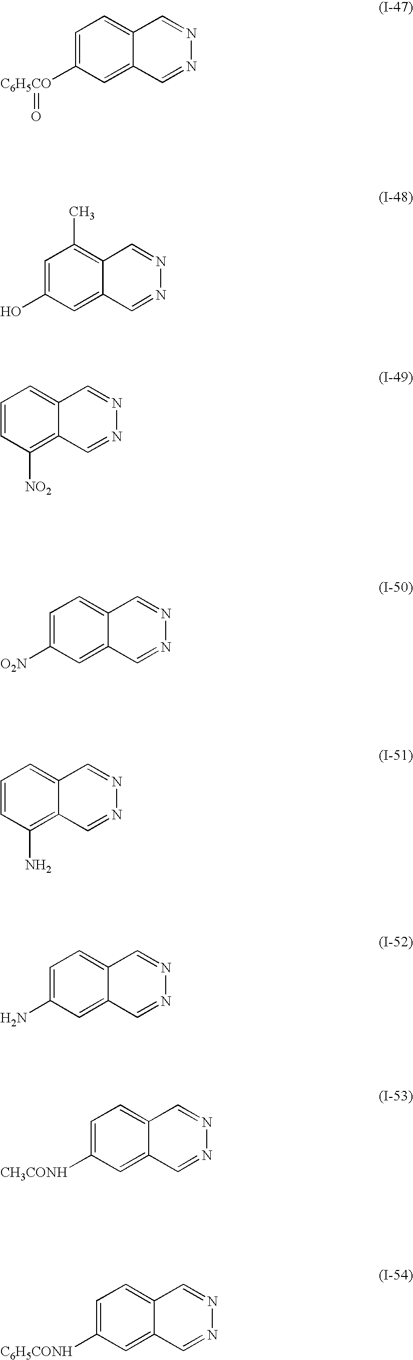

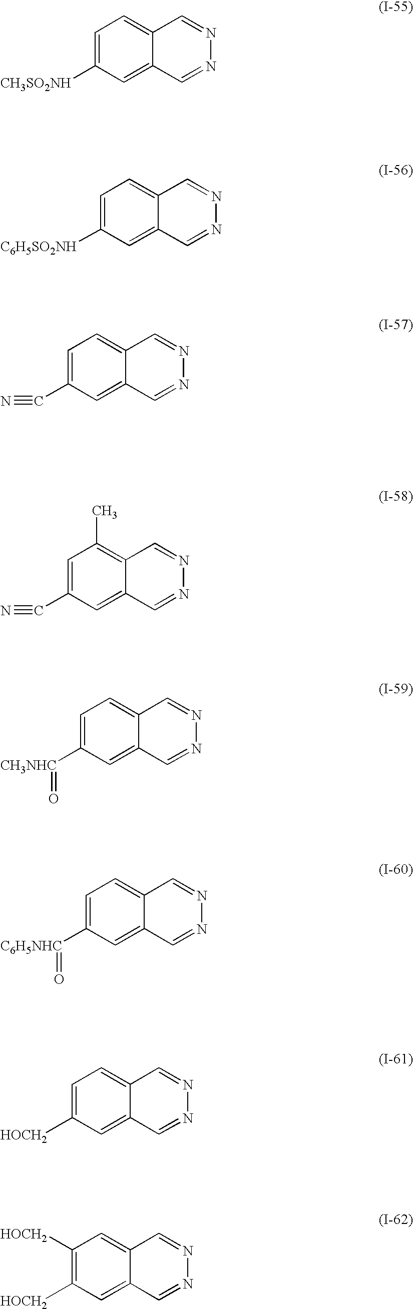

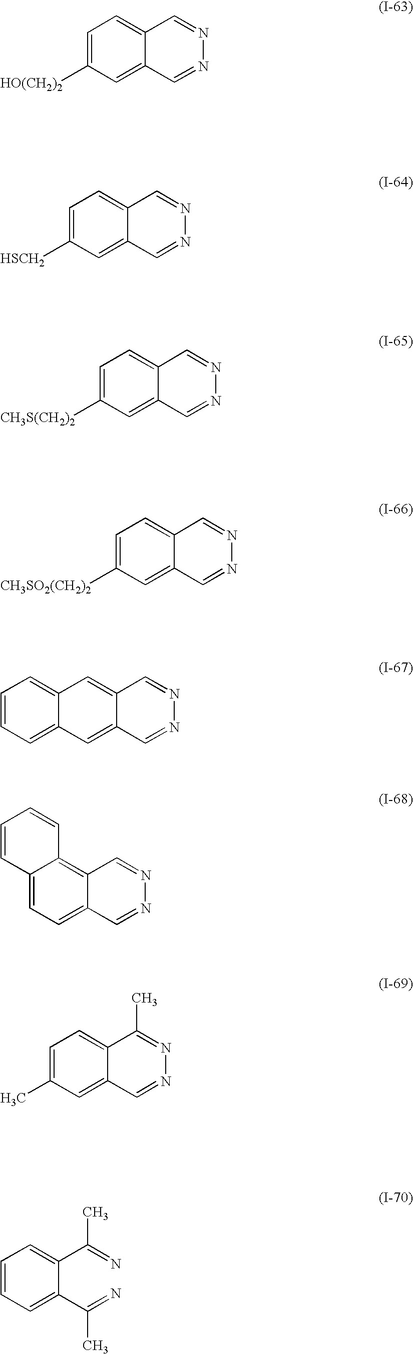

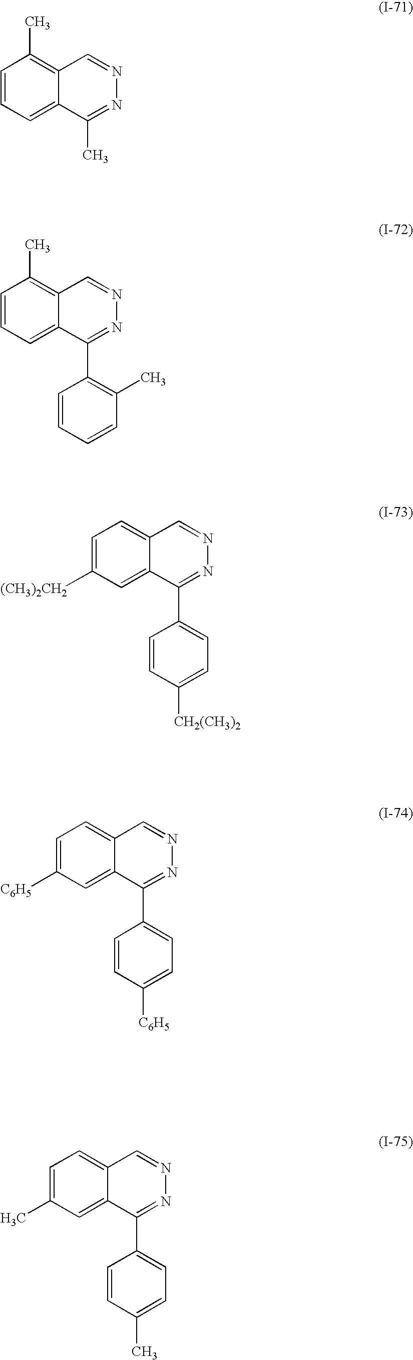

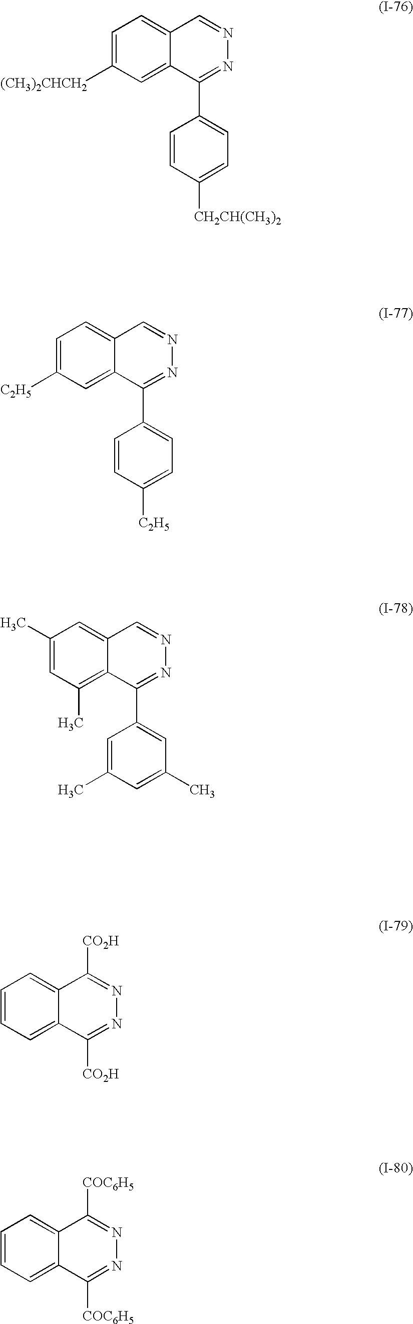

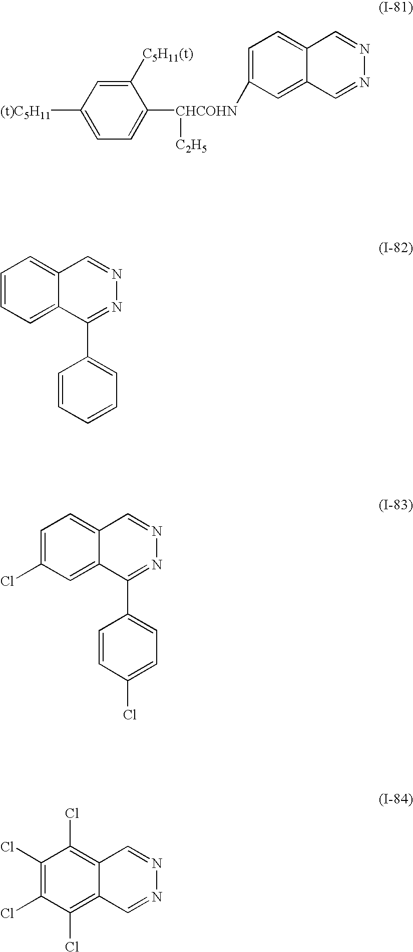

The compound represented by the general formula (I) of the invention may be added to the photothermographic material on the side provided with the image forming layer, either in the photosensitive layer that can act as the image forming layer or in a non-photosensitive layer such as a protective layer.

The compound represented by the general formula (I) of the invention can be desirably added by from 10⁻⁴ to 1 mol, preferably 10⁻³ to 0.3 mol, and further preferably 10⁻³ to 0.1 mol as being expressed by the amount per mol of silver, while varying depending on the purpose.

The compound represented by the general formula (I) of the invention may be added in any form such as a solution, powder and solid dispersion of fine particles. Solid dispersion of fine particles can be obtained by known pulverizing means (e.g., ball mill, vibration ball mill, sand mill, colloid mill, jet mill and roller mill). A dispersing aid may also be used when dispersing the solid fine particles.

The melting point of the compound represented by the general formula (I) of the invention is preferably from −20° C. to 130° C., and further preferably from 30° C. to 100° C., and particular preferably from 50° C. to 80° C.

1-6 Compound of the General Formula (M)

The photothermographic material of the invention preferably contains the compound represented by the following general formula (M).

The compound of the following general formula (M) is specifically described below.

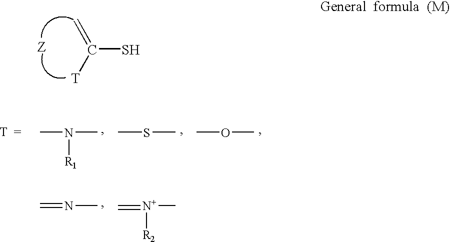

In the general formula (M), Z represents a group of atoms for forming a 5-membered and 6-membered aromatic hetero ring which contains the atom selected from carbon, oxygen, nitrogen, sulfur, selenium and tellurium. Z may further have substituents which may be bonded with each other to have a ring structure to form a condensed ring with the ring structure formed by Z. Preferred specific examples of the aromatic hetero ring may include, for example, imidazole, pyrazole, triazole, tetrazole, thiadiazole, thiazine, pyridazine, pyrimidine, pyrazine, and triazine. Particularly preferred are imidazole, triazole and tetrazole, with imidazole being the most preferred.

In the general formula (M), R₁ and R₂ each represent a hydrogen atom, an alkyl group, aralkyl group, alkoxy group and aryl group. The alkyl group, aralkyl group, alkoxy group and aryl group may have a group to serve as the substituent.

Specific examples of the alkyl group in R₁ and R₂ may include, for example, methyl, ethyl, propyl and cyclohexyl groups. The specific examples of the aralkyl groups in R may include, for example, benzyl group. Specific examples of the alkoxy group in R may include, for example, methoxy and ethoxy groups. Specific examples of the aryl group in R include phenyl and naphthyl groups. Specific examples of the substituent mayclude alkyl groups substituted with amino group, amide group, sulfone amide group (e.g., methylsulfone amide group), ureido group, urethane group (e.g., methylurethane group and ethyl urethane group), aryloxy group (e.g., phenoxy and naphthoxy groups), sulfamoyl group, carbamoyl group (e.g., ethylcarbamoyl group and phenyl carbamoyl group), aryl group (e.g., phenyl and naphthyl groups), alkylthio group (e.g., methylthio and hexylthio groups), arylthio group (for example, phenylthio group), hydroxyl group, halogen atom (e.g., fluorine, chlorine, bromine, and iodine), sulfonic acid group, carboxylic acid group, cyano group, carboxy group or a salt thereof, or phosphoric amide group), that is, the substituent including amino group, amide group, sulfoneamide group, ureido group, urethane group, aryloxy group, sulfamoyl group, carbamoyl group, aryl group, alkylthio group, arylthio group, hydroxy group, halogen atom, sulfonic acid group, carboxylic acid group, cyano group, carboxy group or a salt thereof, or phosphoric amide group. The groups described above may further have substituents, and the substituents may include R described above and those groups mentioned as the substituent therefor.

Preferred R,₁ and R₂ are a hydrogen atom, a substituted and unsubstituted phenyl group and alkyl group. The number of total carbon atoms for R₁ and R₂ is preferably 0 to 20. Particularly preferred is a hydrogen atom and substituted and unsubstituted phenyl group.

Preferred compounds in the general formula (M) are 2-mercapto benzoles and 1-phenyl-5-mercaptotetrazoles, with 2-mercapto-6-methylbenzimidazole being particularly preferred.

Specific examples of the compounds represented by the general formula (M) are shown below, however, the invention is not restricted thereto.

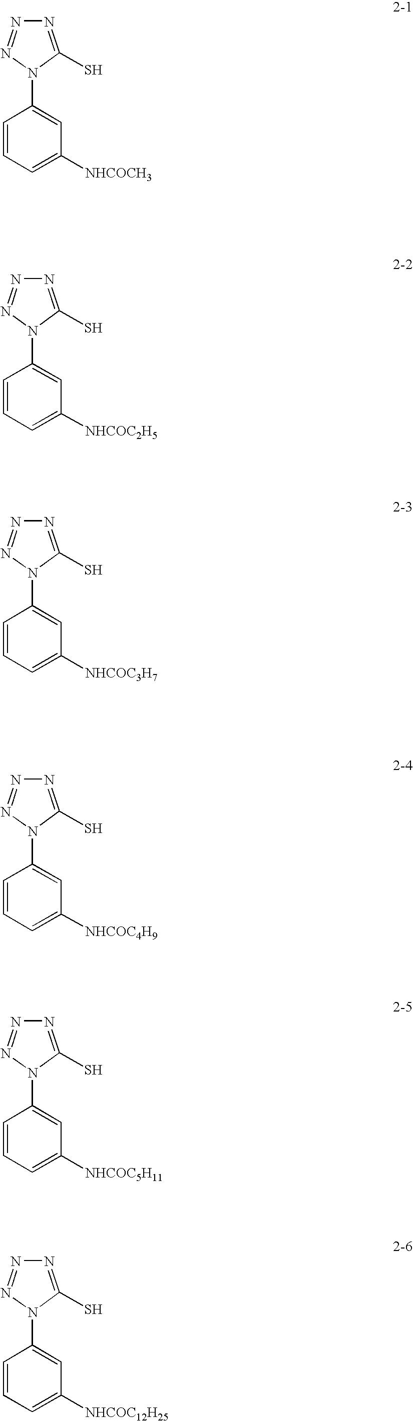

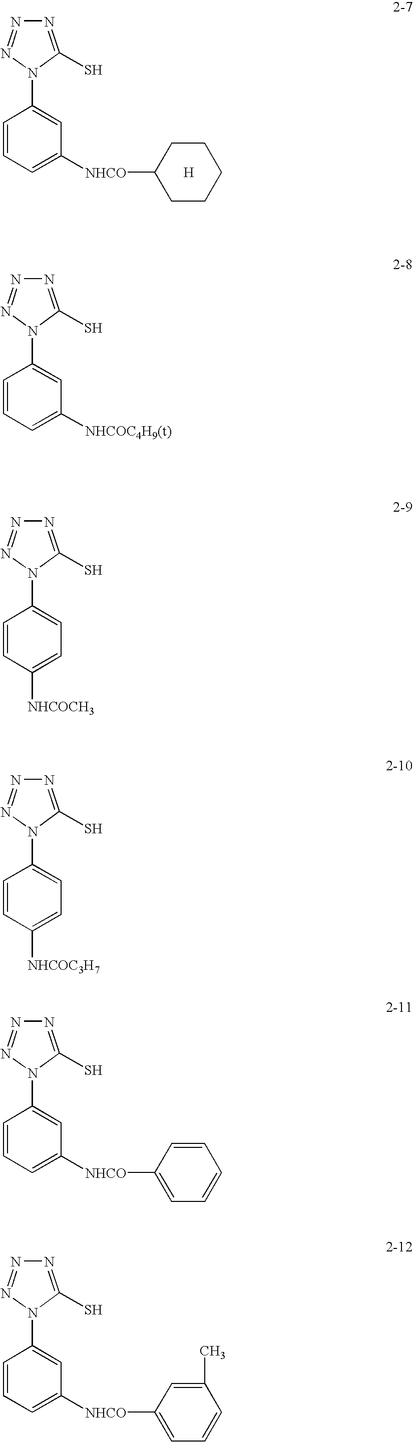

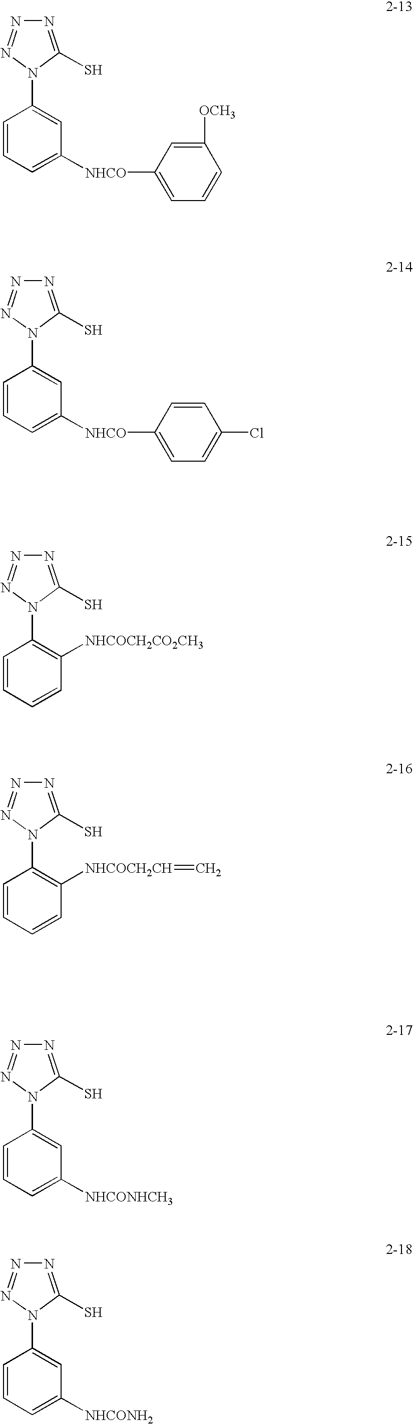

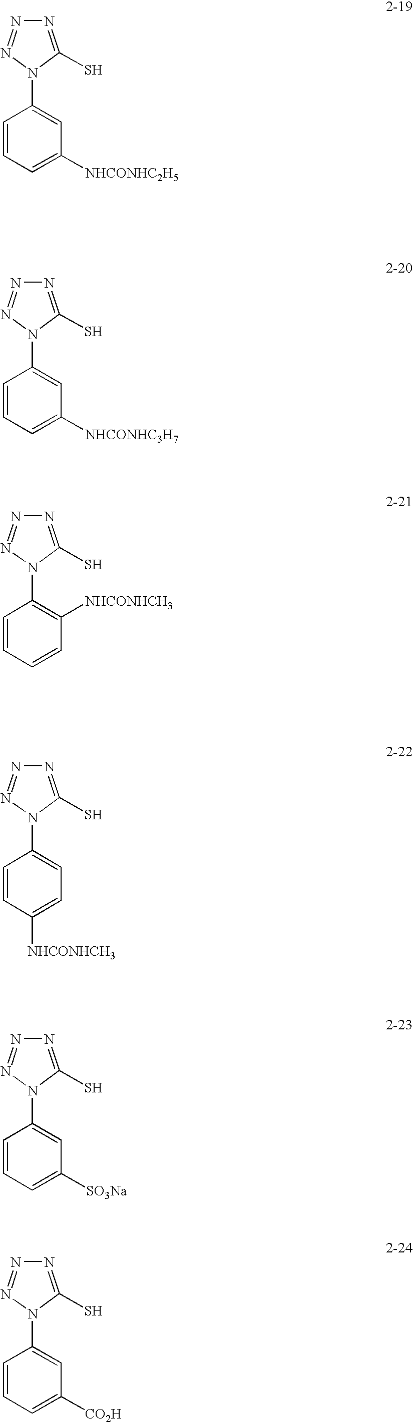

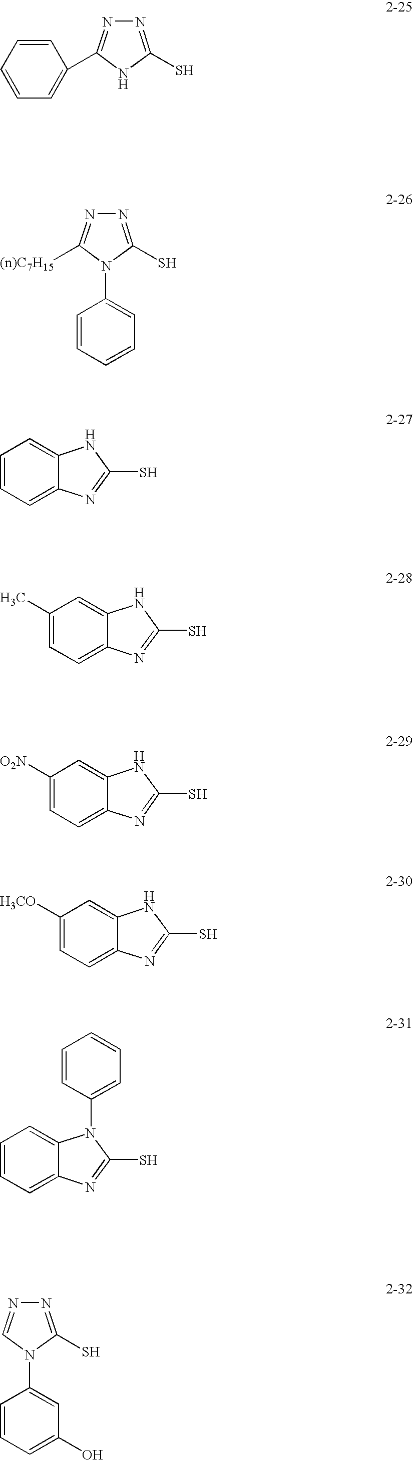

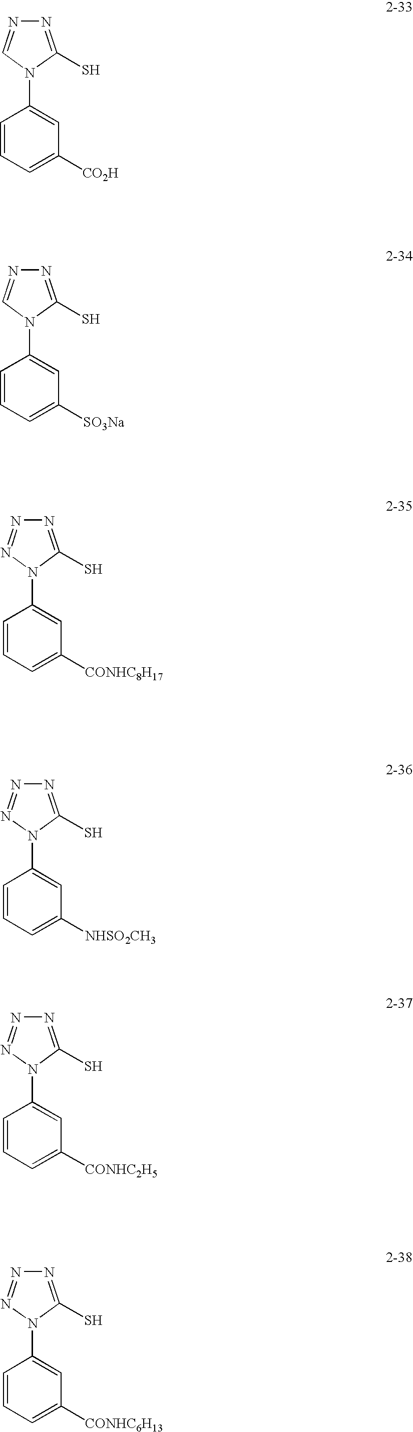

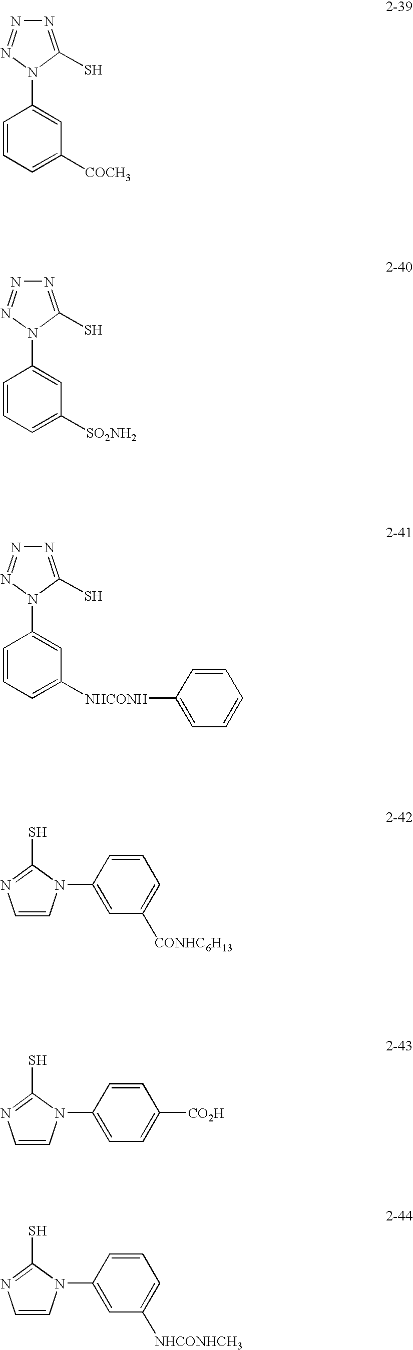

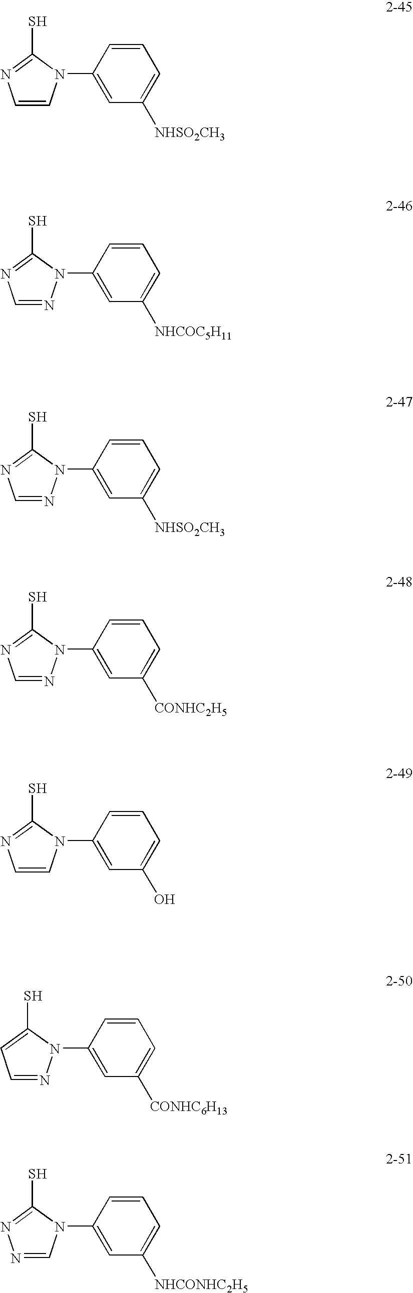

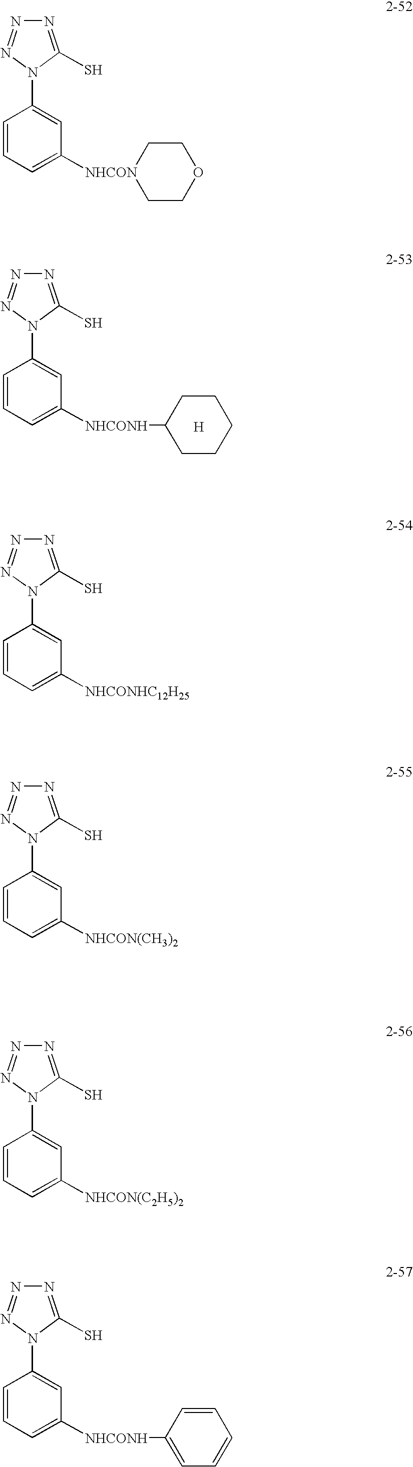

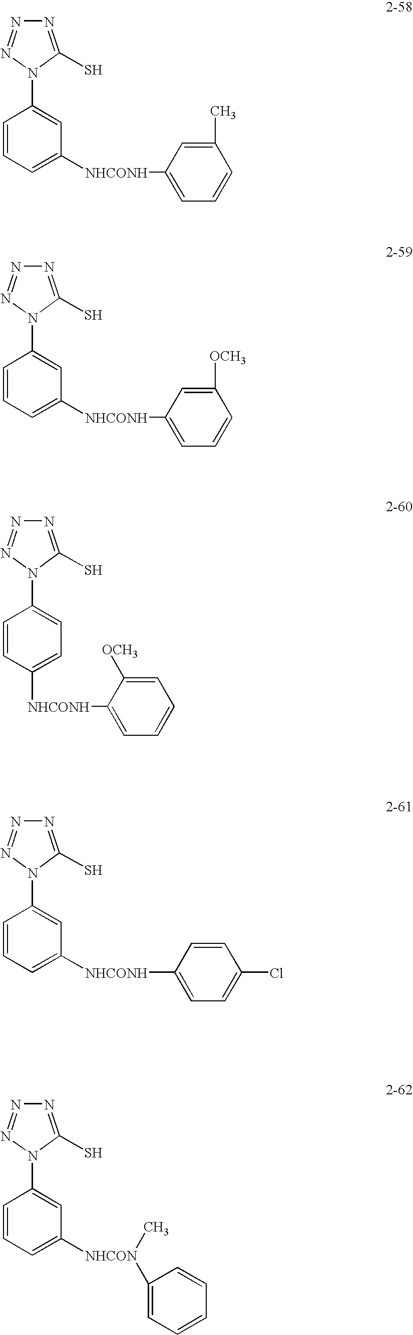

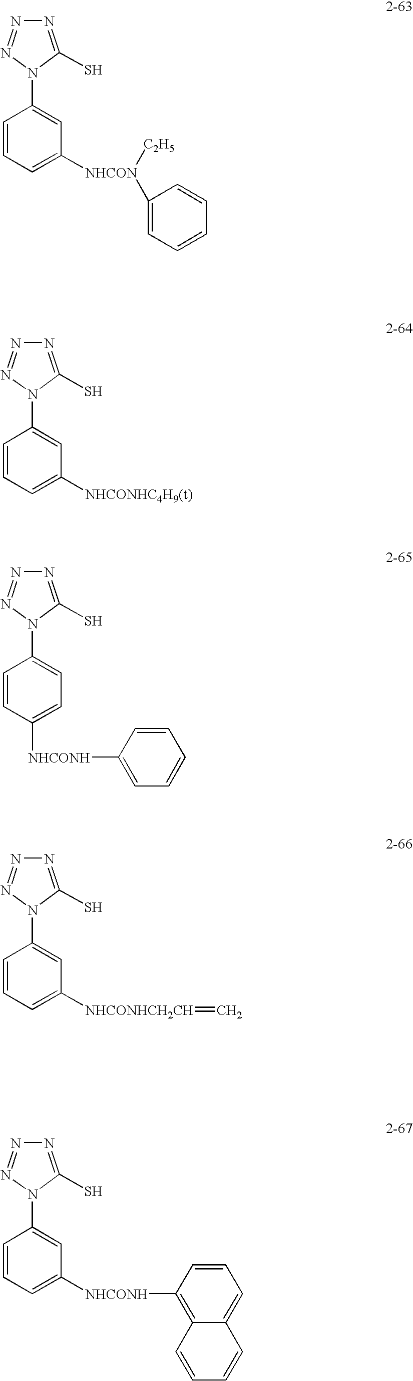

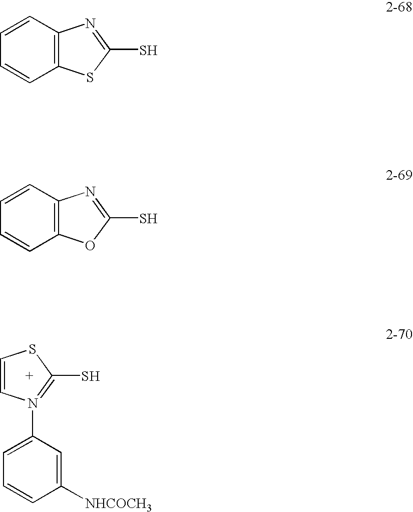

The compound represented by the general formula (M) may be used by being dissolved in water or an appropriate organic solvent, for example, alcohols (methanol, ethanol, propanol, and fluorinated alcohol), ketones (acetone and methyl ethyl ketone), dimethylformamide (dimethylsulfoxide, and methyl cellosolve).

Further, it can be prepared by a well-known emulsifying and dispersing method using an oil such as dibutyl phthalate, tricresyl phosphate, glyceryl triacetate, or diethyl phthalate and an auxiliary solvent such as ethyl acetate or cyclohexanone and mechanically preparing a emulsified dispersion for use. Further, the powder of the compound represented by the general formula (2) may be dispersed in water using a ball mill, colloid mill or ultrasonic waves for use.

The compound represented by the general formula (M) may be incorporated in any layer disposed on the support so long as the layer is on the side of the layer containing the silver halide and it is preferably incorporated into a layer containing a silver halide emulsion or a layer adjacent thereto.

Further, the addition amount of the compound of the general formula (M) is preferably 1×10⁻⁴ to 5×10⁻¹ mol, and more preferably 5×10⁻⁴ to 5×10⁻² mol, based on one mol of the silver halide.

1-7. Reducing Agent

The photothermographic material of the invention contains a thermal developer which is a reducing agent for an organic silver salt. The reducing agent for the organic silver salt may be any material for reducing silver ions into metal silver (preferably, organic material). Examples of the reducing agent are described in column Nos. 0043 to 0045 of JP-A No. 11-65021 and page 7, line 34 to page 18, line 12 of EPA-0803764A1.

As the reducing agent preferably used in the invention, the compound represented by the following general formula (R) is preferred and it is specifically described below.

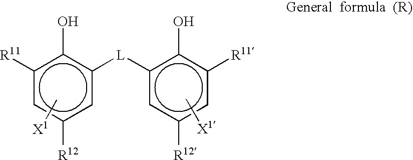

In the general formula (R), R¹¹ and R^{11′} each independently represent, an alkyl group of 1 to 20 carbon atoms. R¹² and R^{12′} each independently represent a hydrogen atom or a substituent with which the benzene ring can be substituted. L represents group —S- or group —CHR¹³-. R¹³ represents a hydrogen atom or an alkyl group of 1 to 20 carbon atoms. X¹ and X^{1′} each independently represent a hydrogen atom or a group with which the benzene ring can be substituted.

Each of the substituents is to be described specifically.

1) R¹¹ and R^{11′}

R¹¹ and R^{11′} each independently represent a substituted or unsubstituted alkyl group having 1 to 20 carbon atoms. There is no particular limitation to the substituent for the alkyl group and it may include, preferably, an aryl group, hydroxyl group, alkoxy group, aryloxy group, alkylthio group, arylthio group, acylamino group, sulfoneamide group, sulfonyl group, phosphoryl group, acyl group, carbamoyl group, ester group and halogen atom.

2) R¹² and R^{12′}, X¹ and X^{1′}

R¹² and R^{12′} each independently represent a hydrogen atom or a group with which the benzene ring can be substituted.

X¹ and X^{1′} each independently represent a hydrogen atom or a group with which the benzene ring can be substituted.

Each of the groups as the substituent on the benzene ring may include, preferably, an alkyl group, aryl group, halogen atom, alkoxy group, and acylamino group.

3) L

L represents a group —S— or a group —CHR¹³—. R¹³ represents a hydrogen atom or an alkyl group having 1 to 20 carbon atoms, and the alkyl group may have a substituent.

Specific Examples of the unsubstituted alkyl group for R¹³ may include, for example, methyl group, ethyl group, propyl group, butyl group, heptyl group, undecyl group, isopropyl group, 1-ethylpentyl group, and 2,4,4-trimethylpentyl group.

Examples of the substituent for the alkyl group are identical to the substituents for R¹¹ and may include, for example, a halogen atom, an alkoxy group, alkylthio group, aryloxy group, arylthio group, acylamino group, sulfoneamino group, sulfonyl group, phosphoryl group, oxycarbonyl group, carbamoyl group, and sulfamoyl group.

4) Preferred Substituent

R¹¹ and R^{11′} are preferably secondary or tertiary alkyl groups having 3 to 15 carbon atoms and may include, specifically, isopropyl group, isobutyl group, t-butyl group, t-amyl group, t-octyl group, cyclohexyl group, cyclopentyl group, 1-methylcyclohexyl group, and 1-methylcyclopropyl methylcyclopropyl group. More preferably, R¹¹ and R^{11′} are tertiary alkyl groups of 4 to 12 carbon atoms and, among them, t-butyl group, t-amyl group, and 1-methylcyclohexyl group are further preferred, with the t-butyl group being the most preferred.

R¹² and R^{12′} are preferably alkyl groups of 1 to 20 carbon atoms and may include, specifically, methyl group, ethyl group, propyl group, butyl group, isopropyl group, t-butyl group, t-amyl group, cyclohexyl group, 1-methylcyclohexyl group, benzyl group, methoxymethyl group, and methoxyethyl group. More preferred are methyl group, ethyl group, propyl group, isopropyl group and t-butyl group.

X¹ and X^{1′} include, preferably, a hydrogen atom, halogen atom and alkyl group, with the hydrogen atom being more preferred.

L is preferably group —CHR¹³—.

R¹³ is preferably a hydrogen atom or an alkyl group having 1 to 15 carbon atoms. As the alkyl group, methyl group, ethyl group, propyl group, isopropyl group and 2,4,4-trimethylpentyl group are preferred. Particularly preferred R¹³ is a hydrogen atom, methyl group, propyl group or isopropyl group.

In a case where R¹³ is a hydrogen atom, R¹² and R^{12′} are preferably alkyl groups of 2 to 5 carbon atoms, with ethyl group and propyl group being more preferred and ethyl group being most preferred.

In a case where R¹³ is a primary or secondary alkyl group of 1 to 8 carbon atoms, R¹² and R^{12′} are preferably methyl group. As the primary or secondary alkyl group of 1 to 8 carbon atoms for R¹³, methyl group, ethyl group, propyl group, and isopropyl group are further preferred and, methyl group, ethyl group and propyl group are still further preferred.

In a case where both of R¹¹ and R^{11′} and R¹² and R^{12′} are methyl groups, R¹³ is preferably a secondary alkyl group. In this case, as the secondary alkyl group for R¹³, isopropyl group, isobutyl group, and 1-ethylpentyl group are preferred, with the isopropyl group being more preferred.

Photothermographic developing performances may vary depending on the combination of R¹¹ and R^{11′} and R¹² and R^{12′}, and R¹³ of the reducing agents. Since the photothermographic developing performances may be controlled by using two or more kinds of the reducing agents at various mixing ratios, it is preferred to use two or more kinds of the reducing agents in combination depending on the purpose.

Specific examples of the reducing agents that may be used in the invention including the compounds represented by the general formula (R) are shown below, however, the invention is not restricted thereto.

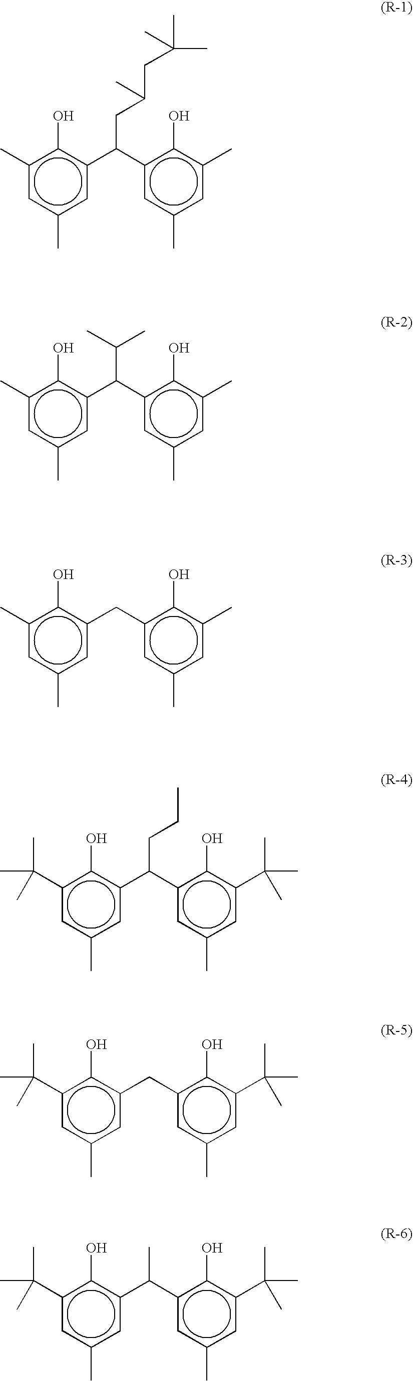

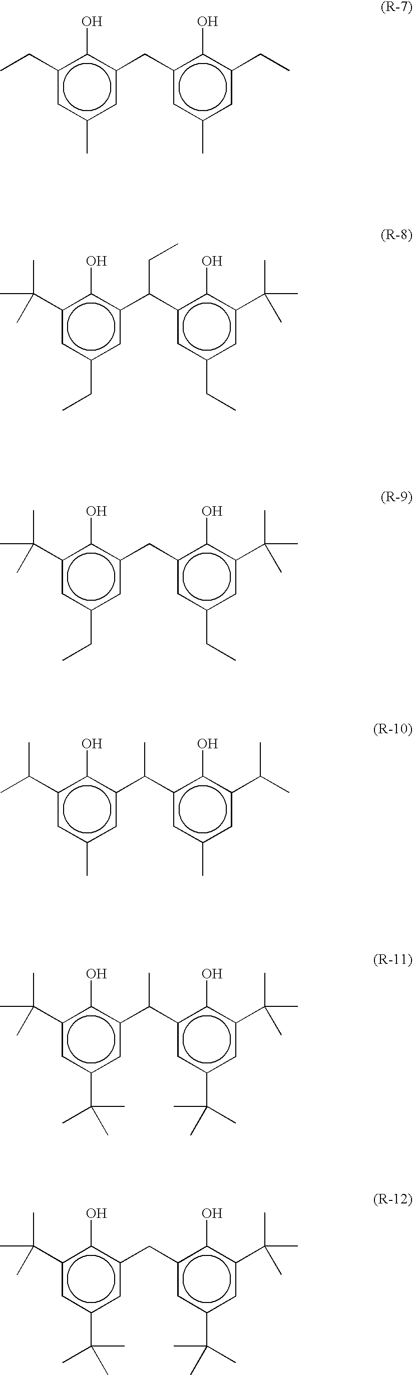

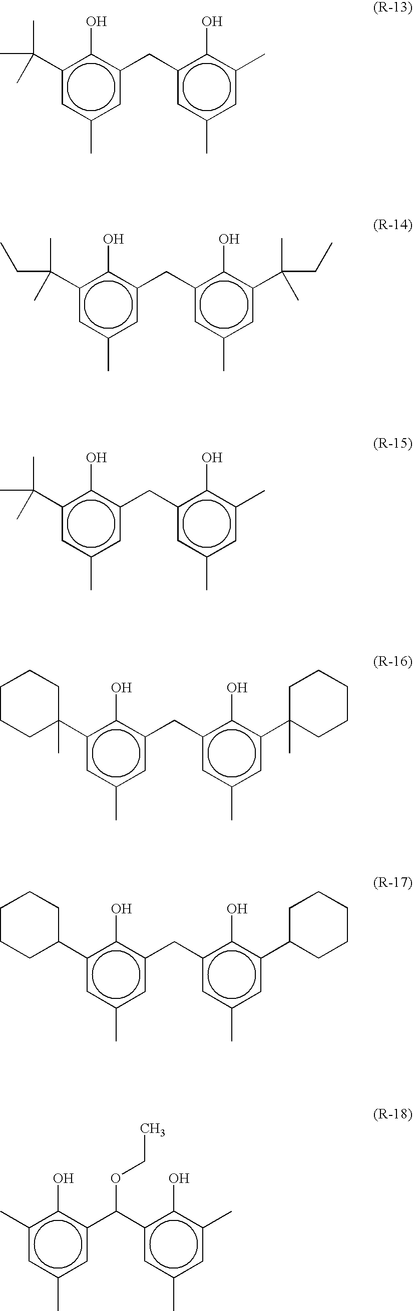

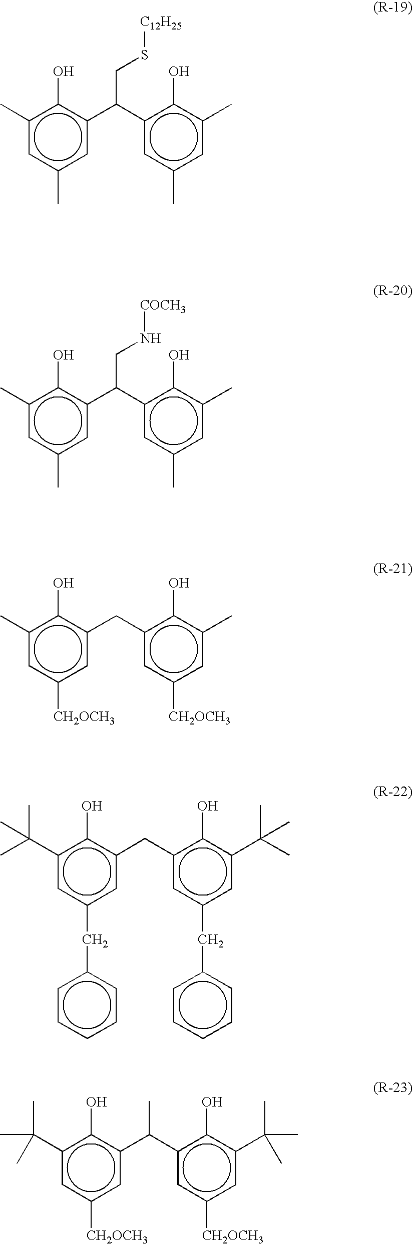

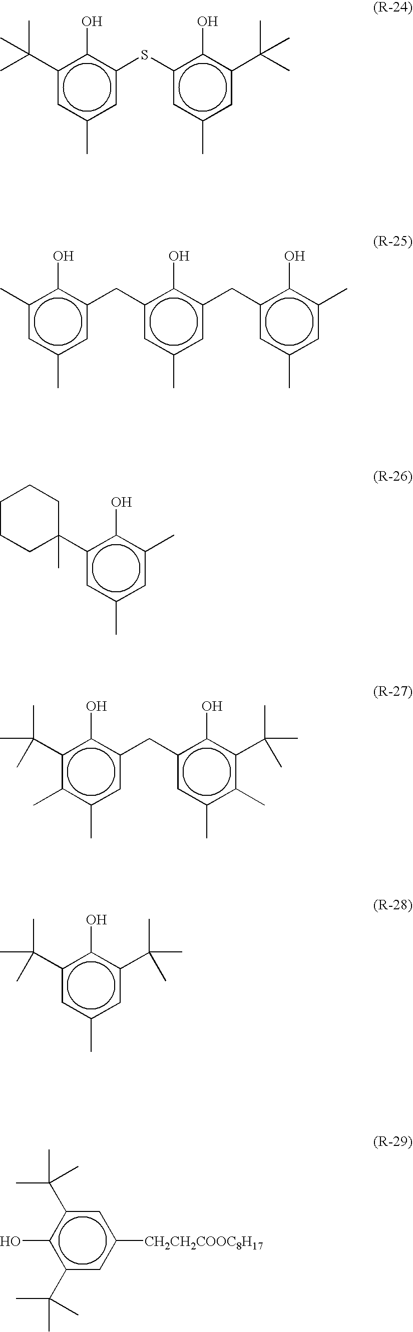

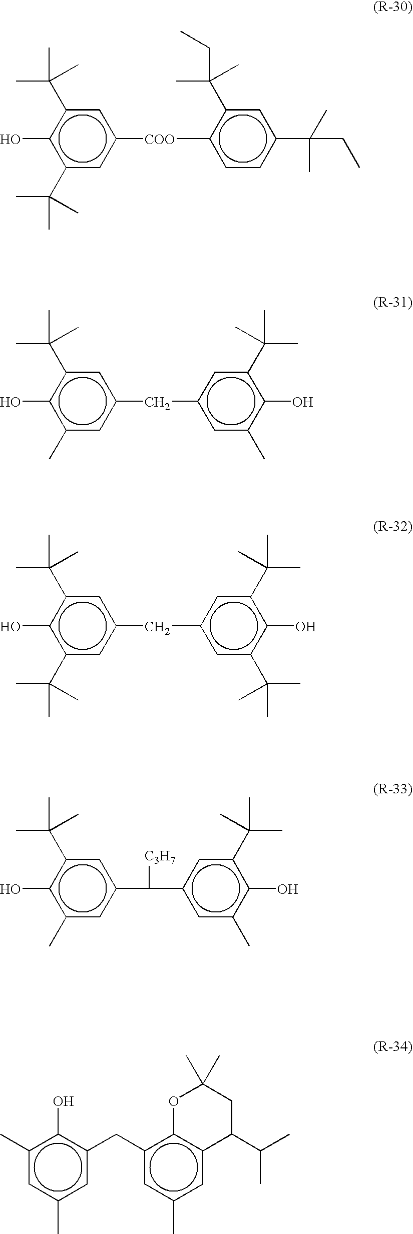

In the invention, the addition amount of the reducing agent is preferably from 0.01 to 5.0 g/m², and more preferably 0.1 to 3.0 g/m², and it is added preferably in an amount of 5 to 50 mol %, and further preferably 10 to 40 mol % per mol of silver on the surface having an image forming layer.

The reducing agent of the invention may be incorporated in the image forming layer containing the organic silver salt and the photosensitive silver halide and adjacent layers thereof, however, it is more contained preferably in the image forming layer.

The reducing agent of the invention may be contained in the coating liquid by any form, such as in the form of a solution, in the form of an emulsified dispersion and in the form of a solid dispersion of fine particles, and may be incorporated in the photosensitive material.

Conventionally known emulsifying and dispersing methods may include, for example, a method of dissolving the reducing agent using an oil such as dibutyl phthalate, tricresyl phosphate, and glyceryl triacetate, or diethyl phthalate and an auxiliary solvent such as ethyl acetate or cyclohexanone and mechanically preparing an emulsified dispersion.

Further, the methods of dispersing fine solid particles may include a method of dispersing the reducing agent into an appropriate solvent such as water by a ball mill, colloid mill, vibration ball mill, sand mill, jet mill or roller mill or supersonic waves and preparing solid dispersions. A dispersing method using the sand mill is preferred. In this case, a protection colloid (e.g., polyvinyl alcohol), a surfactant (anionic surfactant such as sodium triisopropyl naphthalene sulfonate (a mixture of those having different substituted positions for three isopropyl groups)) may be used. The aqueous dispersion may be incorporated with a corrosion inhibitor (e.g., sodium benzoisothiazolinone salt).

The solid dispersion of fine particles is preferably applied with a heat treatment (annealing treatment) after dispersion. In the annealing treatment, heat treatment is conducted after dispersing the fine particles in the media at a temperature higher than that during dispersing the fine particles in the media. Heat treatment is conducted preferably within 2 weeks after dispersing, more preferably within one week, and still more preferably within three days after dispersing in the media. It is most preferably conducted within 30 hours after dispersing. The dispersion is preferably stored with cooling after dispersing till heat treatment is conducted. It is preferably stored at 15° C. or lower, and further preferably stored at 1° C. to 10° C. Since the heat treatment temperature and the treatment time are different depending on the step of conducting heat treatment, the size and the shape of the dispersed particles and the concentration and the composition of the dispersion and cannot be determined generally, but it is at least necessary for temperature and time sufficient to retain the changed particle size of the photographic organic compound within 20% when stood still at 40° C. for 3 days after preparation of the solid dispersion. “Particle size” in the present specification means an average value grain size for 1000 particles measured using an electric microscope. Specifically, it is appropriate to conduct a heat treatment for 2 hours to 300 hours at a temperature higher by 5° C. or more than the temperature upon media dispersion. It is preferred to conduct the heat treatment at a temperature higher by 5° C. to 100° C. than the temperature upon media dispersion for 2 hours to 100 hours and, it is more preferred to conduct the heat treatment at a temperature higher by 5° C. to 70° C. than the temperature upon media dispersion for 2 hours to 48 hours and, it is furthermore preferred to conduct the heat treatment at a temperature higher by 5° C. to 30° C. than the temperature upon media dispersion for 2 hours to 24 hours. The solid dispersion prepared under these conditions in the invention has extremely good store stability with lapse of time. Further, when the photothermographic material is prepared using the solid dispersion of the invention to be described later, a photothermographic material having good coating surface property may be obtained.

As the pattern for the heating temperature upon conducting heat treatment, heating can be applied in various ptterns. Particularly in a case of elevating the temperature up to an intended temperature higher by 40° C. or more than the temperature upon dispersing, it is preferred to adopt a two-step temperature elevation pattern of heating at a temperature lower than the intended temperature for 10 min or more previously, and then elevating the temperature up to the intended temperature. That is, it is preferred to elevate the temperature to a level higher, by 5 to 40° C., than the temperature upon media dispersion at the first stage and then conducting heat treatment for 5 min to 48 hours and then elevating the temperature to a level higher by 40° C. to 100° C. than that of the temperature upon media dispersion at the second step. The temperature in the first step is preferably higher by 5 to 40° C., and more preferably 5 to 30° C., and most preferably 5 to 20° C., than the temperature upon media dispersion in the first stage. Further, the time for heating at the temperature in the first step is preferably 5 min to 48 hours, further preferably 10 min to 24 hours, and most preferably 10 min to 12 hours.

The annealing treatment is desirably applied not only to the dispersion of the reducing agent, but also to all solid dispersions used in the invention.

A particularly preferred method is a method of dispersing solid particles of the reducing agent, and it is preferred to add the reducing agent as the fine particles having an average grain size of 0.01 μm to 10 μm, preferably 0.05 μm to 5 μm, and more preferably from 0.1 μm to 1 μm. In the invention, other solid dispersions are also preferably used by being dispersed to have a particle size within the aforementioned range.

1-8. Color Tone Controlling Agent

In the photothermographic material of the invention, a color tone controlling agent for controlling the color tone of developed silver is preferably contained. The color tone controlling agent is an additive to control the color tone of the developed silver to a desired tone. For example, when images having pure black tone is desired, a reducing compound forming a yellow oxidized product is preferably used in a case where the color tone of the developed silver is blue tinted. Further, in a case of a developed silver having yellow brown tone, it is preferred to use a compound forming cyan color as the color tone controlling agent. In addition, it is preferred to control and use the color of the color tone controlling agent depending on the color tone formed by the eveloped silver and on the desired tone of images.

1) Color Tone Controlling Agent Represented by the General Formula (P)

For the color tone controlling agent represented by the general formula (P), it is preferred to incorporate the color tone controlling agent represented by the general formula (P) in the image forming layer.

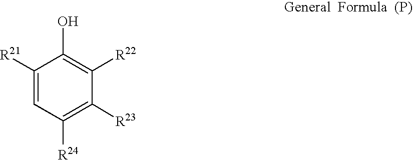

In the formula, R²¹ and R²² each independently represent a hydrogen atom, an alkyl group or acylamino group, with a proviso that each of R²¹ and R²² is not 2-hydroxyphenylmethyl group and both of them do not represent hydrogen atoms simultaneously. R²³ represents a hydrogen atom or an alkyl group. R²⁴ represents a substituent with which the benzene ring can be substituted.

When R²¹ represents an alkyl group, an alkyl group having 1 to 30 carbon atoms is preferred and an allyl group having 1 to 10 carbon atoms is more preferred.

The alkyl group may have a substituent. Preferable examples of the unsubstituted alkyl group include methyl, ethyl, butyl, octyl, isopropyl, t-butyl, t-octyl, t-amyl, sec-butyl, cyclohexyl, or 1-methyl-cyclohexyl group. More preferable is a group that is sterically larger than the isopropyl group (e.g., isopropyl group, isononyl group, t-butyl group, t-amyl group, t-octyl group, cyclohexyl group, 1-methyl-cyclohexyl group or adamantyl group. Among them, t-butyl, t-octyl, or t-amyl group as tertiary alkyl group is particularly preferred.

In a case where the alkyl group has a substituent, the substituent may include, for example, a halogen atom, an aryl group, alkoxy group, amino group, acyl group, acylamino group, alkylthio group, arylthio group, sulfoneamide group, acyloxy group, oxycarbonyl group, carbamoyl group, sulfamoyl group, sulfonyl group, and phosphoryl groups.

When R²² is an alkyl group, an alkyl group having 1 to 30 carbon atoms is preferred and an unsubstituted alkyl group having 1 to 24 carbon atoms is more preferred.

The alkyl group may have a substituent. Specific examples of the unsubstituted alkyl group include methyl, ethyl, butyl, octyl, isopropyl, t-butyl, t-octyl, t-amyl, sec-butyl, cyclohexyl, 1-methyl-cyclohexyl groups.

Examples of the substituent are identical with those for R²¹.

When R²¹ and R²² are acylamino groups, an acylamino group having 1 to 30 carbon atoms is preferred and an acylamino group of 1 to 10 carbon atoms is more preferred.

The acylamino group may be unsubstituted or may have a substituent. Specific example thereof include acetylamino group, alkoxyacetylamino group and aryloxyacetylamino groups.

R²¹ is preferably an alkyl group, among the hydrogen atom, alkyl group and acylamino group.

On the other hand, among the hydrogen atom, alkyl group and acylamino group and, R²² is preferably a hydrogen atom or an unsubstituted alkyl group having 1 to 24 carbon atoms, and specific example include methyl group, isopropyl group and t-butyl group.

Both R²¹ and R²² are not 2-hydroxyphenylmethyl groups, nor are hydrogen atoms simultaneously.

R²³ represents a hydrogen atom or an alkyl group, and among them, a hydrogen atom or an alkyl group having 1 to 30 carbon atoms are preferred and hydrogen atom or unsubstituted alkyl group having 1 to 24 carbon atoms is more preferred. Description for the alkyl group is identical with that for R²². Specific examples include methyl group, isopropyl group and t-butyl group.

Either one of R²² and R²³ is preferably a hydrogen atom.

R²⁴ represents a group with which the benzene ring may be substituted, and this is a group identical with that explained for R¹² and R^{12′} of the compound represented by the general formula (R). Preferred R²⁴ is a substituted or unsubstituted alkyl group having 1 to 30 carbon atoms, oxycarbonyl group having 2 to 30 carbon atoms, and an alkyl group having 1 to 24 carbon atoms is more preferred. The substituent for the alkyl group may include, for example, aryl group, amino group, alkoxy group, oxycarbonyl group, acylamino group, acyloxy group, imide group, and ureido group, and aryl group, amino group, oxycarbonyl group, with alkoxy group being more preferred.

Further preferred structure for the compound of the general formula (P) is represented by the following general formula (P-2).

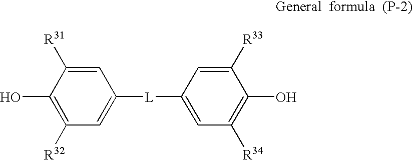

In the formula, R³¹, R³², R³³ and R³⁴ each independently represent a hydrogen atom or a substituted or unsubstituted alkyl group having 1 to 20 carbon atoms. Both of R³¹ and R³² or both of R³³ and R³⁴ do not represent hydrogen atoms simultaneously. R³¹, R³², R³³ and R³⁴ are preferably alkyl groups having 1 to 10 carbon atoms. There is no particular limitation to the substituent of the alkyl group and it may include an aryl group, hydroxy group, alkoxy group, aryloxy group, alkylthio group, arylthio group, acylamino group, sulfoneamide group, sulfonyl group, phosphoryl group, acyl group, carbamoyl group, ester group, and halogen atom. Among them, it is preferred that at least one and more, preferably two or more of them is a group sterically larger than the isopropyl group (e.g., isopropyl group, isononyl group, t-butyl group, t-amyl group, t-octyl group, cyclohexyl group, 1-methyl-cyclohexyl group and adamantyl group). t-Butyl, t-octyl and t-amyl group which are tertiary alkyl groups sterically larger than the isopropyl group are particularly preferred. L is identical with L in the compound of the general formula (R).

Specific examples of the compound represented by the general formula (P) and the general formula (P-2) in the invention are shown below, however, the invention is not restricted thereto.

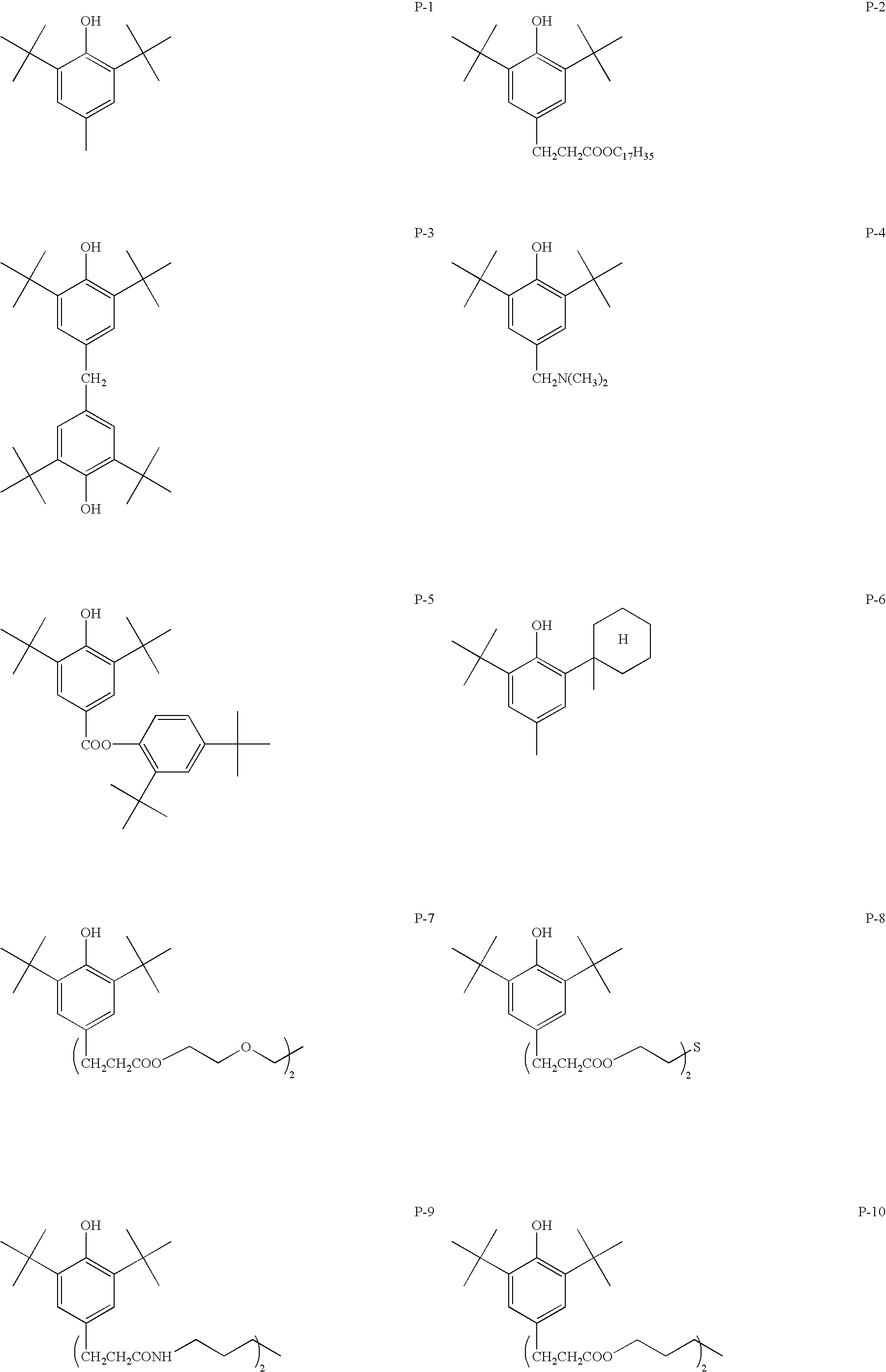

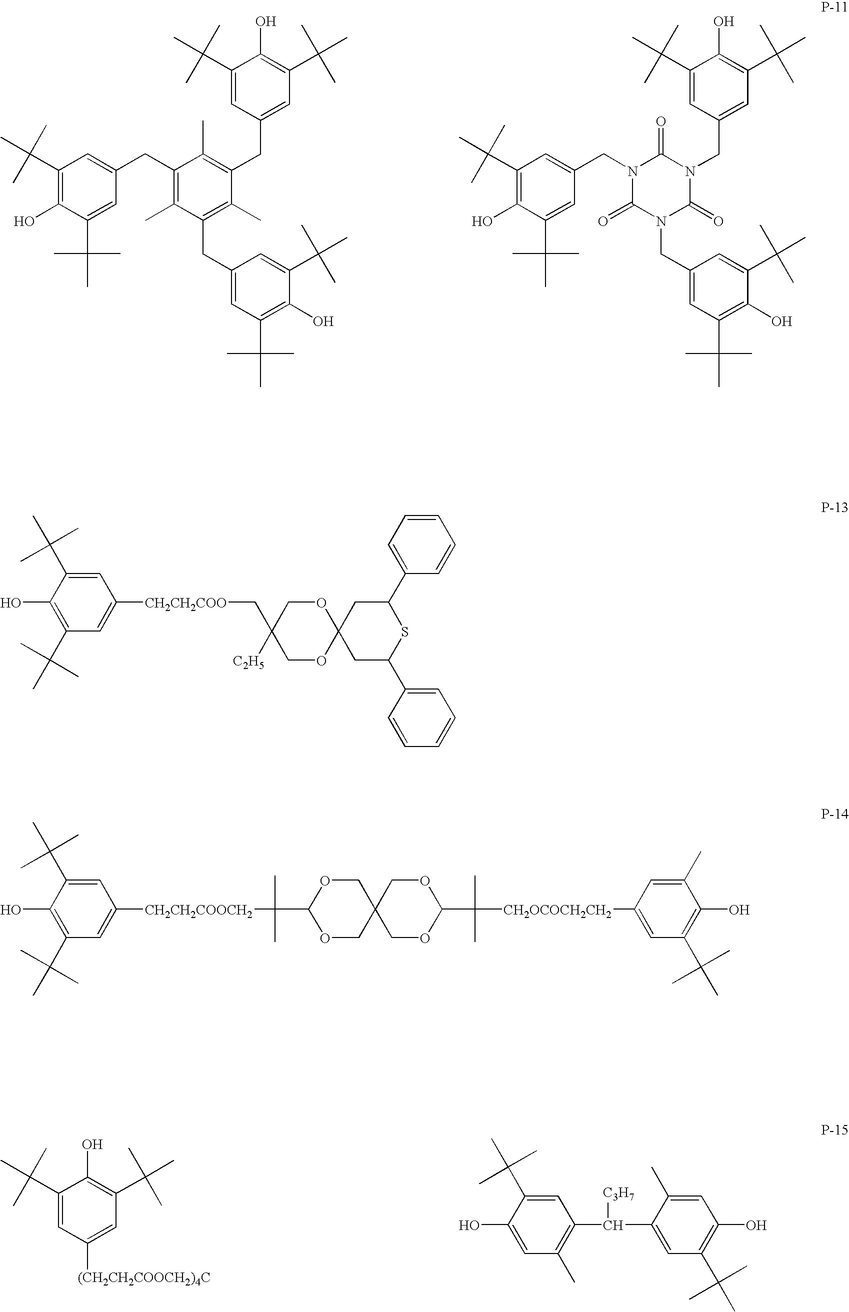

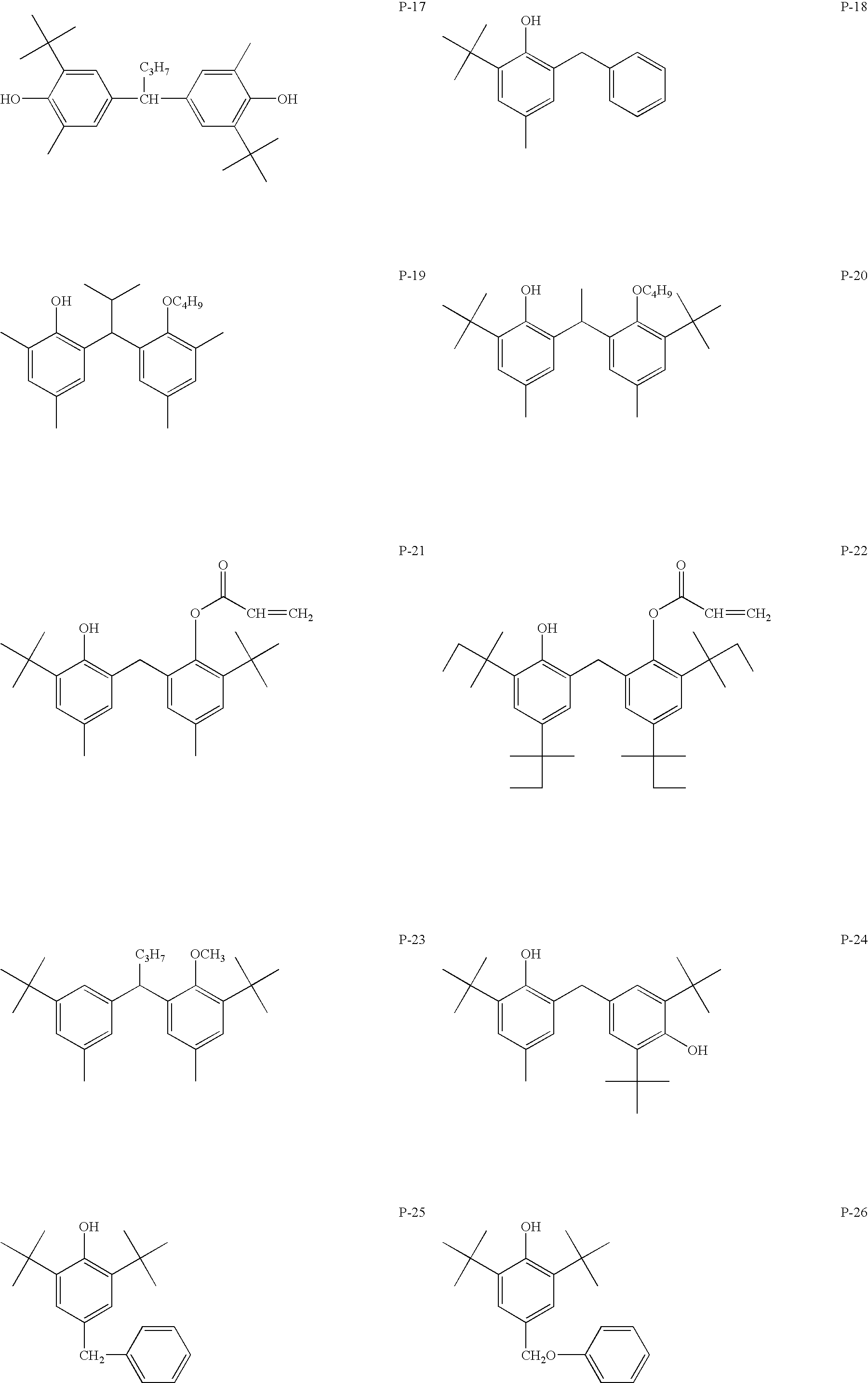

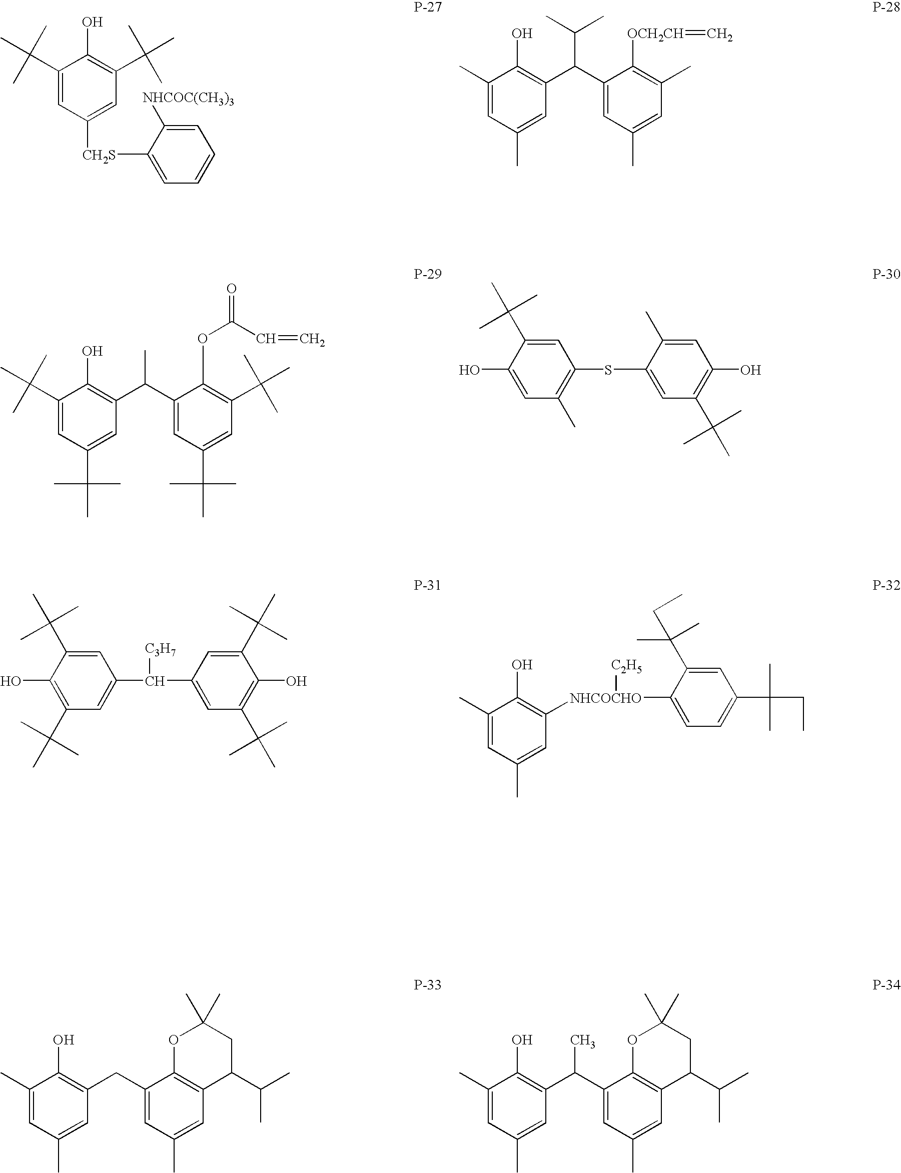

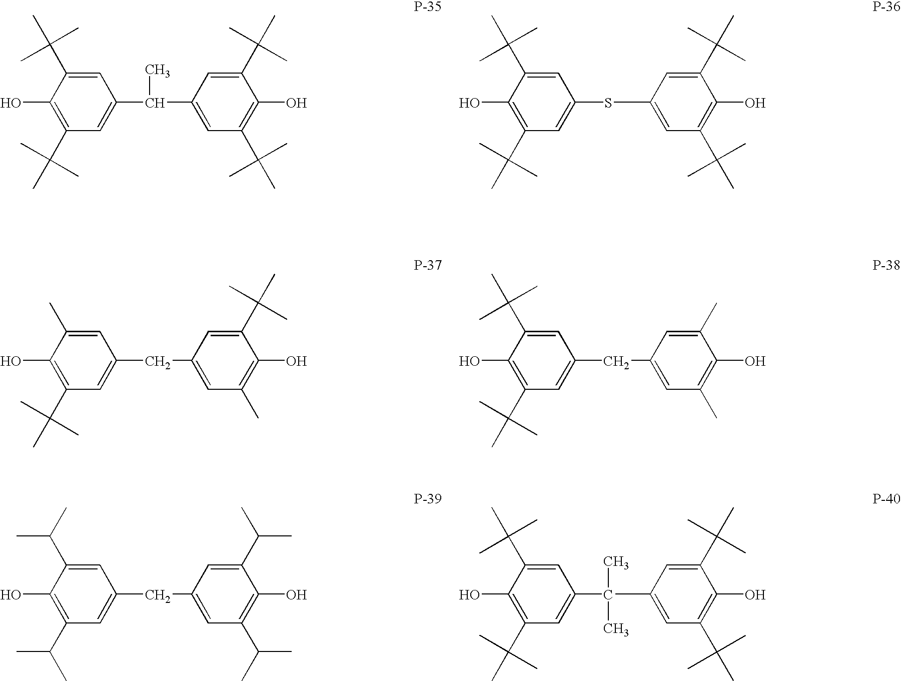

2) Couplers

Another color tone controlling agent is a coupler capable of coupling with oxidized products of the reducing agent for thermal development to form colors. The couplers are described in Japanese Patent Applications Nos. 2001-120890, 2001-135284, 2001-124795, 2001-017595, 2001-094184, 2001-067988 and 2001-098854. Desired color can be formed depending on the combination of the reducing agent and the coupler.

The color tone controlling agent may be incorporated in a coating liquid by any forms, such as in the form of a solution, in the form of an emulsified dispersion or in the form of a solid dispersion of fine particles, and may be incorporated in the photosensitive material.

Conventionally known emulsifying and dispersing methods may include a method of dissolving the reducing agent using an oil such as dibutyl phthalate, tricresyl phosphate, glyceryl triacetate, or diethyl phthalate and an auxiliary solvent such as ethyl acetate or cyclohexanone and mechanically preparing an emulsified dispersion.

Further, the method for dispersing solids of fine particles may include a method of dispersing a powder of the compound into an appropriate solvent such as water using a ball mill, colloid mill, vibration ball mill, sand mill, jet mill or roller mill or ultrasonic waves thereby preparing a solid dispersion. In this case, a protection colloid (e.g., polyvinyl alcohol), a surfactant (an anionic surfactant such as sodium triisopropyl naphthalene sulfonate (a mixture of those having different substitution positions for three isopropyl groups)) may be used. The aqueous dispersion may be incorporated together with a corrosion inhibitor (e.g., sodium benzoisothiazolinate).

The color tone controlling agents are preferably incorporated in an image forming layer containing the organic silver salt. Alternatively, one kind of color tone controlling agent may incorporated in the image forming layer while the other may be incorporated in the non-image forming layer adjacent therewith, or both of them may be incorporated in the non-image forming layer. In case where the image forming layer is constituted with plural layers, they may be incorporated, respectively, into separate layers.

The ratio of the addition amount of the color tone controlling agent to the reducing agent represented by the general formula (R) (molar ratio) is within a range preferably from 0.001 to 0.2, more preferably 0.005 to 0.1, and further preferably 0.008 to 0.005.

1-9 Hydrogen Bond-Forming Compound

In the invention, it is preferred to use a non-reducing compound having a group capable of forming a hydrogen bond with an aromatic hydroxyl group (—OH) of the reducing agent in combination.

The group capable of forming the hydrogen bond may include, for example, phosphoryl group, sulfoxide group, sulfonyl group, carbonyl group, amide group, ester group, urethane group, ureido group, tertiary amino group, and nitrogen-containing aromatic group. Among them, preferred are those compounds having a phosphoryl group, sulfoxide group, amide group (under the conditions of not having >N—H group, and blocked as: >N—Ra (Ra is a substituent other than H)), urethane group (under the conditions of not having >N—H group, and blocked as: >N—Ra (Ra is a substituent other than H)), ureido group (under the conditions of not having >N—H group, and blocked as: >N—Ra (Ra is a substituent other than H)).

In the invention, particularly preferred hydrogen bond-forming compound is the compound represented by the following general formula (D).

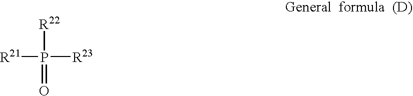

In the general formula (D), R²¹ to R²³ each independently represent an alkyl group, aryl group, alkoxy group, aryloxy group, amino group or heterocyclic group, in which the group may be unsubstituted or have a substituent.

In a case where R²¹ to R²³ have a substituent, the substituent may include, for example, a halogen atom, an alkyl group, aryl group, alkoxy group, amino group, acyl group, acylamino group, alkylthio group, arylthio group, sulfoneamide group, acyloxy group, oxycarbonyl group, carbamoyl group, sulfamoyl group, sulfonyl group, and phosphoryl group. Preferred substituent is an alkyl group or aryl group and may include, for example, methyl group, ethyl group, isopropyl group, t-butyl group, t-octyl group, phenyl group, 4-alkoxyphenyl group, and 4-acyloxyphenyl group.

Specific examples of the alkyl group of R²¹ to R²³ include methyl group, ethyl group, butyl group, octyl group, dodecyl group, isopropyl group, t-butyl group, t-amyl group, t-octyl group, cyclohexyl group, 1-methylcyclohexyl group, benzyl group, phenetyl group, and 2-phenoxypropyl group.

The aryl group may include, for example, phenyl group, cresyl group, xylyl group, naphthyl group, 4-t-butylphenyl group, 4-t-octylphenyl group, 4-anisidyl group, and 3,5-dichlorophenyl group.

The alkoxy group may include, for example, methoxy group, thoxy group, butoxy group, octyloxy group, 2-ethylhexyloxy group, 3,5,5-trimethylhexyloxy group, dodecyloxy group, cyclohexyloxy group, 4-methylcyclohexyloxy group, and benzyloxy group.

The aryloxy group may include, for example, phenoxy group, cresyloxy group, isopropylphenoxy group, 4-t-butylphenoxy group, naphthoxy group, and biphenyloxy group.

The amino group may include, for example, dimethylamino group, diethylamino group, dibutylamino group, dioctylamino group, N-methyl-N-hexylamino group, dicyclohexylamino group, diphenylamino group, and N-methyl-N-phenylamino group.

As R²¹ to R²³, alkyl group, aryl group, alkoxy group, and aryloxy group are preferred. With a view point of the effect of the invention, it is preferred that at least one of R²¹ to R²³ is an alkyl or aryl group and it is more preferred that two or more of them are an alkyl or aryl group. Further, in view of the availability at a reduced cost, it is preferred that R²¹ to R²³ are of the same group.

Specific examples of the hydrogen bond-forming compounds including the compound of the general formula (D) usable in the invention are shown below, however, the invention is not restricted thereto.

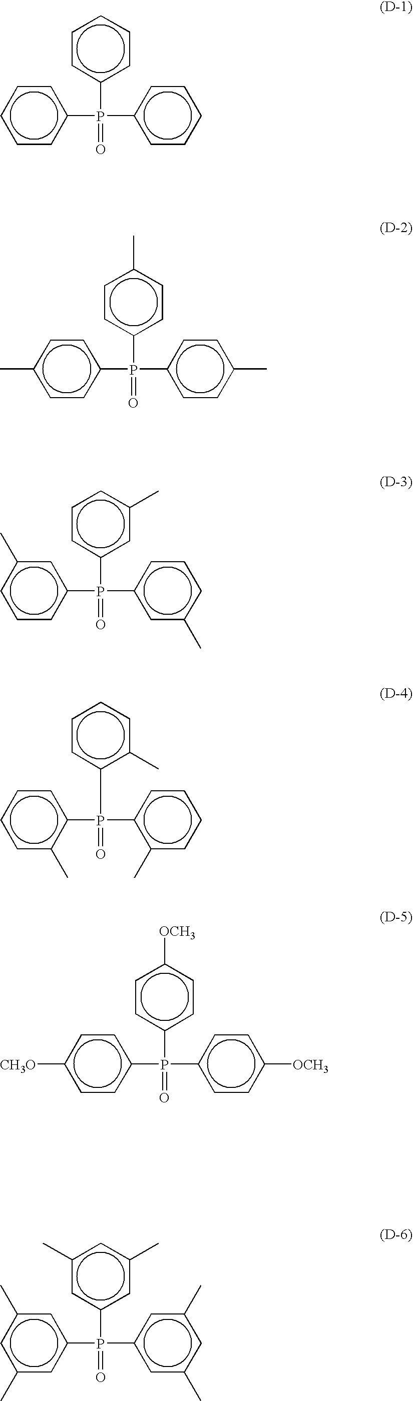

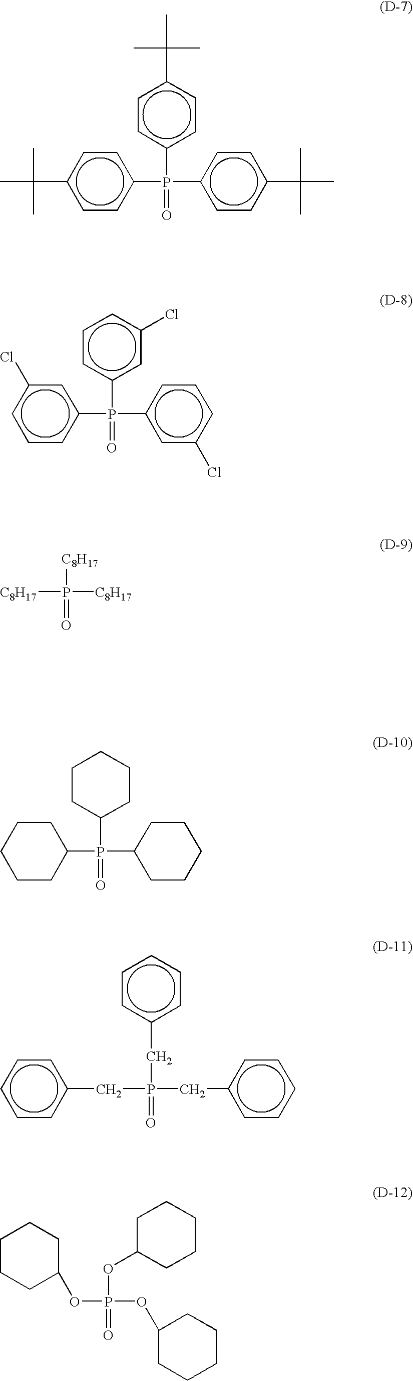

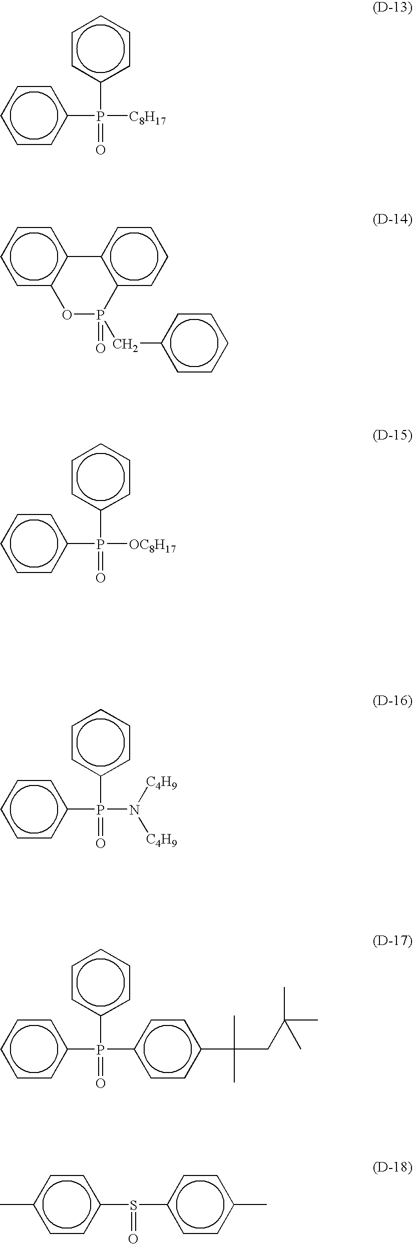

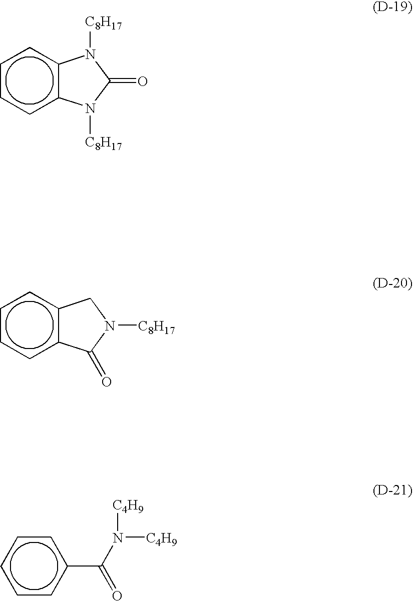

Specific examples of the hydrogen bond-forming compounds also include those described in Japanese Patent Applications Nos. 2000-192191 and 2000-194811 in addition to those described above.

The hydrogen bond-forming compound of the invention, like the reducing agent, may be incorporated in a coating liquid in the form of solution, in the form of emulsified dispersion and in the form of solid dispersion of fine particles and may be used in the photosensitive material. The hydrogen bond-forming compound of the invention form a complex with the hydrogen bond with a compound having the phenolic hydroxyl group in the state of solution, and may be isolated in the state of crystals as a complex depending on the combination with the reducing agent.

Use of the thus isolated crystal powder for the solid dispersion of fine particles is particularly preferred for obtaining stable performance. Further, a method of mixing the reducing agent and the hydrogen bond-forming compound of the invention as a powder and forming a complex during dispersing using a sand grinder mill with an appropriate dispersant can also be used preferably.

The hydrogen bond-forming compound of the invention is used within a range preferably from 1 to 200 mol %, more preferably 10 to 150 mol %, and further preferably 30 to 100 mol % based on the reducing agent.

1-10 Photosensitive Silver Halide

1) Silver Halide Composition

The photosensitive silver halide used in the invention has no particular restriction for the halogen composition, and silver chloride, silver bromochloride, silver bromide, silver bromoiodide, silver chlorobromoiodide and silver iodide may be used. Among them, silver bromide, silver bromoiodide and silver iodide are preferred. The distribution of the halogen composition in the grain may be uniform or the halogen composition may be changed stepwise, or may be changed continuously. Further, silver halide grains having a core/shell structure can be used preferably. A 2-5 layered structure is preferred and, more preferably, a core/shell grain of 2-4 layered structure can be used for the structure. Further, a technique of localizing silver bromide or silver iodide on the surface of silver chloride, silver bromide or silver bromochloride grains can also be used preferably.

2) Grain Forming Method

The method of forming a photosensitive silver halide is well-known in the relevant field and, for example, methods described in the Research Disclosure, June 1978, No. 17029 and U.S. Pat. No. 3,700,458 can be used. Specifically, a method of preparing a photosensitive silver halide by adding a silver-supplying compound and a halogen-supplying compound in gelatin or other polymer solution, and then mixing the same with an organic silver salt is employed. Further, a method as described in column Nos. 0217 to 0224 in JP-A No. 11-119374 and methods described of JP-A Nos. 11-352627 and 2000-347335 are also preferred.

3) Grain Size

The grain size of the photosensitive silver halide is preferably smaller in order to suppress clouding after forming images, and specifically, it is 0.20 μm or less, preferably 0.01 μm or more, and 0.15 μm or less, and further preferably 0.02 μm or more and 0.12 μm or less. The grain size as used herein is a diameter when converted into a circular image of an area identical with a projected area of a silver halide grain (projected area of a main plane in a case of a flat grain).

4) Shape

The shape of the silver halide grain may include, for example, cubical, octahedral, plate-like, spherical, rod-like, potato-like grains and the cubical grains is particularly preferred in the invention. A grain in which corners of the silver halide grain are rounded is also used preferably. While there is a particular limitation to the plane index (Miller index) for the outer surface of the photosensitive silver halide grain, it is preferred that the ratio of [100] plane is showing high spectral sensitizing efficiency in a case of adsorbing spectral sensitizing dye is large. The ratio is, preferably, 50% or more, more preferably, 65% or more and, further preferably, 80% or more. The ratio for the miller index expressed by [100] plane ratio may be determined by a method described in T. Tani. J. Imaging Sci., 29, 165 (1985) that utilizes the adsorption dependence of [111] plane and [100] plane in the adsorption of the sensitizing dye.

5) Heavy Metal

The photosensitive silver halide grain of the invention may contain a metal or a metal complex of Group VIII to Group XX of the Periodical Table (including Groups I to XVIII). Rhodium, ruthenium or iridium is preferred as the metal or the central metal for complex of metal belonging to Group VIII to Group X of the Periodical Table. The metal complex may be a single type, or two or more kind of complexes of identical or different metals may be used in combination. A preferred content is within a range from 1×10⁻⁹ mol to 1×10⁻³ mol per mol of silver. The heavy metals, metal complexes and addition methods thereof are described in JP-A No.7-225449, in column Nos. 0018 to 0024 of JP-A No. 11-65021 and in column Nos. 0027 to 0240 of JP-A No. 11-119374.

In the present invention, a silver halide grain in which a hexacyano metal complex is present on the outermost surface of the grain is preferred. The hexacyanometal complex can include, for example, [Fe(CN)₆]⁴⁻, [Fe(CN)₆]³⁻, [Ru(CN)₆]⁴⁻[Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, hexacyano Fe complex is preferred.

Since the hexacyano metal complex is present in the form of ions in an aqueous solution, pair cation is not important, and it is preferred to use alkali metal ions such as sodium ion, potassium ion, rubidium ion, cesium ion and lithium ion, ammonium ion and alkyl ammonium ion (for example, tetramethyl ammonium ion, tetraethyl ammonium ion, tetrapropyl ammonium ion, and tetra(n-butyl) ammonium ion).

The hexacyano metal complex can be added by being mixed with water, as well as a mixed solvent with an appropriate organic solvent miscible with water (e.g., alcohols, ethers, glycols, ketones, esters and amides) and gelatin.

The addition amount of the hexacyano metal complex is preferably 1×10⁻⁵ mol or more and 1×10⁻² mol or less, and more preferably 1×10⁻⁴ mol or more and 1×10⁻³ or less per mol of silver.

In order to make the hexacyano metal complex present on the uppermost surface of the silver halide grain, the hexacyano metal complex is added directly, after completion of addition of an aqueous solution of silver nitrate used for forming the grain, and before completing the charging step, during water washing step, or during dispersion step before chemical sensitizing step of conducting chalcogen sensitization such as sulfur sensitization, selenium sensitization and tellurium sensitization or noble metal sensitization such as gold sensitization, or added directly before the chemical sensitizing step. In order not to grow the fine silver halide grain, it is preferred to add the hexacyano metal complex rapidly after forming the grain and it is preferred to add the same before completion of the charging step.

Addition of the hexacyano metal complex may be started after adding 96% by mass of the total amount of silver nitrate to be added for forming the grain or, more preferably, may be started after adding 98% by mass and, particularly preferred, after adding 99% by mass of the total amount.

When the hexacyanometal complexes are added after adding an aqueous solution of silver nitrate just before completing the formation of grains, they can be adsorbed to the uppermost surface of the silver halide grains and most of them form less soluble salts with silver ions on the grain surface. Since the hexacyano iron (II) silver salt is less soluble than AgI, re-dissolution with fine particles may be prevented and fine silver halide particles with less particle size may be prepared.

Further, metal atoms that may be contained in the silver halide grains used in the invention, and the desalting method and chemical sensitization method for the silver halide emulsion are described in column Nos. 0046 to 0050 of JP-A No. 11-84574, in column Nos. 0025 to 0031 of JP-A No. 11-65021, and in column Nos. 0242 to 0250 of JP-A No. 11-119374.

6) Gelatin

Various gelatins can be used as the gelatin contained in the photosensitive silver halide emulsion used in the invention. It is necessary that the dispersed state of the photosensitive silver halide emulsion in the organic silver salt-containing coating liquid be maintained satisfactorily and use of gelatin having a molecular weight of 10,000 to 1,000,000 is preferred. Further, it is also preferred to conduct phthalizing treatment for the substituents of the gelatin. The gelatins may be used during formation of grains or during dispersion after the desalting treatment, and they may be used preferably during grain formation.

7) Chemical Sensitization

The photosensitive silver halide grains in the invention are preferably sensitized chemically by sulfur sensitization, selenium sensitization or tellurium sensitization. As the compounds used preferably for the sulfur sensitization, selenium sensitization or tellurium sensitization, known compounds described, for example, in JP-A No. 7-128768 can be used. Particularly, tellurium sensitization is preferred in the invention and compounds described in the documents shown in column Number 0030 of JP-A No. 11-65021 and compounds shown by the general formulae (II), (III), and (IV) in JP-A No. 5-313284 are particularly preferred.

The photosensitive silver halide grains used in the invention are preferably sensitized chemically by gold sensitization alone or in combination with the chalcogen sensitization described above. As the gold sensitizer, those having +1 or +3 gold valence are preferred and gold compounds used usually are preferred for the gold sensitizer. Preferred typical examples are chloroauric acid, bromoauric acid, potassium chloroaurate, potassium bromoaurate, auric trichloride, potassium auric thiocyanate, potassium iodo aurate, tetracyano auric acid ammonium aurothiocyanate and pyridylgrichloro gold. Further, gold sensitizers described in U.S. Pat. No. 5,858,637 and Japanese Patent Application No. 2001-79450 are also used preferably.

In the invention, chemical sensitization may be performed at any timing so long as it is after the formation of grains and before coating and, for example, may be performed, after desalting, and (1) before spectral sensitization, (2) at the same time with spectral sensitization, (3) after the spectral sensitization and (4) just before coating. The amount of sulfur, selenium and tellurium sensitizer used in the invention varies depending on the silver halide grains used and chemical ripening conditions and it is used by about 10⁻⁸ to 10⁻² mol, and preferably 10⁻⁷ to 10⁻³ mol per mol of silver halide.

The addition amount of the gold sensitizer varies depending on various conditions and generally it is 10⁻⁷ mol to 10⁻³ mol, and more preferably 10⁻⁶ mol to 5×10⁻⁴ mol per mol of silver halide. There is no particular limitation to the conditions for the chemical sensitization performed in the invention, where pH is about 5 to 8, pAg is about 6 to 11 and the temperature is about 40 to 95° C.

In the silver halide emulsion used in the invention, a thiosulfonic acid compound may be added using the method shown in EP-A No. 293,917.

In the photosensitive silver halide grains used in the invention, a reducing sensitizer is preferably used. As the specific compound for the reducing sensitization, ascorbic acid and thiourea dioxide are preferred, as well as use of stannaneous chloride, aminoimino methanesulfinic acid, hydrazine derivatives, borane compounds, silane compounds and polyamine compounds is preferred. The reducing sensitizer may be added at any stage in the production process for the photosensitive emulsion from crystal growth to the preparation step just before coating. Further, reducing sensitization is applied preferably by ripening while maintaining pH to 7 or more and pAg to 8.3 or less for the emulsion, and it is also preferred to perform the reducing sensitization by introducing a single addition portion of silver ions during grain formation.

8) FED Sensitizer

The photosensitive silver halide emulsion in the invention preferably contains an FED sensitizer (Fragmentable Electron Donating Sensitizer) as a compound generating two electrons by one photon. The FED sensitizer may include the compounds described in U.S. Pat. Nos. 5,747,235, 5,747,236, 6,054,260, and 5,994,051, and Japanese Patent Application No. 2001-86161.

Preferred FED compounds used in the invention are those compounds represented by the following type A or types 1 to 4.

First, the compounds of types 1 to 4 are explained.

In the type 1 compound, “bond cleaving reaction” specifically means cleavage of carbon-carbon bond or carbon-silicon bond, with which cleavage of carbon-hydrogen bond may be accompanied. The type 1 compound is a compound which is one-electron oxidized to produce a one-electron oxidation product, which releases two or more electrons (preferably, three or more electrons) through a subsequent bond cleaving reaction. In other words, this is a compound which can be further oxidized by two or more electrons (preferably, three or more electrons).

Preferred compounds among the type 1 compounds are represented by the general formula (1-1) or the general formula (1-2). In the compounds, after the reducing groups represented by RED₁₁ or RED₁₂ of the general formula (1-1) or the general formula (1-2) are one-electron oxidized, they can spontaneously leave L₁₁ or L₁₂ by bond cleaving reaction, that is, by cleavage of the C (carbon atom)-L₁₁ bond or C (carbon atom)-L₁₂ bond, to release further two more electrons, preferably, three or more electrons.

The compound represented by the general formula (1-1) is first described specifically. The reducing group represented by RED₁₁ in the general formula (1-1) that can be one-electron oxidized is a group capable of forming a predetermined ring to be described later bonding with R₁₁₁ and may include, specifically, divalent groups formed by removing one hydrogen atom from the following monovalent groups at an appropriate portion from the following monovalent groups suitable to form a ring. They include, for example, alkylamino group, arylamino group (e.g., anilino group, and naphthylamino group), heterocyclicamino group (e.g., benzothiazolylamino group and pyrrolinoamino group), alkylthio group, aryl thio group (e.g., phenylthio group), heterocyclicthio group, alkoxy group, aryloxy group (e.g., phenoxy group), heterocyclicoxy group, aryl group (e.g., phenyl group, naphthyl group, and anthranyl group), aromatic or non-aromatic heterocyclic group (specific examples of the heterocyclic group including, for example, tetrahydroquinoline ring, tetrahydroisoquinoline ring, tetragtdroquinoxaline ring, tetrahydroquinazoline ring, indoline ring, indole ring, indazole ring, carbazole ring, phenoxazine ring, phenotiazine ring, benzothiazoline ring, pyrrole ring, imidazole ring, thiazoline ring, piperidine ring, pyrrolidine ring, morpholine ring, benzimidazole ring, benzoimidazoline ring, benzooxazoline ring, and 3,4-methylenedioxyphenyl ring) (hereinafter RED₁₁ is described by the name of the monovalent group for the sake of convenience). They may have a substituent.

The substituent may include, for example, a halogen atom, an alkyl group (including, aralkyl group, cycloalkyl group, and active methine group), alkenyl group, alkinyl, aryl group, heterocyclic group (with no restriction to the substitutive position), heterocyclic group containing quaternarized nitrogen atom (e.g., pyridinio group, imidazolio group, quinolinio group, and isoquinolinio group), acyl group, alkoxycarbonyl group, aryloxycarbonyl group, carbamoyl group, carboxy group or a salt thereof, sulfonylcarbamoyl group, acylacarbamoyl group, sulfamoylcarbamoyl group, carbazoyl group, oxalyl group, oxamoyl group, cyano group, thiocarbamoyl group, hydroxyl group, alkoxy group (including groups containing ethyleneoxy group units or propyleneoxy group units repetitively), aryloxy group, heterocyclicoxy group, acyloxy group, (alkoxy or aryloxy)carbonyloxy group, carbamoyloxy group, sulfonyloxy group, amino group, (alkyl, aryl or heterocyclic)amino group, acylamino group, sulfoneamide group, ureido group, thioureido group, imido group, (alkoxy or aryloxy)carbonylamino group, sulfurmoylamino group, semicarbadide group, thiosemicarbadide group, hydrazino group, ammonia group, oxamoylamino group, (alkyl or aryl)sulfonyl ureido group, acylureido group, acylsulfamoylamino group, nitro group, mercapto group, (alkyl, aryl or heterocyclic)thio group, (alkyl or aryl)sufonyl group, (alkyl or aryl)sulfinyl group, sulfo group or a salt thereof, sulfamoyl group, acylsulfamoyl group, sulfonylsulfamoyl group or a salt thereof, and a group containing phosphoric amide or phosphoric ester structure. The substituents may further be substituted with a substituent.

In the general formula (1-1), L₁₁ represents a leaving group capable of leaving through a bond cleaving after the reducing group represented by RED₁₁ is one-electron oxidized, specifically, it represents a carboxy group or a salt thereof or a silyl group.

When L₁₁ represents the salt of the carboxy group, the counter ion for forming the salt may include, specifically, alkali metal ions, alkaline earth metal ions, heavy metal ions ammonium ion, and phosphonium ion. When L₁₁ represents the silyl group, specific examples of the silyl group include trialkyl silyl group, aryldialkyl silyl group, and triaryl silyl group in which the alkyl group may include, for example, methyl, ethyl, benzyl and t-butyl groups, and the aryl group may include, for example, a phenyl group.

In the general formula (1-1), R₁₁₂ represents a hydrogen atom or a substituent capable of substituting a hydrogen atom or a carbon atom. When R₁₁₂ represents the substituent capable of substituting the carbon atom, the substituent may include those identical with the substituents in a case where RED₁₁₁ has the substituent. However, R₁₁₂ does not represent the group identical with L₁₁.

In the general formula (1-1), R₁₁₁ represents a non-metal atom group capable of forming a specific 5-membered or 6-membered cyclic structure together with the carbon atom (C) and RED₁₁. The specific 5-membered or 6-membered cyclic structure formed by R₁₁₁ means a cyclic structure corresponding to a tetrahydro form, hexahydro form or a octahydro form of a 5-membered or 6-membered aromatic ring (including aromatic hetero ring). The hydro form means a ring structure in which a carbon-carbon double bond (or carbon-nitrogen double bond) incorporated in the aromatic ring (including aromatic hetero ring) is partially hydrogenated, the tetrahydro form means a structure in which two carbon-carbon double bonds (or carbon-nitrogen double bonds) are hydrogenated, the hexahydro form means a structure in which three carbon-carbon double bonds (or carbon-nitrogen double bond) are hydrogenated, and the octahydro form means a structure in which four carbon-carbon double bonds (or carbon-nitrogen double bonds) are hydrogenated. The aromatic ring forms a partially hydrogenated non-aromatic ring through hydrogenation.

Specifically, examples of the single 5-membered ring may include, for example, pyrolidine ring, imidazolidine ring, thiazolidine ring, pyrazolidine ring, and oxazolidine ring corresponding to the tetrahydro form of the aromatic ring such as pyrrole ring, imidazole ring, thiazole ring, pyrazole ring, and oxazole ring. Examples of mono-cyclic 6-membered ring include a tetrahydro form or hexahydro form of an aromatic ring such as pyridine ring, pyridazine ring, pyrimidine ring and pyradine ring and may include, for example, piperidine ring, tetrahydropyridine ring, tetrahydropyrimidine ring, and piperadine ring. Examples of the condensed 6-membered ring may include, for example, tetraline ring, tetrahydroquinoline ring, tetrahydroisoquinoline ring, tetrahydroquinazoline ring, and tetrahydroquinoxaline ring corresponding to the tetrahydro form of an aromatic ring such as naphthalene ring, quinoline ring, isoquinoline ring, quinazoline ring and quinoxaline ring. Examples of tri-cyclic compound include tetrahydrocarbazole ring as a tetrahydro form of a carbazole ring and an octahyerophenanthridine ring as an octahydro form of a phenanthridine ring.

The ring structures described above may further be substituted, and examples of the substituent include those identical substituent with those explained for the substituent that RED₁₁ may have. The substituents of the ring structures may further be joined to form a ring in which a newly formed ring is a non-aromatic carbocyclic or heterocyclic ring.

Preferred compounds represented by the general formula (1-1) of the invention is to be explained. In the general formula (1-1), L₁₁ is, preferably, a carboxy group or a salt thereof. The counter ion for the salt is preferably an alkali metal ion or ammonium ion, with the alkali metal ion (particularly Li⁺, Na⁺, K⁺ ion) being most preferred.

In the general formula (1-1), RED₁₁ is preferably an alkylamino group, arylamino group, heterocyclic amino group, aryl group, and aromatic or non-aromatic heterocyclic group. Preferred heterocyclic group may include, for example, tetrahydroquinolinyl group, tetrahydroquinoxalinyl group, tetrahydroquinazolinyl group, indolyl group, indolenyl group, carbazolyl group, phenoxazinyl group, phenotiazinyl group, benzothiazolynyl group, pyrrolyl group, imidazolyl group, thiazolidinyl group, benzimidazolyl group, benzoimizolynyl group, and 3,4-methylenedioxyphenyl-1-yl group. More preferred are arylamino group (particularly anilino group), aryl group (particularly, phenyl group).

When RED₁₁ represents the aryl group, the aryl group preferably has at least one electron donative group. The electron donating group may include a hydroxy group, alkoxy group, mercapto group, sulfoneamide group, acylamino group, alkylamino group, arylamino group, heterocyclic amino group, active methine group, electron excess aromatic heterocyclic group (e.g., indolyl group, pyrrolyl group, imidazolyl group, benzimidazolyl group, thiazolyl group, benzthiazolyl group, and indazolyl group), and nitrogen atom-substituted non-aromatic nitrogen containing heterocyclic group (e.g., pyrrolidinyl group, indolynyl group, piperidinyl group, piperazinyl group, and morpholino group). The active methine group means a methine group substituted with two electron attractive groups and the electron attractive group means acyl group, alkoxycarbonyl group, aryloxy carbonyl group, carbamoyl group, alkylsulfonyl group, arylsulfonyl group, sulfamoyl group, trifluoromethyl group, cyano group, nitro group, and imino group. The two electron attractive groups may be bonded with each other to form a ring structure.

When RED₁₁ represents an aryl group, a substituent for the aryl group is preferably an alkylamino group, hydroxyl group, alkoxy group, mercapto group, sulfoneamide group, active methine group, and nitrogen atom-substituted non-aromatic nitrogen-containing heterocyclic group, and further preferably alkylamino group, hydroxyl group, active methine group, and nitrogen atom-substituted non-aromatic nitrogen-containing heterocyclic group, and most preferably alkylamino group and nitrogen atom-substituted non-aromatic nitrogen-containing heterocyclic group.

In the general formula (1-1), R₁₁₂ is preferably a hydrogen atom, an alkyl group, aryl group (e.g., phenyl group), alkoxy group (e.g., methoxy group, ethoxy group and benzyloxy group), hydroxyl group, alkylthio group (e.g., methylthio group and butylthio group), amino group, alkylamino group, arylamino group, and heterocyclic amino group, and, more preferably, hydrogen atom, alkyl group, alkoxy group, phenyl group, and alkylamino group.

In the general formula (1-1), R₁₁₁ is preferably a non-metal atom group which can form, together with a carbon atom (C) and RED₁₁, any one of specified 5- or 6-membered ring structures as described below. Namely, examples of the specified 5- or 6-membered ring structures include a pyrrolidine ring and an imidazolidine ring corresponding to tetrahydrogenated forms of a pyrrole ring and an imidazole ring, respectively, which are each individually a monocyclic 5-membered aromatic ring; a piperidine ring, a tetrahydropyridine ring, a tetrahydropyrimidine ring and a piperazine ring which are each individually a tetrahydrogenated or hexahydrogenated form of a pyridine ring, a pyridazine ring, a pyrimidine ring, or a pyrazine ring which is a monocyclic 6-membered aromatic ring; a tetralin ring, a tetrahydroquinoline ring, a tetrahydroisoquinoline ring, a tetrahydroquinazoline ring and a tetrahydroquinoxaline ring corresponding to tetrahydrogenated forms of a naphthalene ring, a quinoline ring, an isoquinoline ring, a quinazoline ring and a quinoxaline ring, respectively, which are each individually a condensed ring of a 6-membered aromatic ring; and a tetrahydrocarbazole ring and an octahydrophenanthridine ring of a tetrahydrogenated form of a carbazole ring and an octahydrogenated form of a phenanthridine ring, respectively, which are each individually a tricyclic aromatic ring.

Examples of more preferable ring structures which R₁₁₁ forms include a pyrrolidine ring, an imidazolidine ring, a piperidine ring, a tetrahydropyridine ring, a tetrahydropyrimidine ring, a piperazine ring, a tetrahydroquinoline ring, a tetrahydroquinazoline ring, a tetrahydroquinoxaline ring and a tetrahydrocarbazole ring whereupon a pyrrolidine ring, a piperidine ring, a piperazine ring, a tetrahydroquinoline ring, a tetrahydroquinazoline ring, a tetrahydroquinoxaline ring and a tetrahydrocarbazole ring are particularly preferable, and a pyrrolidine ring, a piperidine ring and a tetrahydroquinoline ring are most preferable.

Next, the general formula (1-2) will be explained in detail.

RED₁₂, and L₁₂ in the general formula (1-2) are groups having definitions equivalent to those described in RED₁₁ and L₁₁ in the general formula (1-1), respectively, and same applies to preferable ranges thereof. However, RED₁₂ is a monovalent group in all cases except a case in which it forms any one of ring structures described below and, specifically, represents monovalent groups equivalent to those represented by RED₁₁. R₁₂₁ and R₁₂₂ are groups having a definition equivalent to that described in R₁₁₂ in the general formula (1-1) and the same applies to preferable ranges thereof. ED₁₂ represents an electron-donating group. At least one pair selected from the group consisting of: a pair of R₁₂₁ and RED₁₂, a pair of R₁₂₁ and R₁₂₂, and a pair of ED₁₂ and RED₁₂ may be combined with each other within each pair to form a ring structure.

The electron-donating group represented by ED₁₂ in the general formula (1-2) is at least one member selected from the group consisting of: a hydroxyl group, an alkoxy group, a mercapto group, an alkylthio group, an arylthio group, a heterothio group, a sulfonamide group, an acylamino group, an alkylamino group, an arylamino group, a heterocyclic amino group, an active methine group, an aromatic heterocyclic group in excess of electrons (for example, an indolyl group, a pyrrolyl group or an indazolyl group), a non-aromatic nitrogen-containing heterocyclic group which is substituted by a nitrogen atom (for example, a pyrrolidinyl group, a piperidinyl group, an indolinyl group, a piperazinyl group or a morpholino group) and an aryl group substituted by any one of these electron-donating groups (for example, a p-hydroxyphenyl group, a p-dialkylaminophenyl group, an o,p-dialkoxyphenyl group or a 4-hydroxynaphthyl group). Such active methine groups referred to in this case are same as those which were explained as substituents at the time RED₁₁ represented an aryl group.

ED₁₂ preferably represents at least one member selected from the group consisting of: a hydroxyl group, an alkoxy group, a mercapto group, a sulfonamide group, an alkylamino group, an arylamino group, an active methine group, an aromatic heterocyclic group in excess of electrons, a non-aromatic nitrogen-containing heterocyclic group which is substituted by a nitrogen atom and a phenyl group substituted by any one of these electron-donating groups whereupon a hydroxyl group, a mercapto group, a sulfonamide group, an alkylamino group, an arylamino group, an active methine group, a non-aromatic nitrogen-containing heterocyclic group which is substituted by a nitrogen atom and a phenyl group substituted by any one of these electron-donating groups (e.g., a p-hydroxyphenyl group, a p-dialkylaminophenyl group or an o,p-dialkoxyphenyl group) are more preferable.

At least one pair selected from the group consisting of: a pair of R₁₂₂ and RED₁₂, a pair of R₁₂₂ and R₁₂₁, and a pair of ED₁₂ and RED₁₂ in the general formula (1-2) may, within each pair, be combined with each other to form a ring structure. The ring structure to be formed on this occasion is referred to as a substituted or non-substituted ring structure of a 5- to 7-membered non-aromatic carbon ring or a hetero ring which is a single ring or a condensed ring.

When R₁₂₂ and RED₁₂ form a ring structure therebetween, specific examples of such ring structures include a pyrrolidine ring, a pyrroline ring, an imidazolidine ring, an imidazoline ring, a thiazolidine ring, a thiazoline ring, a pyrazolidine ring, a pyrazoline ring, an oxazolidine ring, an oxazoline ring, an indane ring, a piperidine ring, a piperazine ring, a morpholine ring, a tetrahydropyridine ring, a tetrahydropyrimidine ring, an indoline ring, a tetralin ring, a tetrahydroquinoline ring, a tetrahydroisoquinoline ring, a tetrahydroquinoxaline ring, a tetrahydro-1,4-oxazine ring, a 2,3-dihydrobenzo-1,4-oxazine ring, a tetrahydro-1,4-thiazine ring, a 2,3-dihydrobenzo-1,4-thiazine ring, a 2,3-dihydrobenzofuran ring and a 2,3-dihydrobenzothiophene ring.

When ED₁₂ and RED₁₂ form a ring structure therebetween, ED₁₂ preferably represents at least one group selected from the group consisting of an amino group, an alkylamino group and an arylamino group whereupon specific examples of such ring structures to be formed include a tetrahydropyrazine ring, a pyperazine ring, a tetrahydroquinoxaline ring and a tetrahydroisoquinoline ring.

When R₁₂₂ and R₁₂₁ form a ring structure therebetween, specific examples of such ring structures include a cyclohexane ring and a cyclopentane ring.

More preferable compounds among compounds represented by the general formula (1-1) are represented by the following general formulas (10) to (12), and still more preferable compounds among compounds represented by the general formula (1-2) are represented by the following general formulas (13) and (14):

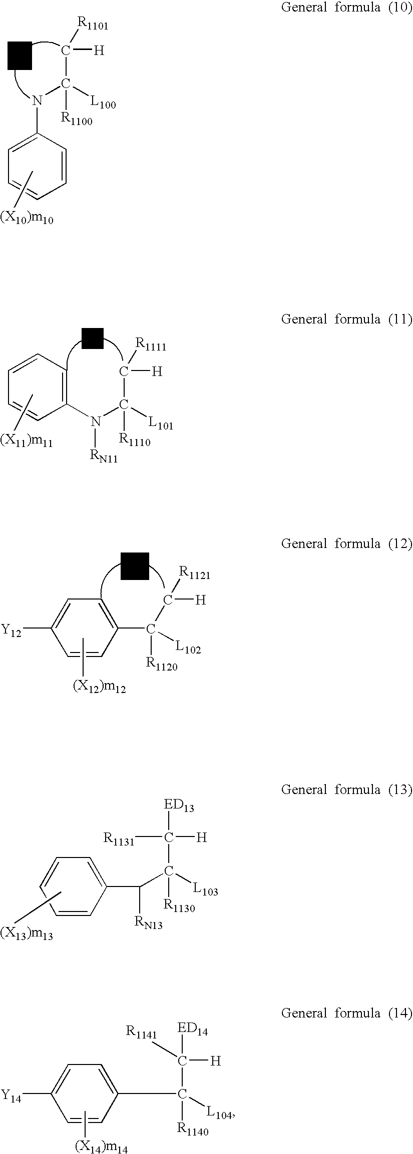

In the general formulas (10) to (14), L₁₀₀, L₁₀₁, L₁₀₂, L₁₀₃ and L₁₀₄ are groups each having a definition equivalent to that described in L₁₁ in the general formula (1-1) and the same applies to preferable ranges thereof. R₁₁₀₀ and R₁₁₁₀, R₁₁₁₀ and R₁₁₁₁, R₁₁₂₀ and R₁₁₂₁, R₁₁₃₀ and R₁₁₃₁, and R₁₁₄₀ and R₁₁₄₁ are each a pair of groups having, within each pair, a definition equivalent to that of a pair of R₁₂₁ and R₁₂₂ in the general formula (1-2), and the same applies to preferable ranges thereof. ED₁₂ and ED₁₄ are groups each having a definition equivalent to that of ED₁₂ in the general formula (1-2), and the same applies to preferable ranges thereof.

X₁₀, X₁₁, X₁₂, X₁₃ and X₁₄ each independently represent a substituent which can substitute a benzene ring; and m₁₀, m₁₁, m₁₂, m₁₃ and m₁₄ each independently represent an integer of from 0 to 3 whereupon, when any one of them is plural in number, a plurality of X₁₀s, X₁₁s, X₁₂s, X₁₃s or X₁₄s may be the same or different from one another. Y₁₂ and Y₁₄ each independently represent any one group selected from the group consisting of: an amino group, an alkylamino group, an arylamino group, a nitrogen-containing heterocyclic group which is substituted by a nitrogen atom (e.g., a pyrrolyl group, a piperidinyl group, an indolinyl group, a piperazino group or a morpholino group), a hydroxyl group and an alkoxy group.

Z₁₀, Z₁₁, and Z₁₂ each independently represent a non-metallic atomic group which can form a specified ring structure. The specified ring structure to be formed by Z₁₀ is referred to as a tetra- or hexa-hydrogenated form of a 5- or 6-membered nitrogen-containing aromatic hetero ring which is a single ring or a condensed ring. Specific examples of such specified ring structures include a pyrrolidine ring, an imidazolidine ring, a thiazolidine ring, a pyrazolidine ring, a piperidine ring, a tetrahydropyridine ring, a tetrahydropyrimidine ring, a piperazine ring, a tetrahydroquinoline ring, a tetrahydroisoquinoline ring, a tetrahydroquinazoline ring and a tetrahydroquinoxaline ring. The specific ring structure to be formed by Z₁₁ is referred to as a tetrahydroquinoline ring or a tetrahydroquinoxaline ring. The specified ring structure to be formed by Z₁₂ is referred to as at least one member selected from the group consisting of: a tetralin ring, a tetrahydroquinoline ring and a tetrahydroisoquinoline ring.

R_{N11} and R_{N13} each independently represent a hydrogen atom or a substituent which can be substituted by a nitrogen atom. Specific examples of such substituents include an alkyl group, an alkenyl group, an alkynyl group, an aryl group, a heterocyclic group and an acyl group whereupon an alkyl group and an aryl group are preferable.

Specific examples of substituents represented by X₁₀, X₁₁, X₁₂, X₁₃, X₁₄ which can each individually substitute a benzene ring are same as those of substituents which RED₁₁ in the general formula (1-1) may have. On this occasion, preferable are a halogen atom, an alkyl group, an aryl group, a heterocyclic group, an acyl group, an alkoxycarbonyl group, an aryloxycarbonyl group, a carbamoyl group, a cyano group, an alkoxy group (inclusive of a group having a repeating unit of an ethyleneoxy group or a propyleneoxy group), (an alkyl-, an aryl-, or a heterocyclic-) amino group, an acylamino group, a sulfonamide group, a ureido group, a thioureido group, an imide group, (an alkoxy- or an aryloxy-) carbonylamino group, a nitro group, (an alkyl-, an aryl- or a heterocyclic-) thio group, (an alkyl- or an aryl-) sulfonyl group, sulfamoyl group and the like.

m₁₀, m₁₁, m₁₂, m₁₃ and m₁₄ each independently represent preferably from 0 to 2 and more preferably 0 or 1.

Y₁₂ and Y₁₄ each independently represent preferably any one member selected from the group consisting of: an alkylamino group, an arylamino group, a non-aromatic nitrogen-containing heterocyclic group which is substituted by a nitrogen atom, a hydroxyl group and an alkoxy group, more preferably any one member selected from the group consisting of: an alkylamino group, a 5- or 6-membered non-aromatic nitrogen-containing heterocyclic group which is substituted by a nitrogen atom and a hydroxyl group, and most preferably an alkylamino group (particularly, a dialkylamino group) or a 5- or 6-membered non-aromatic nitrogen-containing heterocyclic group which is substituted by a nitrogen atom.

In the general formula (13), at least one pair selected from the group consisting of: a pair of R₁₁₃₁ and X₁₃, a pair of R₁₁₃₁ and R_{N13}, a pair of R₁₁₃₀ and X₁₃, and a pair of R₁₁₃₀ and R_{N13} may, within each pair, be combined with each other to form a ring structure. Further, in the general formula (14), at least one pair selected from the group consisting of: a pair of R₁₁₄₁ and X₁₄, a pair of R₁₁₄₁ and R₁₁₄₀, a pair of ED₁₄ and X₁₄, and a pair of R₁₁₄₀ and X₁₄ may, within each pair, be combined with each other to form a ring structure. The ring structure to be formed on this occasion is referred to as a substituted or non-substituted ring structure of a 5- to 7-membered non-aromatic carbon ring or hetero ring which is a single ring or a condensed ring.

In the general formula (13), a case in which R₁₁₃₁ and X₁₃ are combined with each other to form a ring structure and a case in which R₁₁₃₁ and R_{N13} are combined with each other to form a ring structure are each individually a preferable example of the compound represented by the general formula (13) in the same manner as in a case in which they do not form a ring structure in each of the former two cases.

Specific examples of such ring structures to be formed by R₁₁₃₁ and X₁₃ in the general formula (13) include an indoline ring (on this occasion, R₁₁₃₁ has a single bond), a tetrahydroquinoline ring, a tetrahydroquinoxaline ring, a 2,3-dihydrobenzo-1,4-oxazine ring, and a 2,3-dihydrobenzo-1,4-thiazine ring whereupon an indoline ring, a tetrahydroquinoline ring and a tetrahydroquinoxaline ring are particularly preferable.

Specific examples of such ring structures to be formed by R₁₁₃₁ and R_{N13} in the general formula (13) include a pyrrolidine ring, a pyrroline ring, an imidazolidine ring, an imidazoline ring, a thiazolidine ring, a thiazoline ring, a pyrazolidine ring, a pyrazoline ring, an oxazolidine ring, an oxazoline ring, a piperidine ring, a piperazine ring, a morpholine ring, a tetrahydropyridine ring, a tetrahydropyrimidine ring, an indoline ring, a tetrahydroquinoline ring, a tetrahydroisoquinoline ring, a tetrahydroquinoxaline ring, a tertrahydro-1,4-oxazine ring, a 2,3-dihydrobenzo-1,4-oxazine ring, a tetrahydro-1,4-thazine ring, a 2,3-dihydrobenzo-1,4-thiazine ring, a 2,3-dihydrobenzofuran ring and a 2,3-dihydrobenzothiophene ring whereupon a pyrrolidine ring, a pyperidine ring, a tetrahydroquinoline ring and a tetrahydroquinoxaline ring are particularly preferable.

In the general formula (14), a case in which R₁₁₄₁ and X₁₄ are combined with each other to form a ring structure and a case in which ED₁₄ and X₁₄ are combined with each other to form a ring structure are each individually a preferable example of the compound represented by the general formula (14) in the same manner as in a case in which they do not form a ring structure in each of the former two cases.

Specific examples of such ring structures to be formed by allowing R₁₁₄₁ an X₁₄ to be combined with each other in the general formula (14) include an indane ring, a tetralin ring, a tetrahydroquinoline ring, a tetrahydroisoquinoline ring, an indoline ring. Examples of such ring structures to be formed by allowing ED₁₄ and X₁₄ to be combined with each other include a tetrahydroisoquinoline ring and a tetrahydrocinnoline ring.

Next, the compounds of type 2 will be explained.

The type 2 compound is a compound that is one-electron oxidized to produce a one-electron oxidation product, then, when the resultant compound in one-electron oxidized form is subjected to a carbon-carbon bond cleaving reaction, it releases one or more electron, in other words, it is a compound that can be one-electron oxidized. The term “bond cleaving reaction” as used herein is intended to mean a carbon-carbon bond cleaving reaction which may be followed by a carbon-hydrogen bond cleaving reaction.

Preferable compounds among compounds of the type 2 are represented by the general formula (2), wherein, after a reducing group represented by RED₂ is one-electron oxidized, L₂ is allowed to be spontaneously leaved through a bond cleaving reaction, that is, a cleavage of a C (carbon atom)-L₂ bond is effected and, along with this cleavage, the compounds can each release one more electron.

However, the type 2 compounds are compounds each of which has two or more adsorbable groups (hereinafter, referred to also as “adsorptive group”) to silver halide in the same molecular structure; more preferably, they are compounds each of which has a nitrogen-containing heterocyclic group substituted by two or more mercapto groups as the adsorbable group. Such adsorbable groups will be explained below. RED₂ in the general formula (2) represents a group having a definition equivalent to that of RED₁₂ in the general formula (1-2) and the same applies to preferable ranges thereof. L₂ represents a carboxyl group or a salt thereof whereupon a counter ion to form the salt thereof is same as that explained in L₁₁ in the general formula (1-1) and same applies to preferable ranges thereo. R₂₁ and R₂₂ each independently represent a hydrogen atom or a substituent, and also each independently represent a group equivalent to that of R₁₁₂ in the general formula (1-1) and same applies to preferable ranges thereof. RED₂ and R₂₁ may be combined with each other to form a ring structure.

The ring structure to be formed on this occasion is a 5- to 7-membered non-aromatic carbon ring or hetero ring which may be a single ring or a condensed ring and also may have a substituent. Examples of such ring structures include an indoline ring, a 2,3-dihydrobenzothiophene ring, a 2,3-dihydrobenzofuran ring, a 1,2-dihydropyridine ring, a 1,4-dihydropyridine ring, a benzo-a-pyran ring, a benzothiazoline ring, a benzoxazoline ring, a benzimidazoline ring, a 1,2-dihydroquinoline ring, a 1,2-dihydroquinazoline ring, a 1,2-dihyroquinoxaline ring, a chromane ring and an isochromane ring whereupon an indoline ring, a 2,3-dihydrobenzothiophene ring, a 1,2-dihydropyridine ring, a benzothiazoline ring, a benzoxazoline ring, a benzimidazoline ring, a 1,2-dihydroquinoline ring, a 1,2-dihydroquinazoline ring and a 1,2-dihydroquinoxaline ring are preferable; and an indoline ring, a benzothiazoline ring, a benzimidazoline ring and a 1,2-dihydroquinoline ring are more preferable; and an indoline ring is particularly preferable.

Next, the compounds of type 3 will be explained.

The type 3 compound is a compound that is one-electron oxidized to produce a one-electron oxidation product, which releases additional one or more electrons after a subsequent bond-forming step whereupon the term “bond-forming step” as used herein is intended to mean formation of an inter-atomic bond such as a carbon-carbon bond, a carbon-nitrogen bond, a carbon-sulfur bond or a carbon-oxygen bond.

The type 3 compound is preferably a compound characterized in that a one-electron oxidized product by subjecting the compound to a one-electron oxidization reaction subsequently reacts with a carbon-carbon double-bond portion or a carbon-carbon triple-bond portion to form a bond and, thereafter, can further release one or more electrons.

The one-electron oxidized form to be generated by subjecting the compound of the type 3 compound to a one-electron oxidation reaction is also referred to as a cationic radical species which can occasionally be changed into a neutral radical species along with deprotonation therefrom. The one-electron oxidized form (a cationic radical species or neutral radical species) generates a chemical reaction generally referred to as “addition cyclization reaction” in a carbon-carbon double-bond portion or a carbon-carbon triple-bond portion which is simultaneously present in the same molecule to form an inter-atomic bond such as a carbon-carbon bond, a carbon-nitrogen bond, a carbon-sulfur bond or a carbon-oxygen bond and, then, to form a new ring structure in the molecule. It is the characteristics of the type 3 compound that, at the same time of or after forming the new ring structure as described above, one or more electrons can further be released.

In more detail, the compound of the type 3 is characterized in that it can produce a radical species having a ring structure newly formed by this addition cyclization reaction to be performed after the compound is one-electron oxidizied and, then, an electron is further released as a second electron, either directly or along with deprotonation, from the radical species to allow the compound to be oxidized.

In the type 3 compounds, a compound is further included in which two-electron oxidized product is subjected, after being subjected to a hydrolysis reaction in one case, or directly in another case, to a tautomeric reaction which is generated along with a transfer of a proton whereupon the two-electron oxidized product has an ability of being oxidized and further releasing one or more electron, ordinarily two or more electrons therefrom. Alternatively, a compound is further included in which the two-electron oxidized product has an ability of being oxidized and further releasing one or more electrons, ordinarily two or more electrons directly therefrom without undergoing the tautomeric reaction.

The type 3 compounds are preferably represented by the general formula (3).

RED₃ in the general formula (3) represents a group having a definition equivalent to that of RED₁₂ in the general formula (1-2).

RED₃ is preferably an aryl group or a heterocyclic group which is substituted by a group selected from the group consisting of: an arylamino group, a heterocyclic amino group, a hydroxyl group, a mercapto group, an alkylthio group, a methyl group and an amino group.

When RED₃ represents the arylamino group, examples of such arylamino groups include an aniline group and a naphthylamino group. A hetero ring of the heterocyclic amino group is an aromatic or a non-aromatic hetero ring which is a single ring or a condensed ring whereupon it preferably has at least one aromatic ring as a partial structure. The term “has an aromatic ring as a partial structure” as used herein is intended to include any one of the following cases: 1) the hetero ring itself is an aromatic ring; 2) an aromatic ring is condensed to a hetero ring to form a condensed ring; and 3) a hetero ring is substituted by an aromatic ring, wherein the cases 1) and 2) are preferable. On this occasion, an amino group directly substitutes the aromatic ring at any position thereon which is contained in the hetero ring as a partial structure. Examples of such hetero rings include a pyrrole ring, an indole ring, an indoline ring, an imidazole ring, a benzimidazole ring, a benzimidazoline ring, a thiazole ring, a benzothiazole ring, a benzothiazoline ring, an oxazole ring, a benzoxazole ring, a benzoxazoline ring, a quinoline ring, a tetrahydroquinoline ring, a quinoxaline ring, a tetrahydroquinoxaline ring, a quinazoline ring, a tetrahydroquinazoline ring, a pyridine ring, an isoquinoline ring, a thiophene ring, a benzothiophene ring, a 2,3-dihydrobenzothiophene ring, a furan ring, a benzofuran ring, a 2,3-dihydrobenzofuran ring, a carbazole ring, a phenothiazine ring, a phenoxazine ring and phenazine ring.

When RED₃ represents the arylamino group or the heterocyclic amino group, an amino group of the arylamino group or an amino group of the heterocyclic amino group may further be substituted by an arbitrary substituent which, along with the aryl group or the heterocyclic group, may further form a ring structure. Examples of such cases include an indoline ring, a tetrahydroquinoline ring and a carbazole ring.

When RED₃ represents the aryl group or the heterocyclic group which is substituted by any one group selected from the group consisting of: a hydroxyl group, a mercapto group, a methyl group, an alkylthio group and an amino group, the aryl group is referred to as a phenyl group, a naphthyl group or the like, while a hetero ring of the heterocyclic group is referred to as the same cycle as that explained in the “hetero ring of heterocyclic amino group”. Further, on this occasion, the methyl group may have an arbitrary substituent which, along with the aryl group or the heterocyclic group, may form a ring structure. Examples of such ring structures include a tetralin ring and an indane ring. Whereas, the amino group may also contains one group selected from the group consisting of: an alkyl group, an aryl group and a heterocyclic group as a substituent which, along with the aryl group or the heterocyclic group, may form a ring structure. Examples of such ring structures include a tetrahydroquinoline ring, an indoline ring and a carbazole ring.

RED₃ represents preferably an arylamino group, or an aryl group or a heterocyclic group which is substituted by a hydroxyl group, a mercapto group, a methyl group or an amino group, more preferably an arylamino group, or an aryl group or a heterocyclic group which is substituted by a mercapto group, a methyl group or an amino group, and particularly preferably an arylamino group, an aryl group or a heterocyclic group which is substituted by a methyl group or an amino group.

Examples of preferable arylamino groups include an aniline group and a naphthylamino group whereupon an anilino group is particularly preferable. Examples of such preferable substituents of an anilino group include a chlorine atom, an alkyl group, an alkoxy group, an acylamino group, a sulfamoyl group, a carbamoyl group, a ureido group, a sulfonamide group, an alkoxycarbonyl group, a cyano group, an alkyl- or aryl-sulfonyl group and a heterocyclic group.

Examples of preferable aryl groups or heterocyclic groups each substituted by a hydroxyl group include a hydroxyphenyl group, a 5-hydroxyindoline ring group and a 6-hydroxy-1,2,3,4-tetrahydroquinoline ring group whereupon a hydroxyphenyl group is particularly preferable.

Examples of preferable aryl groups or heterocyclic groups each substituted by a mercapto group include a mercaptophenyl group, a 5-mercaptoindoline ring group and a 6-mercapto-1,2,3,4-tetrahydroquinoline ring group whereupon a mercaptophenyl group is particularly preferable.

Examples of preferable aryl groups or heterocyclic groups each substituted by a methyl group include a methylphenyl group, an ethylphenyl group, an isopropylphenyl group, a 3-methylindole ring group, a 3-isopropylindole ring group, a 5-methylindole ring group, a 5-methylindoline ring group, a 6-methyl-1,2,3,4-tetrahydroquinoline ring group and a 6-methyl-1,2,3,4-tetrahydroquinoxaline ring group.

Examples of preferable aryl groups or heterocyclic groups each substituted by an amino group include a methylaminophenyl group, an octylaminophenyl group, a dodecylaminophenyl group, a dimethylaminophenyl group, a bezylaminophenyl group, a phenyaminophenyl group, a methylaminonaphthyl group, a 5-methylaminotetralin group, a 1-butylamino-3,4-methylenedioxyphenyl group, a 3-methylaminopyrrole ring group, a 3-ethylaminoindole ring group, a 5-benzylaminoindoline ring group, a 2-aminoimidazole ring group, a 2-methylaminothiazole ring group and a 6-phenylaminobezothiazole ring group whereupon a phenyl group substituted by an alkylamino group or a phenylamino group is more preferable; and a phenyl group substituted by an alkylamino group is particularly preferable.

Examples of preferable substituents contained in an aryl group or a heterocyclic group substituted by a hydroxyl group, a mercapto group, a methyl group or an amino group include a chlorine atom, an alkyl group, an alkoxy group, an acylamino group, a sulfamoyl group, a carbamoyl group, a ureido group, a sulfonamide group, an alkoxycarbonyl group, a cyano group, an alkyl- or aryl-sulfonyl group, a heterocyclic group, an alkylamino group and an arylamino group.

A reactive group represented by Y₃ in the general formula (3) is specifically referred to as an organic group containing at least one portion of a carbon-carbon double bond portion and a carbon-carbon triple bond portion. The carbon-carbon double bond portion or the carbon-carbon triple bond portion may have a substituent and, as examples of such substituents, mentioned are same substituents as those which RED₁, in the general formula (1-1) may have. Examples of such preferable substituents include an alkyl group, an aryl group, an alkoxycarbonyl group, a carbamoyl group, an acyl group, a cyano group and an electron-donating group. The term “electron-donating group” as used herein is intended to include an alkoxy group, a hydroxyl group, an amino group, an alkylamino group, an arylamino group, a heterocyclic amino group, a sulfonamide group, an acylamino group, an active methine group, a mercapto group, an alkylthio group, an arylthio group and an aryl group having at least one of these groups as a substituent. The term “active methine group” as used herein is intended to include a methine group which is substituted by two electron-attractive groups, wherein the term “electron-attractive group” as used herein is intended to include an acyl group, an alkoxycarbonyl group, an aryloxycarbonyl group, a carbamoyl group, an alkylsufonyl group, an arylsufonyl group, a sulfamoyl group, a trifluoromethyl group, a cyano group, a nitro group and an imino group whereupon two electron-attractive groups may be combined with each other to form a ring structure.

When Y₃ represents the carbon-carbon double bond portion, examples of preferable substituents thereof include an alkyl group, an alkoxycarbonyl group, a carbamoyl group and an electron-donating group whereupon examples of such preferable electron-donating groups include an alkoxy group, an amino group, an alkylamino group, an arylamino group, a heterocyclic amino group, a sulfonamide group, an acylamino group, an active methine group, a mercapto group, an alkylthio group and a phenyl group having any one of these electron-donating groups as a substituent. Substituents such as an alkyl group, an alkoxy group, an alkylthio group and an alkylamino group are preferably combined with one another to form a ring structure containing a carbon-carbon double bond whereupon specific examples of such preferable ring structures include a 2,3-dihydro-γ-pyran ring group, a cyclohexene ring group, a 1-thia-2-cyclohexene-3-yl group and a tetrahydropyridine ring group.

When Y₃ represents the organic group containing a carbon-carbon double bond portion, substituents thereof may be combined with each other to form a ring structure. The ring structure to be formed on this occasion is a 5- to 7-membered non-aromatic carbon ring or heterocycle. When Y₃ represents the carbon-carbon triple bond portion, examples of preferable substituents thereof include a hydrogen atom, an alkoxycarbonyl group, a carbamoyl group and an electron-donating group whereupon examples of such preferable electron-donating groups include an alkoxy group, an amino group, an alkylamino group, an arylamino group, a heterocyclic amino group, a sulfonamide group, an acylamino group, an active methine group, a mercapto group, an alkylthio group and a phenyl group having any one of these electron-donating groups as a substituent.

The reactive group represented by Y₃ in the general formula (3) is preferably an organic group containing a carbon-carbon double bond.

L₃ in the general formula (3) represents a linking group which connects RED₃ and Y₃ whereupon specific examples of such linking groups include a single bond, an alkylene group, an arylene group, a heterocyclic group, each group of —O—, —S—, —NRN—, —C(═O)—, —SO₂—, —SO—, and —P(═O)—, and appropriate groups each comprising any one combination thereof, wherein R_{N} represents at least one member selected from the group consisting of: a hydrogen atom, an alkyl group, an aryl group and a heterocyclic group. The linking group represented by L₃ may have a substituent. As for such substituents, mentioned are same substituents as those which RED₁₁ in the general formula (1-1) may have.

As to the groups represented by L₃ in the general formula (3), it is preferable that, when a cationic radical species to be generated by allowing RED₃ in the general formula (3) to be oxidized, or a radical species to be generated along with removal of a proton therefrom, and a reactive group represented by Y₃ in the general formula (3) are allowed to react with each other to form a bond, atomic groups relating to such a reaction can form a 3- to 7-membered ring structure by allowing L₃ to be incorporated.

Examples of preferable L₃ include a single bond, an alkylene group, an arylene group (particularly phenylene group), a group of —C(═O)—, a group of —O—, a group of —NH—, a group of—N(alkyl group)-, and divalent groups each comprising any one combination thereof.

Among compounds represented by the general formula (3), preferable compounds are represented by the following general formulas (I) to (IV):

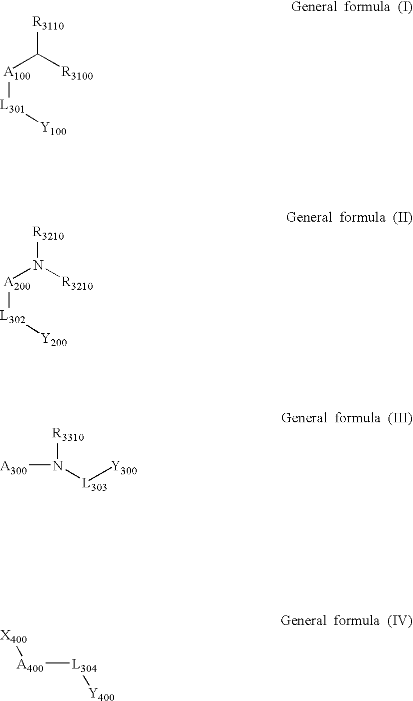

In the general formulas (I) to (IV), A₁₀₀, A₂₀₀, A₃₀₀ and A₄₀₀ each independently represent an aryl group or a heterocyclic group whereupon preferable ranges thereof are the same as that of RED₃ in the general formula (3). L₃₀₁, L₃₀₂, L₃₀₃ and L₃₀₄ each independently represent a linking group which has a definition equivalent to that of L₃ in the general formula (3) and the same applies to preferable ranges thereof. Y₁₀₀, Y₂₀₀, Y₃₀₀ and Y₄₀₀ each independently represent a reactive group which has a definition equivalent to that of Y₃ in the general formula (3) and the same applies to preferable ranges thereof. R₃₁₀₀, R₃₁₁₀, R₃₂₀₀, R₃₂₁₀ and R₃₃₁₀ each independently represent a hydrogen atom or a substituent, wherein R₃₁₀₀ and R₃₁₁₀ each independently represent preferably at least one member selected from the group consisting of: a hydrogen atom, an alkyl group and an aryl group; wherein R₃₂₀₀ and R₃₃₁₀ each independently represent preferably a hydrogen atom; and wherein R₃₂₁₀ represents preferably a substituent whereupon examples of such preferable substituents include an alkyl group and an aryl group. At least one pair selected from the group consisting of: a pair of R₃₁₁₀ and A₁₀₀, a pair of R₃₂₁₀ and A₂₀₀, and a pair of R₃₃₁₀ and A₃₀₀ may, within each pair, be combined with each other to form a ring structure. Examples of such preferable ring structures to be formed on this occasion include a tetralin ring, an indane ring, a tetrahydroquinoline ring and an indoline ring. X₄₀₀ represents at least one member selected from the group consisting of: a hydroxyl group, a mercapto group and an alkylthio group whereupon a hydroxyl group and a mercapto group are preferable, and a mercapto group is more preferable.

Here, a relation between any one of the general formulas (I) to (IV) and the general formula (3) is explained. A₁₀₀ in the general formula (I) represents an aryl group or a heterocyclic group substituted by a methyl group: —CH(R₃₁₁₀)(R₃₁₀₀); A₂₀₀ in the general formula (II) represents an aryl group or a heterocyclic group substituted by an amino group: —N(R₃₂₁₀)R₃₂₀₀); A₄₀₀ in the general formula (IV) represents an aryl group or a heterocyclic group substituted by at least one group selected from the group consisting of: a hydroxyl group, a mercapto group and an alkylthio group which are represented by X₄₀₀; and a group represented by A₃₀₀ —N(R₃₃₁₀)— in the general formula (III) represents an arylamino group or a heterocyclic amino group.

Among compounds represented by the general formulas (I) to (IV), the compounds represented by the general formulas (I), (II) and (IV) are preferable.

Next, the compounds of type 4 are explained.

The type 4 compound is a compound which has a ring structure substituted by a reducing group and, along with a cleavage reaction to be performed on a ring structure after the reducing group is one-electron oxidized, can further release one or more electrons.

The type 4 compound is subjected to a one-electron oxidation reaction and, thereafter, the ring structure is subjected to a cleaving reaction. This cleaving reaction denotes a model represented by the following formulas:

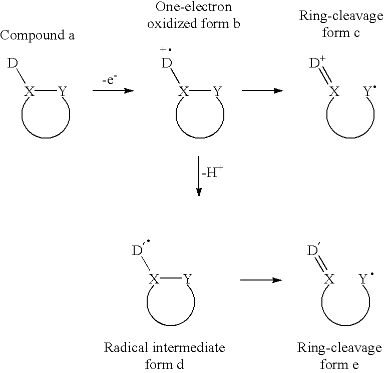

In the formulas, a compound a shows the type 4 compound. In the compound a, D represents a reducing group, while X and Y each independently represent an atom in a ring structure that forms a bond which undergoes cleavage at a one-electron oxidation reaction. Firstly, the compound a is subjected to a one-electron oxidation reaction to produce a one-electron oxidized form b thereof. From this step, a single bond of D-X becomes a double bond and, at the same time, a bond of X- Y is opened to produce a ring-cleavage form c. Alternatively, there is sometimes provided another path in which the one-electron oxidized form b is deprived of a proton to generate a radical intermediate form d and, then, via thus-generated radical intermediate form d, a ring-cleavage form body e is generated in the same manner. It is the characteristics of the compound according to the invention that one or more electrons are subsequently released from the thus-generated ring-cleavage form c or e.

A ring structure which the type 4 compound has denotes a 3- to 7-membered carbon ring or a heterocycle, that is, a saturated or unsaturated non-aromatic ring which is a single ring or a condensed ring. The ring structure is preferably a saturated ring structure and more preferably a 3- or 4-membered ring. Examples of such preferable ring structures include a cyclopropane ring, a cyclobutane ring, an oxirane ring, an oxetane ring, an aziridine ring, an azetidine ring, an episulfide ring and a thietane ring whereupon a cyclopropane ring, a cyclobutane ring, an oxirane ring, an oxetane ring and azetidine ring are more preferable; and a cyclopropane ring, a cyclobutane ring and an azetidine ring are particularly preferable. Any one of these ring structures may have a substituent.

The type 4 compounds are preferably represented by the general formula (4-1) or (4-2). RED₁₄ and RED₄₂ in general formulas (4-1) and (4-2) each independently represent a group having a definition equivalent to that of RED₁₂ in the general formula (1-2) and the same applies to preferable ranges thereof. R₄₀ to R₄₄ and R₄₅ to R₄₉ each independently represent a hydrogen atom or a substituent. As to such substituents, mentioned are the same substituents as those which RED₁₂ may have. Z₄₂ in the general formula (4-2) represents at least one member selected from the group consisting of: —CR₄₂₀R₄₂₁—, —NR₄₂₃—, and —O—, wherein R₄₂₀ and R₄₂₁ each independently represent a hydrogen atom or a substituent; and R₄₂₃ represents at least one member selected from the group consisting of: a hydrogen atom, an alkyl group, an aryl group and a heterocyclic group.

R₄₀ in the general formula (4-1) preferably represents at least one member selected from the group consisting of: a hydrogen atom, an alkyl group, an alkenyl group, an alkynyl group, an aryl group, a heterocyclic group, an alkoxy group, an amino group, an alkylamino group, an arylamino group, a heterocyclic amino group, an alkoxycarbonyl group, an acyl group, a carbamoyl group, a cyano group and a sulfamoyl group whereupon a hydrogen group, an alkyl group, an aryl group, a heterocyclic group, an alkoxy group, an alkoxycarbonyl group, an acyl group and a carbamoyl group are more preferable; and a hydrogen atom, an alkyl group, an aryl group, a heterocyclic group, an alkoxycarbonyl group and a carbamoyl group are particularly preferable.

A case in which at least one of R₄₁ to R₄₄ represents a donor-type group, and a case in which both R₄₁ and R₄₂, or both R₄₃ and R₄₄ are electron-attractive groups are preferable whereupon a case in which at least one of R₄₁ to R₄₄ is a donor-type group is more preferable; and a case in which not only at least one of R₄₁ to R₄₄ is a donor-type group but also a group which is not a donor-type group in R₄₁ and R₄₄ is a hydrogen atom or an alkyl group is still more preferable.

The term “donor-type group” as used herein denotes a group selected from the group consisting of: a hydroxyl group, an alkoxy group, an aryloxy group, a mercapto group, an acylamino group, a sulfonylamino group, an active methine group, and any other appropriate groups selected from the preferable groups as RED₄₁ and RED₄₂. Examples of such preferable donor-type groups to be used include an alkylamino group, an arylamino group, a heterocyclic amino group, a 5-membered aromatic heterocyclic group containing one nitrogen atom in the ring (either a single ring or a condensed ring is permissible), a non-aromatic nitrogen-containing heterocyclic group which is substituted by a nitrogen atom, a phenyl group substituted by at least one electron-donating group (wherein examples of such electron-donating groups to be used include a hydroxyl group, an alkoxy group, an aryloxy group, an amino group, an alkylamino group, an arylamino group, a heterocyclic amino group and a non-aromatic nitrogen-containing heterocyclic group which is substituted by a nitrogen atom) whereupon an alkylamino group, an arylamino group, a 5-membered aromatic heterocyclic group containing a nitrogen atom in the ring (wherein examples of aromatic heterocycles corresponding to respective groups include an indole ring, a pyrrole ring and a carbazole ring) and a phenyl group substituted by an electron-donating group (wherein, particularly, examples of such phenyl groups include a phenyl group substituted by 3 or more alkoxy groups and a phenyl group substituted by one group selected from the group consisting of: a hydroxyl group, an alkylamino group and an arylamino group) are more preferably used; and an arylamino group, a 5-membered aromatic heterocyclic group containing one nitrogen atom in the ring (denoting a 3-indolyl group), a phenyl group substituted by an electron-donating group (particularly denoting a trialkoxyphenyl group or a phenyl group substituted by an alkylamino group or an arylamino group) are particularly preferably used. The electron-attractive groups are the same as those mentioned when the active methine is explained.

A preferable range of R₄₅ in the general formula (4-2) is the same as that of R₄₀ in the general formula (4-1).

R₄₆ to R₄₉ each independently represent preferably a hydrogen atom, an alkyl group, an alkenyl group, an alkynyl group, an aryl group, a heterocyclic group, a hydroxyl group, an alkoxy group, an amino group, an alkylamino group, an aryl amino group, a heterocyclic amino group, a mercapto group, an arylthio group, an alkylthio group, an acylamino group, a sulfonamino group, more preferably a hydrogen atom, an alkyl group, an aryl group, a heterocyclic group, an alkoxy group, an alkylamino group, an arylamino group and a heterocyclic amino group, and particularly preferably include a hydrogen atom, an alkyl group, an aryl group, a heterocyclic group, an alkylamino group and an arylamino group when Z₄₂ is represented by —CR₄₂₀R₄₂₁, a hydrogen atom, an alkyl group, an aryl group and a heterocyclic group when Z₄₂ is represented by —NR₄₂₃, and a hydrogen atom, an alkyl group, an aryl group and a heterocyclic group when Z₄₂ is represented by —O—.

Z₄₂ is preferably —CR₄₂₀R₁₂₁— or —NR₄₂₃— and more preferably —NR₄₂₃—, wherein R₄₂₀ and R₄₂₁ each independently represent preferably a hydrogen atom, an alkyl group, an alkenyl group, an alkynyl group, an aryl group, a heterocyclic group, a hydroxyl group, an alkoxy group, an amino group, a mercapto group, an acylamino group and a sulfonamino group, and more preferably a hydrogen atom, an alkyl group, an aryl group, a heterocyclic group, an alkoxy group and an amino group; and R₄₂₃ represents preferably a hydrogen atom an alkyl group, an aryl group and an aromatic heterocyclic group, and more preferably a methyl group, an ethyl group, an isopropyl group, a t-butyl group, a t-amyl group, a benzyl group, a diphenylmethyl group, an allyl group, a phenyl group, a naphthyl group, a 2-pyridyl group, a 4-pyridyl group and a 2-thiazolyl group.

When R₄₀ to R₄₉, R₄₂₀, R₄₂₁ and R₄₂₃ each independently represent a substituent, the substituent has preferably a total carbon atoms of 40 or less, more preferably a total carbon atoms of 30 or less, and particularly preferably a total carbon atoms of 15 or less. Further, such substituents may be combined with each other or with any other portion (RED₄₁, RED₄₂ or Z₄₂) in a molecule to form a ring.

It is preferable that the compounds of types 1, 3 and 4 according to the invention are each individually “a compound having a group adsorptive to (hereinafter also referred to as “adsorptive group against”) a silver halide in a molecule” or “a compound having a partial structure of a spectral sensitizing dye in a molecule”. The compound of the type 2 is “a compound having two or more adsorptive groups against a silver halide in a molecule”.

The adsorptive group to the silver halide in each of the compounds of the types 1 to 4 according to the invention is a group which is directly adsorbed to the silver halide or a group which accelerates adsorption to the silver halide whereupon specific examples of such adsorptive groups include a mercapto group (inclusive of a salt thereof, a thion group (—C(═S)—), a heterocyclic group which contains at least one atom selected from the group consisting of: a nitrogen atom, a sulfur atom, a selenium atom and tellurium atom, a sulfide group, a cationic group and an ethynyl group. However, the compound of the type 2 according to the invention does not contain the sulfide group as an adsorptive group.

The mercapto group (or a salt thereof) which is referred to as the adsorptive group denotes a mercapto group itself (or a salt thereof) and, more preferably, a heterocyclic group, an aryl group or an alkyl group substituted by at least one mercapto group (or a salt thereof). On this occasion, the heterocyclic group denotes a 5- to 7-membered aromatic or non-aromatic heterocyclic group which is a single ring or a condensed ring whereupon examples of such heterocyclic groups include an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group and a triazine ring group. Further, a heterocyclic group containing a quaternized nitrogen atom is permissible and, on this occasion, the mercapto group as a substituent may be dissociated to be a mesoion; examples of such heterocyclic groups include an imidazolium ring group, a pyrazolium ring group, a thiazolium ring group, a triazolium ring group, a tetrazolium ring group, a thiadiazolium ring group, a pyridinium ring group, a pyrimidinium ring group, a triazinium ring group whereupon a triazolium ring group (e.g., 1,2,4-triazolium-3-thiolate ring group) is preferable. As for aryl groups, mentioned is a phenyl group or a naphthyl group. As for alkyl groups, mentioned is a straight-chain, branched-chain or cyclic akyl group having from 1 to 30 carbon atoms. When a mercapto group forms a salt, examples of counter ions include an alkali metal, an alkali earth metal, cations such as heavy metals (e.g., Li⁺, Na⁺, K⁺, Mg²⁺, Ag⁺ and Zn²⁺), an ammonium ion, a heterocyclic group containing a quaternized nitrogen atom and a phosphonium ion.

A marcapto group as an adsorptive group may further undergo a tautomeric reaction to be a thion group whereupon specific examples of such thion groups include a thioamide group (on this occasion, a group of —C(═S)—NH—) and a group containing a partial structure of the thioamide group, that is, a chain or cyclic thioamide group, a thioureido group, a thiourethane group or a dithiocarbamic acid ester group. Examples of cyclic thion groups include a thiazoline-2-thion group, a oxazolidine-2-thion group, a 2-thiohydantoin group, a rhodanine group, an isorhodanine group, a thiobarbituric acid group and a 2-thioxo-oxazolidine-4-one group.

The thion groups as adsorptive groups include, for example, not only thion groups generated by allowing the mercapto group to undergo a tautomeric reaction, but also thion groups in which a mercapto group does not undergo a tautomeric reaction (because of no hydrogen atom on an a position of the thion group), that is, a chain or cyclic thioamide group, a thioureido group, a thiourethane group and a dithiocarbamic acid ester.

The heterocyclic group having at least one atom selected from the group consisting of: a nitrogen atom, a sulfur atom, a selenium atom and a tellurium atom as an adsorptive group denotes a nitrogen-containing heterocyclic group having a group of —NH— which can form an imino silver group (>NAg) as a partial structure of the heterocycle thereof or a heterocyclic group having at least one group selected from the group consisting of: a group of “—S—”, a group of “—Se—”, a group of “—Te—” and a group of “═N—” which can each be coordinated to a silver ion by a coordinate bond as a partial structure of the heterocycle thereof whereupon examples of the former heterocyclic groups include a benzotriazole group, a triazole group, an indazole group, a pyrazole group, a tetrazole group, a benzimidazole group, an imidazole group, a purine group, while examples of the latter heterocyclic groups include a thiophene group, a thiazole group, an oxazole group, a benzothiazole group, a benzoxazole group, a thiadiazole group, an oxadiazole group, a triazine group, a selenazole group, a benzoselenazole group, a tellurazole group and a benzotellurazole group. Thereamong, examples of the former heterocyclic groups are preferable.

The sulfide group as an adsorptive group denotes all groups which have a partial structure of “—S—” whereupon the group having at least one partial structure selected from the group consisting of: alkyl (or allylene)-S-alkyl (or alkylene), aryl (or arylene)-S-alkyl (or alkylene), and aryl (or arylene)-S-aryl (or arylene) is preferable. Further, any one of such sulfide groups may form a ring structure or form a group of —S—S—. As for specific examples of the groups which form a ring structure, mentioned is a group which has one ring selected from the group consisting of: a thiolane ring, a 1,3-dithiolane ring or a 1,2-dithiolane ring, a thiane ring, a dithiane ring, a tetrahydro-1,4-thiadine ring and the like. A particularly preferable sulfide group is a group having a partial structure of an alkyl (or alkylene)-S-alkyl (or alkylene).

The cationic group as an adsorptive group denotes a group containing a quaternized nitrogen atom and, specifically an ammonio group or a group having a nitrogen-containing heterocyclic group which contains a quaternized nitrogen atom whereupon examples of such ammonio groups include a trialkylammonio group, a dialkylarylamonio group and an alkyldiarylammonio group and specifically include a benzyldimethylammonio group, a trihexylammonio group and a phenyldiethylammonio group. The nitrogen-containing heterocyclic groups which each contain a quaternized nitrogen atom include, for example, a pyridinio group, a quinolinio group, an isoquinolinio group and an imidazolio group whereupon a pyridinio group and an imidazolio group are preferable; and a pyridinio group is particularly preferable. These nitrogen-containing heterocyclic groups which each have a quaternized nitrogen atom may have an arbitrary substituent whereupon, in a case of a pyridinio group or an imidazolio group, such substituents are preferably an alkyl group, an aryl group, an acylamino group, a chlorine atom, an alkoxycarbonyl group, a carbamoyl group and the like and, particularly in a case of a pyridinio group, the substituent is particularly preferably a phenyl group.

The ethynyl group as an adsorptive group denotes a group of —C≡CH in which a hydrogen atom may be substituted.

The adsorptive groups described above may each have an arbitrary substituent. Specific examples of the adsorptive groups further include those described, for example, in JP-A No. 11-95355, Specification, pp. 4 to 7.

Examples of preferable adsorptive groups include a mercapto-substituted nitrogen-containing heterocyclic group (e.g., 2-mercaptothiadiazole group, a 3-mercapto-1,2,4-triazole group, a 5-mercaptotetrazole group, a 2-mercapto-1,3,4-oxadiazole group, a 2-mercaptobenzothiazole group or a 1,5-dimethyl-1,2,4-triazolium-3-thiolate group), a dimercapto-substituted heterocyclic group (e.g., 2,4-dimercaptopyrimidine group, a 2,4-dimercaptotriazine group, a 3,5-dimercapto-1,2,4-triazole group or a 2,5-dimercapto-1,3-thiazole group), and a nitrogen-containing heterocyclic group having a group of —NH— which can form an imino silver group (>NAg) as a partial structure of a heterocycle thereof (e.g., a benzotriazole group, a benzimidazole group or an indazole group).

The partial structure of the spectral sensitizing dye denotes a group having a color-forming group of a spectral sensitizing dye, that is, a residue generated by removing an arbitrary hydrogen atom or a substituent from a spectral sensitizing dye compound. A preferable spectral sensitizing dye is a spectral sensitizing dye to be used by a typical color sensitizing technique whereupon examples of such spectral sensitizing dyes include cyanine dyes, complex cyanine dyes, merocyanine dyes, complex merocyanine dyes, holopolar cyanine dyes, styryl dyes and hemicyanine dyes. Representative spectral sensitizing dyes are disclosed in Research Disclosure, Item 36544 (September, 1994). These dyes may be synthesized by those skilled in the art in accordance with procedures described in the Research Disclosure or F. M. Hamer, “The Cyanine Dyes and Related Compounds”, Interscience Publishers, New York, (1964). Further, dyes described in JP-A No. 11-95355 (corresponding to U.S. PATENT No. 6054260), Specification, pp. 7 to 14 are applicable to the invention as they are.

The compounds of types 1 to 4 according to the invention each have preferably from 10 to 60 carbon atoms in total, more preferably from 10 to 50 carbon atoms in total, still more preferably from 11 to 40 carbon atoms in total and particularly preferably from 12 to 30 carbon atoms in total.

The compounds of types 1 to 4 according to the invention are subjected to a one-electron oxidation reaction by being triggered by allowing a silver halide photosensitive material containing any one of these compounds to be exposed to light and, after a subsequent reaction, oxidized and to further release one electron or two or more electrons depending on the type whereupon an oxidation potential of a first electron is preferably about 1.4 V or less and more preferably 1.0 V or less, while this oxidation potential is preferably 0 V or more and more preferably 0.3 V or more; hence, the oxidation potential is preferably in the range of from about 0 V to about 1.4 V and more preferably in the range of from about 0.3 V to about 1.0 V.

The oxidation potential can be measured by a cyclic voltamperometry technique in which, specifically, a sample is dissolved in a solution in which acetonitrile to water (inclusive of 0.1M lithium perchlorate) is 80% to 20% (by vol %), aerated with a nitrogen gas for 10 minutes and, then, measurement of the resultant solution is performed with a scanning speed of 0.1 V/s at 25° C. using a vitreous carbon disk as an operating electrode, a platinum wire as a counter electrode and a calomel electrode (SCE) as a reference electrode. A value of the oxidation potential against the SCE at the time of a peak potential of the cyclic voltamperometry wave is determined.

When the compounds of types 1 to 4 according to the invention are each individually subjected to a one-electron oxidation reaction and, after a subsequent reaction, allowed to release further one electron therefrom, an oxidation potential of such latter step is preferably from −0.5 V to −2 V, more preferably from −0.7 V to 2 V and still more preferably from −0.9 V to −1.6 V.

When the compounds of types 1 to 4 according to the invention are each individually subjected to a one-electron oxidation reaction and, after a subsequent reaction, allowed to be oxidized to release further two or more electrons therefrom, an oxidation potential of such latter step is not particularly limited. This is because there are many cases in which, since the oxidation potential of the second electron and those of the third and subsequent electrons cannot clearly be distinguished from one another, it is difficult to precisely measure these oxidation potentials and to distinguish them from one another.

Specific examples of the compounds of types 1 to 4 are given below to illustrate the invention and should not be interpreted as limiting it in any way.

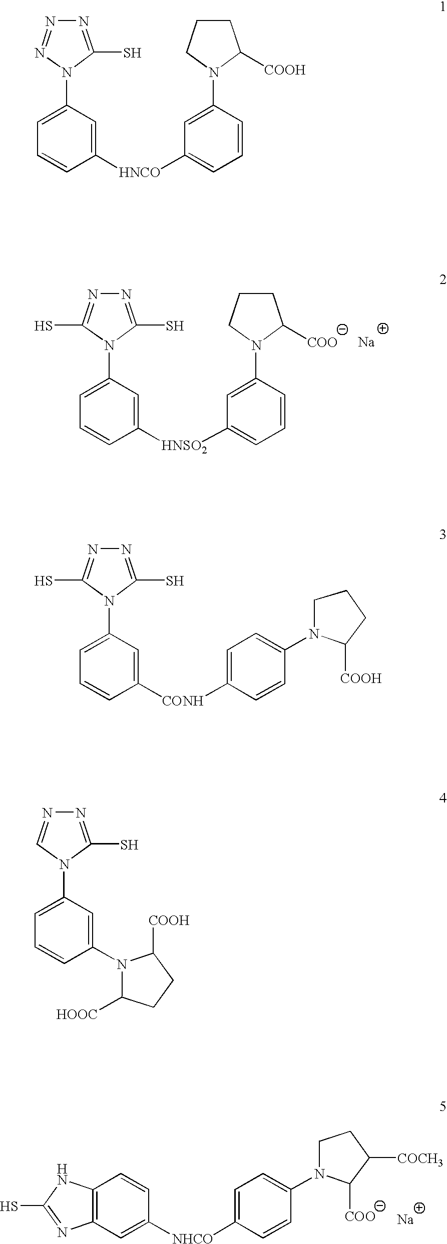

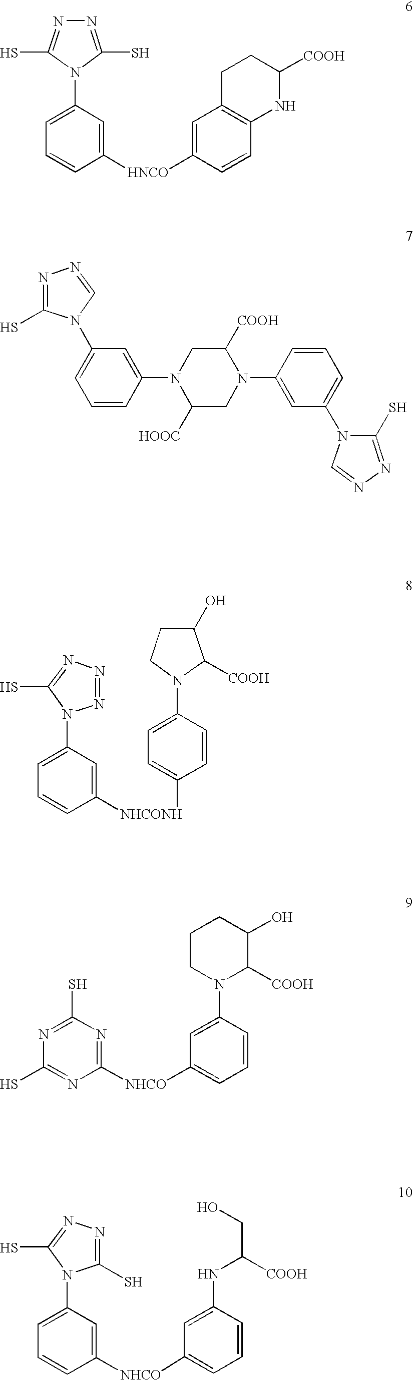

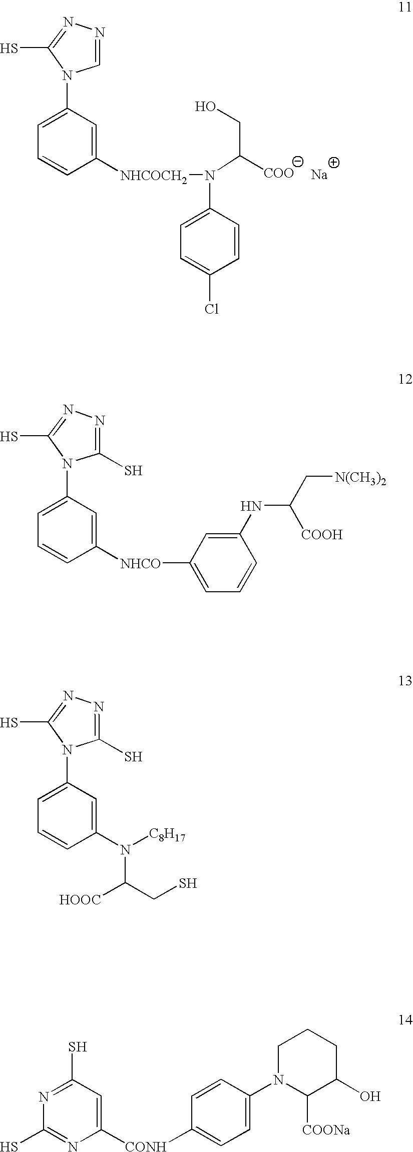

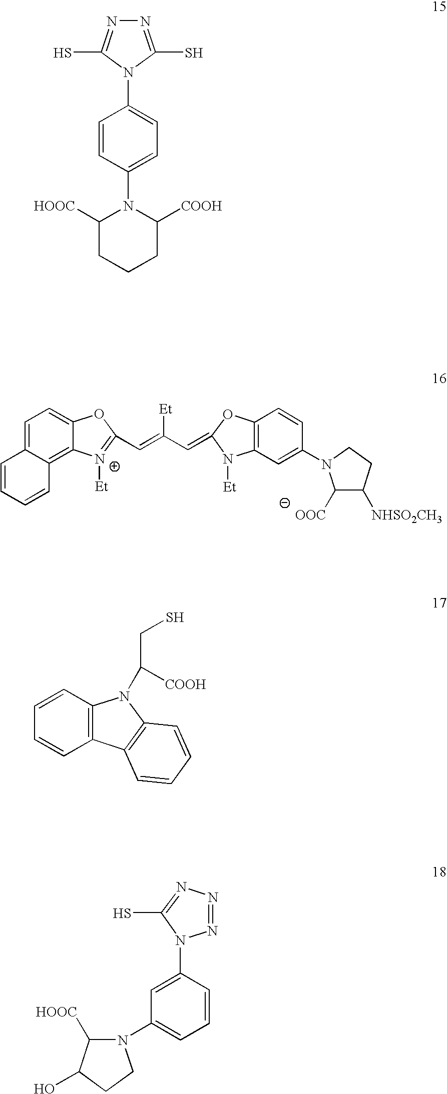

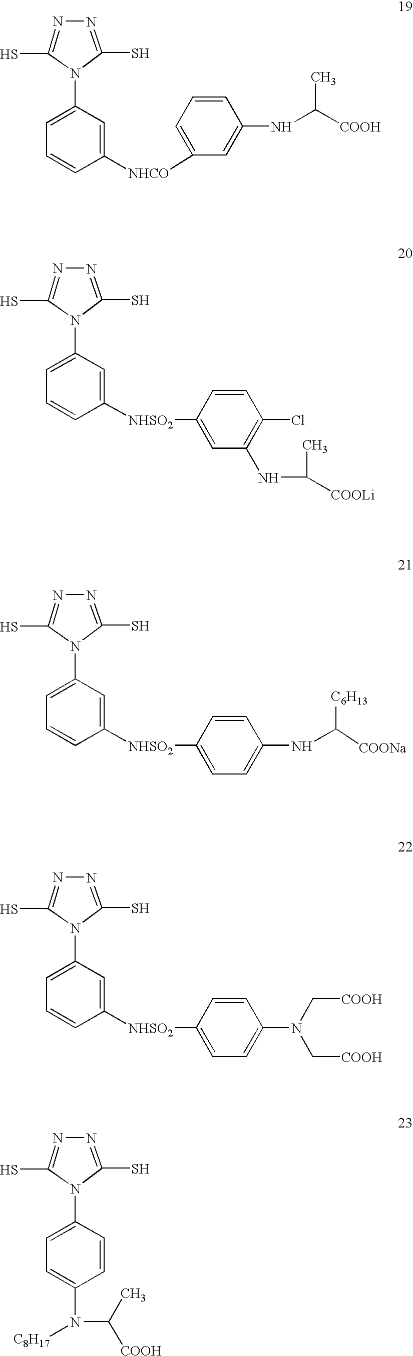

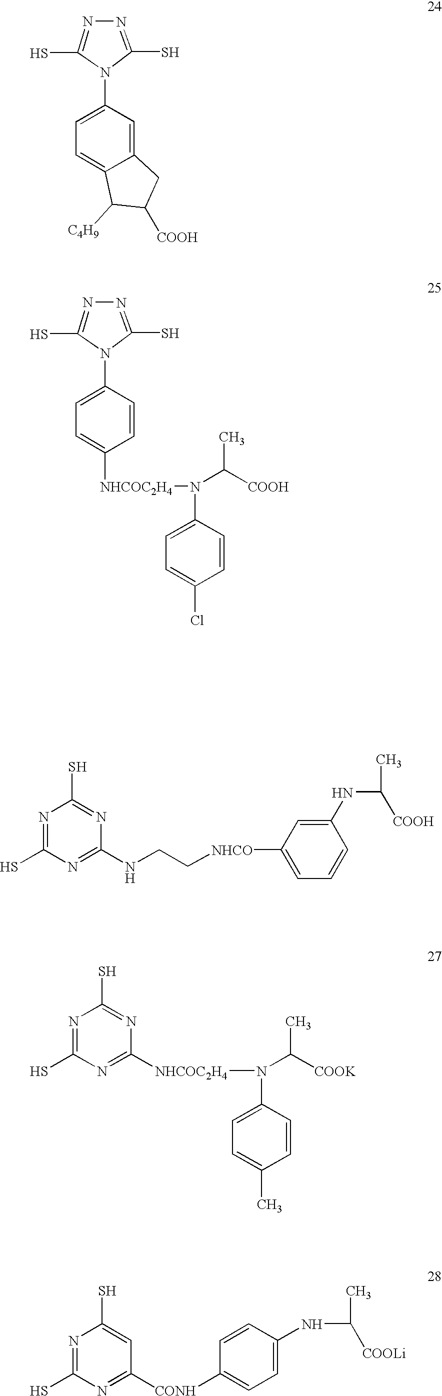

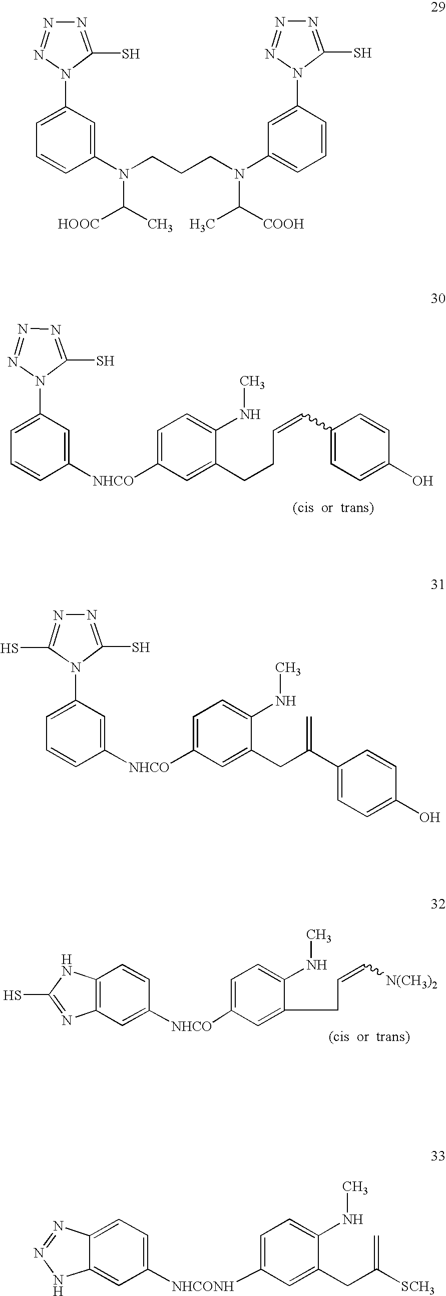

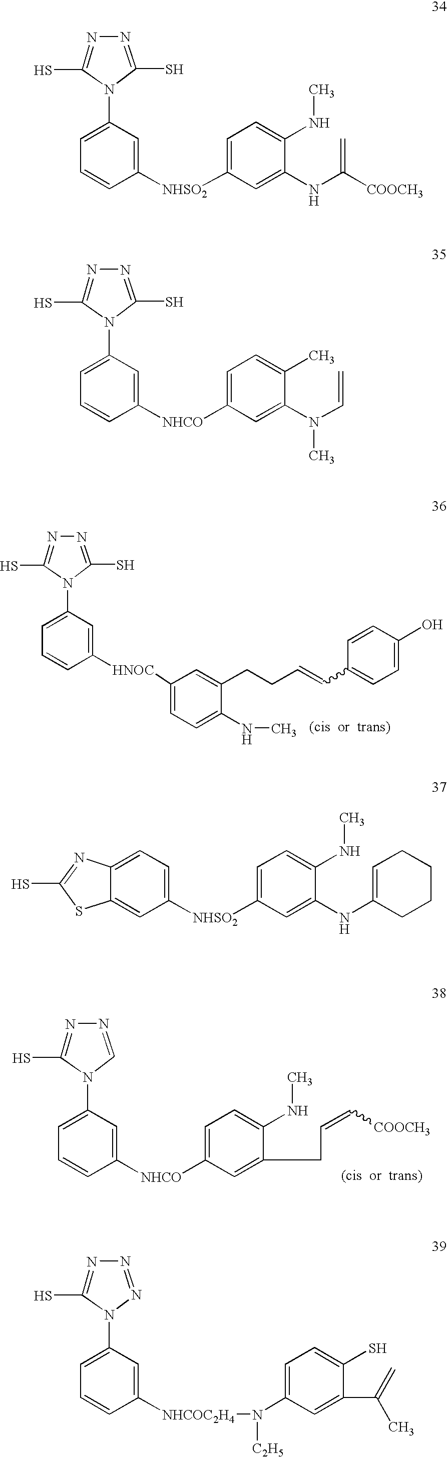

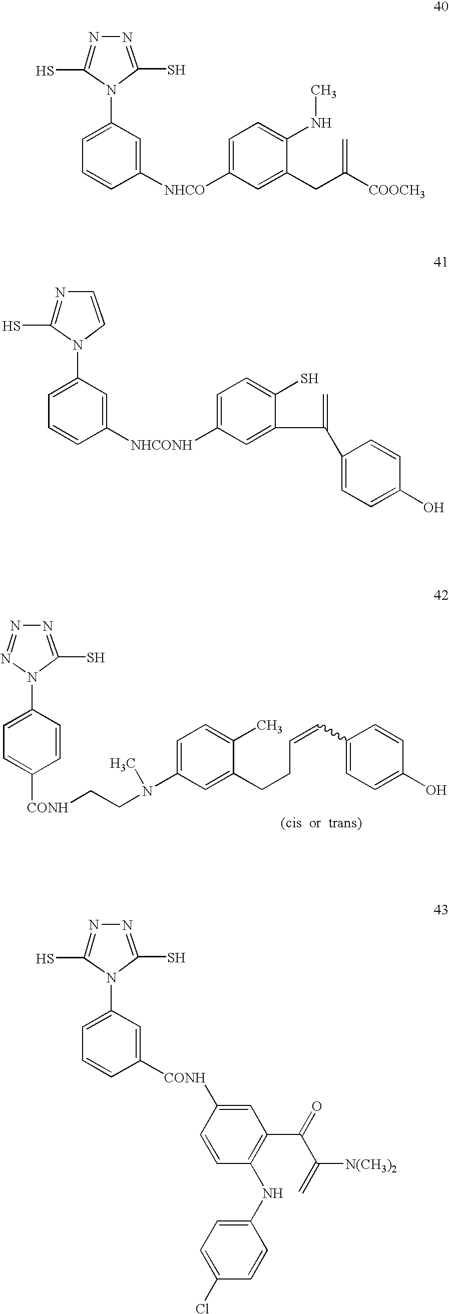

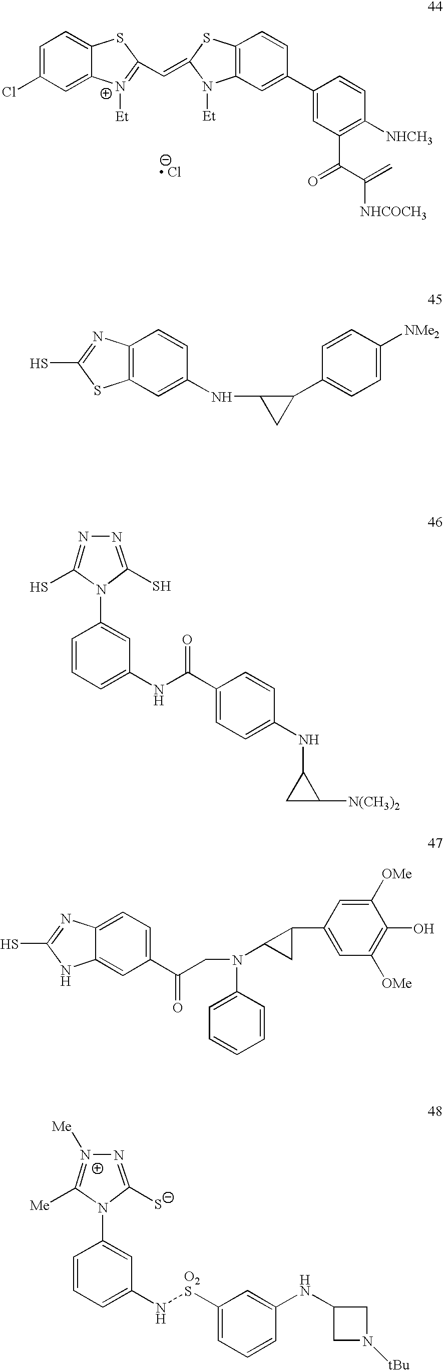

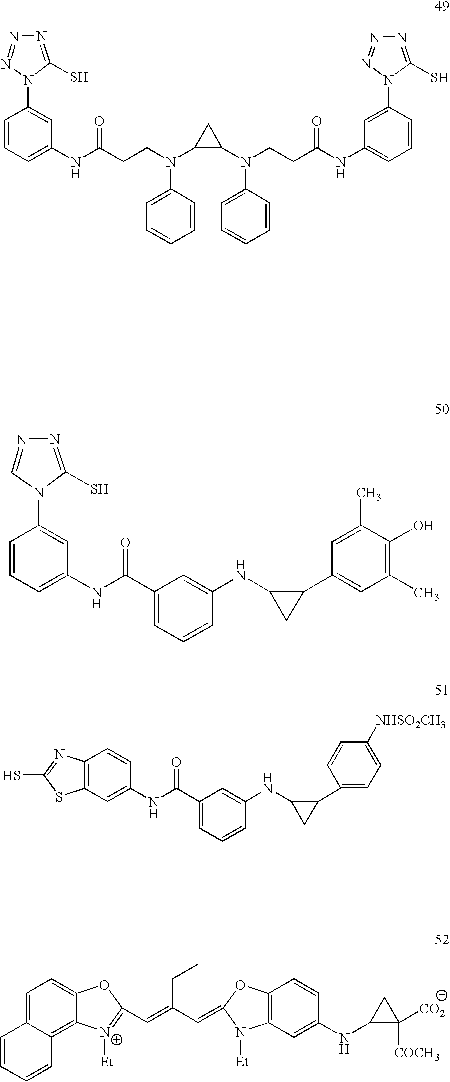

The compounds of types 1 to 4 are the same as those explained in detail in Japanese Patent Application Nos. 2001-234075, 2001-234048, 2001-250679 and 2001-272137, respectively. Specific examples of compounds described in these Japanese Patent Applications can be incorporated into specific examples of the compounds of types 1 to 4 according to the invention.

Next, the compounds of type A are described.

The type A compound denotes a compound which is represented by X—Y, in which X represents a reducing group; and Y represents a leaving group, wherein the reducing group represented by X is one-electron oxidized to produce a one-electron oxidation product and, subsequently, the thus-produced one-electron oxidized product leaves Y to produce X radical through a subsequent X—Y bond cleaving reaction and, thereafter, one more electron can further be released from the thus-generated X radical. The reaction at a time when the compound of the type A is oxidized can be represented by the following formula:

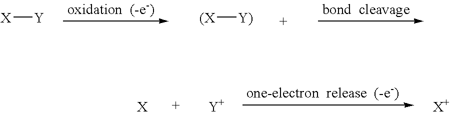

The type A compound has an oxidation potential preferably in the range of from 0 V to 1.4 V and more preferably in the range of from 0.3 V to 1.0 V. The oxidation potential of the radical X to be generated by the above-described reaction is preferably in the range of from −0.7 V to −2.0 V and more preferably in the range of from −0.9 V to −1.6 V.

The type A compound is preferably represented by the general formula (A).

In the general formula (A), REDO represents a reducing group; L₀ represents a leaving group; and R₀ and R₁ each independently represent a hydrogen atom or a substituent. A pair of RED₀ and R₀, a pair of R₀ and R₁, or both pairs of RED₀ and R₀, and R₀ and R₁ may, within each pair, be combined with each other to form a ring structure.

RED₀ represents a group having a definition equivalent to that of RED₁₂ in the general formula (1-2) and the same applies to preferable ranges thereof. R₀ and R₁ represent groups having definitions equivalent to those of R₂₁ and R₂₂ in the general formula (2), respectively, and the same applies to respective preferable ranges thereof. However, R₀ and R₁ do not represent a group having a definition equivalent to that of L₀ other than a hydrogen atom. RED₀ and R₀ may be combined with each other to form a ring structure whereupon examples of such ring structures include the same examples of ring structures which are formed by allowing RED₂ and R₂₁ in the general formula (2) to be combined with each other and the same applies to respective preferable ranges thereof. Examples of ring structures which are formed by allowing R₀ and R₁ to be combined with each other include a cyclopentane ring and a tetrahydrofuran ring.

The leaving group represented by L₀ denotes at least one member selected from the group consisting of: a carboxyl group or a salt thereof, a silyl group, a stannyl group, a germyl group, a triaryl boron-atomic anion, a group of —C(R₀)(R₁)-RED₀ and a hydrogen atom. The carboxylic group or the salt thereof and the silyl group are groups having definitions equivalent to those of L₁₁ in the general formula (1-1) and the same applies to preferable ranges thereof.

The stannyl group is preferably a trialkylstannyl group; the germyl group is preferably a trialkylgermyl group; and the triaryl boron-atomic anion is preferably a triphenyl boron-atomic anion whereupon a phenyl group thereof may be substituted. When L₀ represents a group of —C(R₀)(R₁)-RED₀, the compound represented by the general formula (A) denotes a bis-type compound in which groups of —C(R₀)(R₁)-RED₀ are combined with each other.

The leaving group represented by L₀ in the general formula (A) is preferably at least one member selected from the group consisting of: a carboxylic group or a salt thereof, a silyl group and a group of —C(R₀)(R₁)-RED₀ whereupon the carboxylic group and the salt thereof, as well as a hydrogen atom, are more preferable.

When L₀ represents a hydrogen atom, it is preferable that a compound represented by the general formula (A) has a base portion in the molecule. By an action of this base, the compound represented by the general formula (A) is oxidized and, then, the hydrogen atom represented by L₀ is deprotonated to generate a radical represented by “RED₀(R₀)(R₁)C—.” and, thereafter, an electron is released form the thus-generated radical.

The base on this occasion specifically denotes a conjugate base of an acid showing pKa in the range of from about 1 to about 10 whereupon examples of such bases include nitrogen-containing heterocycles (pyridines, imidazoles, benzimidazoles and thiazoles and the like); anilines; trialkylamines; an amino group; carbon acids (active methylene anion and the like); a thio acetic acid anion; a carboxylate (—COO⁻), a sulfate (—SO₃⁻); and an amine oxide (>N⁺(O⁻)—). Preferably, the base is a conjugate base of an acid showing pKa in the range of from about 1 to about 8 whereupon more preferable examples of such bases include a carboxylate, a sulfate and an amine oxide and particularly preferable examples thereof include a carboxylate. When these bases each contain an anion, they may each have a counter cation; whereupon examples of such counter cations include the same counter ions as those which were explained as being capable of forming a salt when L₀ represented a carboxylic group or a salt thereof.

As for positions which these base portions are bonded to, any one of RED₀, R₀ and R₁ of the general formula (A) is permissible; however, R₁ is preferable. Examples of preferable R₁'s when the base denotes a carboxylate include groups of —(CH₂)₃—COO⁻, —(CH₂)₂—COO⁻ and —CH₂—COO⁻.

The compound represented by the general formula (A) is preferably “a compound which contains a group adsorbable to (also referred to as an adsorptive group to) a silver halide in a molecule” or “a compound which contains a partial structure of a spectral sensitizing dye in a molecule” and more preferably “a compound which contains a group adsorbable to (also referred to as an adsorptive group to) a silver halide in a molecule”.

Examples of such adsorptive groups against the silver halide which the compound represented by the general formula (A) has include the same adsorptive groups as those which the compounds of the types 1 to 4 according to the invention may have and, further, a selenoxo group (—C═Se—), a telluroxo group (—C═Te—), a seleno group (—Se—), a telluro group (—Te—) and an active methine group. The terms “selenoxo group (—C═Se—)” and “telluroxo group (—C═Te—)” as used herein are intended to include Se and Te derivatives, respectively, of compound having a thione group (—C═S—) and, as explained when the thione group is explained, they may be groups having a selenoamide group (—C═Se—NH—) and telluroamide group (—C═Te—NH—), respectively. The terms “seleno group (—Se—)” and “telluro group (—Te—)” as used herein are intended to include Se and Te derivatives, respectively, of compound having a sulfide group (—S—) whereupon examples of such Se and Te derivatives include Se and Te derivatives of compounds each having a sulfide group as they are. The term “active methine group” as used herein is intended to include a methine group substituted by two electron-attractive groups whereupon examples of such electron-attractive groups include an acyl group, an alkoxycarbonyl group, an aryloxycarbonyl group, a carbamoyl group, an alkylsufonyl group, an arylsufonyl group, a sufamoyl group, a trifluoromethyl group, a cyano group, a nitro group and an imino group. On this occasion, two electron-attractive groups may be combined with each other to form a ring structure.

Examples of adsorption accelerating groups which the compounds represented by the general formula (A) may have include, preferably, a mercapto group (and a salt thereof), a thione group (—C═S—), a heterocyclic group containing at least one atom selected from the group consisting of: a nitrogen atom, a sulfur atom, a selenium atom and a tellurium atom, and a sulfide group and, more preferably, a meracpto-substituted nitrogen-containing heterocyclic group, a dimercapto-substituted heterocyclic group and a nitrogen-containing heterocyclic group having a group of —NH— capable of forming a silver imino group (>NAg) as a partial structure of a heterocycle. Preferable ranges thereof are the same as those of adsorptive groups which the compounds of the types 1 to 4 may have.

The partial structure of the compounds of spectral sensitizing dye represented by the general formula (A) may have the same partial structure of the compounds of the spectral sensitizing dyes of the types 1 to 4 may have.

Specific examples of the compounds represented by the general formula (A) are given below to illustrate the invention and should not be interpreted as limiting it in any way.

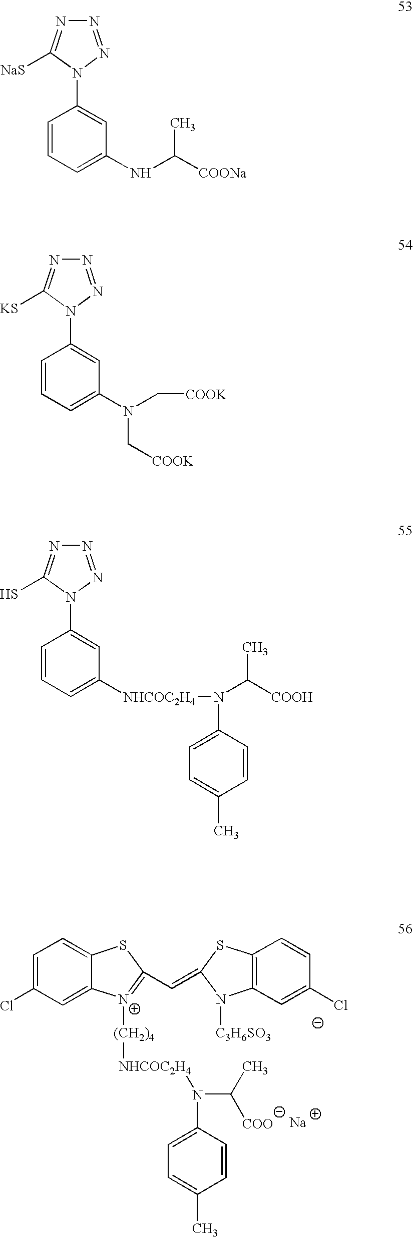

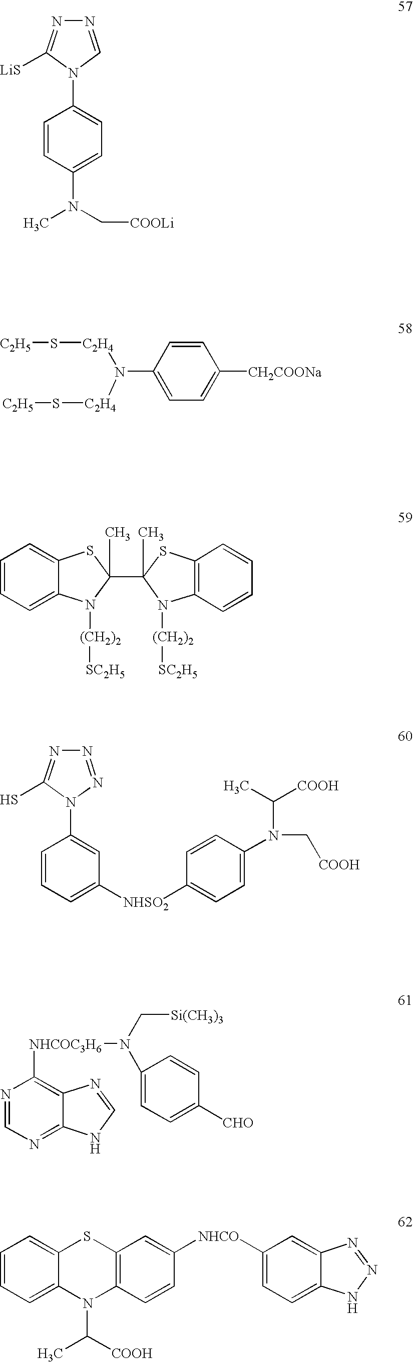

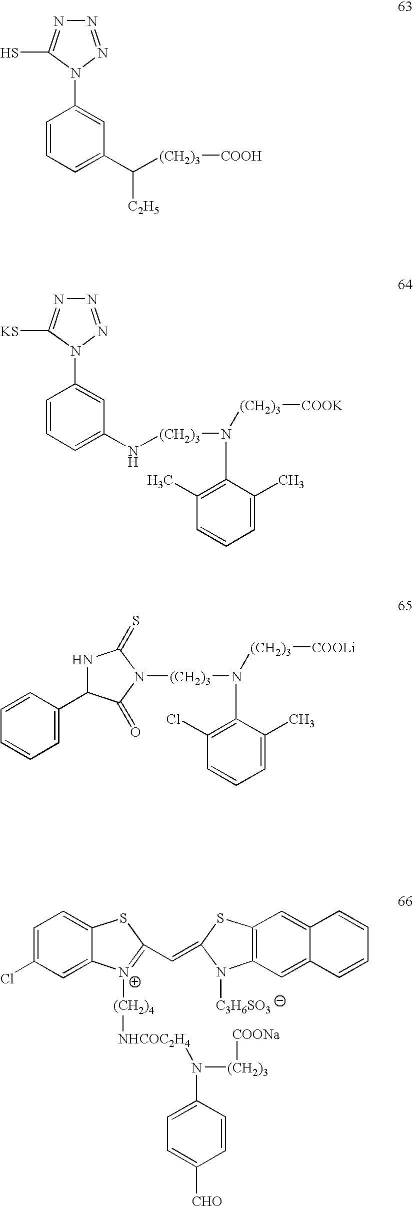

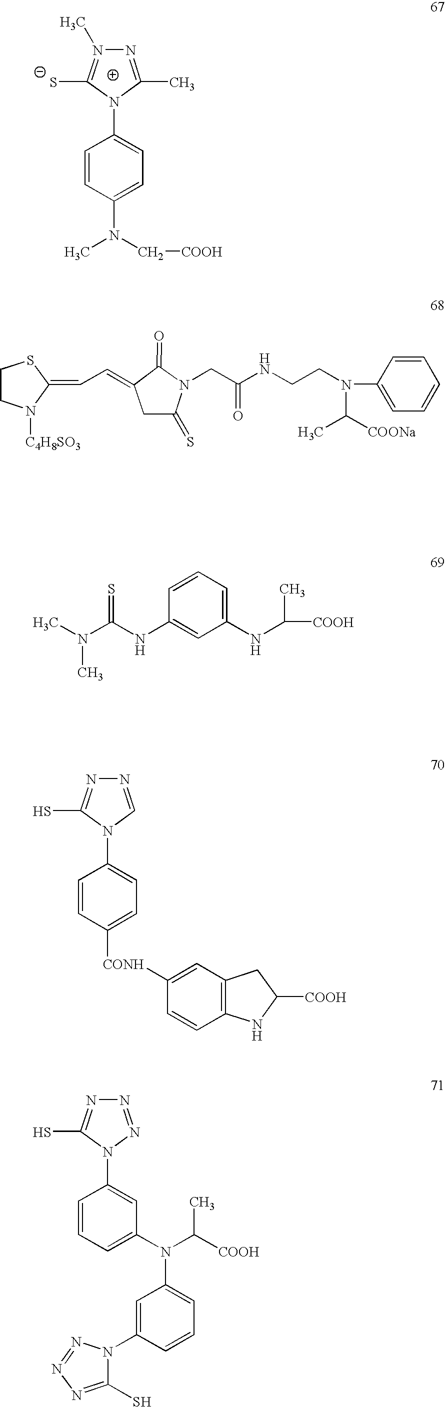

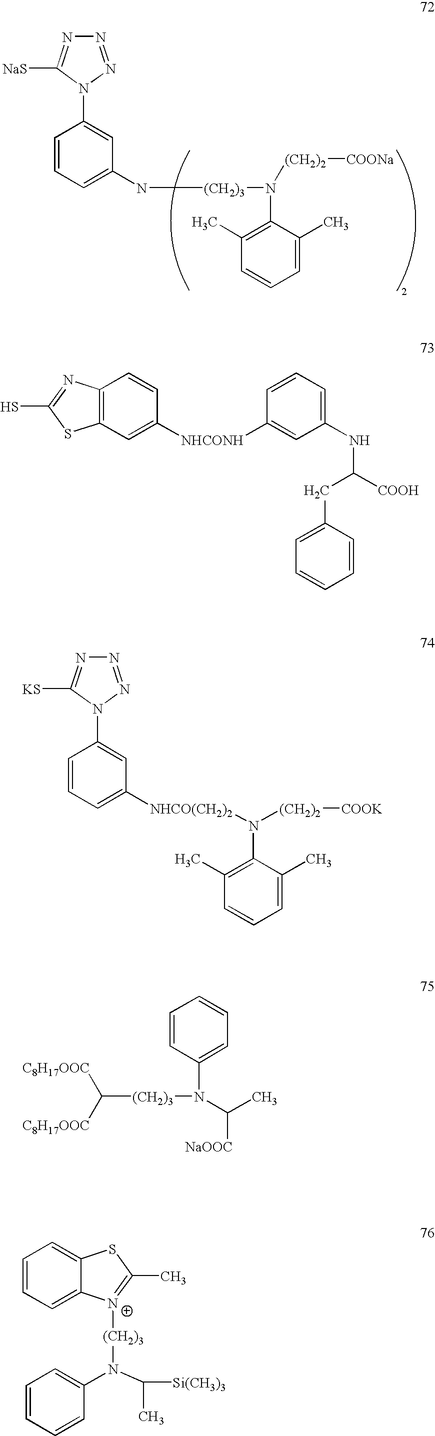

Specific examples of the compounds represented by the general formula (A) include compounds, being referred to as “one-photon-two-electron sensitizing agent” or “deprotonating electron-donating sensitizer agent” as they are, which are described, for example, in JP-A Nos. 9-211769 (compounds PMT-1 to S-37 shown in Tables E and F, pp. 28 to 32), 9-211774, 11-95355 (compounds INV 1 to 36), WO99/05570 (compounds 1 to 74, 80 to 87, and 92 to 122), U.S. Pat. Nos. 5,747,235 and 5,747,236, EP-A Nos. 786692 (compounds INV 1 to 35), 893732, U.S. Pat. Nos. 6,054,260 and 5,994,051.

The compounds of the type A or types 1 to 4 according to the invention may be used in any stage at the time when an emulsion is prepared or in a process of producing the photosensitive material. For example, mentioned are the time at which grains are formed, a desalting step, the time at which chemical sensitization is performed and the time before coating is performed. It is also possible to divide each of these compounds into a plurality of portions and add them in a plurality of times. As for a preferable position in which these compounds are each added, mentioned are a period of time from the time when formation of grains is completed till the time before the desalting step is performed, at the time in which chemical sensitization is performed (during a period of time from the time immediately before starting of chemical sensitization till the time immediately after the completion of the chemical sensitization), and before coating is performed whereupon the time at which the chemical sensitization is performed, and the time before the coating is performed are more preferable.

It is preferable that the compounds of the type A or types 1 to 4 according to the invention are dissolved in water or a water-soluble solvent such as methanol or ethanol before being added. When the compounds are dissolved in water, the compounds which can increase solubility thereof by changing a pH thereof either to a higher value or a lower value may be dissolved by changing the pH thereof either to a higher value or a lower value before being added.

It is preferable that the compounds of the type (A) or the types 1 to 4 is used in an emulsion layer; however, they are added not only to the emulsion layer but also to a protective layer or an intermediate layer and may be diffused at the time of coating. Timing of coating of each of the compounds according to the invention is permissible either before or after a sensitizing dye is added and the each compound is allowed to be contained in a silver halide emulsion layer preferably in the range of from 1×10⁻⁹ mol to 5×10⁻² mol, and more preferably in the range of from 1×10⁻⁸ mol to 2×10⁻³ mol, per mol of silver halide in each case.

9) Spectral Sensitization Dyes Represented by General Formulas (D-a) to (D-d)

It is preferable that a photosensitive silver halide according to the invention is spectrally sensitized by at least one member selected from the group consisting of spectral sensitizing dyes represented by the general formulas (D-a) to (D-d).

Spectral sensitizing dyes represented by the general formulas (D-a) to (D-d) will be described in detail below.

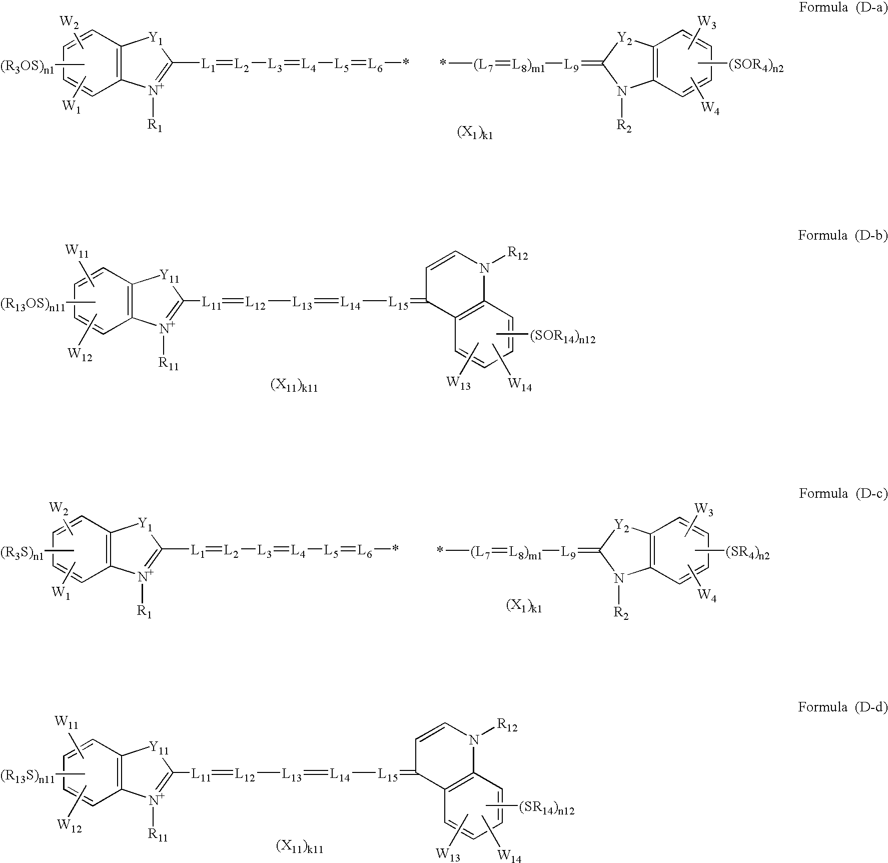

In the general formulas (D-a) to (D-d), examples of aliphatic groups represented by each of R₁, R₂, R₁₁, and R₁₂ include branched- or straight-chain alkyl groups each having from 1 to 10 carbon atoms (e.g., a methyl group, an ethyl group, a propyl group, a butyl group, a pentyl group, an isopentyl group, a 2-ethyl-hexyl group, an octyl group and a decyl group), alkenyl groups each having from 3 to 10 carbon atoms (e.g., a 2-propenyl group, a 3-butenyl group, a 1-methyl-3-propenyl group, a 3-pentenyl group, a 1-methyl-3-butenyl group and a 4-hexenyl group), and aralkyl groups each having from 7 to 10 carbon atoms (e.g., a benzyl group and a phenethyl group). These groups may each be further substituted by a group selected from the group consisting of: a lower alkyl group (e.g., a methyl group, an ethyl group or a propyl group), a halogen atom (e.g., a fluorine atom, a chlorine atom or a bromine atom), a vinyl group, an aryl group (e.g., a phenyl group, a p-tolyl group or a p-bromophenyl group), a trifluoromethyl group, an alkoxy group (e.g., a methoxy group, an ethoxy group or a methoxyethoxy group), an aryloxy group (e.g., a phenoxy group or a p-tolyloxy group), a cyano group, a sulfonyl group (e.g., a methane sulfonyl group, a trifluoromethane sulfonyl group or a p-toluene sulfonyl group), an alkoxycarbonyl group (e.g., an ethoxycarbonyl group or a butoxycarbonyl group), an amino group (e.g., an amino group or a biscarboxymethylamino group), an aryl group (e.g., a phenyl group or a carboxyphenyl group), a heterocyclic group (e.g., a tetrahydrofurfuryl group or a 2-pyrrolidinone-1-yl group), an acyl group (e.g., an acetyl group or a benzoyl group), a ureido group (e.g., a ureido group, a 3-methylureido group or a 3-phenylureido group), a thioureido group (e.g., a thioureido group or a 3-methylthioureido group), an alkylthio group (e.g., a methylthio group or an ethylthio group), an arylthio group (e.g., a phenylthio group), a heterocyclic thio group (e.g., a 2-thienylthio group, a 3-thienylthio group or a 2-imidazolylthio group), a carbonyloxy group (e.g., an acetyloxy group, a propanoyloxy group or a benzoyloxy group), an acylamino group (e.g., an acetylamino group or a benzoylamino group), a thioamide group (e.g., a thioacetamide group or a thiobenzoylamino group) and the like, or by a hydrophilic group selected from the group consisting of: a sulfo group, a carboxyl group, a phosphono group, a sulfato group, a hydroxyl group, a mercapto group, a sulfino group, a carbamoyl group (e.g., a carbamoyl group, an N-methyl carbamoyl group or an N,N-tetramethylene carbamoyl group), a sufamoyl group (e.g., a sulfamoyl group, an N,N-3-oxapentamethylene aminosulfonyl group), a sulfonamide group (e.g., a methane sulfonamide or a butane sulfonamide), a sulfonylaminocarbonyl group (e.g., a methane sulfonylaminocarbonyl group or an ethane sulfonylaminocarbonyl group), an acylaminosulfonyl group (e.g., an acetamide sulfonyl group or a methoxyacetamide sulfonyl group), an acylaminocarbonyl group (e.g., an acetamide carbonyl group or a methoxyacetamide carbonyl group), a sulfinylaminocarbonyl group (e.g., a methane sulfinylaminocarbonyl group or an ethane sulfinylaminocarbonyl group) and the like.

Examples of aliphatic groups each substituted by any one of these hydrophilic groups include a carboxymethyl group, a carboxyethyl group, a carboxybutyl group, a carboxypentyl group, a 3-sulfatobutyl group, a 3-sulfopropyl group, a 2-hydroxy-3-sulfopropyl group, a 4-sulfobutyl group, a 5-sulfopentyl group, a 3-sulfopentyl group, a 3-sulfinobutyl group, a 3-phosphonopropyl group, a hydroxyethyl group, an N-methane sulfonylcarbamoylmethyl group, a 2-carboxy-2-propenyl group, an o-sulfobenzyl group, a p-sulfophenethyl group and a p-carboxybenzyl group.

Examples of lower alkyl groups represented by each of R₃, R₄, R₁₃ and R₁₄ include a straight- or branched-chain alkyl groups each having 5 or less carbon atoms whereupon specific examples thereof include a methyl group, an ethyl group, a propyl group, a butyl group, a pentyl group and an isopropyl group. Examples of cycloalkyl groups include a cyclopropyl group, a cyclobutyl group and a cyclopentyl group. Examples of alkenyl groups include a 2-propenyl group, a 3-butenyl group, a 1-methyl-3-propenyl group, a 3-pentenyl group, a 1-methyl-3-butenyl group and 4-hexenyl group. Examples of aralkyl groups include a benzyl group, a phenethyl group, a p-methoxyphenylmethyl group and an o-acetylaminophenylethyl group. Aryl groups include substituted or non-substituted ones whereupon examples of the aryl groups include a phenethyl group, a 2-naphthyl group, a 1-naphthyl group, an o-tolyl group, o-methoxyphenyl group, an m-chlorophenyl group, an m-bromophenyl group, a p-tolyl group and a p-ethoxyphenyl group. Heterocyclic groups include substituted or non-substituted ones whereupon examples of the hererocyclic groups include a 2-furyl group, a 5-methyl-2-furyl group, a 2-thienyl group, a 3-thienyl group, a 2-imidazolyl group, a 2-methyl-l-imidazolyl group, a 4-phenyl-2-thiazolyl group, a 5-hydroxy-2-benzothiazolyl group, a 2-pyridyl group and a 1-pyrrolyl group.

These groups may each be substituted by one group selected from the group consisting of: a lower alkyl group (e.g., a methyl group or an ethyl group), a lower alkoxy group (e.g., a methoxy group or an ethoxy group), a hydroxyl group, a halogen atom (e.g., a fluorine atom, a chlorine atom, a bromine atom or a iodine atom), an aryl group (e.g., a phenyl group, a tolyl group or a chlorophenyl group), a mercapto group, a lower alkylthio group (e.g., a methylthio group or an ethylthio group).

Specific examples of substituents represented by each of W₁ to W₄, and W₁₁, to W₁₄ include an alkyl group (e.g., a methyl group, an ethyl group, a butyl group or an isobutyl group), an aryl group (inclusive of those of a single ring and multiple rings; such as a phenyl group or a naphthyl group), a heterocyclic group (e.g., a thienyl group, a furyl group, a pyridyl group, a carbazolyl group, a pyrrolyl group or an indolyl group), a halogen atom (e.g., a fluorine atom, a chlorine atom or a bromine atom), a vinyl group, an aryl group (e.g., a phenyl group, a p-tolyl group or a p-bromophenyl group), trifluoromethyl group, an alkoxy group (e.g., a methoxy group, an ethoxy group or a methoxyethoxy group), an aryloxy group (e.g., a phenoxy group or a p-tolyloxy group), a sulfonyl group (e.g., a methane sulfonyl group or a p-toluene sulfonyl group), an alkoxy carbonyl group (e.g., ethoxycarbonyl group or a butoxycarbonyl group), an amino group (e.g., an amino group or a biscarboxymethylamino group), an aryl group (e.g., a phenyl group or a carboxyphenyl group), a heterocyclic group (e.g., a tetrahydrofurfuryl group or a 2-pyrrolidinone-1-yl group), an acyl group (e.g., an acetyl group or a benzoyl group), a ureido group (e.g., a ureido group, a 3-methylureido group or a 3-phenylureido group), a thioureido group (e.g., a thioureido group or a 3-methyl thioureido group), an alkylthio group (e.g., a methylthio group or an ethylthio group), an arylthio group (e.g., a phenylthio group), a hydroxyl group and a styryl group.

These groups may be substituted by any one of the groups which are mentioned as examples when the aliphatic groups represented by R₁ and the like are explained whereupon specific examples of such substituted alkyl groups include a 2-methoxyethyl group, a 2-hydroxyethyl group, a 3-ethoxycarbonylpropyl group, a 2-carbamoylethyl group, a 2-methane sulfonylethyl group, a 3-methane sulfonylaminopropyl group, a benzyl group, a phenethyl group, a carboxymethyl group, a carboxyethyl group, an allyl group and a 2-furylethyl group; specific examples of such substituted aryl groups include a p-carboxyphenyl group, a p-N,N-dimethylaminophenyl group, a p-morpholinophenyl group, a p-methoxyphenyl group, a 3,4-dimethoxyphenyl group, a 3,4-methylene dioxyphenyl group, a 3-chlorophenyl group and a p-nitrophenyl group; and specific examples of substituted heterocyclic groups include a 5-chloro-2-pyridyl group, a 5-ethoxycarbonyl-2-pyridyl group and a 5-carbamoyl-2-pyridyl group.

Examples of condensed rings which may be formed by allowing W₁ and W₂, W₃ and W₄, W₁₁, and W₁₂, W₁₃ and W₁₄, R₃ and W₁, R₃and W₂, R₁₃ and W₁₁, R₁₃ and W_{12,} R₄ and W₃, R₄ and W₄, R₁₄ and W₁₃, and R₁₄ and W₁₄ to be combined with each other within each combination include 5- or 6-membered saturated or unsaturated condensed carbon rings. These condensed rings can be substituted at an arbitrary position thereof whereupon examples of groups for use in such substitution include groups which were mentioned as examples of groups which were able to substitute the aliphatic groups.

In the general formulas (D-a) to (D-d), methine groups represented by each of L₁ to L₉, and L₁₁, to L₁₅ each independently denote a substituted or non-substituted methine group. Specific examples of such substituted groups include a substituted or non-substituted lower alkyl group (such as a methyl group, an ethyl group, an isopropyl group or a benzyl group), an alkoxy group (such as a methoxy group or an ethoxy group), an aryloxy group (such as a phenoxy group or a naphthoxy group), an aryl group (such as a phenyl group, a naphthyl group, a p-tolyl group, an o-carboxyphenyl group), —N(V₁, V₂), —SR and a heterocyclic group (such as a 2-thienyl group, a 2-furyl group and an N,N′-bis(methoxyethyl)barbituric acid group, wherein R represents at least one group selected from the group consisting of: a lower alkyl group as described above, an aryl group and a heterocyclic group; and V₁ and V₂ each independently represent a substituted or non-substituted lower alkyl group or aryl group, wherein V₁ and V₂ may be combined with each other to form a 5- or 6-membered nitrogen-containing heterocycle. Further, methine groups which are adjacent to each other or have another group in between may be combined with one another to form a 5- or 6-membered ring.

When the compounds represented by the general formulas (D-a) to (D-d) are each individually substituted by a group having an electric charge of cation or anion, a counter ion of anion or cation having an equivalent electric charge is formed such that an electric charge in a molecule is cancelled. In ions necessary for canceling an electric charge in a molecule exhibited in each of X₁ and X₁₁, examples of cations include a proton, an organic ammonium ion (such as a triethylammonium ion or a triethanolammonium ion) and an inorganic cation (such as each ion of lithium, sodium and potassium); and examples of acid anions include a halogen ion (such as a chlorine ion, a bromine ion or an iodine ion), a p-toluene sulfonic acid ion, a perchloric acid ion, a 4-fluoroboron ion, a sulfuric acid ion, a methyl sulfuric acid ion, an ethyl sulfuric acid ion, a methane sulfonic acid ion and a trifluoromethane sulfonic acid ion. Specific examples of the photosensitive dyes represented by the general formulas (D-a) to (D-d) are given below to illustrate the invention and should not be interpreted as limiting it in any way.

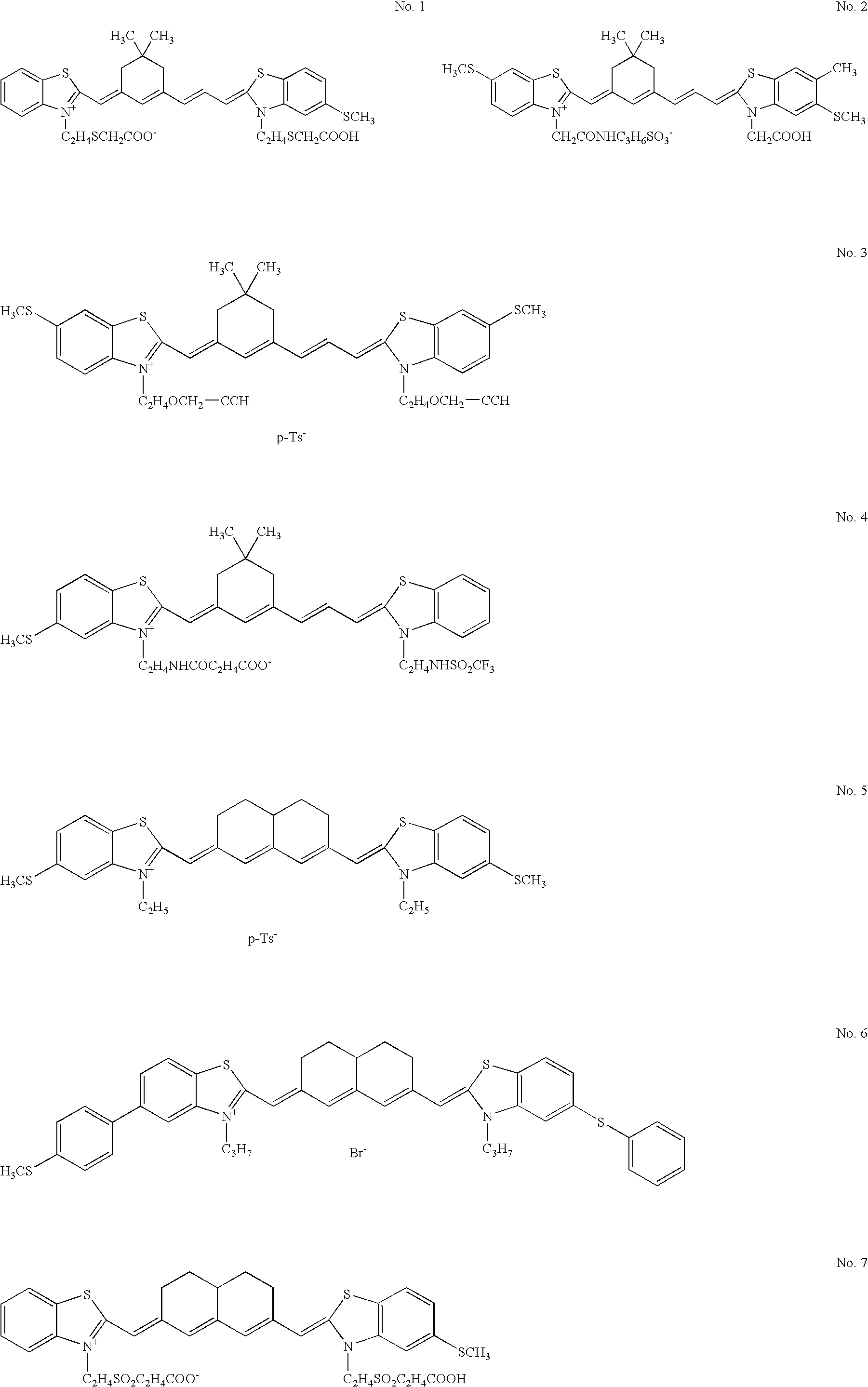

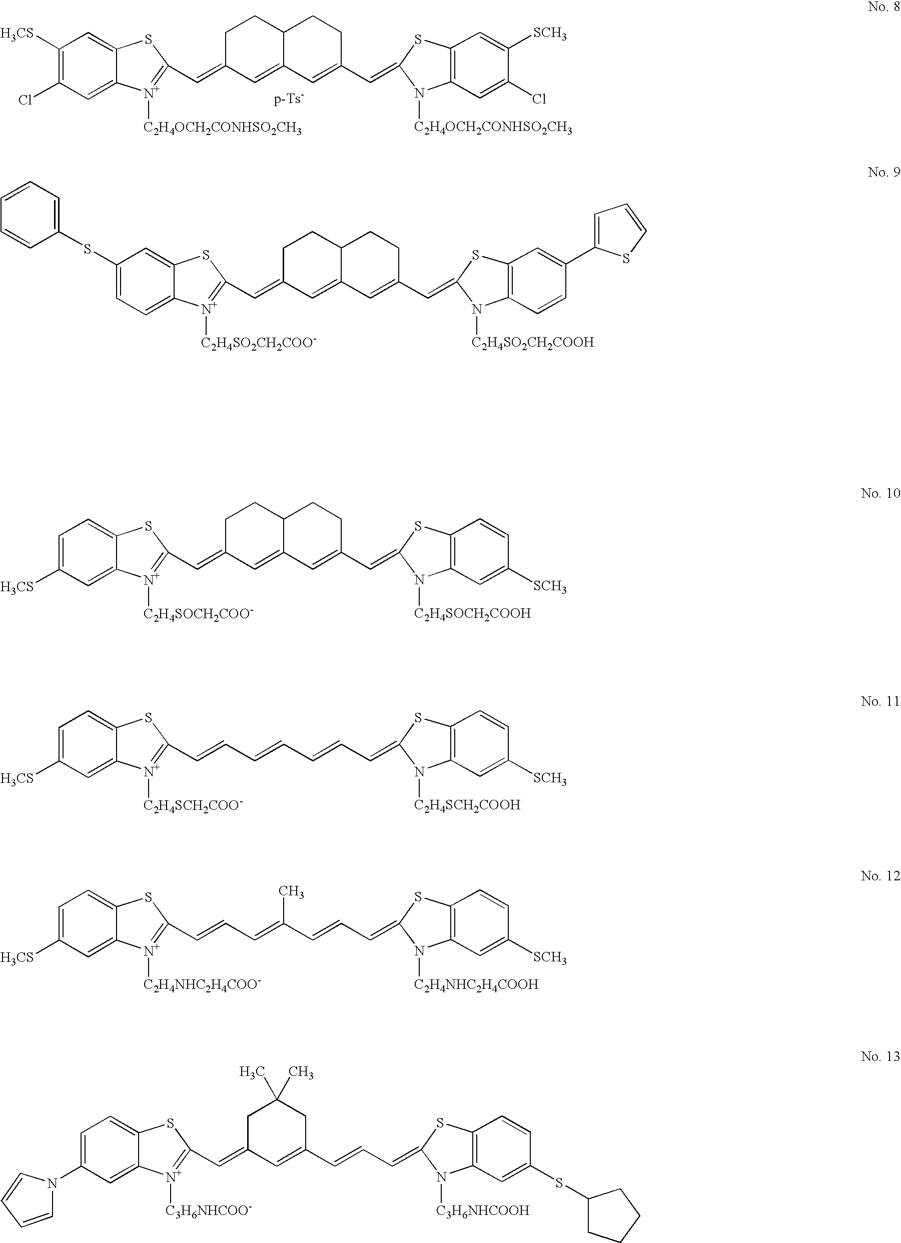

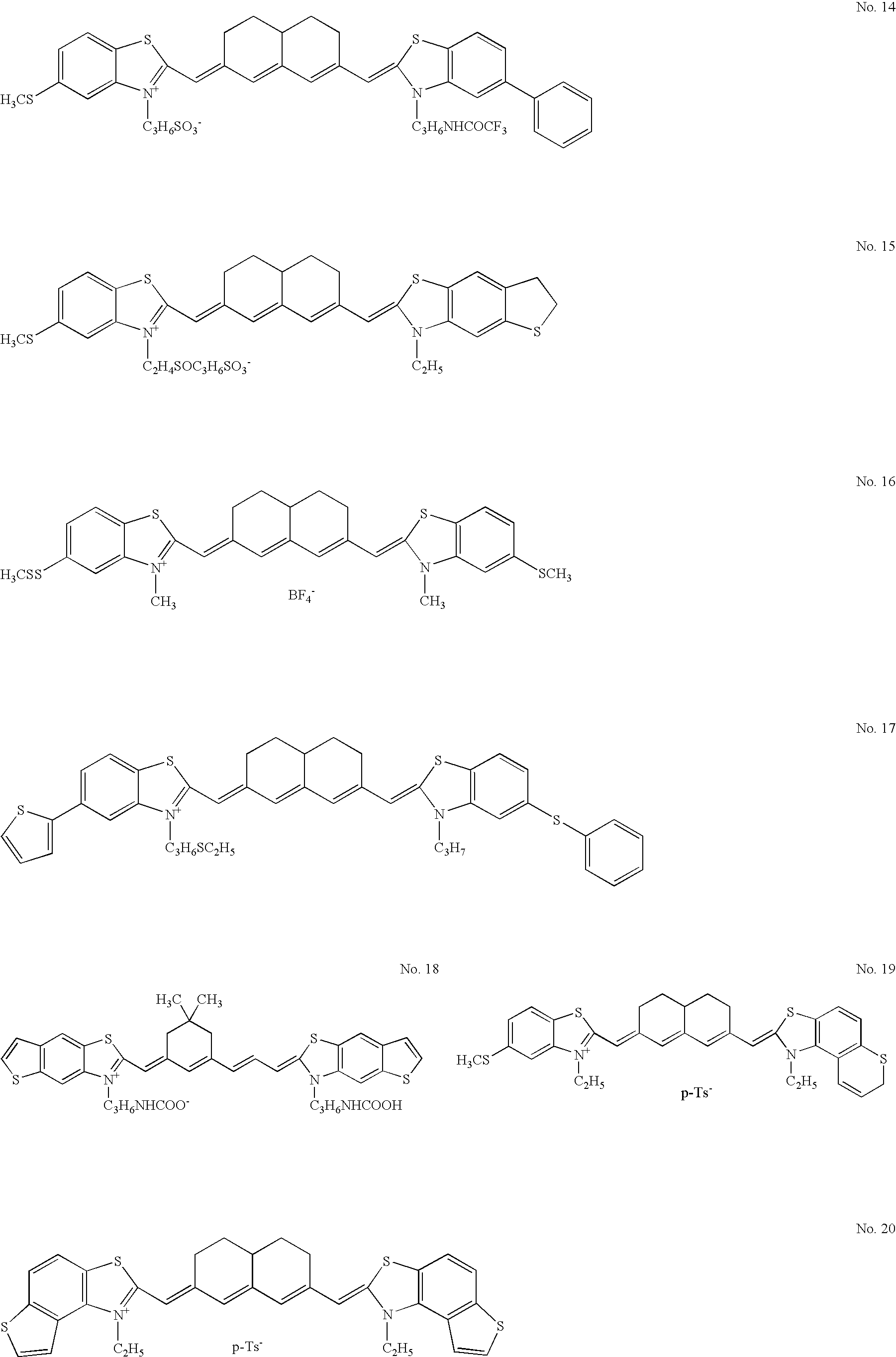

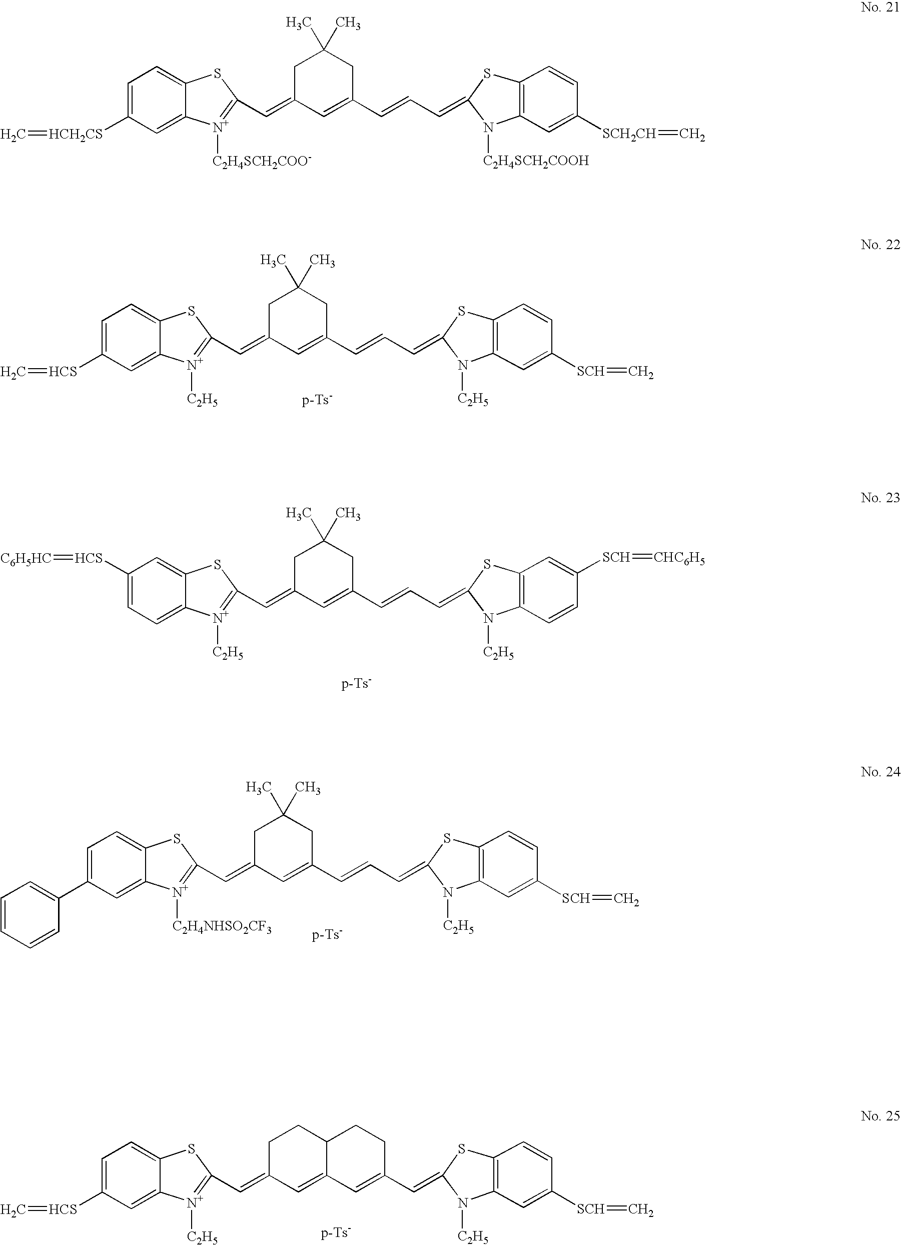

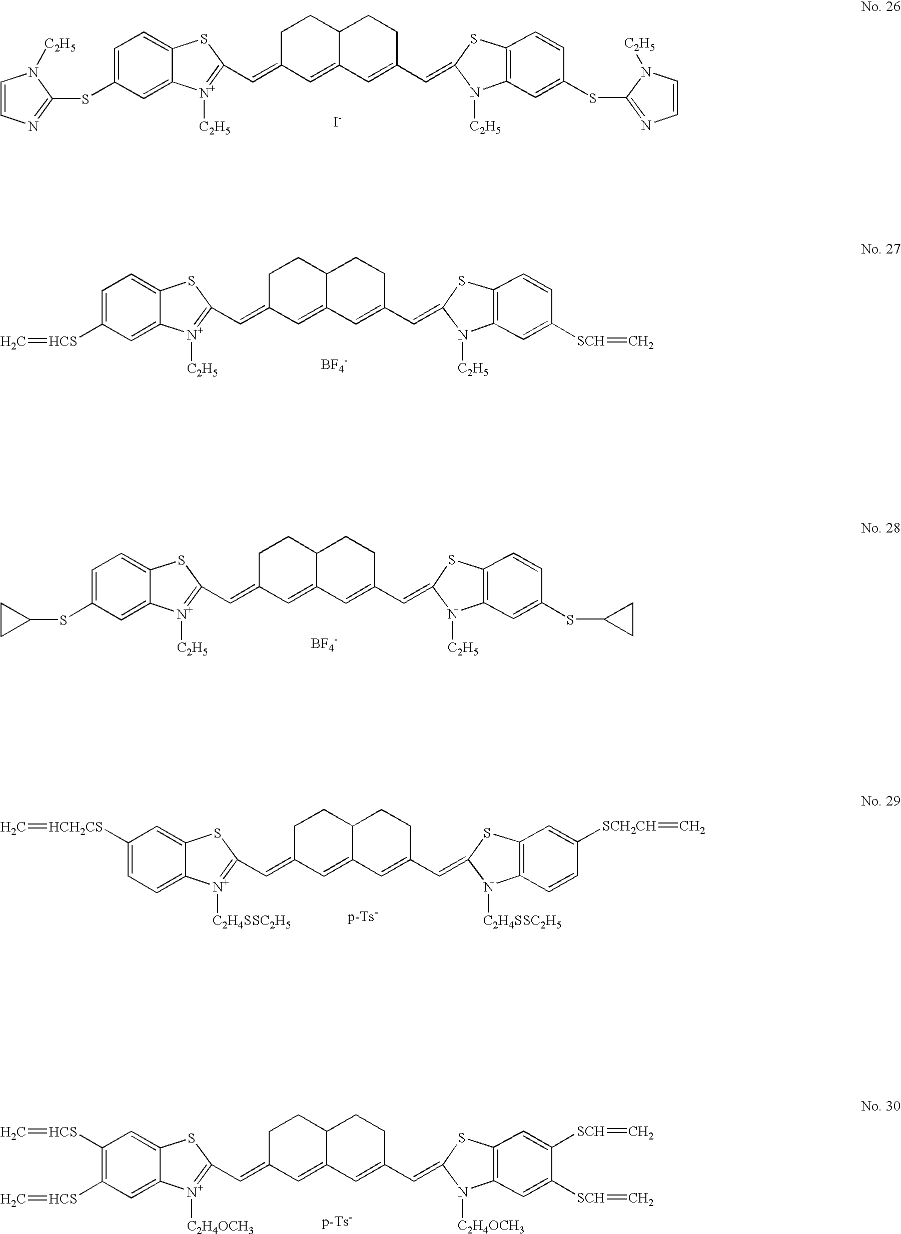

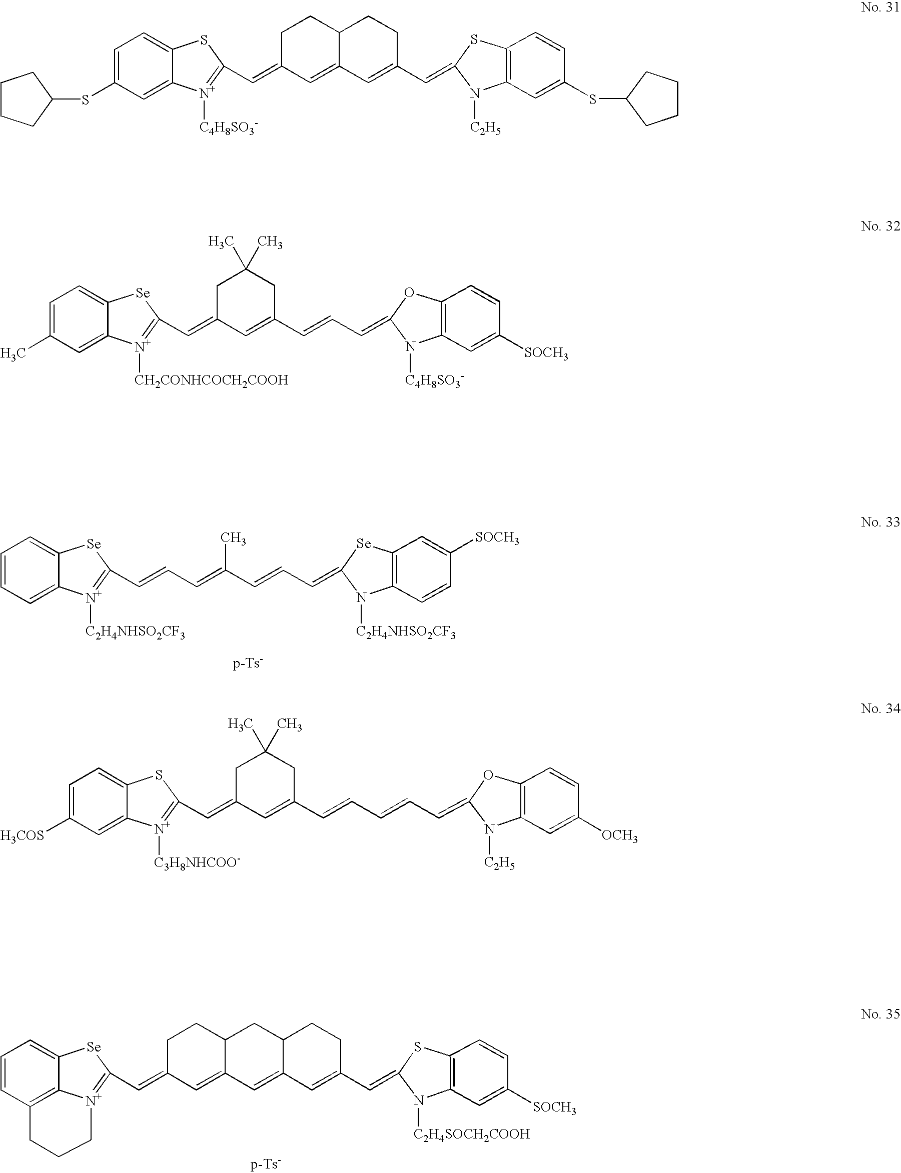

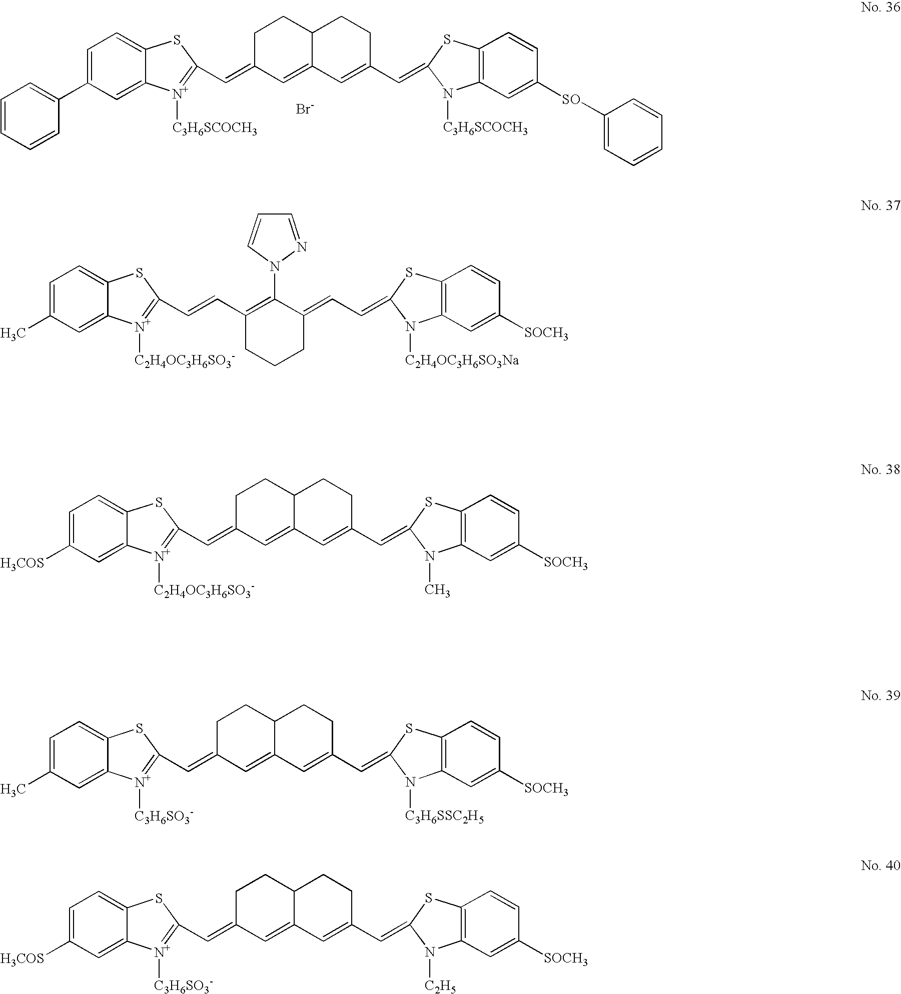

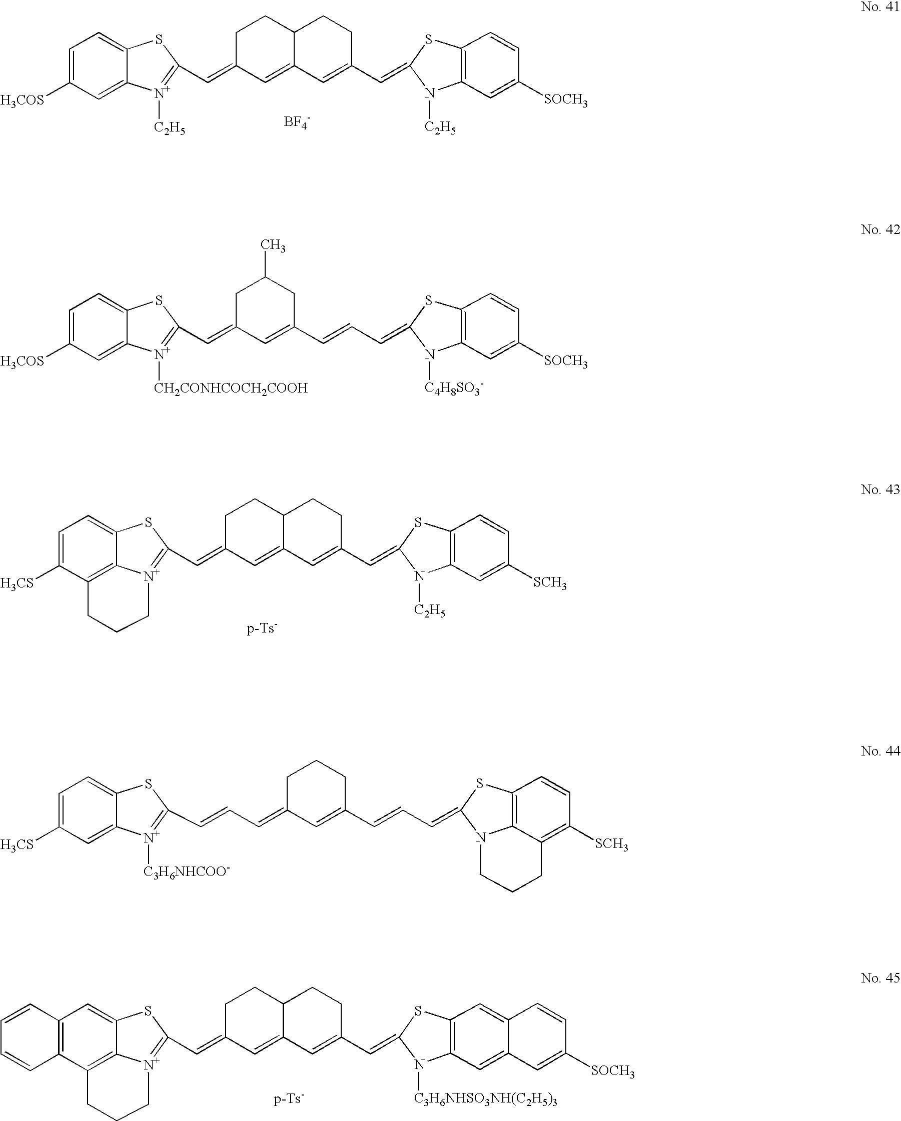

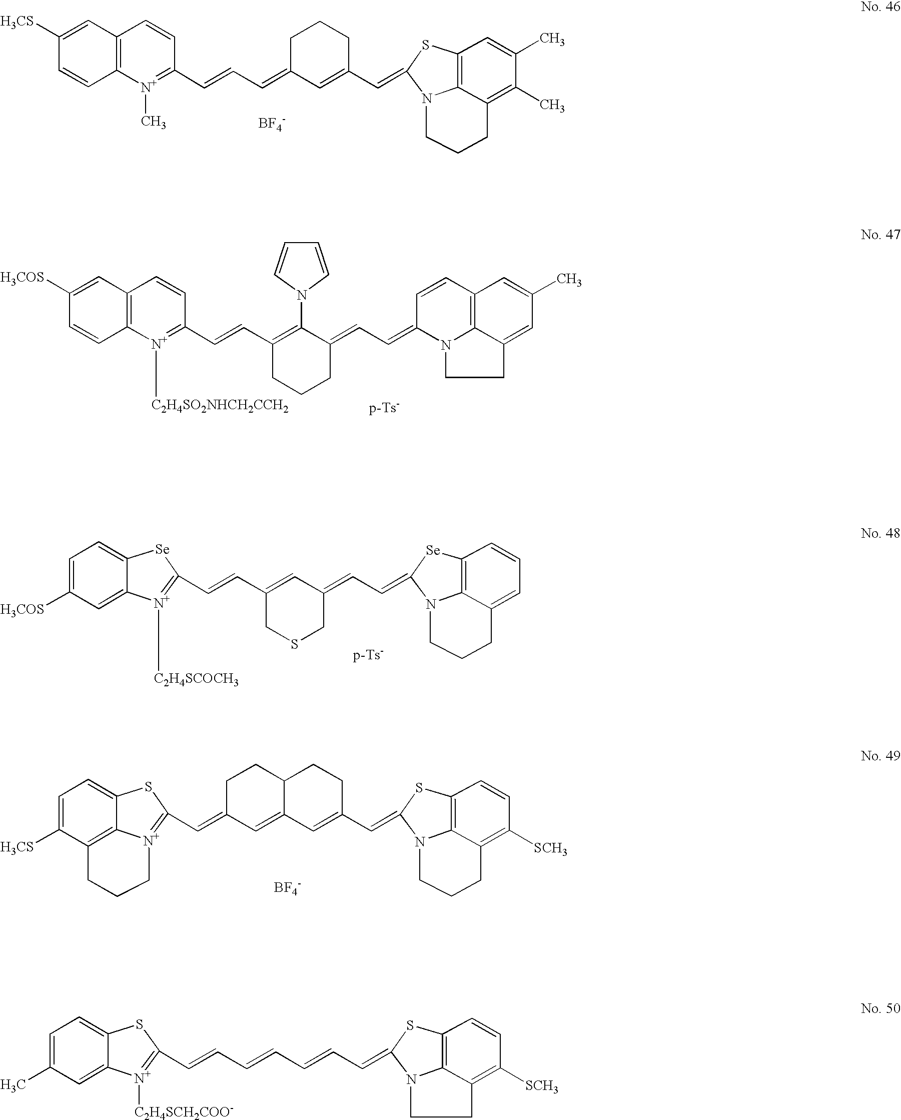

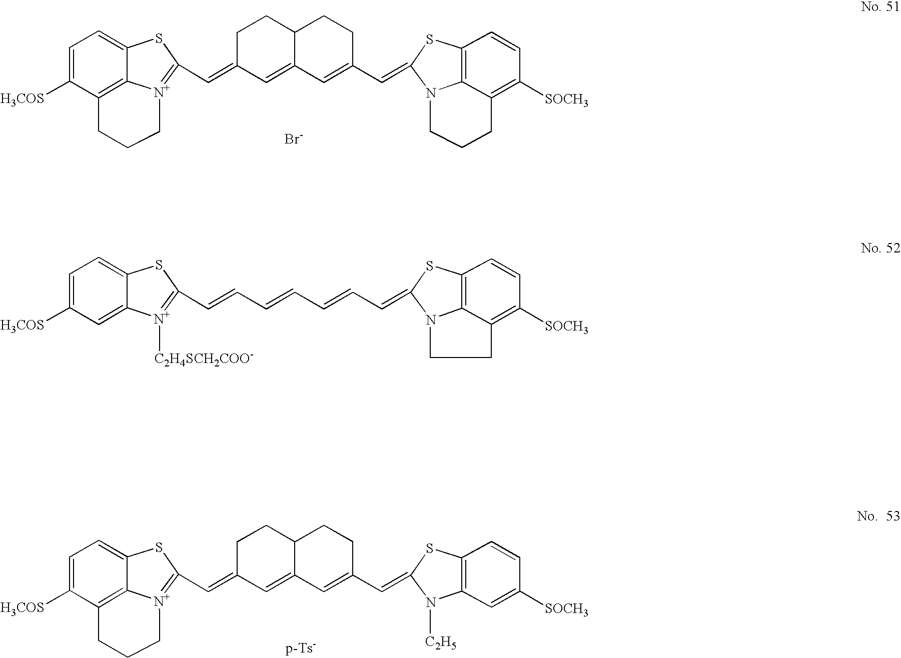

The infrared photosensitive dyes represented by the general formulas (D-a) to (D-d) according to the invention may be synthesized by a method described, for example, in F. M. Hamer, “The Chemistry of Heterocyclic Compounds”, Vol. 18, “The Cyanine Dyes and Related Compounds”, A. Weissberger ed., Interscience, New York, (1964), JP-A Nos. 3-138638 and 10-73900, WO95/23355, U.S. Pat. No. 2,734,900, BP No. 774779, Japanese Patent Application Nos. 10-269843 and 11-58686.

The infrared photosensitive dyes represented by the general formulas (D-a) to (D-d) according to the invention may be used either each individually or in combination thereof. When the infrared photosensitive dyes are used either each individually or in combination thereof, a quantity of the infrared photosensitive dye or a total quantity of the infrared photosensitive dyes to be contained in a silver halide emulsion is in the range of from 1×10⁻⁶ mol to 5×10⁻³ mol, preferably in the range of from 1×10⁻⁵ mol to 2.5×10⁻³ mol, and more preferably in the range of from 4×10⁻⁵ mol to 1×10⁻³ mol, per mol of silver halide in each case. When two or more types of the photosensitive dyes are used in combination according to the invention, those photosensitive dyes are contained in the silver halide emulsion at an arbitrary ratio.

Sensitizing dyes and addition methods thereof are described in paragraphs 0103 to 0109 in JP-A No. 11-65021, in terms of compounds represented by the general formula (II) in JP-A No. 10-186572, in terms of dyes represented by the general formula (I) in JP-A No. 11-119374 and in paragraph 0106 therein, in U.S. Pat. No. 5,510,236, in terms of dyes mentioned in Example 5 in U.S. Pat. No. 3,871,887, in JP-A No. 2-96131, in terms of dyes disclosed in JP-A No. 59-48753, in from 1. 38, p. 19 to 1. 35, p. 20 in EP-A No. 0803764, in Japanese Patent Application Nos. 2000-86865, 2000-102560, 2000-205399 and the like. These sensitizing dyes may be used either each individually or in combination of two or more species thereof. Timing of adding any one of the sensitizing dyes to the silver halide emulsion according to the invention is preferably during a period of time from the end of a desalting step till the start of a coating step and more preferably during a period of time from the time when desalting is completed till the time when chemical ripening is completed.

10) Simultaneous Usage of a Plurality of Silver Halides

As for the photosensitive silver halide emulsion in the photosensitive material according to the invention, one type thereof may be used alone or two or more types thereof (different in average grain sizes, halogen compositions, crystal habits, or conditions of chemical sensitization from one another) may be used in combination. By simultaneously using a plurality of photosensitive silver halides different in sensitivity, gradation can be adjusted. Techniques relating thereto are described, for example, in JP-A Nos. 57-119341, 53-106125, 47-3929, 48-55730, 46-5187, 50-73627 and 57-150841. A sensitivity difference between any two of such emulsions is preferably 0.2 logE or more.

11) Coating Amount

An amount of the photosensitive silver halide to be added is, in terms of a coating silver quantity per m² of the photosensitive material, preferably from 0.03 g/m² to 0.6 g/m², more preferably from 0.05 g/m² to 0.4 g/m², and most preferably from 0.07 g/m² to 0.3 g/m² and, per mol of an organic silver salt, preferably from 0.01 mol to 0.5 mol, more preferably from 0.02 mol to 0.3 mol, and still more preferably from 0.03 mol to 0.2 mol.

12) Method for Mixing Photosensitive Silver Halide and Organic Silver Salt

Regarding a method and a condition for admixing the photosensitive silver halide and an organic silver salt which have separately been prepared, there are provided a method in which the thus prepared silver halide grains and the organic silver salt are mixed using one device selected from the group consisting of: a high-speed stirrer, a ball mill, a sand mill, a colloid mill, a shaking mill and a homogenizer, a method in which the photosensitive silver halide thus prepared is added to an organic silver salt at any desired timing while the organic silver salt is being prepared to prepare a final organic silver salt, or the like; however, the method and condition are not limited to any specific type, so long as an effect according to the invention can sufficiently be exerted. Further, mixing two or more types of aqueous dispersions of organic silver salts and two or more types of aqueous dispersions of photosensitive silver salts is an advantageous method for adjusting photographic characteristics.

A preferable timing at which the silver halide is added to a coating solution for an image-forming layer may be during a period of time from 180 minutes before coating is applied till immediately before the coating is completed, and preferably during a period of time from 60 minutes before the coating is applied till 10 seconds before the coating is completed; however, a method and a condition of such an addition is not particularly limited, so far as an effect according to the invention can be exerted. Specific mixing methods include, for example, a method of mixing in a tank such that an average dwelling time, as calculated from an adding flow rate and a supplying flow rate to a coater, is allowed to be within a predetermined duration, or a method of using a static mixer or the like described, for example, by N. Harnby, M. F. Edwards & A. W. Nienow, (translated by Koji Takahashi), “Liquid Mixing Technology” Chap. 8, Nikkan Kogyo Shimbun (1989).

According to the invention, in order to enhance spectral sensitizing efficiency, a supersensitizer may be used. As for the super-sensitizers, mentioned are compounds described, for example, in EP-A No. 587,338, U.S. Pat. Nos. 3,877,943 and 4,873,184, JP-A Nos. 5-341432, 11-109547 and 10-111543.

1-11. Compounds Represented by General Formula (T)

The photothermographic material according to the invention preferably contains a compound represented by the following general formula (T):

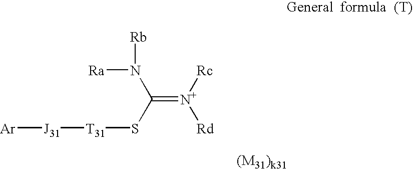

wherein Ar represents an aromatic hydrocarbon group or an aromatic heterocyclic group;

T₃₁ represents a divalent linking group containing an aliphatic hydrocarbon group or a bond;

J₃₁ represents a divalent linking group containing at least one atom selected from the group consisting of: an oxygen atom, a sulfur atom and a nitrogen atom, or a bond;

Ra, Rb, Rc and Rd each independently represent a member selected from the group consisting of: a hydrogen atom, an acyl group, an aliphatic hydrocarbon group, an aryl group and a heterocyclic group, wherein at least one pair selected from the group consisting of: a pair of Ra and Rb, a pair of Rc and Rd, a pair of Ra and Rc, and a pair of Rb and Rd may, within each pair, be combined with each other to form a nitrogen-containing heterocyclic group;

M₃₁ represents an ion necessary to balance an electric charge in a molecule; and

k₃₁ represents a number of ions necessary to balance the electric charge in the molecule.

As for such divalent linking groups each comprising the aliphatic hydrocarbon group represented by T₃₁, mentioned are a straight-chain, branched-chain, or cyclic alkylene group (having preferably from 1 to 20 carbon atoms, more preferably from 1 to 16 carbon atoms and still more preferably from 1 to 12 carbon atoms), an alkenyl group (having preferably from 2 to 20 carbon atoms, more preferably from 2 to 16 carbon atoms and still more preferably from 2 to 12 carbon atoms), and an alkynyl group (having preferably from 2 to 20 carbon atoms, more preferably from 2 to 16 carbon atoms and still more preferably from 2 to 12 carbon atoms); these groups may each have a substituent whereupon examples of such substituents of aliphatic hydrocarbon groups include a straight-chain, branched-chain or cyclic alkyl group (having preferably from 1 to 20 carbon atoms, more preferably from 1 to 16 carbon atoms and still more preferably from 1 to 12 carbon atoms), an alkenyl group (having preferably from 2 to 20 carbon atoms, more preferably from 2 to 16 carbon atoms and still more preferably from 2 to 12 carbon atoms), and an alkynyl group (having preferably from 2 to 20 carbon atoms, more preferably from 2 to 16 carbon atoms and still more preferably from 2 to 12 carbon atoms); examples of such substituents of aryl groups include an aryl group of a single ring or condensed ring having from 6 to 20 carbon atoms (such as a phenyl group and a naphthyl group, the phenyl group being preferable therebetween); and examples of such substituents of heterocyclic groups, include a 3- to 10-membered saturated or unsaturated heterocyclic group (such as a 2-thiazolyl group, a 1-piperazinyl group, a 2-pyridyl group, a 3-pyridyl group, a 2-furyl group, a 2-thienyl group, a 2-benzimidazolyl group or a carbazolyl group), wherein a heterocycle in these groups may be of a single ring or a condensed ring formed together with another ring. These groups may each have a substituent at an arbitrary position whereupon examples of such substituents include an alkyl group (inclusive of a cycloalkyl group or an aralkyl group; having preferably from 1 to 20 carbon atoms, more preferably 1 to 12 carbon atoms and particularly preferably from 1 to 8 carbon atoms; such as a methyl group, an ethyl group, an n-propyl group, an isopropyl group, an n-butyl group, a tert-butyl group, an n-heptyl group, an n-octyl group, an n-decyl group, an n-undecyl, an n-hexadecyl group, a cyclopropyl group, a cyclopentyl group, a cyclohexyl group, a benzyl group or a phenethyl group), an alkenyl group (having preferably from 2 to 20 carbon atoms, more preferably from 2 to 12 carbon atoms, and particularly preferably from 2 to 8 carbon atoms; such as a vinyl group, an allyl group, a 2-butenyl group or a 3-pentenyl group), an alkynyl group (having preferably from 2 to 20 carbon atoms, more preferably from 2 to 12 carbon atoms, and particularly preferably from 2 to 8 carbon atoms; such as a propargyl group or a 3-pentynyl group), an aryl group (having preferably from 6 to 30 carbon atoms, more preferably from 6 to 20 carbon atoms, and particularly preferably from 6 to 12 carbon atoms; such as a phenyl group, a p-tolyl group, an o-aminophenyl group or a naphthyl group), an amino group (having preferably from 0 to 20 carbon atoms, more preferably from 0 to 10 carbon atoms, and particularly preferably from 0 to 6 carbon atoms; such as an amino group, a methylamino group, an ethylamino group, a dimethylamino group, a diethylamino group, a diphenylamino group or a dibenzylamino group), an imino group (having preferably from 1 to 20 carbon atoms, more preferably from 1 to 18 carbon atoms and particularly preferably from 1 to 12 carbon atoms; such as a methylimino group, an ethylimino group, a propylimino group or a phenylimino group), an alkoxy group (having preferably from 1 to 20 carbon atoms, more preferably from 1 to 12 carbon atoms, and particularly preferably from 1 to 8 carbon atoms; such as a methoxy group, an ethoxy group, a butoxy group), an aryloxy group (having preferably from 6 to 20 carbon atoms, more preferably from 6 to 16 carbon atoms, and particularly preferably from 6 to 12 carbon atoms; such as a phenyloxy group or a 2-naphthyloxy group), an acyl group (having preferably from 1 to 20 carbon atoms, more preferably from 1 to 16 carbon atoms, and particularly preferably from 1 to 12 carbon atoms; such as an acetyl group, a benzoyl group, a formyl group or a pivaloyl group), an alkoxycarbonyl group (having preferably from 2 to 20 carbon atoms, more preferably from 2 to 16 carbon atoms, and particularly preferably from 2 to 12 carbon atoms; such as a methoxycarbonyl group or an ethoxycarbonyl group), an aryloxycarbonyl group (having preferably from 7 to 20 carbon atoms, more preferably from 7 to 16 carbon atoms, and particularly preferably from 7 to 10 carbon atoms; such as a phenyloxycarbonyl group), an acyloxy group (having preferably form 1 to 20 carbon atoms, more preferably from 1 to 16 carbon atoms, and particularly preferably from 1 to 10 carbon atoms; such as an acetoxy group or a benzoyloxy group), an acylamino group (having preferably from 1 to 20 carbon atoms, more preferably from 1 to 16 carbon atoms, and particularly preferably from 1 to 10 carbon atoms; such as an acetylamino group or a benzoylamino group), an alkoxycarbonylamino group (having preferably from 2 to 20 carbon atoms, more preferably from 2 to 16 carbon atoms, and particularly preferably from 2 to 12 carbon atoms; such as a methoxycarbonylamino group), an aryloxycarbonylamino group (having preferably from 7 to 20 carbon atoms, more preferably from 7 to 16 carbon atoms, and particularly preferably from 7 to 12 carbon atoms; such as a phenyloxycarbonylamino group), a sulfonylamino group (having preferably from 1 to 20 carbon atoms, more preferably from 1 to 16 carbon atoms, and particularly preferably from 1 to 12 carbon atoms; such as a methane sulfonylamino group or a benzene sulfonylamino group), a sulfamoyl group (having preferably from 0 to 20 carbon atoms, more preferably from 0 to 16 carbon atoms, and particularly preferably from 0 to 12 carbon atoms; such as a sulfamoyl group, a methylsulfamoyl group, a dimethylsulfamoyl group or a phenylsulfamoyl group), a carbamoyl group (having preferably from 1 to 20 carbon atoms, more preferably from 1 to 16 carbon atoms, and particularly preferably from 1 to 12 carbon atoms; such as a carbamoyl group, a methylcarbamoyl group, a diethylcarbamoyl group, a phenylcarbamoyl group), an alkylthio group (having preferably from 1 to 20 carbon atoms, more preferably from 1 to 16 carbon atoms, and particularly preferably from 1 to 12 carbon atoms; such as a methylthio group or an ethylthio group), an arylthio group (having preferably from 6 to 20 carbon atoms, more preferably from 6 to 16 carbon atoms and particularly preferably from 6 to 12 carbon atoms; such as a phenylthio group), a sulfonyl group (having preferably from 1 to 20 carbon atom, more preferably from 1 to 16 carbon atoms, and particularly preferably from 1 to 12 carbon atoms; such as a methane sulfonyl group or a tosyl group), a sulfinyl group (having preferably from 1 to 20 carbon atoms, more preferably from 1 to 16 carbon atoms, and particularly preferably from 1 to 12 carbon atoms; such as a methane sulfinyl group or a benzene sulfinyl group), an ureido group (having preferably from 1 to 20 carbon atoms, more preferably from 1 to 16 carbon atoms, and particularly preferably from 1 to 12 carbon atoms; such as an ureido group, a methylureido group or a phenylureido group), a phosphoric acid amide group (having preferably from 1 to 20 carbon atoms, more preferably from 1 to 16 carbon atoms, and particularly preferably from 1 to 12 carbon atoms; such as a diethylphosphoric acid amide or a phenylphosphoric acid amide group), a hydroxyl group, a mercapto group, a halogen atom (such as a fluorine atom, a chlorine atom, a bromine atom or an iodine atom), a cyano group, a sulfo group, a sulfino group, a carboxyl group, a phosphono group, a phosphino group, a nitro group, a hydroxamic acid group, a hydrazino group, and a heterocyclic group (such as an imidazolyl group, a benzimidazolyl group, a thiazolyl group, a benzothiazolyl group, a carbazolyl group, a pyridyl group, a furyl group, a piperidyl group or a morpholino group).

Among these groups, groups such as a hydroxyl group, a mercapto group, a sulfo group, a sulfino group, a carboxylic group, a phosphono group and a phosphino group which can each form a salt may be salts thereof. These substituents may further be substituted by other substituents. When two or more of such other substituents are present, such other substituents may be the same or different from one another. Examples of such other substituents include preferably an alkyl group, an aralkyl group, an alkoxy group, an aryl group, an alkylthio group, an acyl group, an acylamino group, an imino group, a sufamoyl group, a sulfonyl group, a sulfonylamino group, an ureido group, an amino group, a halogen atom, a nitro group, a heterocyclic group, an alkoxycarbonyl group, a hydroxyl group, a sulfo group, a carbamoyl group and a carboxylic group, more preferably an alkyl group, an alkoxy group, an aryl group, an alkylthio group, an acyl group, an acylamino group, an imino group, a sulfonylamino group, a ureido group, an amino group, a halogen atom, a nitro group, a heterocyclic group, an alkoxycarbonyl group, a hydroxyl group, a sulfo group, a carbamoyl group and a carboxylic group, and still more preferably an alkyl group, an alkoxy group, an aryl group, an alkylthio group, an acylamino group, an imino group, an ureido group, an amino group, a heterocyclic group, an alkoxycarbonyl group, a hydroxyl group, a sulfo group, a carbamoyl group and a carboxylic group. An amidino group may contain a substituent whereupon examples of such substituents include an alkyl group (such as a methyl group, an ethyl group, a pyridyl methyl group, a benzyl group, a phenethyl group, a carboxybenzyl group or an aminophenylmethyl group), an aryl group (such as a phenyl group, a p-tolyl g group, a naphthyl group, an o-aminophenyl group or an o-methoxyphenyl group), a heterocyclic group (such as a 2-thiazolyl group, a 2-pyridyl group, a 3-pyridyl group, a 2-furyl group, a 3-furyl group, a 2-thieno group, a 2-imidazolyl group, a benzothiazolyl group or a carbazolyl group).

Examples of divalent linking groups, each containing at least one atom selected from the group consisting of: an oxygen atom, a sulfur atom and a nitrogen atom, represented by J₃₁ include groups described below. These groups may be used in combination.

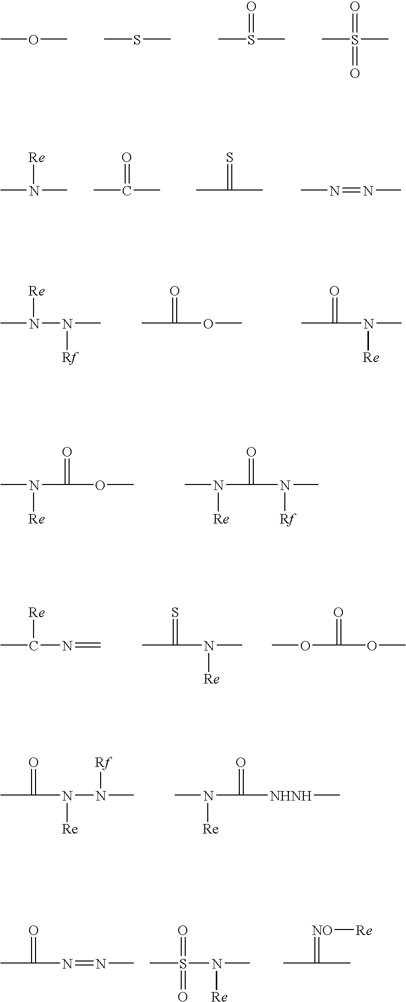

In the above-described groups, Re and Rf have definitions equivalent to those described in Ra through Rd.

An aromatic hydrocarbon group represented by Ar is an aryl group of a single ring or a condensed ring having preferably from 6 to 30 carbon atoms and more preferably from 6 to 20 carbon atoms whereupon examples of such aromatic hydrocarbon groups include a phenyl group and a naphthyl group, with the phenyl group being particularly preferable. An aromatic heterocyclic group represented by Ar is a 5- to 10-membered unsaturated heterocyclic group containing at least one atom selected from the group consisting of. N, O and S whereupon a heterocycle in each of these heterocyclic groups may be a single ring or a condensed ring formed together with another ring. Examples of such heterocycles in these heterocyclic groups include preferably a 5- or 6-membered aromatic heterocycle and the benzo-condensed ring thereof, more preferably a 5- or 6-membered nitrogen-containing aromatic heterocycle and the benzo-condensed ring thereof, and still more preferably a 5- or 6-membered aromatic heterocycle which contains one or two nitrogen atoms and the benzo-condensed ring thereof.

Examples of such heterocycles, from which respective heterocyclic groups are derived, include thiophene, furan, pyrrole, imidazole, pyrazole, pyridine, pyrazine, pyridazine, triazole, triazine, indole, indazole, purine, thiadiazole, oxadiazole, quinoline, phthalazine, naphthyridine, quinoxaline, quinazoline, cinnoline, pteridine, acrydine, phenathroline, phenazine, tetrazole, thiazole, oxazole, benzimidazole, benzoxazole, benzothiazole, benzothiazoline, benzotriazole, tetrazaindene and carbazole, preferably imidazole, pyrazole, pyridine, pyrazine, indole, indazole, thiadiazole, oxadiazole, quinoline, phenazine, tetrazole, thiazole, oxazole, benzimidazole, benzoxazole, benzothiazole, benzothiazoline, benzotriazole, tetrazaindene and carbazole, and more preferably imidazole, pyridine, pyrazine, quinoline, phenazine, tetrazole, thiazole, benzoxazole, benzimidazole, benzothiazole, benzothiazoline, benzotriazole, and carbazole.

The aromatic hydrocarbon group and aromatic heterocyclic group represented by Ar may each have a substituent whereupon examples of such substituents include the same substituents as those defined in T₃₁ and same applies to preferable ranges thereof. These substituents may further be substituted and, when two or more substituents are present, they may be same or different from one another. Further, the group represented by Ar is preferably an aromatic heterocyclic group.

Examples of aliphatic hydrocarbon groups, aryl groups and heterocyclic groups represented by Ra, Rb, Rc and Rd include the same examples of aliphatic hydrocarbon groups, aryl groups and heterocyclic groups defined in T₃₁ and the same applies to preferable ranges thereof. Acyl groups represented by Ra, Rb, Rc and Rd are each individually an aliphatic or aromatic group having from 1 to 12 carbon atoms whereupon examples thereof include an acetyl group, a benzoyl group, a formyl group and a pivaloyl group. The nitrogen-containing heterocyclic groups formed by allowing Ra and Rb, Rc and Rd, Ra and Rc, or Rb and Rd to be combined with each other within each combination include, for example, 3- to 10-membered, saturated or unsaturated heterocyclic groups (such as respective groups derived from a piperidine ring, a piperazine ring, an acridine ring, a pyrrolidine ring, a pyrrole ring and a morpholine ring).

Specific examples of acid anions, necessary to balance an electric charge in a molecule, represented by M₃₁ include a halogen ion (such as a chlorine ion, a bromine ion or an iodine ion), a p-toluene sulfonic acid ion, a perchloric acid ion, a tetrafluoroboric acid ion, a sulfuric acid ion, a methylsulfuric acid ion, an ethylsulfuric acid ion, a methane sulfonic acid ion and a trifluoromethane sulfonic acid ion.

Specific examples of the compounds represented by the general formula (T) are given below to illustrate the invention and should not be interpreted as limiting it in any way.

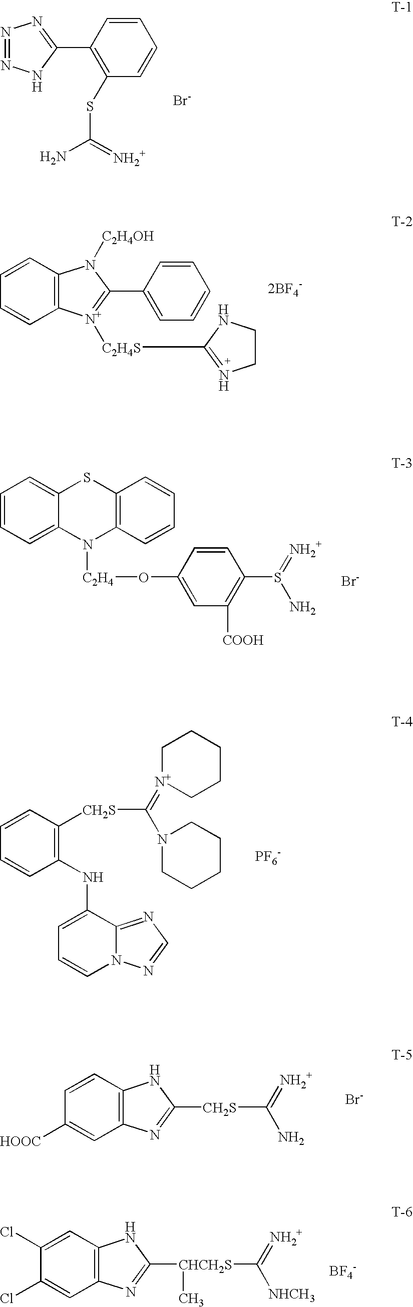

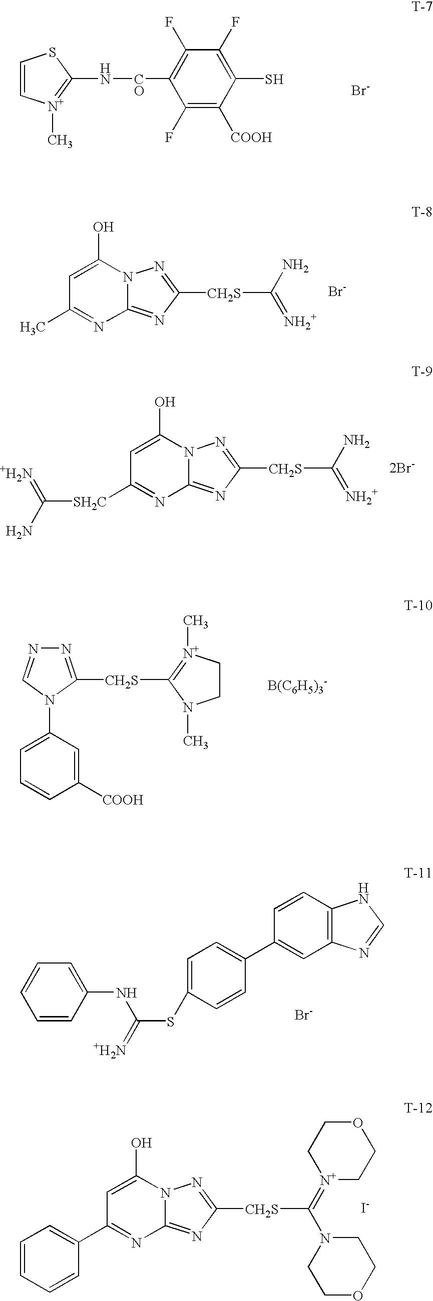

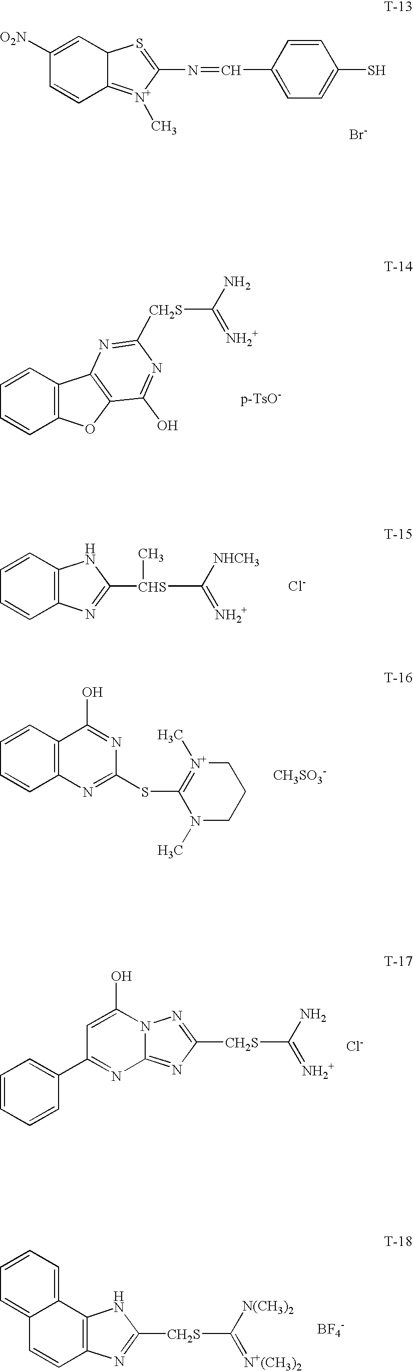

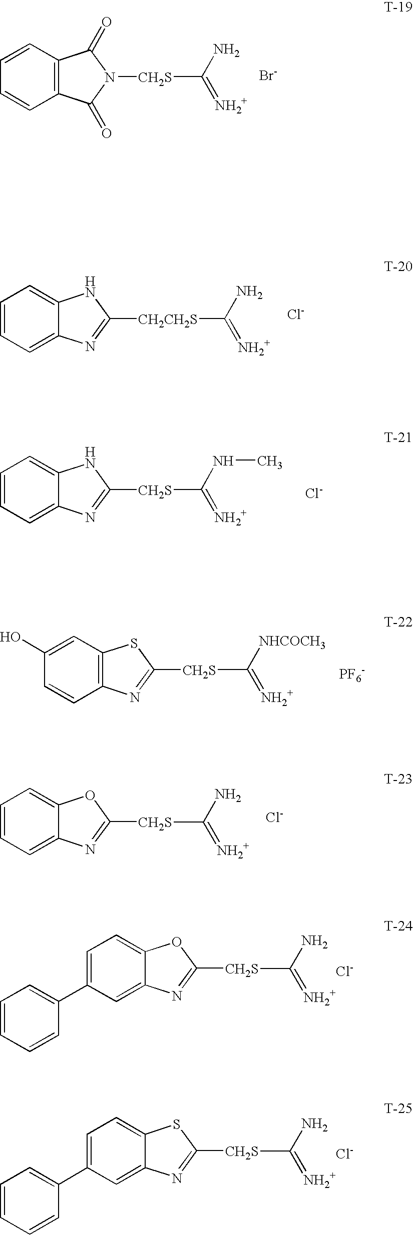

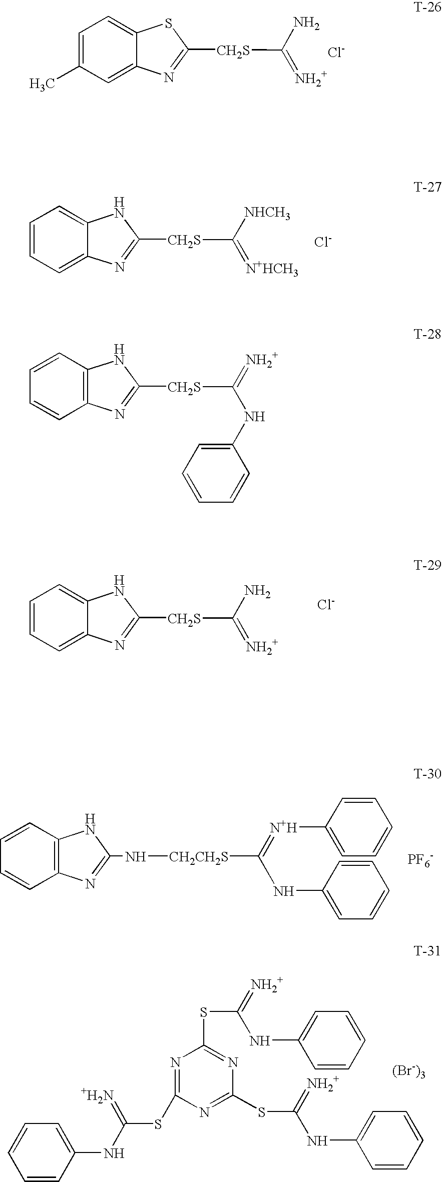

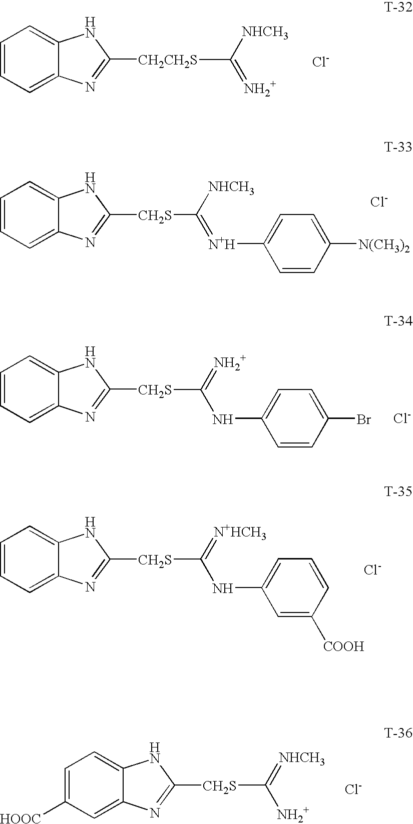

As for compounds represented by the general formula (T) according to the invention, a commercially available compound may be used or a compound can be synthesized in accordance with a known method, for example, described in “Shin-Jikkenkagaku Koza” (Series of Experimental Chemistry) edited by the Chemical Society of Japan, Vol. 14-III, pp. 1739 to 1741 (1978).

Such a compound represented by the general formula (T) according to the invention can be added either in a photosensitive layer or a non-photosensitive layer in the photothermographic material; however, the addition thereof can preferably be performed in the photosensitive layer.

A quantity of the compound represented by the general formula (T) to be added is, though varying depending on a desired object, in the range of from 10⁻⁴ mol to 1 mol, preferably in the range of from 10⁻³ mol to 0.3 mol, and more preferably in the range of from 10⁻³ mol to 0.1 mol, per mol of Ag in each case. Further, the compounds represented by the general formula (T) may be used either each individually or in combination thereof.

The compound represented by the general formula (T) may be used after being dissolved in water or an appropriate organic solvent such as any of alcohols (for example, methanol, ethanol, propanol and fluorinated alcohol), any of ketones (for example, acetone, methyl ethyl ketone), dimethyl formamide, dimethyl sulfoxide or methyl cellosolve. Further, the compound may also be dissolved using an oil such as dibutyl phthalate, tricresyl phosphate, glyceryl triacetate or diethyl phthalate, or an auxiliary solvent such as ethyl acetate or cyclohexanone, thereby mechanically preparing an emulsify-dispersed product in accordance with a well known emulsify-dispersion method and, then, the resultant dispersion is used. Alternatively, the compound in powder form may be dispersed in water using a ball mill, a colloid mill, a sand grinder mill, a Manton-Gaulin, a microfluidizer, or by means of ultrasonic wave in accordance with a method known as a solid dispersion method and, then, the resultant dispersion is used. Further, at the time when solid fine grains of the compound are dispersed, a dispersion aid may be used.

1-12. Heteroatom-Containing Macrocyclic Compound

The photothermographic material according to the invention preferably contains a heteroatom-containing macrocyclic compound.

The heteroatom-containing macrocyclic compound according to the invention denotes a 9- or more membered macrocyclic compound containing at least one heteroatom selected from the group consisting of: a nitrogen atom, an oxygen atom, a sulfur atom and a selenium atom, preferably a 12- to 24-membered macrocyclic compound, and more preferably a 15- to 21-membered macrocyclic compound.

Representative examples of such compounds include a compound, being commonly known as a crown ether, which was synthesized by Pederson in 1967 and, since the characteristic report of the synthesis thereof, a number of such compounds have been synthesized. These compounds are described in detail in C. J. Pederson, “Journal of American Chemical Society”, Vol. 86 (2495), pp. 7017-7036 (1967); G. W. Gokel & S. H. Korzeniowski, “Macrocyclic Polyether Synthesis”, Springer-Vergal (1982); “Chemistry of Crown Ether” edited by Oda, Shono & Tabuse, published by Kagaku Dojin (1978); “Host-Guest” edited by Tabuse, published by Kyoritsu Shuppan (1979); Sasaki & Koga, Yuki Gosei Kagaku (Journal of Organic Synthetic Chemistry) Vol. 45 (6), pp. 571-582 (1987); and the like.

Specific examples of the heteroatom-containing macrocyclic compounds according to the invention are shown below, but the invention is by no means limited thereto.

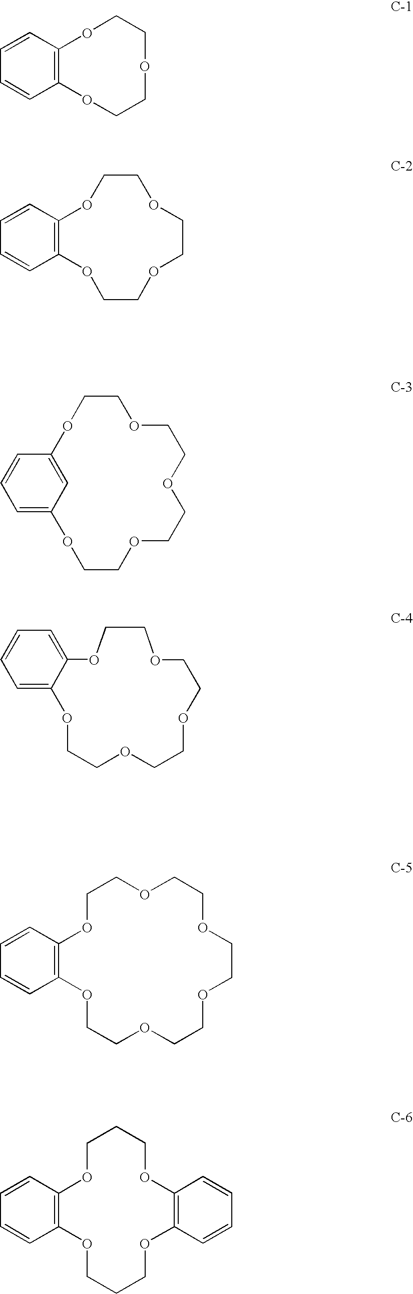

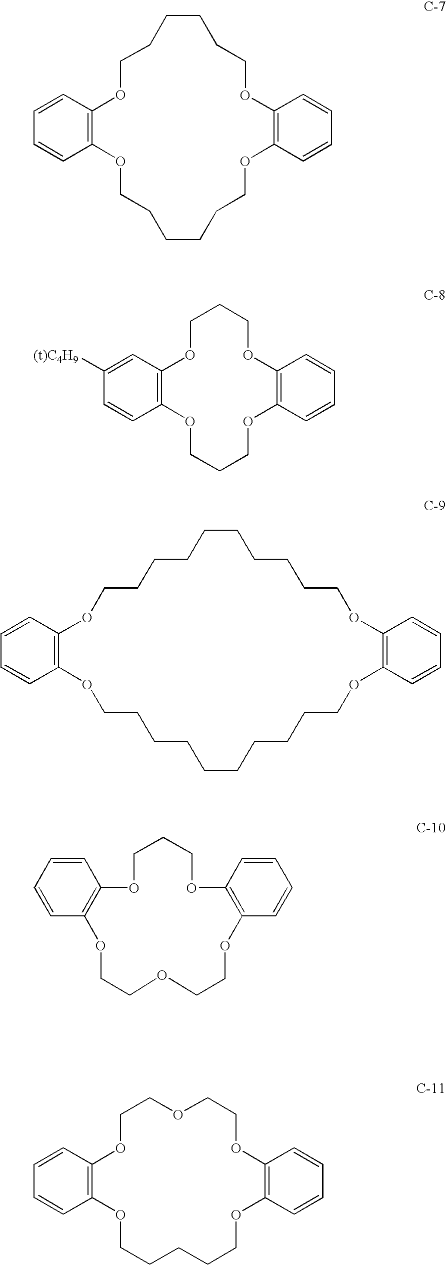

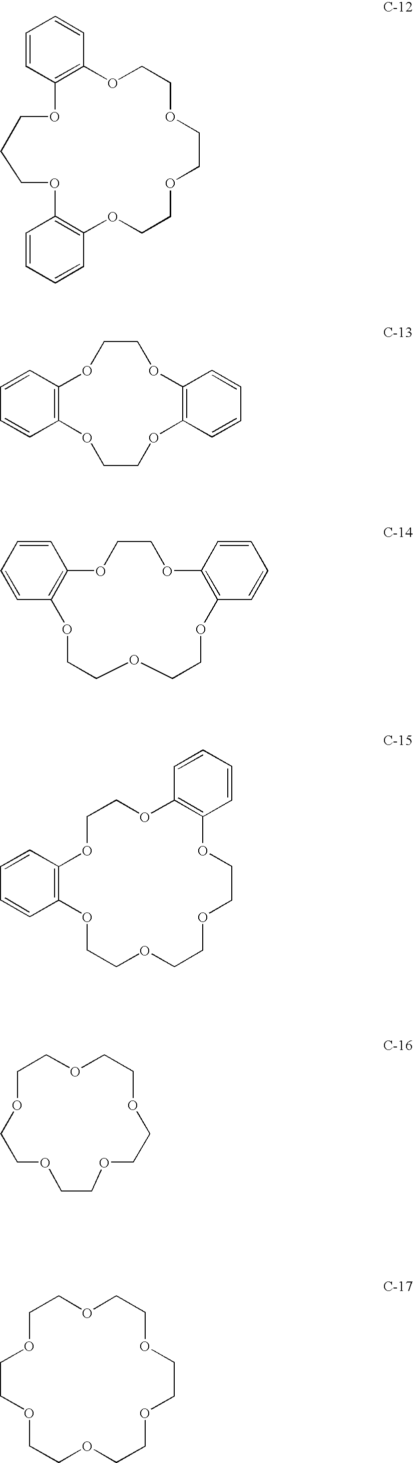

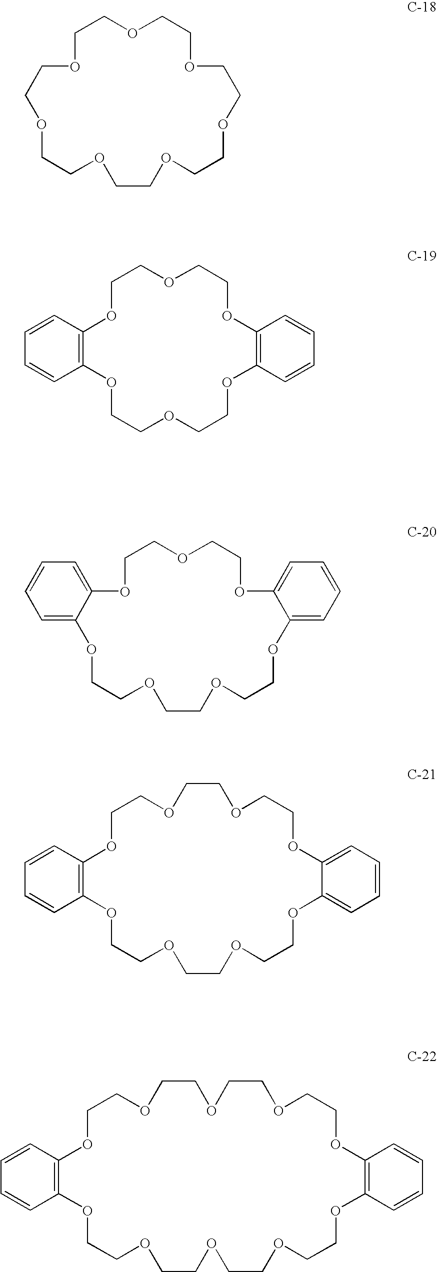

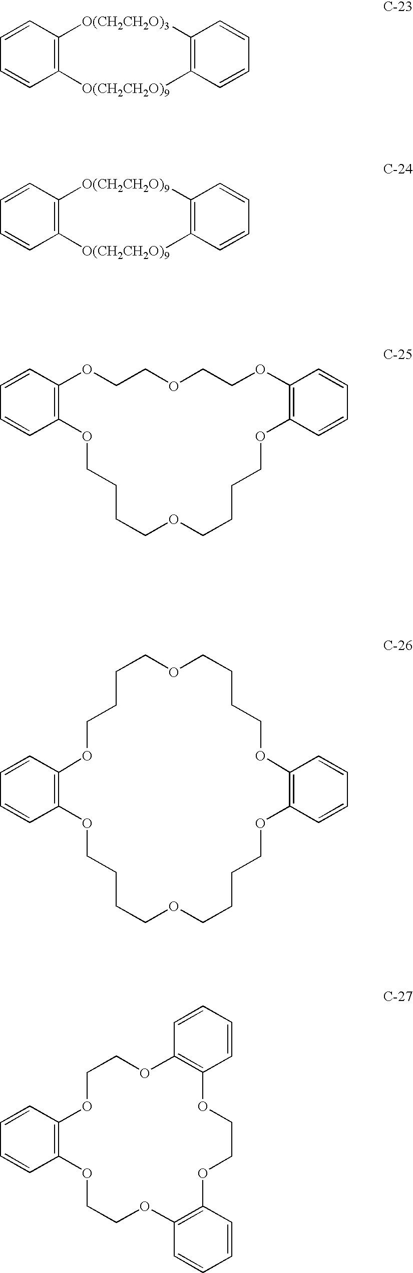

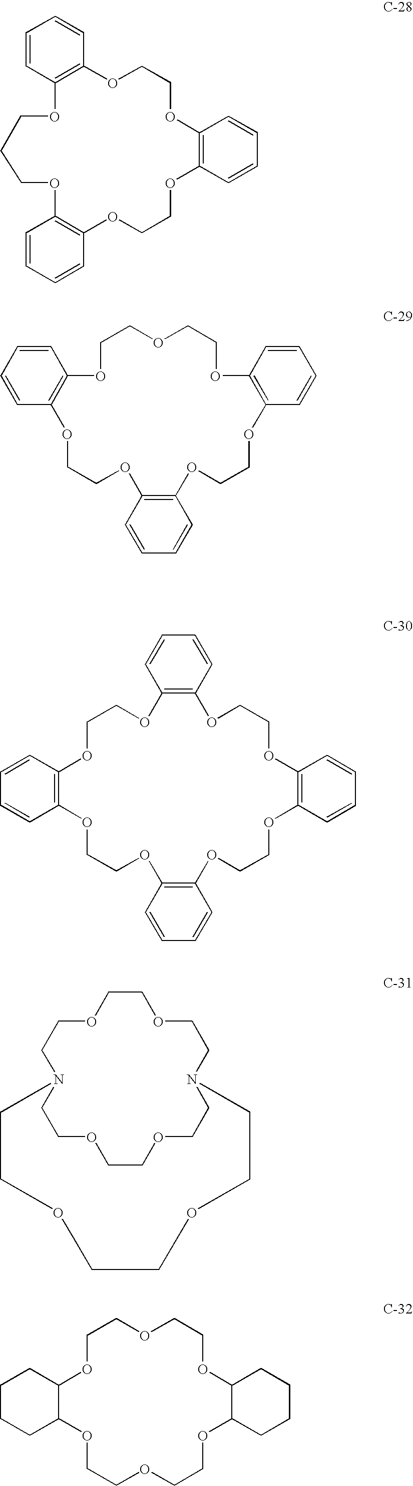

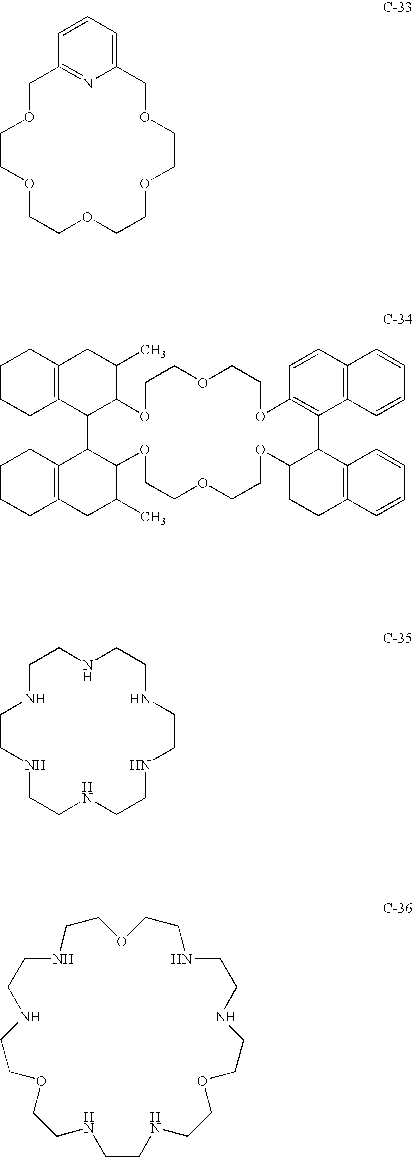

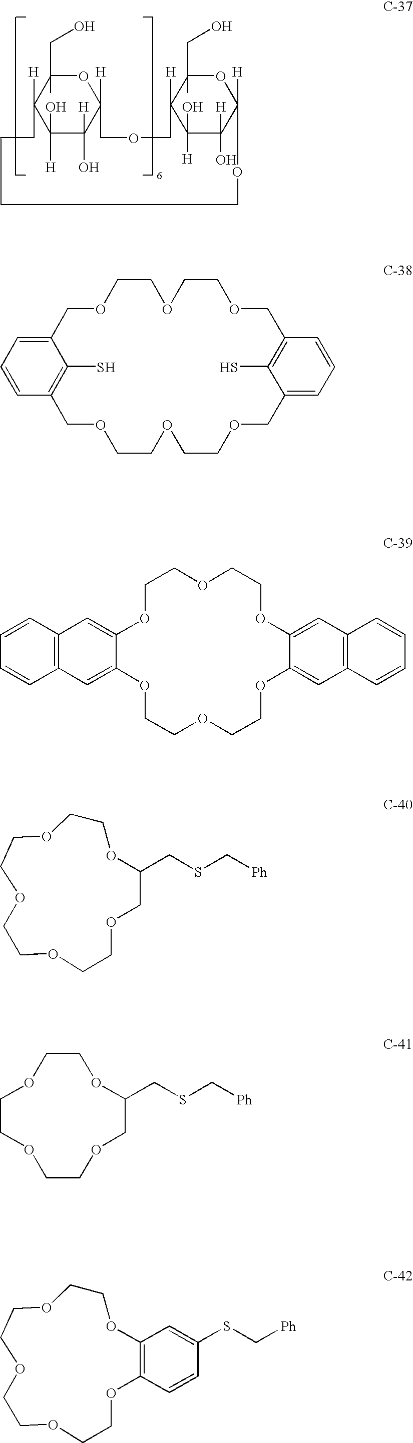

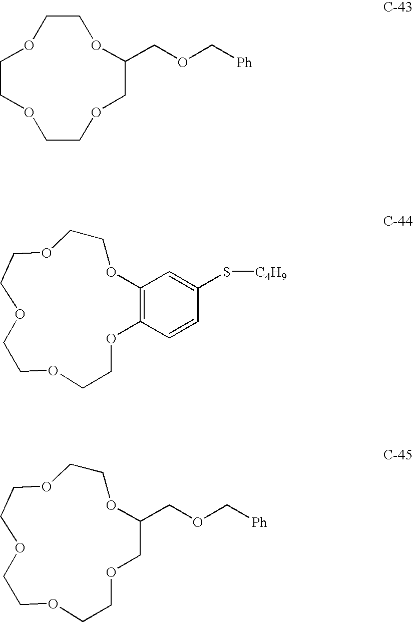

Advantageous effects of the use of the compound represented by the general formula (T) in combination with the heteroatom-containing macrocyclic compound has not been elucidated; however, it is considered that adsorption quantity of the sensitizing dye is increased by the macrocyclic compound and, accordingly, a light absorption at a desired wavelength is increased whereupon super-sensitizing effect of the compound represented by the general formula (T) is promoted, thereby obtaining the sensitizing effect.

Effects of these macrocyclic compounds against conventional silver halide photosensitive materials each using an ordinary gelatin matrix are described in the patent publications described above. However, it is surprising that the same effects as those in the conventional silver halide photosensitive materials were found even in the photothermographic materials which are substantially different from the conventional silver halide photosensitive materials in constitution.

It is not definitely clear why these compounds exerted particularly advantageous effects against the photothermographic material. Unlike the photosensitive layer in the conventional silver halide photosensitive material, the photothermographic layer contains a silver source other than silver halide (such as organic silver salts or toning agent silver complex) whereupon it is supposed that adsorption of a sensitizing dye to silver halide is easily deteriorated, as compared to the conventional silver halide photosensitive materials. It is also contemplated that the heterocycle-containing macrocyclic compound acts on it, thereby promoting adsorption of the sensitizing dye to silver halide.

The heterocycle-containing macrocyclic compound may be added at any stage during a period of from after silver halide is prepared until a coating solution is prepared, to exhibit a desired effect, and is added preferably prior to adding the sensitizing dye.

To enhance effects of the compound in the photothermographic material, as will be described below, it is preferred to introduce an iodide into a surface of the photosensitive silver halide used in the photothermographic material.

These heteroatom-containing macrocyclic compounds are ordinarily incorporated into the photosensitive layer of the photothermographic material after being dissolved either in an organic solvent such as methanol, ethanol or fluorinated alcohols, or water. In a case where solubility thereof is insufficient, a dissolving agent such as potassium acetate, potassium iodide, potassium fluoride, potassium p-toluene sulfonate, KBF₄, KPF₆, NH₄BF₄ or NH₄PF₆ may be added thereto for allowing them to be preliminarily dissolved and, then, dissolved in the organic solvent or water. In the dissolving agent, an ion capable of forming an inclusion compound together with the heteroatom-containing macrocyclic compound is utilized. Any dissolving agent is permissible, so long as it improves solubility of the compound and exerts effects after the addition thereof. A quantity of the dissolving agent to be added is, per mol of silver, in the range of from 10⁻⁴ mol to 1.0 mol and preferably in the range of from 10⁻³ mol to 0.2 mol.

1-13. Antifoggant

1) Organic Polyhalogen Compound

It is preferable that a compound represented by the following general formula (H) is contained in the invention as an antifoggant:

Q-(Y)n-C(Z₁)(Z₂)X General formula (H)

In the general formula (H), Q represents a group selected from the group consisting of: an alkyl group, an aryl group and a heterocyclic group;

Y represents a divalent linking group;

n represents 0 or 1;

Z₁ and Z₂ each independently represent a halogen atom; and

X represents a hydrogen atom or an electron-attractive group.

In the general formula (H), Q preferably represents a phenyl group substituted by an electron-attractive group in which a Hammet's substituent constant σp has a positive value. Regarding the Hammet's substituent constant, Journal of Medicinal Chemistry, Vol. 16, No. 11, pp. 1207 to 1216 (1973) and the like can be referred to.

Examples of such electron-attractive groups include a halogen atom such as a fluorine atom (σp value: 0.06), a chlorine atom (σp value: 0.23), a bromine atom (σp value: 0.23) or an iodine atom (σp value: 0.18); a trihalomethyl group such as a tribromomethyl group (σp value: 0.29), a trichloromethyl group (σp value: 0.33) or a trifluoromethyl group (σp value: 0.54); a cyano group (σp value: 0.66); a nitro group (σp value: 0.78); an aliphatic, aryl or a heterocyclic sulfonyl group such as a methane sulfonyl group (σp value: 0.72); an aliphatic, aryl or a heterocyclic acyl group such as an acetyl group (σp value: 0.50) or a benzoyl group (σp value: 0.43); an alkynyl group such as C≡CH (σp value: 0.23); an aliphatic, aryl or a heterocyclic oxycarbonyl group such as a methoxycarbonyl group (σp value: 0.45) or a phenoxycarbonyl group (σp value: 0.44); a carbamoyl group (σp value: 0.36); a sulfamoyl group (σp value: 0.57); a sulfoxydo group; a heterocyclic group; and a phosphoryl group whereupon a σp value is preferably in the range of from 0.2 to 2.0, and more preferably in the range from 0.4 to 1.0.

Examples of such preferable electron-attractive groups include a carbamoyl group, an alkoxycarbonyl group, an alkylsulfonyl group, an alkylphosphoryl group, a carboxyl group, an alkyl- or aryl-carbonyl group and an aryl sulfonyl group, with a carbamoyl group, an alkoxycarbonyl group, an alkyl sulfonyl group and an alkyl phosphoryl group being particularly preferable; and a carbamoyl group being most preferable.

X is preferably an electron-attractive group, more preferably one member selected from the group consisting of: a halogen atom, an aliphatic, aryl or a heterocyclic sulfonyl group, an aliphatic, aryl or a heterocyclic acyl group, an aliphatic, aryl or a heterocyclic oxycarbonyl group, a carbamoyl group and a sulfamoyl group, and particularly preferably a halogen atom. Among such halogen atoms, a chlorine atom, a bromine atom and an iodine atom are preferable; a chlorine atom and a bromine atom are more preferable; and a bromine atom is particularly preferable.

Y preferably represents a group selected from the group consisting of: —C(═O)—, —SO— and —SO₂— whereupon —C(═O)— and —SO₂— are more preferable, and —SO₂— is most preferable. n represents 0 or 1 whereupon 1 is preferable.

Specific examples of the compounds represented by the general formula (H) are given below to illustrate the invention and should not be interpreted as limiting it in any way.

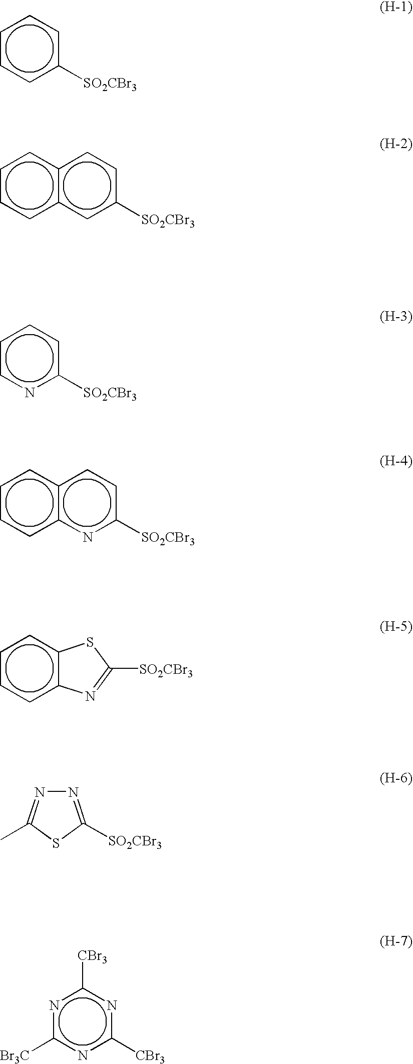

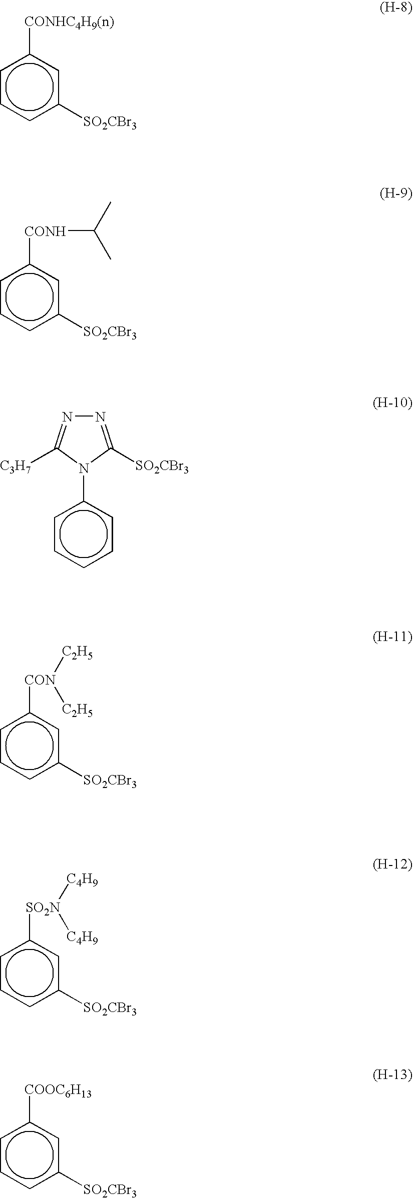

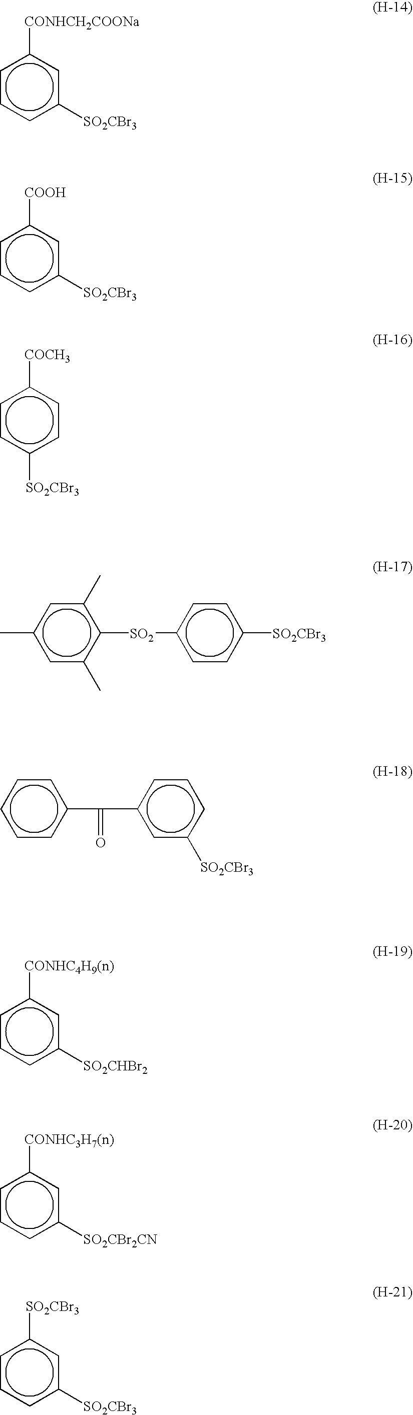

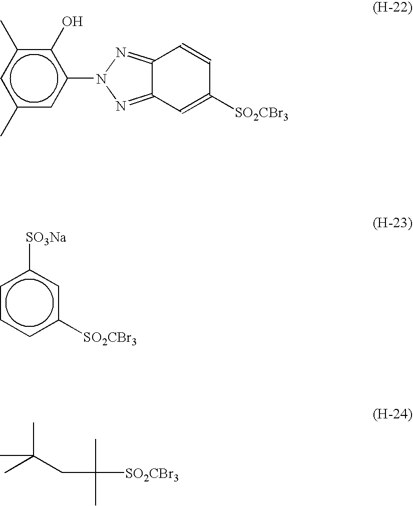

The compound represented by the general formula (H) according to the invention is used preferably in the range of from 10⁻⁴ mol to 0.8 mol, more preferably in the range of from 10⁻³ mol to 0.1 mol, and still more preferably in the range of from 5×10⁻³ mol to 0.05 mol, per mol of a non-photosensitive silver salt in an image forming layer.

According to the invention, as for a method of incorporating the compound represented by the general formula (H) into the photosensitive material, mentioned is the same method as that described in the method of incorporating the reducing agent.

A melting point of the compound represented by the general formula (H) is preferably 200° C. or less, and more preferably 170° C. or less.

Other organic polyhalogen compounds to be used according to the invention include those disclosed in JP-A No. 11-65021, paragraphs 0111 to 0112. Particularly preferable are organic halogenated compounds represented by the formula (P) in Japanese Patent Application No. 11-87297, organic polyhalogen compounds represented by the general formula (II) in JP-A No. 10-339934 and organic poly-halogen compounds described in Japanese Patent Application No. 11-205330.

2) Compounds Represented by General Formula (PR)

It is preferable that any one of propenenitrile compounds represented by the following general formula (PR) is contained as an antifoggant in the photothermographic material according to the invention:

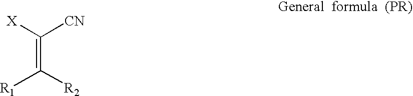

In the general formula (PR), R₁ represents a hydroxyl group or a metal salt thereof; R₂ represents an alkyl or aryl group; X represents an electron-attractive group or a group capable of forming a ring containing an electron-attractive group by being combined with R₂, wherein R₂ may form a ring containing an electron-attractive group together with X.

The electron-attractive group represented by X will be explained. Electron attractivity is defined by “Hammet constant σₚ”. The Hammet constant σₚ is defined by the Hammet law: LogK/K⁰=σₚρ, wherein K⁰ is an acid dissociation constant of a reference substance in an aqueous solution at 25° C.; and K is the same constant of an acid which has been subjected to a para-substitution whereupon a σₚ value of an acid dissociation constant of a para-substituted benzoic acid under a condition of ρ=1 is used. When the acid remains unsubstituted, a relation of σₚ=0 is determined. When the σₚ value becomes positive, the group is rated to be an electron-attractive group. As the σₚ value becomes larger, the electron attractivity becomes stronger.

It is necessary that the electron-attractive group X in the general formula (PR) is at least of the same electron attractivity as that of a group of —COOR (wherein R represents, for example, H, CH₃, or —CH₂CH₃). Hammet constant σₚs of —COOH, —COOCH₃ and —COOC₂H₅ are 0.43, 0.39 and 0.45, respectively. Namely, it is necessary that the σₚ of the electron-attractive group according to the invention is 0.39 or more. Examples of such electron-attractive groups, though not restricted thereto, include a cyano group, an alkoxycarbonyl group, a methaloxycarbonyl group, a hydroxycarbonyl group, a nitro group, an acetyl group, a perfluoroalkyl group, an alkylsufonyl group, an arylsufonyl group and other groups enumerated in Lange's “Handbook of Chemistry”, 14th ed., Chap. 9, pp. 2 to 7, McGraw-Hill Book Company (1992).

R₁ may be a hydroxyl group or a metal salt thereof, for example, OM⁺ (wherein M⁺ represents a metal cation). Preferable M⁺ is a monovalent cation such as Li⁺, Na⁺, K⁺ or Fe⁺²; however, a divalent or trivalent cation may also be used.

R₂ represents an alkyl or aryl group. When R₂ represents an alkyl group, it has preferably from 1 to 20 carbon atoms, more preferably from 1 to 10 carbon atoms and most preferably from 1 to 4 carbon atoms. A particularly preferable alkyl group is a methyl group. When R₂ represents an aryl group, it has preferably from 5 to 10 carbon atoms and more preferably from 6 to 10 carbon atoms. The most preferable aryl group is a phenyl group.

R₂ can form a ring containing an electron-attractive group together with X. The ring is preferably a 5-, 6-, or 7-membered ring. Examples of such rings include a lactone ring and a cyclohexene ring represented by a compound PR-08 described below.

Useful propenenitrile compounds according to the invention are given below. A number of these compounds can be present each either in an “enol” or a “keto” tautomeric form, however, the “enol” form is only shown in each of structural formulas described below for the purpose of simplicity; accordingly, examples of such structural formulas are given below only to illustrate the invention and should not be interpreted as limiting it in any way.

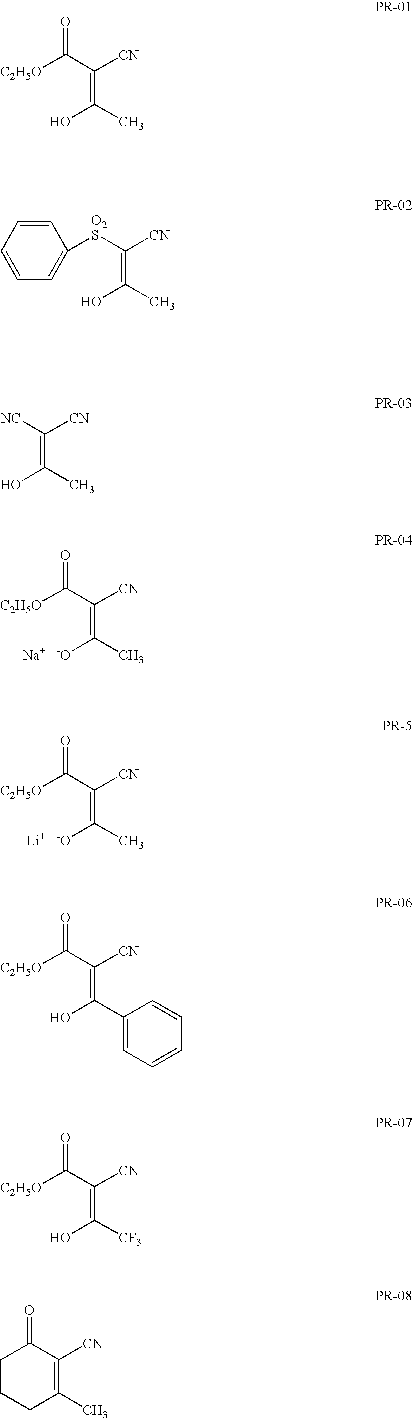

3) Other Antifoggants

Examples of other antifoggants include mercury (II) salts described in JP-A No. 11-65021, paragraph 0113; benzoic acids described in JP-A No. 11-65021, paragraph 0114; salicylic acid derivatives described in JP-A No. 2000-206642; formalin scavenger compounds represented by the formula (S) in JP-A No. 2000-221634; triazine compounds recited in claim 9 in JP-A No. 11-352624; compounds represented by the general formula (III) in JP-A No. 6-11791; and 4-hydoxy-6-methyl-1,3,3a,7-tetrazaindene.

As for antifoggants, stabilizers and stabilizer precursors employable in the invention, mentioned are compounds described in JP-A No. 10-62899, paragraph 0070, those disclosed in patents cited in EP-A No. 0803764, from page 20 line 57 to page 21 line 7, and compounds described in JP-A Nos. 9-281637 and 9-329864.

The photothermographic material according to the invention may contain an azolium salt for the purpose of inhibiting fog. As for such azolium salts, mentioned are compounds represented by the general formula (XI) in JP-A No. 59-193447, compounds described in JP-B No. 55-12581, and compounds represented by the general formula (II) in JP-A No. 60-153039. The azolium salt may be added in any part of the photosensitive material. However, as for a layer to be added with the azolium salt, the layer on the surface provided with a photosensitive layer is preferable, and the layer containing the organic silver salt is more preferable.

The time to add the azolium salt may be in any process of preparing a coating solution. In case of adding the azolium salt to the layer containing the organic silver salt, the azolium salt may be added in any process from the time of preparation of the organic silver salt till the time of preparation of a coating solution whereupon the azolium salt is preferably added at a time during a period of time from the time when preparation of the organic silver salt is completed till the time immediately before coating is conducted. As for addition methods of the azolium salt, any method of using a powder, a solution and a fine particle dispersion may be adopted. The azolium salt may also be added as a solution mixed with other additives such as a sensitizing dye, a reducing agent and a toning agent.

According to the invention, a quantity of the azolium salt to be added may be, though optional, preferably in the range of from 1×10⁻⁶ mol to 2 mol and more preferably in the range of from 1×10⁻³ mol to 0.5 mol, per mol of silver in each case.

1-14. Dyes

The photothermographic material according to the invention may contain various types of dyes and pigments (for example, C.I.Pigment Blue 60; C.I.Pigment Blue 64; and C.I.Pigment Blue 15:6) for the purpose of improvement of color tone, prevention of interference fringes at the time of laser exposure, prevention of irradiation, or anti-halation. These dyes and pigments are described in detail, for example, in WO 98/36322, JP-A Nos. 10-268465 and 11-338098.

Examples of preferable dyes to be employable in the photothermographic material according to the invention are those represented by the following general formulas (1) to (3):

1) Dyes Represented by General Formulae (1) to (3)

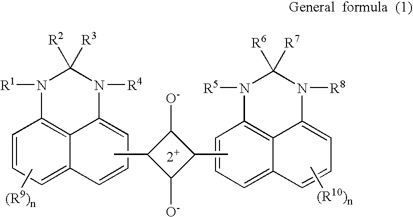

In the general formula (1), R¹, R⁴, R⁵ and R⁸ each independently represent a hydrogen atom or an alkyl group; R², R³, R⁶ and R⁷ each independently represent one member selected from the group consisting of: a hydrogen atom, an alkyl group, a cycloalkyl group, an aryl group, an aralkyl group and a heterocyclic group whereupon at least one pair selected from the group consisting of: a pair of R¹ and R², a pair of R³ and R⁴, a pair of R⁵ and R⁶, either a pair of R⁷ and R⁸ or a pair of R² and R³, and a pair of R⁶ and R⁷may, in each pair, be combined with each other to form a 5- or 6-membered ring. R⁹ and R¹⁰ each independently represent a monovalent group. n represents an integer of from 1 to 3. When at least one member selected from R², R³, R⁶ and R⁷ is a heterocyclic group, R⁹ and R¹⁰ may each individually a hydrogen atom.

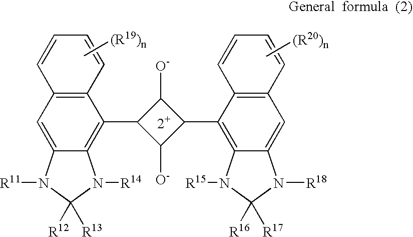

In the general formula (2), R¹¹, R¹², R¹³, R¹⁴, R¹⁵, R¹⁶, R¹⁷, and R¹⁸ each independently represent at least one member selected from the group consisting of: a hydrogen atom, an alkyl group, a cycloakyl group, an aryl group, an aralkyl group and a heterocyclic group whereupon at least one pair selected from the group consisting of: a pair of R¹¹ and R¹², a pair of R¹³ and R¹⁴, a pair of R¹⁵ and R¹⁶, either a pair of R¹⁷ and R¹⁸ or a pair of R¹² and R¹³, and a pair of R¹⁶ and R¹⁷ may, in each pair, be combined with each other to form a 5- or 6-membered ring. R¹⁹ and R²⁰ each independently represent a hydrogen atom or a monovalent group. n represents an integer of from 1 to 3.

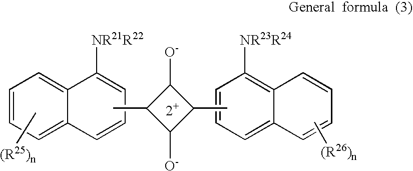

In the general formula (3), R²¹, R²², R²³ and R²⁴ each independently represent one member selected from the group consisting of: a hydrogen atom, an alkyl group, a cycloalkyl group, an aryl group, an aralkyl group and a heterocyclic group; R²⁵ and R²⁶ each independently represent a hydrogen atom or a monovalent group; and n represent an integer of from 1 to 3.

In the general formula (1), an alkyl group which R¹ to R⁸ each independently represent is such an alkyl group as having from 1 to 20 carbon atoms and preferably from 1 to 12 carbon atoms (for example, a methyl group, an ethyl group, a propyl group, a butyl group, a hexyl group or an undecyl group). These groups may be substituted by at least one member selected from the group consisting of: a halogen atom (for example, F, Cl or Br), an alkoxycarbonyl group (for example, a methoxycarbonyl group or an ethoxycarbonyl group), a hydroxyl group, an alkoxy group (for example, a methoxy group, an ethoxy group, a phenoxy group or an isobutoxy group) or acyloxy group (for example, an acetyloxy group, a butyloxy group, a hexyloxy group or a benzoyloxy group) and the like. As for cycloalkyl groups which R², R³, R⁶ and R⁷ each independently represent, a cyclopentyl group and a cyclohexyl group are mentioned. An aryl group which R², R³, R⁶ and R⁷ each independently represent is preferably such an aryl group as having from 6 to 12 carbon atoms whereupon examples of such aryl groups include a phenyl group and a naphthyl group. The aryl groups may each be substituted. Examples of such substituents include an alkyl group having from 1 to 8 carbon atoms (for example, a methyl group, an ethyl group or a butyl group), an alkoxy group having from 1 to 6 carbon atoms (for example, a methoxy group or an ethoxy group), an aryloxy group (for example, a phenoxy group, a p-chlorophenoxy group), a halogen atom (for example, F, Cl or Br), an alkoxycarbonyl group (for example, a methoxycarbonyl group or an ethoxycarbonyl group), a cyano group, a nitro group, an amino group (for example, a methyl amino group, an actyl amino group or a methane sulfonamide group) and a carboxyl group.

An aralkyl group which R², R³, R⁶ and R⁷ each independently represent is preferably such an aralkyl group as having from 7 to 12 carbon atoms (for example, a benzyl group or a phenyl ethyl group), which may have a substituent (for example, a methyl group, a methoxy group or a chlorine atom). Examples of heterocyclic groups which R², R³, R⁶ and R⁷ each independently represent include a pyridyl group, an indolyl group, a pyrrolyl group, a thienyl group and a furyl group. As for monovalent groups which R⁹ an R¹⁰ each independently represent, the same groups as substituents which have been described in the aryl groups can be mentioned. At least one pair selected from the group consisting of: a pair of R¹ and R², a pair of R³ and R⁴, a pair of R⁵ and R⁶, either a pair of R⁷ and R⁸ or a pair of R² and R³, and a pair of R⁶ and R⁷ may, in each pair, be combined with each other to form a cyclopentane ring or a cyclohexane ring. A position at which a squaline ring is attached is ordinarily an ortho position or possibly a para position of an amino group and preferably the ortho position.

In the general formula (2), at least one group selected from the group consisting of: an alkyl group, a cycloalkyl group, an aryl group, an aralkyl group and a heterocyclic group which R¹¹, R¹², R¹³, R¹⁴, R¹⁵, R¹⁶, R¹⁷ and R¹⁸ each independently represent has the same meaning as that of the group which R² in the general formula (1) represents. At least one pair selected from the group consisting of: a pair of R¹¹ and R¹², a pair of R¹³ and R¹⁴, a pair of R¹⁵ and R¹⁶, either a pair of R¹⁷ and R¹⁸ or a pair of R¹² and R¹³, and a pair of R¹⁶ and R¹⁷ may, in each pair, be combined with each other to form a cyclopentane ring or a cyclohexane ring. A monovalent group which R¹⁹ and R²⁰ each independently represent has the same meaning as that of the group which R⁹ in the general formula (1) represents.

In the general formula (3), at least one group selected from the group consisting of: an alkyl group, a cycloalkyl group, an aryl group, an aralkyl group and a heterocyclic group which R²¹, R²², R²³ and R²⁴ each independently represent has the same meaning as that of the group which R¹⁹ in the general formula (1) represents. A monovalent group which R²⁵ and R²⁶ each independently represent has the same meaning as that of the group which R¹⁹ in the general formula (1) represents. A position at which a squaline ring is attached is ordinarily an ortho position or possibly a para position of an amino group and preferably the ortho position.

Specific examples of compounds represented by the general formulas (1) to (3) are given below to illustrate the invention and should not be interpreted as limiting it in any way.

| | |
|---|---|
| Compound | R |

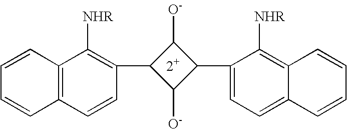

| | |
|---|---|
| 1 | C₂H₅ |
| 2 | C₄H₉ |
| 3 | C₈H₁₇ |

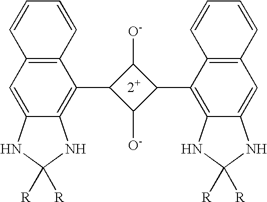

| | | |
|---|---|---|
| 4 | CH₃ | |
| 5 | C₅H₁₁ | |
| 6 | Rs are combined with each other to form | 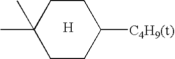 |

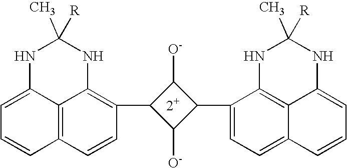

| 7 | 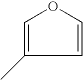 | |
|---|---|---|
| 8 | 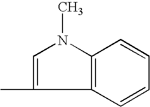 | |
| 9 | 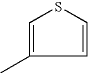 | |
| compound | R | R′ |

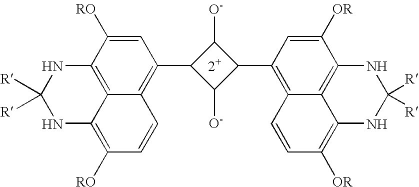

| | | | |
|---|---|---|---|
| 10 | CH₃ | C₂H₅ | |
| 11 | CH₃ | C₅H₁₁ | |
| 12 | C₄H₉ | C₂H₅ | |
| 13 | CH₃ | R′s are combined with each other to form | 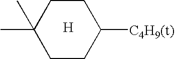 |

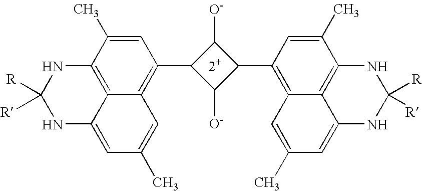

| | | |
|---|---|---|
| 14 | CH₃ | C₆H₅ |
| 15 | C₅H₁₁ | C₅H₁₁ |
| 16 | CH₃ | C₁₁H₂₃ |

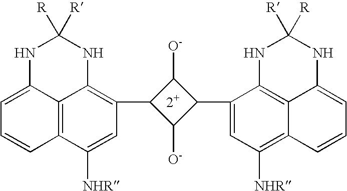

| compound | R | R′ | R″ |
|---|---|---|---|
| 17 | CH₃ | C₁₁H₂₃ | COCH₃ |
| 18 | C₅H₁₁ | C₅H₁₁ | SO₂CH₃ |
| 19 | C₅H₁₁ | C₅H₁₁ | CH₃ |
| 20 | CH₃ | C₆H₅ | COCH₃ |

2) Dyes Represented by General Formula (4)

Next, dyes represented by the general formula (4) are explained.

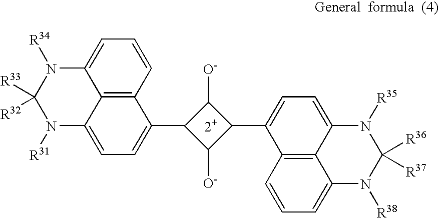

In the general formula (4), R³¹, R³⁴, R³⁵ and R³⁸ each independently represent at least one member selected from the group consisting of: a hydrogen, an alkyl group having from 1 to 20 carbon atoms, a cycloalkyl group having from 1 to 20 carbon atoms, an aryl group having carbon atoms up to 14 and an aralkyl group; R³², R³³, R³⁶ and R³⁷ each independently represent at least one member selected from the group consisting of: a hydrogen, an alkyl group having from 1 to 20 carbon atoms, a cycloalkyl group having from 1 to 20 carbon atoms, an aryl group having carbon atoms up to 14, an aralkyl group and —CH₂OR³⁹ [wherein R³⁹ represents at least one group selected from the group consisting of: an alkylacyl group, —C(═O)R (wherein R is an alkyl group having from 1 to 20 carbon atoms), —SiR′R″R′″ (wherein R′, R″ and R′″ each independently represent an alkyl group having from 1 to 20 carbon atoms) and —SO₂R⁴⁰ (wherein R⁴⁰ is an alkyl group having from 1 to 20 carbon atoms)], or at least one pair selected from the group consisting of: a pair of R³¹ and R³², a pair of R³³ and R³⁴, a pair of R³⁵ and R³⁶, either a pair of R³⁷ and R³⁸ or a pair of R³² and R³³, and a pair of R³⁶ and R³⁷ may, in each pair, be combined with each other to form a 5-, 6-, or 7-membered ring.

According to a particularly preferred embodiment, in the general formula (4), R³¹, R³⁴, R³⁵ and R³⁸ each independently represent a hydrogen; and R³², R³³, R³⁶ and R³⁷ each independently represent at least one member selected from the group consisting of: a hydrogen, an alkyl group having from 1 to 20 carbon atoms, a cycloalkyl group having from 1 to 20 carbon atoms and an aryl group; or a pair of R₃₂ and R₃₃, a pair of R₃₆ and R₃₇, or both pairs of R₃₂ and R₃₃, and R₃₆ and R₃₇ are combined with each other within each pair to form a 5-, 6-, or 7-membered ring. Specific examples of such preferred embodiments are given below to illustrate the invention and should not be interpreted as limiting it in any way.

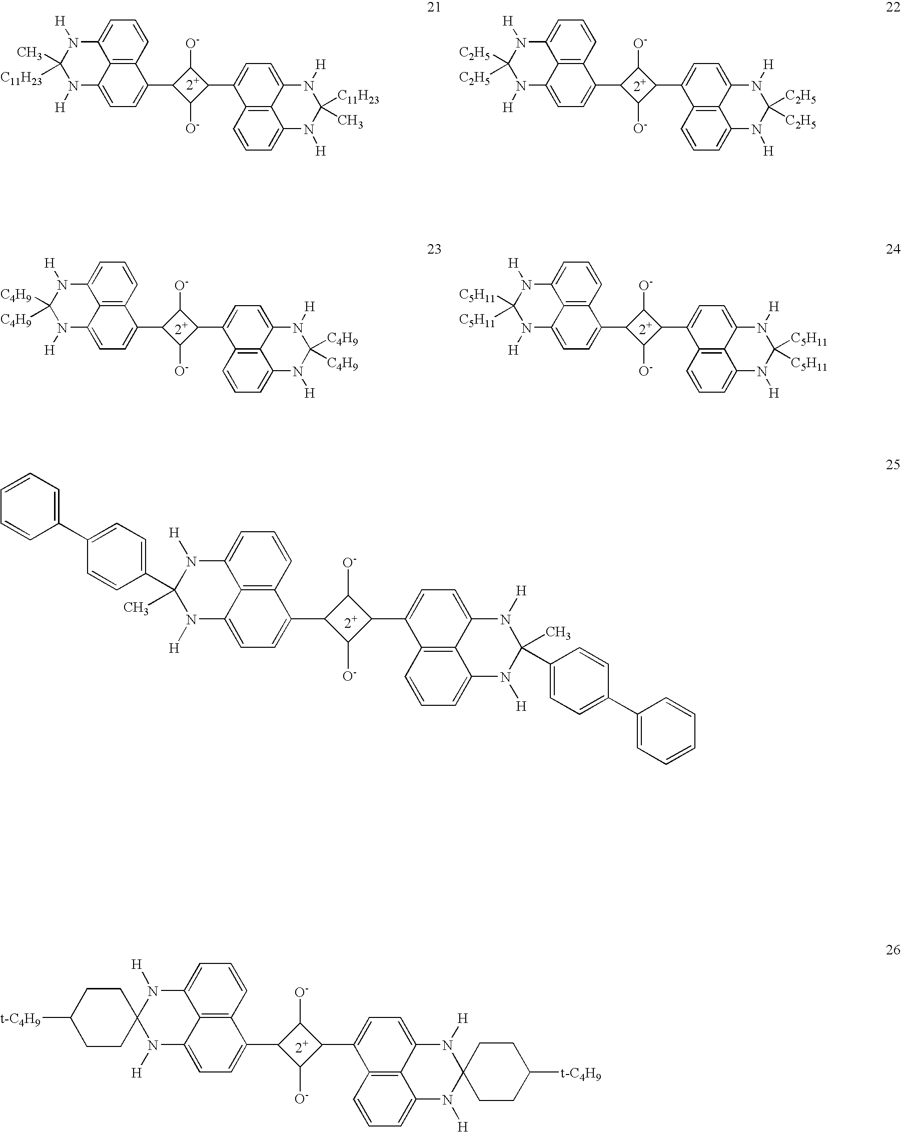

According to another preferred embodiment, a pair of R³³ and R³⁴, and a pair of R³⁷ and R³⁸ are combined with each other within each pair to form a cycloalkyl group having from 1 to 20 carbon atoms, whereupon R³² and R³⁶ each independently represent an aryl group and R³¹ and R³⁵ each independently represent a hydrogen. Preferable, though not restrictive, examples of such embodiments include the following compound:

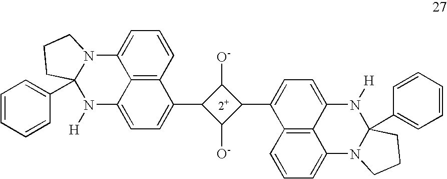

According to a third preferred embodiment, a pair of R³³ and R³⁴, and a pair of R³⁷ and R³⁸ are combined with each other within each pair to form a lactam group whereupon R³² and R³⁶ each independently represent an alkyl group or an aryl group; and R³¹ and R³⁵ each independently represent a hydrogen. Examples of representative dyes of this embodiment include the following compounds:

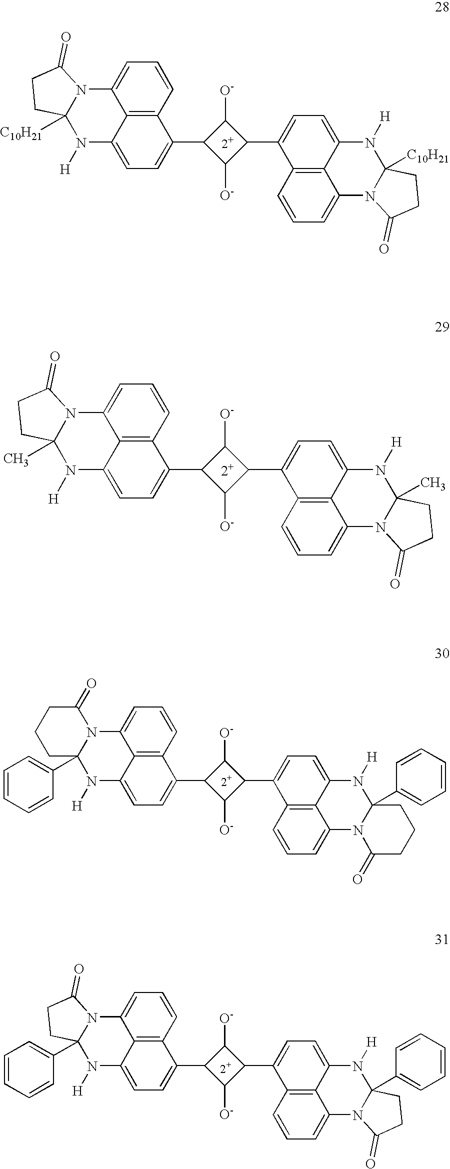

According to still another preferred embodiment, dihydroperimidine square acid complex dyes are represented by the following formula:

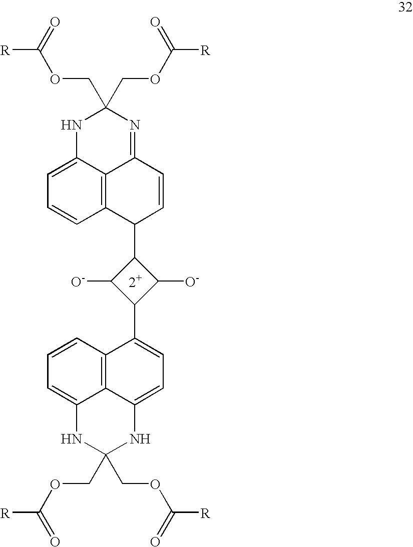

In the formula (32), R represents an alkyl group having from 1 to carbon atoms and preferably having from 4 to 20 carbon atoms. Examples of Rs include a propyl group, a butyl group, a pentyl group, an octyl group, —CH₃—O—CH₂CH₃, and —CH₂—O—CH₂CH₂—O—CH₃; however, the invention is by no means limited thereto.

According to still further preferred embodiment, there are provided R³¹, R³⁴, R³⁵ and R³⁸ which each independently represent a hydrogen and also R³², R³³, R³⁶ and R³⁷ which each independently represent —CH₂OR³⁹ [wherein R³⁹ represents either —SiR′R″R′″ (wherein R′, R″ and R′″ each independently represent an alkyl group having from 1 to 20 carbon atoms) or —SO₂R⁴⁰ (wherein R⁴⁰ represents an alkyl group having from 1 to 20 carbon atoms and preferably from 4 to 20 carbon atoms)].

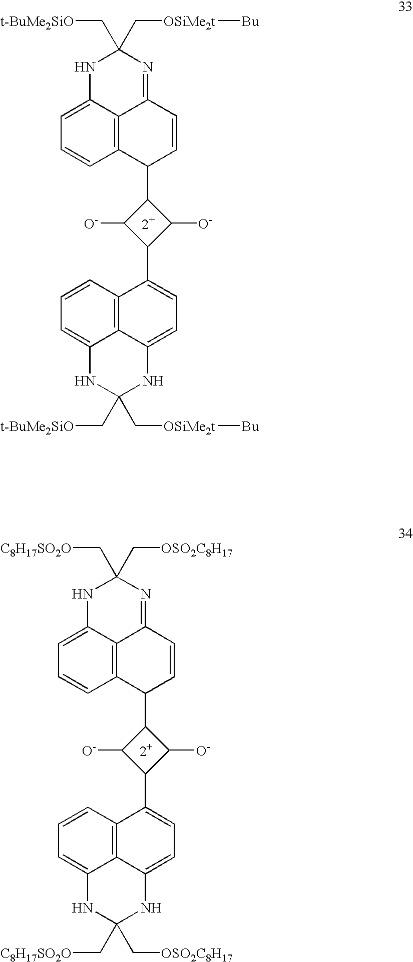

Alternatively, the following compound can also be advantageously used.

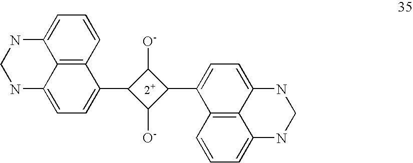

3) Dyes Represented by the General Formula (5)

Next, dyes represented by the general formula (5) will be explained.

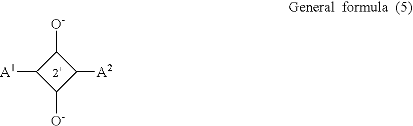

In the formula, at least one of A¹ and A² represents a 5- or 6-membered nitrogen containing-heteroaromatic ring.

Preferably, at least one of A¹ and A² is a 6-membered nitrogen-containing heteroaromatic ring group represented by the general formula (6).

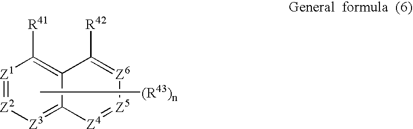

In the formula, R⁴¹ and R⁴² represent a hydrogen atom, —OR⁴⁴ or —NR⁴⁵R⁴⁶, the R⁴⁴ representing a group substituent for a hydrogen atom or an oxygen atom, the R⁴⁵ and R⁴⁶ representing a group substituent for a hydrogen atom or a nitrogen atom. Furthermore, a ring that contains the R⁴¹ and R⁴² in the same ring may be formed; the R⁴⁵ and R⁴⁶ may be combined with each other to form a 5- or 6-membered ring. Z¹ through Z⁶ each represent a carbon atom or a nitrogen atom; any one of Z¹ through Z⁶ represents a nitrogen atom; at least one of the rest is a carbon atom; and at least one of carbon atoms represented by Z¹ through Z⁶ combines with a squalilium carbon in the general formula (5). R⁴³ represents a substituent capable of binding with an atom that forms a 6-membered nitrogen-containing heteroaromatic ring represented by the general formula (6); n1 represents an integer of 0 to 4.

Squalilium compounds represented by the general formula (5) or (6) will be explained.

In the general formula (5), at least one of the A¹ and A² is a 5- or 6-membered nitrogen-containing heteroaromatic ring (for instance, a pyrrole ring, a pyrazole ring, an imidazole ring, an oxazole ring, a thiazole ring, a triazole ring, oxadiazole ring, a thiadiazole ring, an indole ring, a benzimidazole ring, a benzthiazole ring, a purine ring, a pyridine ring, a pyrazine ring, a pyrimidine ring, a pyrazine ring, a triazine ring, a quinoline ring, an isoquinoline ring, a purine ring, a cinnoline ring, a quinoxaline ring, and an acridine ring), furthermore, preferably a 6-membered nitrogen-containing heteroaromatic ring represented by the general formula (6), and particularly preferable to be a quinoline ring structure and isoquinoline ring structure.

In the general formula (6), Z¹ through Z⁶ each represent a carbon atom or a nitrogen atom; any one of the Z¹ through Z⁶ is a nitrogen atom; at least one of the rest is a carbon atom; at least one of carbon atoms represented by the Z¹ through Z⁶ is combined with a squalilium carbon in the general formula (5).

R⁴¹ and R⁴² represent a hydrogen atom, —OR⁴⁴ or —NR⁴⁵R⁴⁶. Furthermore, a ring that contains R⁴¹ and R⁴² in the same ring may be formed. R⁴⁴ represents a group substituent for a hydrogen atom or an oxygen atom and R⁴⁵ and R⁴⁶ each represent a group substituent for a hydrogen atom or a nitrogen atom. A substituent for an oxygen atom and represented by R⁴⁴ and substituent for a nitrogen atom and represented by R⁴⁵ and R⁴⁶ are specifically a halogen atom (a chlorine atom, bromine atom, iodine atom, or fluorine atom, preferably bromine atom may be mentioned); an alkyl group (the number of carbons is preferably 1 to 20, more preferably 1 to 12, and particularly preferably 1 to 8; for instance, methyl, trifluoromethyl, ethyl, iso-propyl, tert-butyl, n-octyl, n-decyl, n-hexadecyl, cyclopropyl, cyclopentyl and cyclohexyl may be mentioned), an alkenyl group (the number of carbons is preferably 2 to 20, more preferably 2 to 12, and particularly preferably 2 to 8; for instance, vinyl, allyl, 2-butenyl, and 3-pentenyl may be mentioned), an alkynyl group (the number of carbons is preferably 2 to 20, more preferably 2 to 12, and particularly preferably 2 to 8; for instance, propargyl and 3-pentinyl may be mentioned), an aryl group (the number of carbons is preferably 6 to 30, more preferably 6 to 20, and particularly preferably 6 to 12; for instance, phenyl, p-methylphenyl and naphthyl ,ay be mentioned), an amino group (the number of carbons is preferably 0 to 20, more preferably 0 to 10, and particularly preferably 0 to 6; for instance, amino, methylamino, dimethylamoni, diethylamino, and dibenzilamino may be mentioned), an acyl group (the number of carbons is preferably 1 to 20, more preferably 1 to 16, and particularly preferably 1 to 12; for instance, acetyl, benzoyl, formyl, and pivaloyl may be mentioned), an alkoxycarbonyl group (the number of carbons is preferably 2 to 20, more preferably 2 to 16, and particularly preferably 2 to 12; for instance, methoxycarbonyl and ethoxycarbonyl may be mentioned), an aryloxycarbonyl group (the number of carbons is preferably 7 to 20, more preferably 7 to 16, and particularly preferably 7 to 12; for instance, phenyloxycarbonyl may be mentioned), an acylamino group (the number of carbons is preferably 2 to 20, more preferably 2 to 16, and particularly preferably 2 to 10; for instance, acetylamino and benzoylamino may be mentioned), an alkoxycarbonylamino group (the number of carbons is preferably 2 to 20, more preferably 2 to 16, and particularly preferably 2 to 12; for instance, methoxycarbonylamino and so on maay be mentioned), an aryloxycarbonylamino group (the number of carbons is preferably 7 to 20, more preferably 7 to 16, and particularly preferably 7 to 12; for instance, phenyloxycarbonylamino and so on maay be mentioned), a sulfonylamino group (the number of carbons is preferably 1 to 20, more preferably 1 to 16, and particularly preferably 1 to 12; for instance, methanesulfonylamino and benzenesulfonylamino may be mentioned), a sulfamoyl group (the number of carbons is preferably 0 to 20, more preferably 0 to 16, and particularly preferably 0 to 12; for instance, sulfamoyl, methylsulfamoyl and dimethylsulfamoyl may be mentioned), a carbamoyl group (the number of carbons is preferably 1 to 20, more preferably 1 to 16, and particularly preferably 1 to 12; for instance, carbamoyl, methylcarbamoyl, diethylcarbamoyl, and phenylcarbamoyl may be mentioned), an alkylsulfonyl group (the number of carbons is preferably 1 to 20, more preferably 1 to 16, and particularly preferably 1 to 12; for instance, methylsulfonyl and ethylsulfonyl maay be mentioned), an arylsulfonyl group (the number of carbons is preferably 6 to 20, more preferably 6 to 16, and particularly preferably 6 to 12; for instance, phenylsulfonyl and so on may be mentioned), a sulfinyl group (the number of carbons is preferably 1 to 20, more preferably 1 to 16, and particularly preferably 1 to 12; for instance, methanesulfinyl and benzenesulfinyl may be mentioned), an ureido group (the number of carbons is preferably 1 to 20, more preferably 1 to 16, and particularly preferably 1 to 12; for instance, ureido, methylureido and phenylureido maay be mentioned), a hydroxyl group and a heterocyclic group (for instance, triazolyl, imidazolyl, pyridyl, furyl, piperidyl, and morpholino maay be mentioned) may be listed. The substituents may be further substituted.

R⁴⁵ is preferably a hydrogen atom. R⁴⁴ and R⁴⁶ are preferably an alkyl group, an alkenyl group, an alkynyl group, an aryl group and a heterocyclic group. Particularly preferable one is the alkyl group.

When a ring that contains R⁴¹ and R⁴² in the same ring is formed, the ring is preferably a 6- or more-membered ring, particularly preferably a 6-membered ring.

R⁴³ represents a substituent capable of bonding with atoms that form a 6-membered nitrogen-containing heteroaromatic ring represented by (6); specifically, an alkyl group (the number of carbons is preferably 1 to 20, more preferably 1 to 12, and particularly preferably 1 to 8; for instance, methyl, ethyl, iso-propyl, tert-butyl, n-octyl, n-decyl, n-hexadecyl, cyclopropyl, cyclopentyl, and cyclohexyl may be mentioned), an alkenyl group (the number of carbons is preferably 2 to 20, more preferably 2 to 12, and particularly preferably 2 to 8; for instance, vinyl, allyl, 2-butenyl, and 3-pentenyl may be mentioned), an alkynyl group (the number of carbons is preferably 2 to 20, more preferably 2 to 12, and particularly preferably 2 to 8; for instance, propargyl and 3-pentinyl may be mentioned), an aryl group (the number of carbons is preferably 6 to 30, more preferably 6 to 20, and particularly preferably 6 to 12; for instance, phenyl, p-methylphenyl and naphthyl may be mentioned), an amino group (the number of carbons is preferably 0 to 20, more preferably 0 to 10, and particularly preferably 0 to 6; for instance, amino, methylamino, dimethylamoni, diethylamino, and dibenzilamino may be mentioned), an alkoxy group (the number of carbons is preferably 1 to 20, more preferably 1 to 12, and particularly preferably 1 to 8; for instance, methoxy, ethoxy and buthoxy may be mentioned), an aryloxy group (the number of carbons is preferably 6 to 20, more preferably 6 to 16, and particularly preferably 6 to 12; for instance, phenyloxy and 2-naphthyloxy may be mentioned), an acyl group (the number of carbons is preferably 1 to 20, more preferably 1 to 16, and particularly preferably 1 to 12; for instance, acetyl, benzoyl, formyl, and pivaloyl may be mentioned), an alkoxycarbonyl group (the number of carbons is preferably 2 to 20, more preferably 2 to 16, and particularly preferably 2 to 12; for instance, methoxycarbonyl and ethoxycarbonyl may be mentioned), an aryloxycarbonyl group (the number of carbons is preferably 7 to 20, more preferably 7 to 16, and particularly preferably 7 to 12; for instance, phenyloxycarbonyl and so on may be mentioned), an acyloxy group (the number of carbons is preferably 2 to 20, more preferably 2 to 16, and particularly preferably 2 to 10; for instance, acetoxy and benzoyloxy may be mentioned), an acylamino group (the number of carbons is preferably 2 to 20, more preferably 2 to 16, and particularly preferably 2 to 10; for instance, acetylamini and benzoylamino may be mentioned), an alkoxycarbonylamino group (the number of carbons is preferably 2 to 20, more preferably 2 to 16, and particularly preferably 2 to 12; for instance, methoxycarbonylamino and so on may be mentioned), an aryloxycarbonylamino group (the number of carbons is preferably 7 to 20, more preferably 7 to 16, and particularly preferably 7 to 12; for instance, phenyloxycarbonylamino and so on may be mentioned), a sulfonylamino group (the number of carbons is preferably 1 to 20, more preferably 1 to 16, and particularly preferably 1 to 12; for instance, methanesulfonylamino and benzenesulfonylamino may be mentioned), a sulfamoyl group (the number of carbons is preferably 0 to 20, more preferably 0 to 16, and particularly preferably 0 to 12; for instance, sulfamoyl, methylsulfamoyl and dimethylsulfamoyl may be mentioned), a carbamoyl group (the number of carbons is preferably 1 to 20, more preferably 1 to 16, and particularly preferably 1 to 12; for instance, carbamoyl, methylcarbamoyl, diethylcarbamoyl, and phenylcarbamoyl may be mentioned), an alkylthio group (the number of carbons is preferably 1 to 20, more preferably 1 to 16, and particularly preferably 1 to 12; for instance, methylthio and ethylthio may be mentioned), an arylthio group (the number of carbons is preferably 6 to 20, more preferably 6 to 16, and particularly preferably 6 to 12; for instance, phenylthio and so on may be mentioned), a sulfinyl group (the number of carbons is preferably 1 to 20, more preferably 1 to 16, and particularly preferably 1 to 12; for instance, methanesulfinyl and benzenesulfinyl may be mentioned), a ureido group (the number of carbons is preferably 1 to 20, more preferably 1 to 16, and particularly preferably 1 to 12; for instance, ureido, methylureido and phenylureido may be mentioned), a phosphoric amide group (the number of carbons is preferably 1 to 20, more preferably 1 to 16, and particularly preferably 1 to 12; for instance, diethylphosphoric amide and phenylphosphoric amide may be mentioned), a hydroxy group, a mercapto group, a halogen atom (for instance, fluorine atom, chlorine atom, bromine atom and iodine atom), a cyano group, a sulfo group, a carboxyl group, a nitro group, a hydroxamic group, a sulfino group, a hydrazino group, a heterocyclic group (for instance, imidazolyl, pyridyl, furyl, piperidyl, and morpholino may be mentioned) can be listed. The substituents may be further substituted.

An n1 represents an integer of 0 to 4, preferably 0 or 1, particularly preferably 0.

A bonding position of a squalene ring is normally at an ortho- or para-position with respect to the R⁴¹ or R⁴².

In the general formula (5), at least one of the A¹ and A² represents a quinoline ring or an iso-quinoline ring.

Hereafter, specific examples of squalilium compounds (dye) represented by the general formula (5) or (6) according to the invention are shown; however, the invention is not restricted thereto.

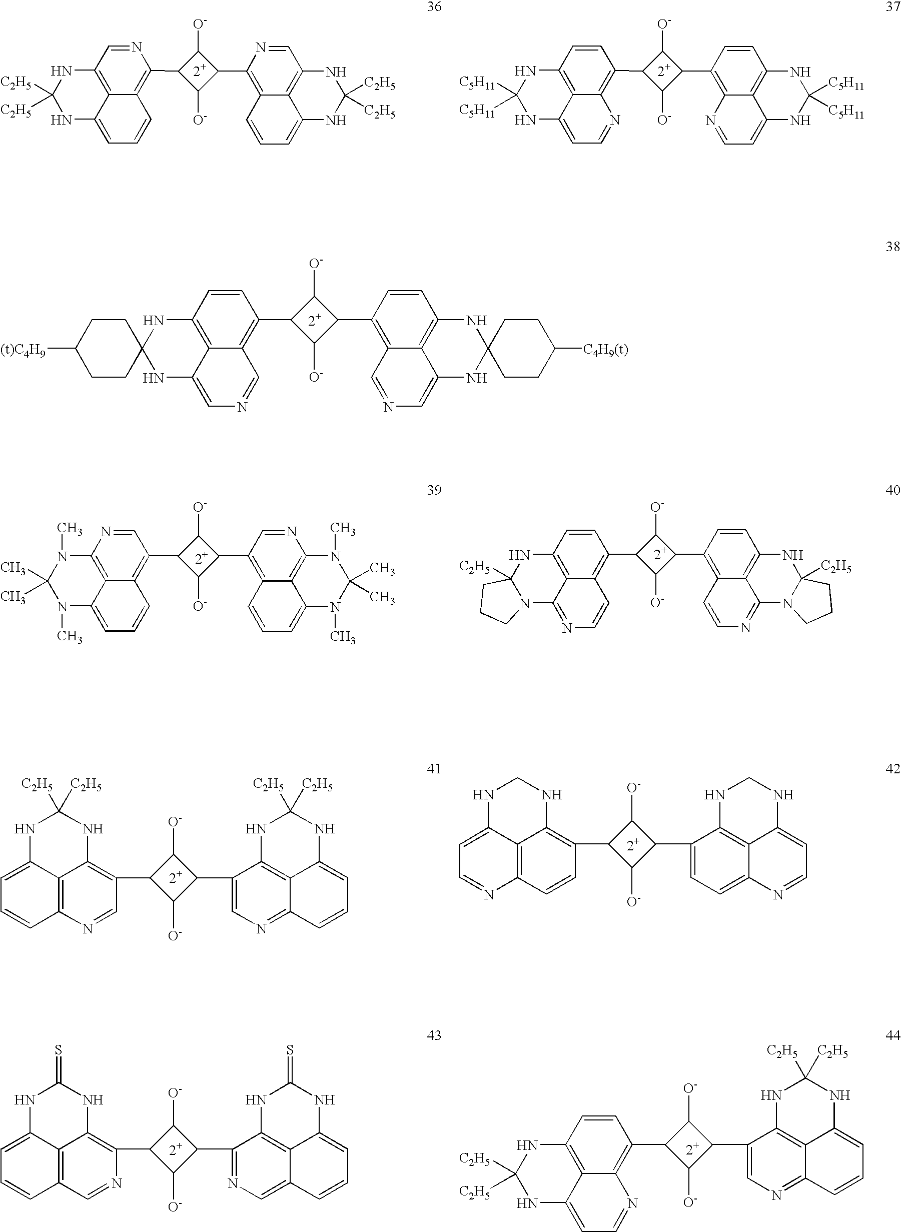

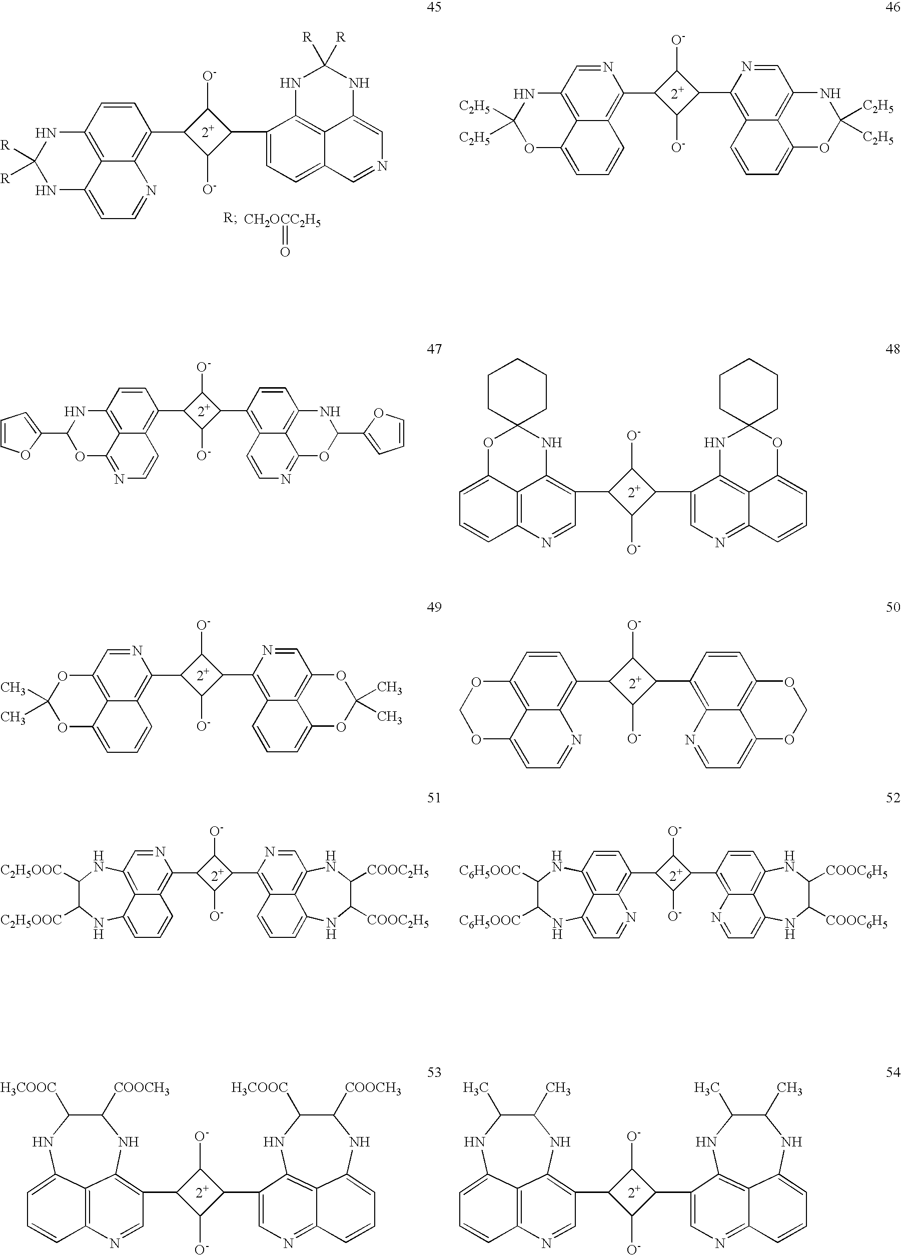

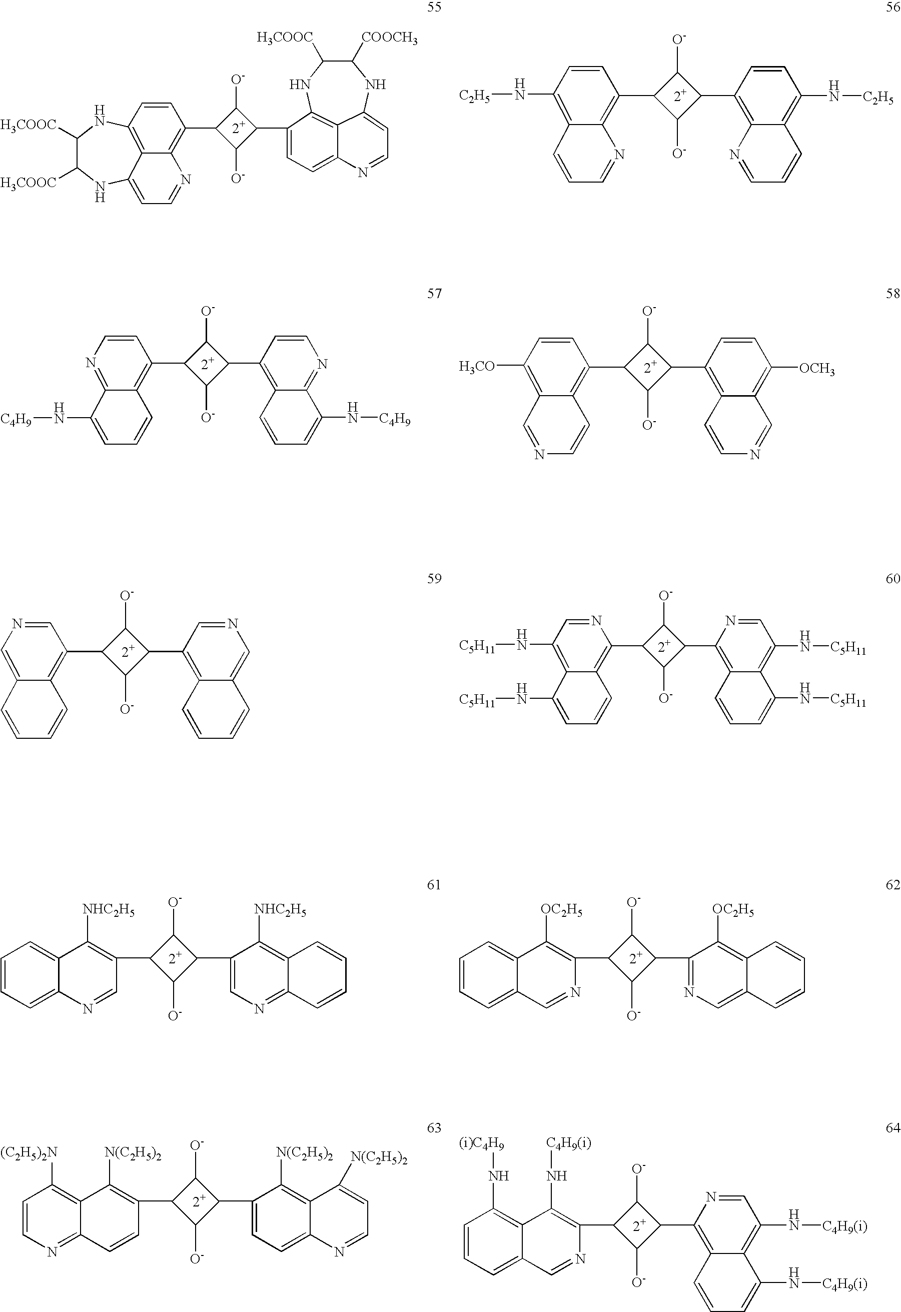

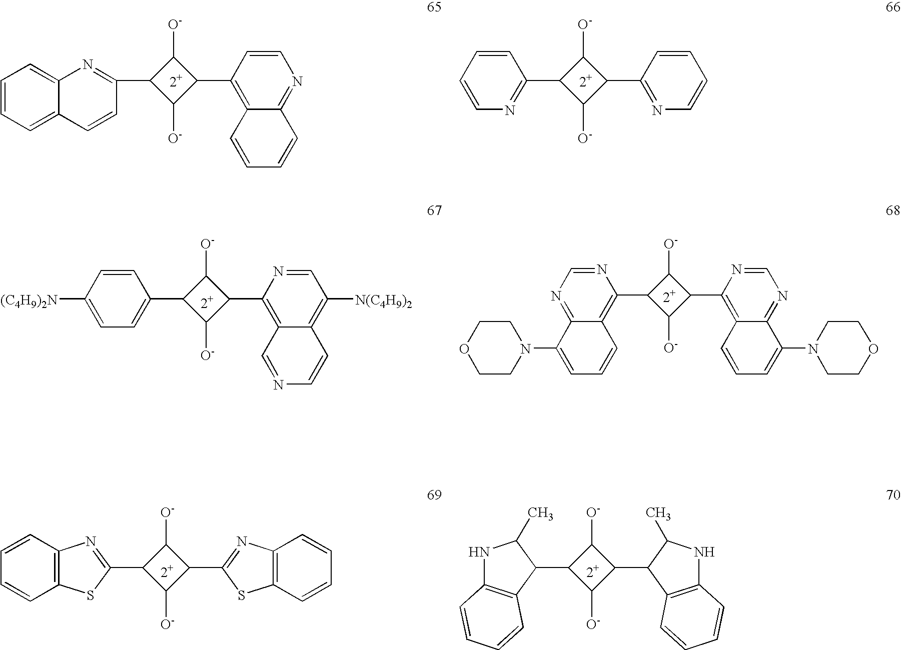

The synthesis of these compounds can be carried out according to methods described in JP-W No.9-509503, and JP-A No. 10-104779.

The compounds are incorporated in an image-forming layer, a surface protective layer, a back layer, or a layer disposed between a support and the image-forming layer to exert irradiation inhibition, halation inhibition, and filter effect and so on.

In the invention, these compounds are solid-dispersed or emulsion-dispersed and incorporated in the layer. In the solid fine particle dispersion method that is well known to those skilled in the art, the compounds are dispersed in an appropriate solvent such as water or the like using a ball mill, colloid mill, vibration ball mill, sand mill, jet mill, roller mill or ultrasonic, and thereby a solid dispersion is prepared. Preferred is a dispersion method that uses a sand mill. In that case, a protective colloid (for instance, polyvinyl alcohol), a surfactant (for instance, an anionic surfactant such as sodium triisopropylnaphthalene sulfonate (a mixture of ones in which substituting positions of three isopropyl groups are different)) may be used. In an aqueous dispersion, an antiseptic agent (for instance, benzoisothiazolinone sodium salt) may be contained.

The obtained dispersion of solid fine particles is preferably added as fine particles having an average particle size of from 0.01 to 10 μm, preferably from 0.05 to 5 μm, more preferably from 0.1 to 1 μm.

An amount of the compounds being added is from 0.1 to 1000 mg/m², preferably from 0.1 to 200 mg/m². These compounds are added, relative to a binder in the layer, in an amount ranging from 0.1 to 60% by mass, preferably in the range of from 0.2 to 30% by mass.

1-15. Other Additives

1) Mercaptos, Disulfides and Thiones

In the invention, in order to control development by suppressing or accelerating development, to improve the spectral sensitization efficiency, and to improve preservation properties before and after development, mercapto compounds, disulfide compounds and thione compounds may be contained; these compounds are described in JP-A No.10-62899 paragraph Nos.0067 through 0069, compounds represented by the general formula (I) in JP-A No.10-186572 and in paragraph Nos.0033 through 0052 as specific examples, EP-A No.0803764A1 page 20, lines 36 through 56, and Japanese Patent Application No.11-273670. Among these, mercapto-substituted heteroaromatic compounds are preferable.

2) Toning Agent

In the photothermographic materials according to the invention, a toning agent is preferably added; the toning agents are described in JP-A No.10-62899 paragraph Nos.0054 through 0055, EP No.0803764A1 page 21, lines 23 through 48, JP-A No.2000-356317 and Japanese Patent Application No.2000-187298; in particular, phthalazinones (phthalazinone, phthalazinone derivatives or metal salts; for instance, 4-(1-naphthyl)phthalazinone, 6-chlorophthalazinone, 5,7-dimethoxyphthalazinone and 2,3-dihydro-1,4-phthalazinone); combinations of phthalazinones and phthalic acids (for instance, phthalic acid, 4-methyl phthalic acid, 4-nitro phthalic acid, diammonium phthalate, sodium phthalate, potassium phthalate and tetrachlorophthalic anhydride); and phthalazines (phthalazine, phthalazine derivatives and metal salts; for instance, 4-(1-naphthyl)phthalazine, 6-isopropylphthalazine, 6-tert-butylphthalazine, 6-chlorophthalazine, 5,7-dimethoxyphthalazine and 2,3-dihydrophthalazine) are preferable; in particular, in combinations with silver halides having a high silver iodide content, combinations of phthalazines and phthalic acids are preferable.

A preferable amount of phthalazines to be added is preferably 0.01 to 0.3 mol per mol of organic silver salt, more preferably 0.02 to 0.2 mol, and particularly preferably 0.02 to 0.1 mol. The amount to be added is an important factor in the development acceleration that is a problem in silver halide emulsions having a high silver iodide content according to the invention; when the amount to be added is properly selected, sufficient development properties and the low fog may both be fulfilled.

3) Plasticizer and Lubricant

Plasticizers and lubricants that may be used in the invention are described in JP-A No.11-65021 paragraph No.0117. The lubricants are described in JP-A No. 11-84573, paragraph Nos. 0061 through 0064 and Japanese Patent Application No.11-106881, paragraph Nos. 0049 through 0062.

4) High Contrast Promoting Agent

In order to form ultrahigh contrast images suitable for use in printing and plate-making, a high contrast promoting agent is preferably added to an image-forming layer. The high contrast promoting agents, methods and amounts to for addition thereof are described in JP-A No. 11-65021 paragraph 0118, JP-A No. 11-223898 paragraph Nos.0136 through 0193, compounds represented by formulas (H), (1) through (3), and (A) and (B) in Japanese Patent Application No.11-87297, and compounds (specific compounds: Chemical formulas 21 through 24) represented by general formulas (III) through (V) in Japanese Patent Application No.11-91652; and the high contrast accelerators are described in JP-A No.11-65021 paragraph No.0102 and JP-A No.11-223898 paragraph Nos.0194 through 0195.

In order to use formic acid and formates as a strong fogging agent, it is preferably added in a face having an image-forming layer that contains photosensitive silver halide by 5 mmol or less per mol of silver, more preferably 1 mmol or less.

When the high contrast promoting agent is used in the photothermographic material according to the invention, acids formed through hydration of diphosphorus pentaoxide or their salts can be preferably used in combination. As acids formed through the hydration of diphosphorus pentaoxide or their salts, metaphosphoric acids (metaphosphates), pyrophosphoric acids (pyrophosphates), orthophosphoric acids (orthophosphates), triphosphates (triphosphates), tetraphosphates (tetraphosphates), and hexametaphosphoric acids (hexametaphosphates) may be mentioned. As particularly preferably used acids formed through hydration of diphosphorus pentaoxide or their salts, orthophosphoric acids (orthophosphates) and hexametaphosphoric acids (hexametaphosphates) may be mentioned. As specific salts, sodium orthophosphate, sodium dihydrogen orthophosphate, sodium hexametaphosphate, and ammonium hexametaphosphate may be mentioned.

An amount (an amount to be coated per m² of a photosensitive material) of the acids formed through the hydration of diphosphorus pentaoxide or their salts to be added may be specified at desired amounts in accordance with performance such as the sensitivity and fog; however, it is preferably 0.1 to 500 mg/m², more preferably 0.5 to 100 mg/m².

1-16. Preparation Method of Coating Solution

A coating solution for use in the formation of an image-forming layer of the invention is well prepared at temperatures equal to or higher than 30° C. and equal to and lower than 65° C., furthermore preferably at temperatures equal to or higher than 35° C. and equal to and lower than 60° C., and still more preferably at temperatures equal to or higher than 35° C. and equal to and lower than 55° C. The coating solution for use in the formation of an image-forming layer immediately after the addition of polymer latex is preferably maintained at temperatures equal to or higher than 30° C. and equal to or lower than 65° C.

1-17. Layer Construction, and Other Constituents

The photothermographic material according to the invention can include, in addition to the image-forming layer, a non-photosensitive layer. The non-photosensitive layer can be divided, from their locations, into (a) a surface protective layer disposed on the image-forming layer (on a more remote side from a support), (b) an interlayer disposed between a plurality of image-forming layers or between the image-forming layer and the protective layer, (c) an undercoat layer disposed between the image-forming layer and the support and (d) a back layer disposed on a side opposite to the image-forming layer.

Furthermore, a layer that acts as an optical filter can be disposed as a layer of (a) or (b). An anti-halation layer is disposed to the photosensitive material as a layer (c) or (d).

1) Surface Protective Layer

In the photothermographic material according to the invention, a surface protective layer may be disposed so as to prevent the image-forming layers from sticking. The surface protective layer may be a monolayer or a multilayer. The surface protective layer is described in JP-A No.11-65021 paragraph Nos. 0119 through 0120 and Japanese Patent Application No.2000-171936.

As the binder in the surface protective layer according to the invention, although gelatin may be preferably used, polyvinyl alcohol (PVA) can be also preferably used singly or in combination. As the gelatins, inert gelatin (for instance, Nitta gelatin 750), and phthalated gelatin (for instance, Nitta gelatin 801) may be used.

As the PVA, ones described in JP-A No.2000-171936 paragraph Nos. 0009 through 0020 may be mentioned; completely saponified PVA-105, partially saponified PVA-205 and PVA-335 and modified polyvinyl alcohol MP-203 (trade names of the products available from Kuraray Co., Ltd.) may be preferably mentioned.

The coating amount (per m² of the support) of polyvinyl alcohol for the protective layer (in a single layer) is preferably 0.3 to 4.0 g/m², more preferably 0.3 to 2.0 g/m².

The coating amount (per m² of the support) of a total binder (including water soluble polymer and latex polymer) for the surface protective layer (in a single layer) is preferably 0.3 to 5.0 g/m², more preferably 0.3 to 2.0 g/m².

2) Anti-Halation Layer

In the photothermographic material according to the invention, an anti-halation layer may be disposed on a side remote from an exposure light source relative to the image-forming layer. The anti-halation layers are described in JP-A No.11-65021 paragraph Nos.0123 through 0124, JP-A Nos.11-223898, 9-230531, 10-36695, 10-104779, 11-231457, 11-352625 and 11-352626.

The anti-halation layer contains an anti-halation dye that has absorption wavelengths of exposed light. When the exposure wavelength is in an infrared region, an infrared absorbing dye may be used; in that case, a dye that does not exhibit absorption in a visible region is preferably used.

When halation is inhibited from occurring by use of a dye having absorption in a visible region, the dye is preferably applied so that after the image formation, a color of the dye may not practically remain; in this case, decolorizing means due to heat of thermal development can be preferably employed; in particular, it is preferable to allow functioning as an anti-halation layer by adding a thermally decolorizing dye and a base precursor to the non-photosensitive layer. These techniques are described in JP-A No.11-231457.

The addition amount of the decolorizing dye is determined according to application of the dye. Usually, an amount that exceeds 0.1 in the optical density (absorbance) when measured at an intended wavelength is used. The optical density is preferably 0.2 to 2. The use amount of the dye to obtain such an optical density is generally substantially 0.001 to 1 g/m².

When decolorizing the dye, the optical density after the heat development can be lowered to 0.1 or less. Two or more kinds of decolorizing dyes may be used together in the heat decolorizing recording materials and photothermographic materials. Similarly, two kinds or more of base precursors may be used in combination.

In the heat decolorization that uses such decolorizing dye and the base precursor, from the heat decolorizability point of view, it is preferable to concurrently use a substance (for instance, diphenylsulfone and 4-chlorophenyl(phenyl)sulfone) described in JP-A No.11-352626 that lowers the melting point, by 3 degree centigrade or more, when used together with the base precursor.

3) Back Layer

The back layers that can be applied to the invention are described in JP-A No.11-65021 paragraph Nos.0128 to 0130.

In the invention, in order to improve silver color tone and the stability of image with time, a coloring agent having a maximum absorption from 300 to 450 nm may be added. Such coloring agents are described in JP-A Nos.62-210458, 63-104046, 63-103235, 63-208846, 63-306436, 63-314535 and 01-61745, and Japanese Patent Application 11-276751. Such coloring agents are usually added in the range of from 0.1 mg/m² to 1 g/m², and a layer to be added is preferably a back layer disposed on a side opposite to the photosensitive layer.

4) Matting Agent

In the invention, in order to improve the conveying ability, a matting agent is preferably added to the surface protective layer and the back layer. The matting agents are described in JP-A No.11-65021 paragraph Nos.0126 to 0127.

The matting agent, when expressed by a coating amount per m² of a photosensitive material, is preferably 1 to 400 mg/m², more preferably 5 to 300 mg/M².

Furthermore, as long as no stardust trouble that generates small white falling-outs and light leakage in the image portion is caused, the matte degree of a surface having an emulsion may be any degrees. However, the Beck's smoothness is preferably 30 seconds or more and 2000 seconds or less, and particularly preferably 40 seconds or more and 1500 seconds or less. The Beck's smoothness can be easily obtained according to Japanese Industrial Standards (JIS) P8119 “Test Method for Smoothness of Paper and Paperboard by Beck Test Device” and TAPPI Standard Method T479.

In the invention, the matte degree of the back layer is preferably 1200 seconds or less and 10 seconds or more in terms of the Beck's smoothness, more preferably 800 seconds or less and 20 seconds or more, and more preferably 500 seconds or less and 40 seconds or more.

In the invention, the matting agent is preferably contained in the outermost surface layer of the photosensitive material or a layer that serves as the outermost surface layer or a layer near to an outer surface; furthermore, it is preferably contained in a layer that functions as a so-called protective layer.

5) Polymer Latex

To the surface protective layer and the back layer according to the invention, a polymer latex may be added.

Such polymer latexes are described in “Synthetic Resin Emulsion” ed. Okuda Taira and Inagaki Hiroshi (Koubunnshi Kannkoukai, 1978), “Application of Synthetic Latex” ed. Sugimura Takaaki, Kataoka Yasuo, Suzuki Souichi and Kasahara Keiji (Koubunnshi Kannkoukai, 1993) and Muroi Souichi, “Chemistry of Synthetic Latex” (Koubunnshi Kannkoukai, 1970), and specifically, a latex of methyl methacrylate (33.5% by mass)/ethyl acrylate (50% by mass)/methacrylic acid (16.5% by mass) copolymer, a latex of methyl methacrylate (47.5% by mass)/butadiene (47.5% by mass)/itaconic acid (5% by mass) copolymer, a latex of a copolymer of ethyl acrylate/methacrylic acid, a latex of methyl methacrylate (58.9% by mass)/2-ethylhexyl acrylate (25.4% by mass)/styrene (8.6% by mass)/2-hydroxyethyl methacrylate (5.1% by mass)/acrylic acid (2.0% by mass) copolymer and a latex of methyl methacrylate (64.0% by mass)/styrene (9.0% by mass)/butyl acrylate (20.0% by mass)/2-hydroxyethyl methacrylate (5.0% by mass)/acrylic acid (2.0% by mass) copolymer may be mentioned.

The polymer latex is preferably used in the range of from 10 to 90% by mass with respect to a total binder (including the water soluble polymer and the latex polymer) in the surface protective layer or the back layer, and particularly preferably in the range of from 20 to 80% by mass.

6) Film Surface pH

The photothermographic material according to the present invention preferably has a film surface pH before heat development of 7.0 or less, more preferably 6.6 or less. The lower limit thereof, though not restricted to a particular value, is substantially 3. The most preferable pH range is in the range of from 4 to 6.2.

In controlling the film surface pH, a nonvolatile acid such as an organic acid such as phthalic acid derivatives and sulfuric acid, and a volatile base such as ammonia are preferably used from a viewpoint of lowering the film surface pH. In particular, since ammonia is highly volatile and can be removed before coating or heat development, it can be preferably used in attaining a lower film surface pH.

Furthermore, nonvolatile bases such as sodium hydroxide, potassium hydroxide and lithium hydroxide and ammonium can be preferably used in combination. The method for measuring the film surface pH is described in Japanese Patent Application No.11-87297 paragraph No.0123.

7) Hardener

The photothermographic material according to the invention preferably contains a hardener at least in one layer. Preferably, the hardener is contained in a non-photosensitive layer, and more preferably in the surface protective layer. Furthermore, as necessary, it can be added in the image-forming layer. The hardener of the invention can be added any time during preparation of a coating solution of the non-photosensitive layer; however, it is preferably added immediately before the coating.

A binder of the non-photosensitive layer to which the hardener of the invention is to be added may be any binders and may be used in any ratios; however, it is preferable to contain gelatin by 30% by mass or more with respect to a total binder of a latex/gelatin-based binder, and more preferable to contain by 50 to 90% by mass. The latex as used herein is one polymerized by emulsion polymerization, suspension polymerization or the like; the latex may be used in combination thereof or separately.

As the gelatin, lime-treated gelatin and acid-treated gelatin may be used, and gelatin hydrolyzates and enzymatic decomposition products of gelatin can also be used. For the acid-treated gelatin, pigskins can be preferably used as a raw material.

As the hardener of the invention, any one that reacts with a binder and forms a hard film can be used without restriction; ones that are used in the photography industry field such as aziridine-based, epoxy-based, vinylsulfone-based, acryloyl-based, chlorotriazine-based, methane-sulfonic acid ester-based, isocyanate-based, carbodiimide-based, maleimide-based, aldehyde-based, ketone-based, polymer-based, and inorganic compound-based can be mentioned; and these are described in Research Disclosure, Nos.17643, section 26 and 18716, section 651 and The Theory of the Photographic Process, 3^{rd} ed. (Macmillan), section 54. Among these, the hardener that is unlikely to lose the activity even in water, particularly, vinylsulfone-based and chlorotriazine-based ones can be preferably used separately or in combination.

The most preferable hardeners used in the invention are the compounds represented by general formula (B) or (C) below.

(CH₂═CH—SO₂)ₙ-L General formula (B):

(X—CH₂—CH₂—SO₂)ₙ-L General formula (C):

In the formulae (B) and (C), X represents a halogen atom, and L represents an n-valent organic linking group. Furthermore, when a compound according to the formula (B) or formula (C) is a low molecular weight compound, n represents an integer of 1 through 4. When it is a high molecular weight compound, L is an organic linking group including a polymer chain, and at this time, n is in the range of from 10 to 1000.

In the formulae (B) and (C), X is preferably a chlorine atom or a bromine atom, and the bromine atom is more preferable. n is an integer of 1 through 4, preferably 2 through 4, more preferably 2 through 3, and most preferably 2.

L is an n-valent organic group, preferably an aliphatic hydrocarbon group, an aromatic hydrocarbon group or a heterocyclic group; these groups may further link through an ether bond, an ester bond, an amide bond, a sulfonamide bond, a urea bond and an urethane bond. Furthermore, these groups may have a substituent; as the substituent, a halogen atom, alkyl group, aryl group, heterocyclic group, hydroxyl group, alkoxy group, aryloxy group, alkylthio group, arylthio group, acyloxy group, alkoxycarbonyl group, carbamoyloxy group, acyl group, acyloxy group, acylamino group, sulfonamide group, carbamoyl group, sulfamoyl group, sulfonyl group, phosphoryl group, carboxyl group and sulfo group may be mentioned, and a halogen atom, alkyl group, hydroxy group, alkoxy group, aryloxy group and acyloxy group are preferable.

As specific examples of vinylsulfone-based hardeners, VS-1 through VS-27 given below may be mentioned; however the invention is not restricted to these.

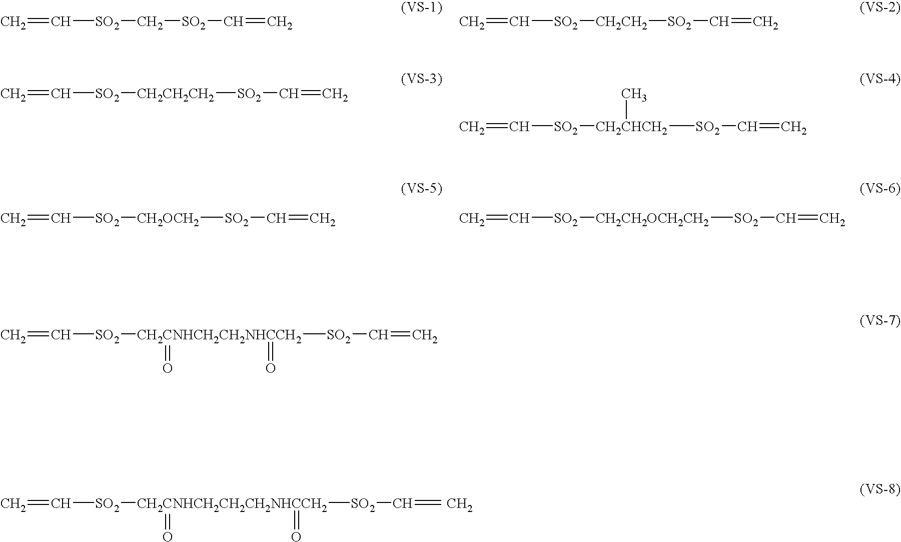

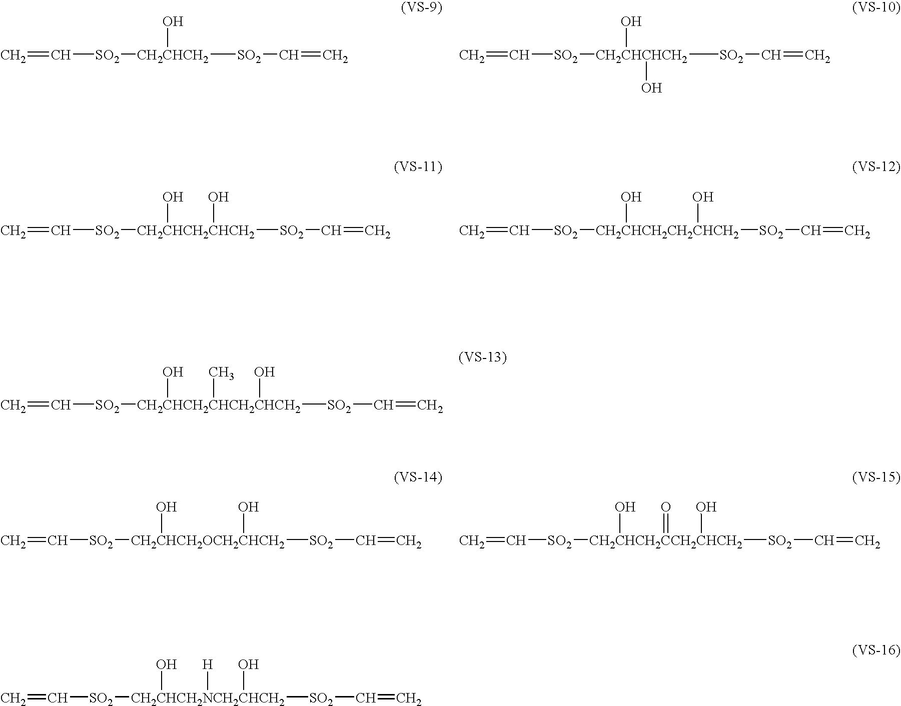

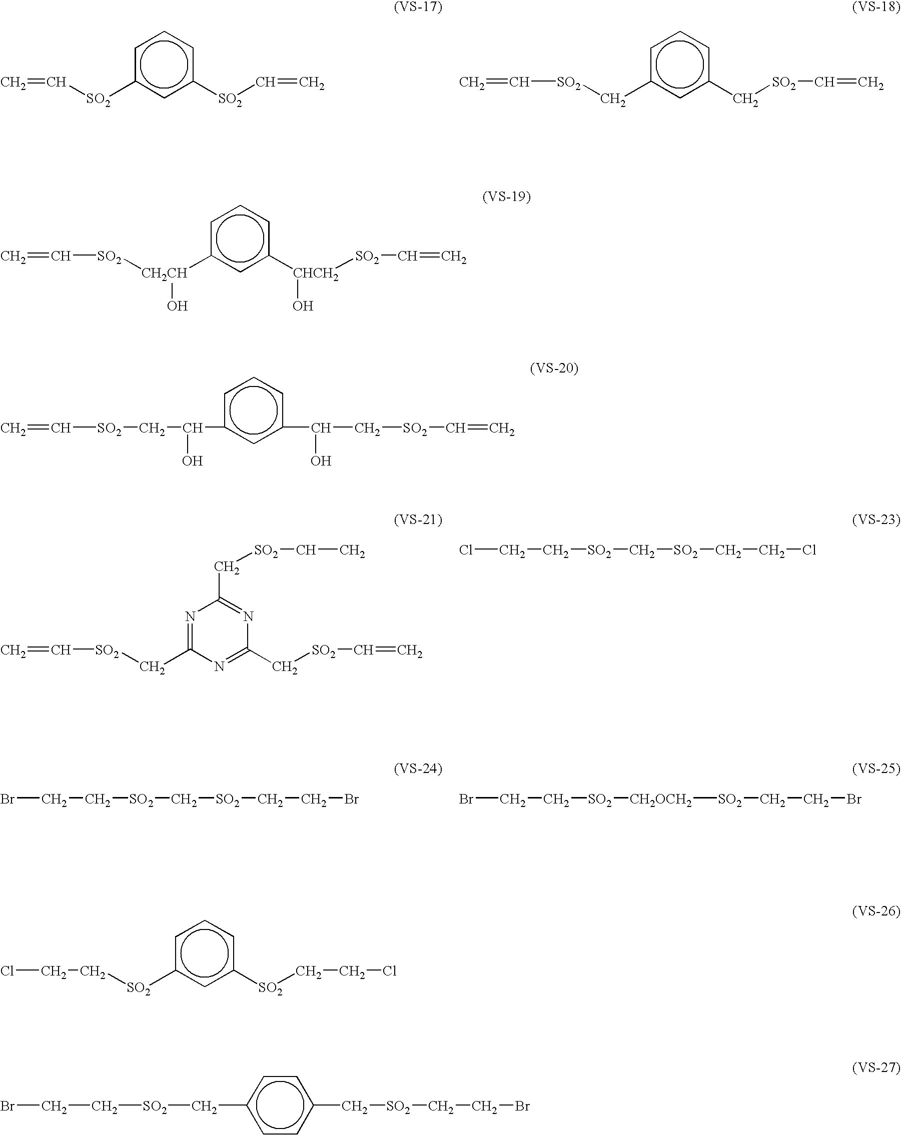

These hardeners can be obtained with reference to a method described in U.S. Pat. No. 4,173,481. Furthermore, as specific examples of chlorotriazine-based hardeners, 2-chloro-4,6-diphenoxytrazine, 2-chloro-4,6-bis[2,4,6-trimethylphenoxy]triazine, 2-chloro-4,6-diglycidoxy-1,3,5-triazine, 2-chloro-4-(n-butoxy)-6-glycidoxy-1,3,5-triazine, 2-chloro-4-(2,4,6-trimethylphenoxy)-6-glycioxy-1,3,5-triazine, 2-chloro-4-(2-chloroethoxy)-6-(2,4,6-trimethylphenoxy)1,3,5-triazine, 2-chloro-4-(2-bromoethoxy)-6-(2,4,6-trimethylphenoxy)-1,3,5-triazine, 2-chloro-4-(2-di-n-butylphosphatoethoxy)-6-(2,4,6-trimethylphenoxy)-1,3,5-triazine, and 2-chloro-4-(2-di-n-butylphosphatoethoxy)-6-(2,6-xylenoxy)-1,3,5-triazine may be mentioned; however, the invention is not restricted thereto. Such compounds may be produced by reacting cyanuric chloride (i.e., 2,4,6-trichlorotriazine) with a hydroxy compound or a thio compound corresponding to a substituent on a heterocycle.

In the invention, a diffusing hardener is preferable from a standpoint of the effect of the invention.

In the invention, a diffusion-resistant hardener is preferably incorporated in a non-photosensitive layer. As used herein, the “diffusion resistance” refers to a hardener that has tendency to localize in a disposed layer. In particular, a polymer hardener is particularly preferable in that in spite of the use of an aqueous coating solution, the diffusion resistance can be imparted.

Furthermore, the diffusion-resistant hardener is preferably a compound that has a reactive group that cross-links with a hydrophilic binder to be hardened and contained in a non-photosensitive layer outside of the image-forming layer, and, particularly an epoxy group or vinylsulfone group as a reactive group in a molecule.

In the invention, as the non-diffusing hardeners that can be preferably used, polymer hardeners having an epoxy group and polymer hardeners having a vinylsulfone group may be mentioned; vinylsulfone compounds and precursors thereof are more preferable. The precursor of a vinylsulfone compound means a compound having a reactive group that becomes a vinylsulfone group through a dehydrochlorination reaction or dehydrobromination reaction; specifically, a halogenated alkyl such as a halogenated ethyl or the like may be mentioned.

The polymer hardener that has an epoxy group preferably has a melting point or softening point of 60 to 200° C. or lower, and a molecular weight per mol of epoxy group of 100 to 2000 or less.

Specifically, polymer hardeners that are obtained by separately polymerizing monomers such as glycidyl acrylate, glycidyl methacrylate, glycidyl itaconate and acrylglycidyl ether, or co-polymerizing these with other monomers may be mentioned.

As the polymer hardeners, compounds that have structures represented by the general formula (B) or (C) are preferable. At this time, L represents a polymer chain, and n is an integer equal to 10 or more, and preferably in the range of from 10 to 1000.

As the polymer hardeners having the above vinylsulfone group, a molecular weight per mol of vinylsulfone group is preferably in the range of from 100 to 2000. Specific examples are given below.

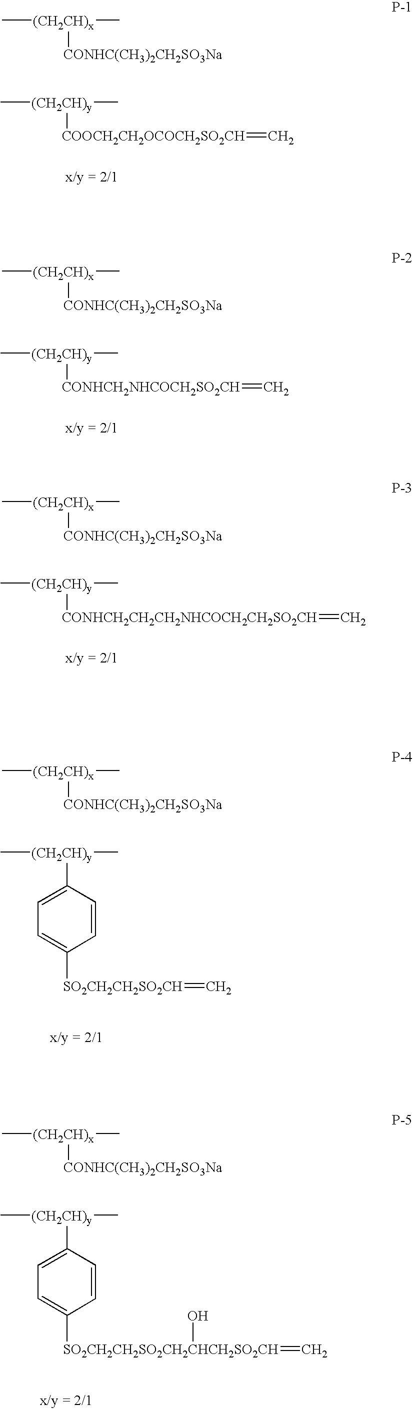

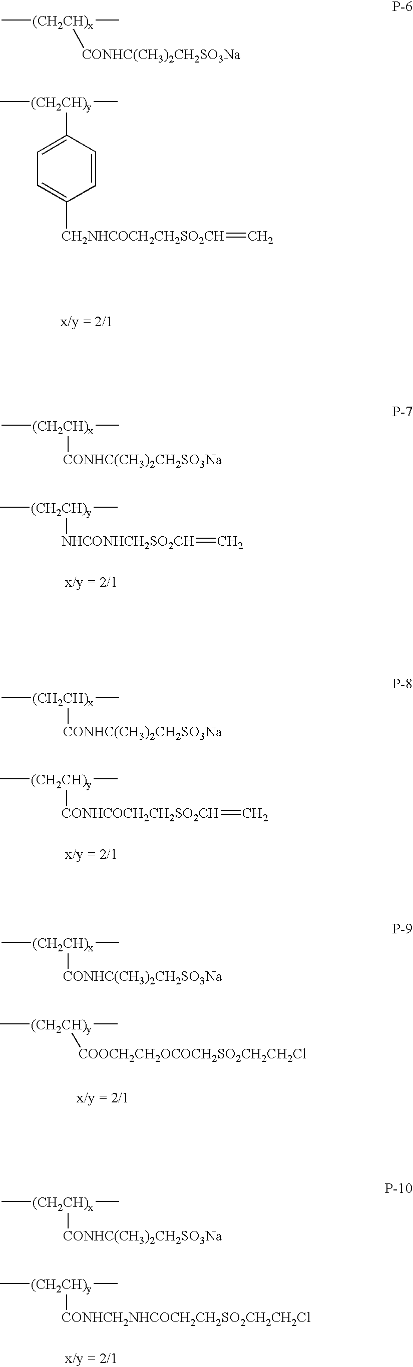

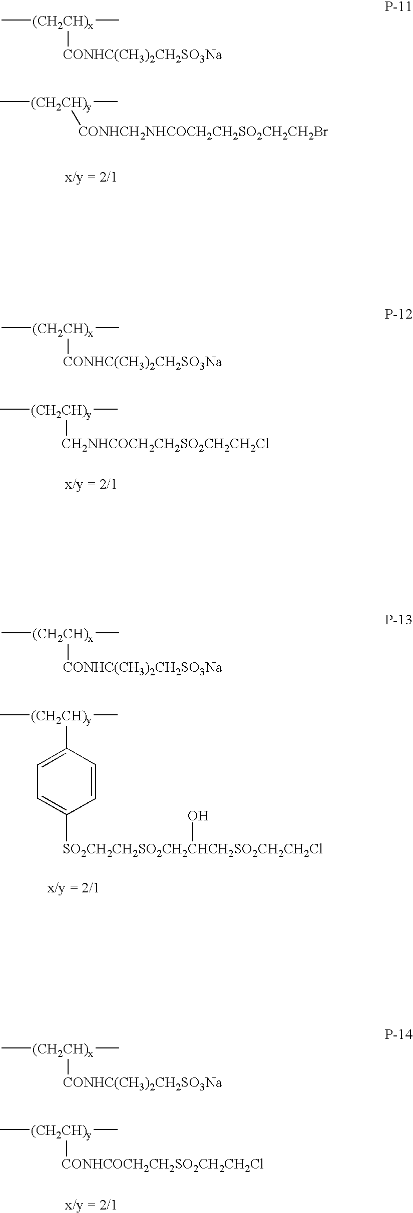

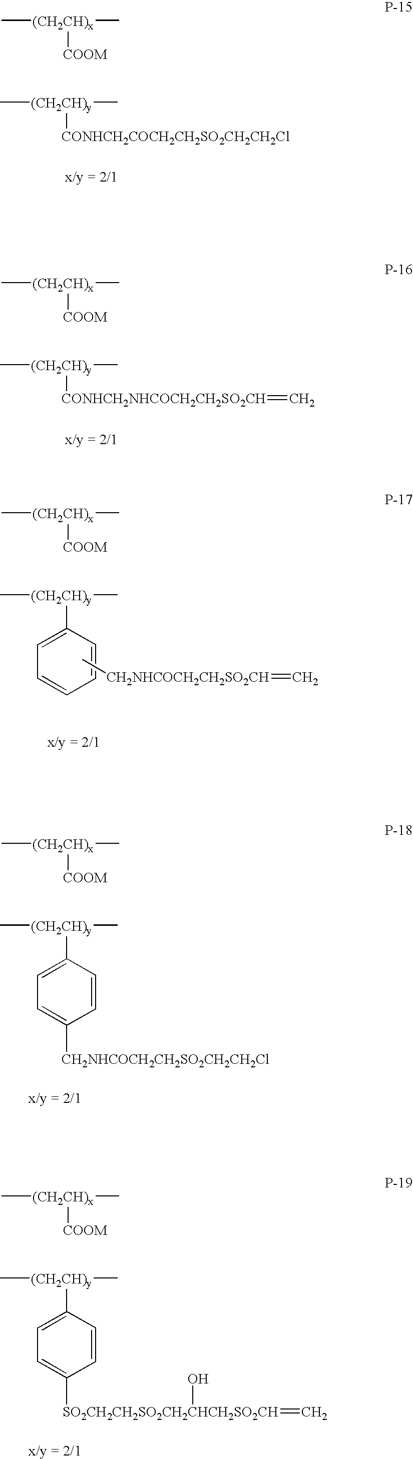

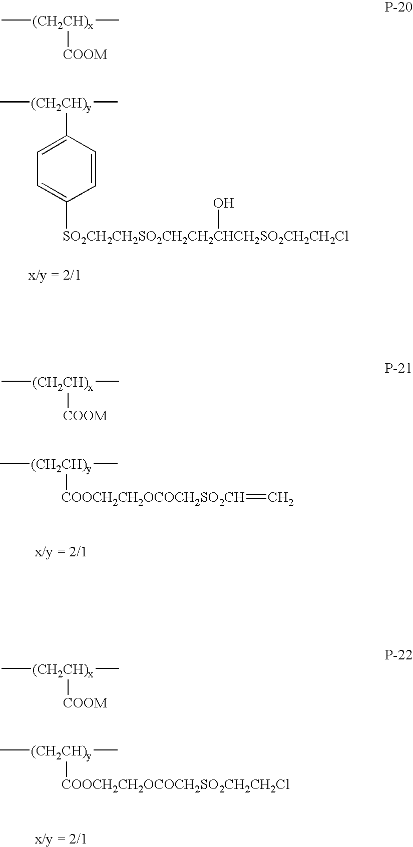

In the formulae, M represents a hydrogen atom, sodium atom or potassium atom; x and y are molar percentages of feeds of the respective units, and, without restricting to the above, may have values of from 0 to 99 and from 1 to 100, respectively. As to the synthesizing methods, JP-B No. 61-35540 can be referenced.

The use amount of the hardener of the invention is preferably 0.01 mmol or more per gram of gelatin, more preferably 0.05 mmol or more, and furthermore preferably 0.4 mmol or more.

8) Surfactant

The surfactants that may be applied to the invention are described in JP-A No. 11-65021 paragraph No.0132.

In the invention, fluorinated surfactants are preferably used. As preferable specific examples of the fluorinated surfactants, compounds described in JP-A Nos. 10-197985, 2000-19680 and 2000-214554 may be mentioned. Furthermore, fluorinated polymer surfactants described in JP-A No. 9-281636 may also be preferably used. In the invention, the fluorinated surfactants described in Japanese Patent Application No. 2000-206560 may be particularly preferably used.

9) Anti-Static Agent

Furthermore, in the invention, an anti-static layer that contains known various kinds of metal oxides or conductive polymers may be provided. The anti-static layer may combine with the undercoat layer or the surface protective layer of the back layer, or may be disposed separately. For the anti-static layer, techniques described in JP-A No. 11-65021 paragraph No. 0135, JP-A Nos. 56-143430, 56-143431, 58-62646, 56-120519, 11-84573 paragraph Nos. 0040 to 0051, U.S. Pat. No. 5,575,957, and JP-A No. 11-223898 paragraph Nos. 0078 to 0084 may be applied.

10) Support

For a transparent support, polyester, in particular, polyethylene terephthalate, which is heat-treated at a temperature in the range of from 130 to 185° C. in order to relieve internal strain remained in the film during the biaxially stretching and to remove thermal shrinkage strain generated during the heat development, is preferably used.

In the case of medical photothermographic materials, the transparent support may be colored with a blue dye (for instance, Dye-1 disclosed in an embodiment of JP-A 8-240877) or uncolored.

Specific examples of the support are described in JP-A No. 11-65021 paragraph No. 0134.

For the support, undercoating techniques of water-soluble polyester disclosed in JP-A 11-84574, styrene-butadiene copolymer disclosed in JP-A 10-186565 and vinylidene chloride copolymer disclosed in JP-A Nos. 2000-39684 and Japanese Patent Application No. 11-106881 paragraph Nos. 0063 to 0080 may be preferably applied.

11) Other Additives

To the photothermographic material, an anti-oxidant, stabilizer, plasticizer, ultraviolet light absorber or coating aide may be added. A solvent described in JP-A No. 11-65021 paragraph No. 0133 may be added. Various kinds of additives are added to any one of the photosensitive layer or non-photosensitive layer. Reference may be made to WO98/36322, EP No. 803764A1, JP-A Nos. 10-186567 and 10-18568.

12) Coating Method

The photothermographic material according to the invention may be coated by use of any of coating methods. Specifically, various coating methods including an extrusion coating, slide coating, curtain coating, immersion coating, knife coating, flow coating or extrusion coating that uses a hopper described in U.S. Pat. No. 2,681,294 can be used; the extrusion coating or slide coating described in Stephen F. Kistler, and Peter M. Schweizer, LIQUID FILM COATING (CHAPMANN & HALL, 1997), pp. 399 to 536 may be preferably used; the slide coating is particularly preferably used.

Examples of the shape of a slide coater usable in the slide coating are shown in ibid, p427, FIG. 11b.1. Furthermore, if needed, two or more layers may be simultaneously coated employing the methods described in ibid, pp. 399 to 536, and methods described in U.S. Pat. No. 2,761,791 and UKP No. 837095.

The coating solution for the organic silver salt-containing layer used in the invention is preferably a so-called thixotropic fluid. This technique may be referenced to JP-A No. 11-52509.

The viscosity of the coating solution for the organic silver salt-containing layer used in the invention is preferably 400 mPa.s or more and 100,000 mPa.s or less, and more preferably 500 mPa.s or more and 20,000 mPa.s or less, at a shear rate of 0.1 S⁻¹.

Furthermore, at the shear rate of 1000 S⁻¹, the viscosity is preferably 1 mPa.s or more and 200 mPa.s or less, and more preferably 5 mPa.s or more and 80 mPa.s or less.

In order to improve the film-forming properties, the photothermographic material according to the invention is preferably heat-treated immediately after the coating and drying. The temperature employed for the heat-treatment is preferably in the range of from 60 to 100° C. at a film surface and a heating-time is preferably in the range of from 1 to 60 seconds. More preferable ranges are from 70 to 90° for the film surface temperature and from 2 to 10 seconds for the heating-duration. Preferable heating methods are described in JP-A No. 2002-107872.

13) Packaging Material

The photothermographic material according to the invention, in order to inhibit changes in the photographic performance during preservation before use or to prevent the material from a habit of curling or winding when preserved in a roll state, is preferably air-tightly packaged with a packaging material low in one or both of the oxygen permeability and the moisture permeability. The oxygen permeability is preferably 50 ml/atm/m²·day or less at 25° C., more preferably 10 ml/atm/m²·day or less, and furthermore preferably 1.0 ml/atm/m²·day or less. The moisture permeability is preferably 10 g/atm/m²·day or less, more preferably 5 g/atm/m²·day or less, and furthermore preferably 1 g/atm/m²·day or less. As specific examples of the packaging materials low in one or both of the oxygen permeability and the moisture permeability, ones described in, for instance, JP-A Nos. 8-254793 and 2000-206653 may be utilized.

14) Other Techniques that can be Applied

As the techniques that may be used in the photothermographic material according to the invention, EP Nos. 803764A1 and 883022A1, WO98/36322, JP-A Nos. 56-62648, 58-62644, 9-43766, 9-281637, 9-297367, 9-304869, 9-311405, 9-329865, 10-10699, 10-62899, 10-69023, 10-186568, 10-90823, 10-171063, 10-186565, 10-186567, 10-186569 through 10-186572, 10-197974, 10-197982, 10-197983, 10-197985 through 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 through 11-133539, 11-133542, 11-133543, 11-223898, 11-352627, 11-305377, 11-305378, 11-305384, 11-305380, 11-316435, 11-327076, 11-338096, 11-338098, 11-338099 and 11-343420, and Japanese Patent Application Nos. 2000-187298, 2000-10229, 2000-47345, 2000-206642, 2000-98530, 2000-98531, 2000-112059, 2000-112060, 2000-112104, 2000-112064 and 2000-171936 can be also cited.

15) Color Image Formation

For construction of a multi-color photothermographic material, a combination of two layers of respective colors may be contained, or, as described in U.S. Pat. No. 4,708,928, all components may be contained in a single layer.

In the case of a multi-color photothermographic material, the respective emulsion layers, in general, as described in U.S. Pat. No. 4,460,681, using a functional or non-functional barrier layer between the respective photosensitive layers, are partitioned from each other and maintained.

2. Method of Forming Image

2-1. Exposure

Any method may be used to expose the photosensitive material according to the invention to light; however, laser light is preferably used as an exposure light source.

As laser lights to be used in the invention, gas lasers (Ar⁺, He—Ne, and He—Cd), YAG lasers, dye lasers, and semiconductor lasers are preferable. Furthermore, a semiconductor laser and a second harmonic generating element can be used. The lasers that can be preferably used, depending on absorption peak wavelengths of the spectral sensitizing dyes and so on of the photothermographic material, are a red to infrared-emitting He—Ne laser, a red-emitting semiconductor laser, or a blue to green-emitting Ar⁺, He—Ne, He—Cd and blue-emitting semiconductor laser.

Recently, in particular, a module in which an SHG (Second Harmonic Generator) element and a semiconductor laser are integrated and a blue-emitting semiconductor laser have been developed, and hence, laser output devices in short wavelength regions are attracting attentions. The blue-emitting semiconductor lasers may record fine images, increase a recording density and obtain long-life and stable output, and accordingly, the blue-emitting semiconductor lasers are expected to have an increased demand in future. A peak wavelength of the laser light is from 300 to 500 nm with respect to blue color, and preferably 350 to 450 nm.

The laser light oscillating in a vertical multimode employing, e.g., high frequency superposition, may be preferably used.

2-2. Heat Development

The photothermographic material according to the invention may be developed according to any methods; however, usually the imagewise exposed photothermographic material is heated for development. A preferable development temperature is 80 to 250° C., and more preferably 100 to 140° C.

A development time is preferably 1 to 60 seconds, more preferably 5 to 30 seconds, and more preferably 5 to 20 seconds.

A plate heating method is preferable as a thermally developing method. In the heat development system according to the plate heating system, the method disclosed in JP-A No. 11-133572 is preferable. According to this method, a heat development device is used in which a photothermographic material having formed a latent image is brought into contact with heating means at a heat developing part, whereby a visible image is obtained. The heat development device includes a plate heater as the heating means and a plurality of pressing rollers that are arranged along one surface of the plate heater and facing the plate heater, such that heat development is performed by allowing the photothermographic material to pass through between the pressing rollers and the plate heater. The plate heater is divided into from two to six sections for heating stages, and the temperature of a tip end portion is preferably lowered, by substantially from 1 to 10° C.

Such a method is also described in JP-A No. 54-30032, in which moisture and an organic solvent included in the photothermographic material can be removed outside of the system, and the shape of the support of the photothermographic material may be prevented from rapidly heating and deforming.

2-3. System

As a medical laser imager that is equipped with an exposure unit and a heat development unit, a Fuji Medical Dry Imager FM-DPL may be mentioned. Details of this system is described in Fuji Medical Review, No. 8, pp 39-55 and the techniques thereof may be utilized. Furthermore, the photothermographic material of the present invention may be used as a photothermographic material for use in laser imagers in “AD network”, which was proposed by Fuji Medical System as a network system that conforms to the DICOM standard.

3. Applicatbility of the Invention

The photothermographic material according to the invention forms a monochrome silver image, and hence is preferably used as photothermographic materials for use in medical diagnosis, industrial photography, printing and COM (computer output microfilm).

### EXAMPLES

The present invention will be described in more detail with reference to the following Examples; however, the invention is not restricted thereto.

### Example 1

1. Preparation of PET Support, and Undercoating

1) Film Formation

From terephthalic acid and ethylene glycol, PET having intrinsic viscosity IV of 0.66 (as measured in phenol/tetrachloroethane=6/4 by weight at 25° C.) was produced in an ordinary manner. After pelletized, the PET was dried at 130° C. for 4 hr and melted at 300° C., followed by extrusion through a T-die. After rapid cooling, a non-stretched film was prepared which had a film thickness of 175 μm after thermal fixation.

The resultant film was stretched to 3.3 times in MD (machine direction) using a roll at different rotating speeds, then stretched to 4.5 times in CD (cross direction) using a tenter. The temperatures for MD and CD stretchings were 110° C. and 130° C., respectively. Then, the film was thermally fixed at 240° C. for 20 seconds, and relaxed by 4% in CD at the same temperature. Thereafter, after the chuck of the tenter was released, the both edges of the film were knurled, and the film was rolled up under 4 kg/cm² to give a rolled film having a thickness of 175 μm.

2) Surface Corona Discharge Treatment

Using a solid-state corona discharge system, Model 6KVA, manufactured by Pillar Technologies, both surfaces of the support were subjected to corona discharge treatment at room temperature at a speed of 20 m/min. From the values of the current and the voltage read from the system at this time, the support was found to be processed at 0.375 kV·A·min/m². The frequency for the treatment was 9.6 kHz, and the gap clearance between an electrode and a dielectric roll was 1.6 mm.

3) Undercoating

3-1) Preparation of coating solution for undercoat layer

| | |
|---|---|
| Formulation (1) (for an undercoat layer at the side provided | |
| with the photosensitive layer): | |
| Pesuresin A-520 (manufactured by Takamatsu Yushi K. K.) | 59 g |
| (30% by mass solution) | |
| Polyethylene glycol monononylphenyl ether (average ethylene | 5.4 g |
| oxide number = 8.5) 10% by mass solution | |
| Fine polymer particles MP-1000 | 0.91 g |
| (manufactured by Soken Chemical Co., Ltd.; | |
| mean particle diameter: 0.4 μm) | |
| Distilled water | 935 ml |
| Formulation (2) (for a first back layer): | |
| Butadiene-styrene copolymer latex (solid content 40% by mass, | 158 g |
| styrene/butadiene = 68/32 by mass) | |
| Sodium 2,4-Dichloro-6-hydroxy-S-triazine (8% by mass aqueous | 20 g |
| solution) | |
| Sodium laurylbenzenesulfonate (1% by mass aqueous solution) | 10 ml |
| Distilled water | 854 ml |
| Formulation (3) (for a second back layer): | |
| SnO₂/SbO (9/1 by mass ratio, mean particle | 84 g |
| diameter 0.038 μm, 17% by mass dispersion) | |
| Gelatin (10% by mass aqueous solution) | 89.2 g |
| Metolose TC-5 (manufactured by Shin-etsu Chemical Co., Ltd.) | 8.6 g |
| (2% by mass aqueous solution) | |
| MP-1000 (manufactured by Soken Chemical Co., Ltd.) | 0.01 g |
| Sodium dodecylbenzenesulfonate (1% by mass aqueous solution) | 10 ml |
| NaOH (1% by mass) | 6 ml |
| Proxel (available from ICI) | 1 ml |
| Distilled water | 805 ml |

3-2) Undercoat

After both surfaces of the biaxially stretched polyethylene terephthalate support (thickness: 175 μm) were subjected to corona discharge treatment in the same manner as above, one surface (photosensitive layer surface) of the support was coated with a coating solution of the undercoat layer (Formulation (1)) using a wire bar, and then dried at 180° C. for 5 minutes to provide a wet coated amount of 6.6 ml/m² (one surface). Next, the other surface (back surface) of the support was coated with a coating solution of the back layer formulation (2) using a wire bar, and then dried at 180° C. for 5 minutes to provide a wet coated amount of 5.7 ml/m². The thus-coated back surface was further coated with the back layer formulation (3) using a wire bar, and then dried at 180° C. for 6 minutes to provide a wet coated a-mount of 7.7 ml/m², to finally give an undercoated support.

2. Back Layer

2-1. Preparation of Coating Solution for Back Layer

1) Preparation of Dispersion Solution (a) of Solid Fine Particles of Base Precursor

1.5 kg of a base precursor compound 1, 225 g of DEMOLE N (trade name, available from Kao Corp), 937.5 g of diphenylsulfone, and 15 g of parahydroxybenzoic acid methyl ester (trade name: Mekkins M, available from Ueno Fine Chemicals Industry, Inc) were admixed with distilled water to give a total of 5 kg, and the mixted solution was dispersed using a lateral sand mill (UVM-2 manufacture by Aimex, Ltd.). The dispersing conditions were such that the mixed solution was fed using a diaphragm pump to the UVM-2 unit filled with zirconia beads having a mean diameter of 0.5 mm, maintaining an internal pressure of 50 hPa or more, dispersing was continued until a desired dispersed state was achieved. The degree of dispersion was measured by absorptivity of the dispersion taking an absorptivity ratio (D450/D650) in 450 nm and 650 nm as a reference. The dispersing operation was continued until a value of the ratio reached 2.2 or more. After the dispersing operation, it was diluted with distilled water so that a concentration of the base precursor might be 20% by mass, followed by filtering through a filter (average mesh diameter: 3 μm, material: polypropylene) to remove dust.

2) Preparation of Solid Dispersion (a) of Dye Fine Particles

6.0 kg of cyanine dye compound-1, 3.0 kg of sodium p-dodecyl sulfonate, 0.6 kg of DEMOLE SMB (trade name, available from Kao Corp.) and 0.15 kg of Safinol 104E (trade name, available from Nisshin Kagaku Co.) were admixed with distilled water to give a total of 60 kg. The obtained mixed solution was dispersed using a lateral sand mill UVM-2 unit filled with zirconia beads having a mean diameter of 0.5 mm. The dispersing operation was continued until the light absorptivity ratio (D650/D750) became 5.0 or more. After the dispersing operation, the mixed solution was diluted with distilled water so that a concentration of cyanine dye became 6% by mass, followed by filtering through a filter (average mesh diameter: 1 μm, material: polypropylene) to eliminate dust.

3) Preparation of Coating Solution for Anti-Halation Layer

30 g of gelatin, 24.5 g of polyacrylamide, 2.2 g of 1 mol/L concentration sodium hydroxide, 2.4 g of mono-dispersed polymethylmethacrylate fine particles (mean particle size: 8 μm, particle size standard deviation: 0.4), 0.08 g of benzoisothiazolinone, 35.9 g of the solid dispersion (a) of dye fine particles, 74.2 g of the solid dispersion (a) of fine particles of the base precursor, 0.6 g of sodium polyethylene sulfonate, 0.21 g of blue dye compound-1, 0.15 g of yellow dye compound-1 and 8.3 g of acrylic acid/ethyl acrylate copolymerized latex (copolymerization ratio: 5/95) were admixed with water to give a total of 818 ml, whereby a coating solution for an anti-halation layer was prepared.

4) Preparation of Coating Solution for Back Surface Protective Layer

In a vessel heated at 40° C., 40 g of gelatin, 1.5 g of fluid paraffin as a fluid paraffin emulsion, 35 mg of benzoisothiazolinone, 6.8 g of 1 mol/L concentration sodium hydroxide, 0.5 g of sodium t-octylphenoxyethoxyethane sulfonate, 0.27 g of sodium polystyrene sulfonate, 2.0 g of N,N-ethylene bis(vinylsulfonacetamide), 37 mg of fluorinated surfactant (F-1), 150 mg of fluorinated surfactant (F-2), 64 mg of fluorinated surfactant (F-3), 32 mg of fluorinated surfactant (F-4), 6.0 g of acrulic acid/ethylacrylate copolymer (copolymerization ratio by weight: 5/95), and 2.0 g of N,N-ethylene bis(vinylsulfonamide) were mixed followed by addition of water to give a total of 1000 ml, whereby a coating solution for a back surface protective layer was prepared.

2-2. Coating of Back Layer

On a back surface side of the undercoat support, the coating solution for an anti-halation layer and the coating solution for a back surface protective layer were simultaneously coated so that the coating amounts of gelatin might be 0.44 g/m² and 1.7 g/m², respectively, followed by drying, to thereby dispose a back layer.

3. Image-Forming Layer and Surface Protective Layer

3-1. Preparation of Coating Materials

1) Silver Halide Emulsion

(Preparation of Silver Halide Emulsion 1)

To 1421 ml of distilled water was added 3.1 ml of a 1% by mass potassium bromide solution, followed by further addition of 3.5 ml of sulfuric acid having a concentration of 0.5 mol/L and 31.7 g of phthalized gelatin. The resultant solution was heated, with stirring, in a stainless reaction vessel to 30° C. as a liquid temperature, and thereto an entirety of a solution A in which 2222 g of silver nitrate was diluted to 94.5 ml with distilled water, and a solution B in which 15.3 g of potassium bromide and 0.8 g of potassium iodide were diluted to 97.4 ml with distilled water were added at a constant flow rate over 45 seconds. Thereafter, 10 ml of a 3.5% by mass aqueous solution of hydrogen peroxide was added, followed by further adding 10.8 ml of a 10% by mass aqueous solution of benzimidazol.

Furthermore, a solution C of 51.86 g silver nitrate diluted in distilled water to 317.5 ml was totally added at a constant flow rate over 20 minutes, and a solution D of 44.2 g potassium bromide and 2.2 g potassium iodide diluted in distilled water to 400 ml, with the pAg maintaining at 8.1, were added employing a controlled double jet method. Potassium hexachloroiriddate (III) was totally added, 10 minutes after the start of addition of solutions C and D so as to be 1×10⁻⁴ mol per mol of silver. Furthermore, 5 seconds after the completion of addition of the solution C, an aqueous solution of potassium hexacyano ferrate (II) was totally added so as to be 3×10⁻⁴ mol per mol of silver. With sulfuric acid of 0.5 mol/L concentration, the pH was adjusted to 3.8, stirring was halted, followed by precipitating, desalting and water-washing. With sodium hydroxide of 1 mol/L concentration, the pH was adjusted to 5.9, whereby a silver halide dispersion having the pAg of 8.0 was prepared.

The silver halide dispersion was maintained with stirring at 38° C., to which was added 5 ml of a methanol solution of 0.34% by mass 1,2-benzoisothiazoline-3-on, and after 40 minutes, heated to 47° C. Twenty minutes after the temperature rise, a methanol solution of sodium benzenethiosulfonate was added by 7.6×10⁻⁵ mol per mol of silver, and after further 5 minutes, a methanol solution of tellurium sensitizer C was added so as to be 2.9×10⁻⁴ mol per mol of silver, followed by ripening for 91 minutes. Then, a methanol solution containing a spectral sensitizing dye A and a sensitizing dye B at a molar ratio of 3:1 was added so as to be 1.2×10⁻³ mol in total of the sensitizing dyes A and B per mol of silver; 1 minutes after, 1.3 ml of a methanol solution of 0.8% by mass N,N′-dihydroxy-N″-diethylmelamine was added; after further 4 minutes, a methanol solution of 5-methyl-2-mercaptobenzoimidazole, a methanol solution of 1-phenyl-2-heptyl-5-mercapto-1,3,4-triazole, and an aqueous solution of 1-(3-methylureido)-5-mercaptotetrazole sodium salt were added so as to be 4.8×10⁻³ mol, 5.4×10⁻³ mol, and 8.5×10⁻³ mol, respectively, per mol of silver, whereby a silver halide emulsion 1 was prepared.

Grains in the prepared silver halide emulsion were silver iodobromide grains that have a mean sphere-equivalent diameter of 0.042 μm and a variation coefficient of the sphere-equivalent diameter of 20 percent and uniformly contained iodine by 3.5 mol percent. Grain size and others were obtained from an average of 1000 grains using an electron microscope. A {100} plate ratio of the grains was found to be 80 percent when measured according to a Kubelca-Munk method.

(Preparation of Silver Halide Emulsion 2)

In order to prepare the silver halide emulsion 1, a liquid temperature during the grain formation was changed from 30° C. to 47° C.; a solution B was prepared by diluting 15.9 g of potassium bromide in a volume of 97.4 ml of distilled water; a solution D was prepared by diluting 45.8 g of potassium bromide in 400 ml of distilled water; an addition time of the solution C was changed to 30 minutes; potassium hexacyano ferrate (II) was removed; and similarly to the preparation of the silver halide emulsion 1, a silver halide dispersion was prepared.

In a similar manner to the preparation of the silver halide emulsion 1, the grain formation, precipitation, water washing and dispersing operation were carried out. Further, similarly to the emulsion 1 except for changing a methanol solution to contain a spectral sensitizing dyes A and B at molar ratio of 1:1 and adding by 7.5×10⁻⁴ mol in total of the spectral sensitizing dyes A and B; a tellurium sensitizer C to adding by 5.1×10⁻⁵ mol per mol of silver; a methanol solution of 1-phenyl-2-heptyl-5-mercapto-1,3,4-triazole to adding by 3.3×10⁻³ mol per mol of silver; and an aqueous solution of 1-(3-methylureido)-5-mercaptotetrazole sodium salt to add by 4.7×10⁻³ mol per mol of silver, a silver halide emulsion 2 was obtained. Emulsion grains of the silver halide emulsion 2 were pure cubic silver bromide grains having a mean average sphere-equivalent diameter of 80 nm and the variation coefficient of the sphere-equivalent diameter of 20 percent.

(Preparation of Silver Halide Emulsion 3)

Similarly to the preparation of the silver halide emulsion 1 except for changing the liquid temperature during the grain formation from 30° C. to 27° C., a silver halide emulsion 3 was prepared. Furthermore, similarly to the silver halide emulsion 1, the precipitation, desalting, water washing and dispersing operation were carried out. Similarly to the silver halide emulsion 1 except for the spectral sensitizing dyes A and B at molar ratio of 1:1 being added as a solid dispersion (aqueous gelatin solution) by 6×10⁻³ mol in total of the sensitizing dyes A and B per mol of silver; the tellurium sensitizer C being added by 5.2×10⁻⁴ mol per mol of silver; and three minutes after the addition of the tellurium sensitizer, bromoauric acid and potassium thiocyanate being added by 5×10⁻⁴ mol and 2×10⁻³ mol, respectively, per mol of silver, a silver halide emulsion 3 was obtained. Emulsion grains of the silver halide emulsion 3 were silver iodobromide grains that have a mean sphere-equivalent diameter of 0.034 μm, the variation coefficient of the sphere-equivalent diameter of 20 percent and contained iodine uniformly by 3.5 percent.

(Preparation of Emulsion Mixture A for Coating)

Seventy % by mass of the silver halide emulsion 1, 15% by mass of the silver halide emulsion 2 and 15% by mass of the silver halide emulsion 3 were dissolved, and thereto, an aqueous solution of 1% by mass of benzothiazolium iodide was added so as to be 7×10⁻³ mol per mol of silver. Furthermore, water was added so that a silver halide content might be 38.2 g as silver per kg of the emulsion mixture for coating solution, and 1-(3-methylureide)-5-mercaptotetrazole sodium salt was added so as to give 0.34 g per kg of the emulsion mixture for coating solution.

2) Preparation of Organic Silver Salt

(Preparation of Aliphatic Silver Dispersion A)

Behenic acid (Product name: Edenor C22-85R, produced by Henkel Co.), distilled water, an aqueous solution of 5 mol/L concentration sodium hydroxide and t-butyl alcohol were mixed in an amount of 87.6 kg, 423 L, 49.2 L and 120 L, respectively, stirred at 75° C. for 1 hr and were allowed to react, to thereby obtain a solution of sodium behenate A. Separately, 206.2 L (pH 4.0) of an aqueous solution of 40.4 kg of silver nitrate was prepared and heated at 10° C. A reaction vessel containing 635 L of distilled water and 30 L of t-butyl alcohol was heated at 30° C., and thereto were added, while vigorously stirring, a total amount of the sodium behenate solution A and a total amount of silver nitrate aqueous solution at constant flow rates over 93 minutes and 15 seconds and 90 minutes, respectively. At this time, for 11 minutes after silver nitrate aqueous solution was started to add, only the silver nitrate aqueous solution was added, thereafter the sodium behenate solution A was started to add, and for 14 minutes and 15 seconds after the completion of the addition of the silver nitrate aqueous solution, only the sodium behenate solution A was added. At this time, a temperature within the reaction vessel was set at 30° C., and an external temperature was controlled so that the liquid temperature might be constant. Furthermore, a pipe of an adding system of the sodium behenate solution A was heated by circulating warm water outside of a double-jacketed pipe, and a liquid temperature of an outlet at an addition nozzle tip end was controlled so as to provide 75° C. Still further, a temperature of a pipe of an adding system of the silver nitrate aqueous solution was kept by circulating cold water outside of a double-jacketed pipe. Adding positions of the sodium behenate solution A and the silver nitrate aqueous solution were symmetrically disposed with a stirrer shaft at a center, and adjusted not to contact with a reaction liquid.

After the addition of the sodium behenate solution A was completed, at a temperature as it is, it was left for 20 minutes while stirring, heated to 35° C. over 30 minutes, followed by ripening for 210 minutes. Immediately after the completion of the ripening, a solid component was filtered by centrifuging and washed with water until the electric conductivity of filtrate became 30 μS/cm. Thus, aliphatic silver salt was obtained. The obtained solid component, without drying, was stored as a wet cake.

Morphology of the obtained silver behenate grains was evaluated using an electron micrography. It was found that the silver behenate grains were flake-like grains having a=0.14 μm, b=0.4 μm, and c=0.6 μm on the average; a mean aspect ratio of 5.2; a mean sphere-equivalent diameter of 0.52 μm; and variation coefficient of sphere-equivalent diameter of 15 percent. (a, b and c as defined above).

To the wet cake equivalent to 260 kg as a dry solid component, 19.3 kg of polyvinyl alcohol (Product name: PVA-217) and water were added to 1000 kg in total followed by rendering a slurry using a dissolver blade, further followed by applying preliminary dispersing operation with a pipe line mixer (model PM-10 available from Mizuho Kogyou Kabushiki Kaisha).

Then, the preliminarily dispersed stock solution was processed three times with a disperser (Product name: Micro-Fluidizer M-6 10 available from Microfluidex International Corporation with a Z type interaction chamber) whose pressure was adjusted to 1260 kg/cm², to thereby give a silver behenate dispersion. In cooling operation, circularly jetting heat exchangers were provided before and after the interaction chamber and a temperature of coolant was adjusted, whereby a dispersion temperature was set at 18° C.

(Preparation of Aliphatic Silver Dispersion B)

<Preparation of Recrystallized Behenic Acid>

One hundred kilograms of behenic acid (product name: Edenor C22-85R, available from Henkel Corp.) was mixed with 1200 kg of isopropyl alcohol, dissolved at 50° C., after filtering through a filter of 10 μm, cooled to 30° C., thereby recrystallized. A cooling rate for recrystallization was controlled to 3° C./hr. The obtained grains were processed by centrifugal filtration, washed by pouring 100 kg of isopropyl alcohol, and then dried. When the obtained grains were esterized and subjected to GC-FID measurement, it was found that the content of behenic acid was 96% by mass, and additionally, 2 mol percent of lignoceric acid, 2 mol percent of arachidic acid and 0.001 mol percent of erucic acid were found.

<Preparation of Aliphatic Silver Dispersion B>

The recrystallized behenic acid, distilled water, an aqueous solution of 5 mol/L concentration sodium hydroxide and t-butyl alcohol were mixed in an amount of 88 kg, 422 L, 49.2 L and 120 L, respectively, stirred at 75° C. for 1 hr to cause a reaction, to thereby provide a solution of sodium behenate B. Separately, 206.2 L (pH 4.0) of an aqueous solution of 40.4 kg of silver nitrate was prepared and kept at 10° C. A reaction vessel containing 635 L of distilled water and 30 L of t-butyl alcohol was heated at 30° C., and thereto, while thoroughly stirring, a total amount of the sodium behenate solution B and a total amount of silver nitrate aqueous solution were added at constant flow rates over 93 minutes and 15 seconds and 90 minutes, respectively. At this time, for 11 minutes after the aqueous solution of silver nitrate was started to add, only the aqueous solution of silver nitrate was added, and thereafter, the sodium behenate solution B was started to add, and for 14 minutes and 15 seconds after the completion of the addition of the aqueous solution of silver nitrate, only the sodium behenate solution B was added. At this time, a temperature in the reaction vessel was set at 30° C., and an external temperature was controlled such that the liquid temperature might be constant. Furthermore, a pipe of an adding system of the sodium behenate solution B was heated by circulating warm water outside of a double-jacketed pipe, and a liquid temperature of an outlet at an addition nozzle tip end was controlled so as to give 75° C. Still further, a temperature of a pipe of an adding system of the silver nitrate aqueous solution was kept by circulating cold water outside of a double-jacketed pipe. An adding position of the sodium behenate solution B and that of the aqueous solution of silver nitrate were symmetrically disposed with a stirrer shaft at a center, and adjusted not to bring into contact with a reaction liquid.

After the completion of the addition of the sodium behenate solution B, with maintaining the temperature, it was left for 20 minutes while stirring, heated to 35° C. over 30 minutes, followed by ripening for 210 minutes. Immediately after the completion of the ripening, the solids were filtered by centrifuging, and washed with water until the electric conductivity of the filtrate became 30 μS/cm. Thus, aliphatic silver salt was obtained. The obtained solids, without drying, were stored as a wet cake.

The obtained silver behenate grains were evaluated for morphology using an electron micrography. It was found that the silver behenate grains had a=0.21 μm, b=0.4 μm, and c=0.4 μm on the average; an average aspect ratio of 2.1; and the variation coefficient of sphere-equivalent diameter of 11 percent (a, b and c as defined above).

To the wet cake equivalent to 260 kg as solids, 19.3 kg of polyvinyl alcohol (Product name: PVA-217) and water were added to 1000 Kg in total, forming into a slurry by use of a dissolver blade, followed by preliminary dispersing operation with a pipe line mixer (model PM-10 available from Mizuho Kogyou Kabushiki Kaisha).

Then, the preliminarily dispersed stock solution was processed three times while adjusting a pressure of a disperser (Product name: Micro-Fluidzer M-610 available from Microfluidex International Corporation with a Z type interaction chamber) to 1150 kg/cm², to thereby obtain a silver behenate dispersion B. In cooling operation, circularly jetting heat exchangers were provided before and after the interaction chamber and a temperature of coolant was adjusted, whereby a dispersion temperature was set at 18° C.

3) Preparation of Reducing Agent Dispersion

(Preparation of Dispersion of Reducing Agent Complex-1)

To 10 kg of reducing agent complex-1, 0.12 kg of triphenylphosphine oxide and 16 kg of an aqueous solution of 10% by mass modified polyvinyl alcohol (Poval MP203 available from Kuraray Co., Ltd.) was added 10 kg of water, followed by thoroughly mixing, to thereby prepare a slurry. The slurry was supplied using a diaphragm pump and dispersed for 4 hr 30 minutes using a lateral sand mill (UVM-2 manufactured by Aimex, Ltd.) filled with zirconia beads having an mean diameter of 0.5 mm followed by addition of 0.2 g of benzoisothiazolinone sodium salt and water, such that a concentration of the reducing agent complex reached 22% by mass, whereby a dispersion of reducing agent complex-1 was obtained. Particles of the reducing agent complex contained in the thus obtained dispersion of reducing agent complex had a median diameter of 0.45 μm and a maximum particle diameter of 1.4 μm or less. The resultant dispersion of reducing agent complex was filtered through a polypropylene filter having a pore diameter of 3.0 μm to remove foreign matters such as dust, then stored.

(Preparation of Dispersion of Reducing Agent-2)

To 10 kg of reducing agent-2 and 16 kg of an aqueous solution of 10% by mass modified polyvinyl alcohol (Poval MP203 available from Kuraray Co., Ltd.) was added 10 kg of water, followed by thoroughly mixing, to thereby prepare a slurry. The slurry was poured using a diaphragm pump and dispersed for 3 hr 30 minutes by use of a lateral sand mill (UVM-2 manufactured by Aimex, Ltd.) filled with zirconia beads having a mean diameter of 0.5 mm followed by addition of 0.2 g of benzoisothiazolinone sodium salt and water such that a concentration of the reducing agent reached 25% by mass. The dispersion, after heating at 40° C. for 30 minutes, was further raised to 80° C. and heat-treated for 2 hr, whereby a dispersion of reducing agent-2 was obtained. Particles of the reducing agent contained in the thus obtained dispersion of reducing agent had a median diameter of 0.40 μm and a maximum particle diameter of 1.5 μm or less. The obtained dispersion of reducing agent was filtered through a polypropylene filter having a pore diameter of 3.0 μm to remove foreign matters such as dust, and then stored.

4) Preparation of Dispersion of Hydrogen Bond-Forming Compound-1

To 10 kg of a hydrogen bond-forming compound-1 and 16 kg of an aqueous solution of 10% by mass of modified polyvinyl alcohol (Poval MP203 available from Kuraray Co., Ltd.) was added 10 kg of water followed by thoroughly mixing, to thereby prepare a slurry. The slurry was poured using a diaphragm pump and dispersed for 3 hr 30 minutes by use of a lateral sand mill (UVM-2 manufactured by Aimex, Ltd.) filled with zirconia beads having a mean diameter of 0.5 mm followed by addition of 0.2 g of benzoisothiazolinone sodium salt and water such that a concentration of the hydrogen bond-forming compound reached 25% by mass. The dispersion solution was heated at 80° C. for 1 hr, whereby a dispersion of hydrogen bond-forming compound-1 was obtained. Particles of hydrogen bond-forming compound contained in the thus obtained dispersion of hydrogen bond-forming compound had a median diameter of 0.35 μm and a maximum particle diameter of 1.5 μm or less. The obtained dispersion of hydrogen boding compound was filtered through a polyethylene filter having a pore diameter of 3.0 μm to remove foreign matters such as dust, and then stored.

5) Preparation of Polyhalogen Compound

(Preparation of Dispersion of Organic Polyhalogen Compound-1)

To 10 kg of an organic polyhalogen compound-1, 10 kg of an aqueous solution of 20% by mass modified polyvinyl alcohol (Poval MP203 available from Kuraray Co., Ltd.) and 0.4 kg of an aqueous solution of 20% by mass triisopropylnaphthalene sulfonate was added 14 kg of water followed by thoroughly mixing, to thereby yield a slurry. The slurry was poured using a diaphragm pump and dispersed for 5 hr by use of a lateral sand mill (UVM-2 manufactured by Aimex, Ltd.) filled with zirconia beads having a mean diameter of 0.5 mm followed by addition of 0.2 g of benzoisothiazolinone sodium salt and water such that a concentration of the organic polyhalogen compound reached 26% by mass, whereby a dispersion of the organic polyhalogen compound-1 was obtained. Particles of the organic polyhalogen compound contained in the thus obtained dispersion of the polyhalogen compound had a median diameter of 0.41 μm and a maximum particle diameter of 2.0 μm or less. The resulting dispersion of the organic polyhalogen compound was filtered through a polypropylene filter having a pore diameter of 10.0 μm to remove foreign matters such as dust, and then stored.

(Preparation of Dispersion of Organic Polyhalogen Compound-2)

To 10 kg of an organic polyhalogen compound-2 and 20 kg of an aqueous solution of 10% by mass modified polyvinyl alcohol (Poval MP203 available from Kuraray Co., Ltd.) was added 0.4 kg of an aqueous solution of 20% by mass sodium triisopropylnaphthalene sulfonate followed by thoroughly mixing, to thereby afford a slurry. The slurry was poured using a diaphragm pump and dispersed for 5 hr by use of a lateral sand mill (UVM-2 manufactured by Aimex, Ltd.) filled with zirconia beads having a mean diameter of 0.5 mm followed by addition of 0.2 g of sodium benzoisothiazolinate and water such that a concentration of the organic polyhalogen compound reached 30% by mass. The dispersion solution was heated at 40° C. for 5 hr, whereby a dispersion of the organic polyhalogen compound-2 was obtained. Particles of the organic polyhalogen compound contained in the thus obtained dispersion of the polyhalogen compound had a median diameter of 0.40 μm and a maximum particle diameter of 1.3 μm or less. The obtained dispersion of the organic polyhalogen compound was filtered through a polypropylene filter having a pore diameter of 3.0 μm to remove foreign matters such as dust, and then stored.

6) Preparation of Solution of Phthalazine Compound

Eight kilograms of degenerated polyvinyl alcohol MP203 produced by Kuraray Co,.Ltd. was dissolved in 174.57 kg of water followed by addition of 3.15 kg of an aqueous solution of 20% by mass sodium triisopropylnaphthalene sulfonate and 14.28 kg of an aqueous solution of 70% by mass of 6-isopropylphthalazine, to thereby give a solution of 5% by mass of 6-isoprpylphthalazine.

7) Preparation of Dispersion of Pigment-1

To 64 g of C.I. Pigment Blue 60 and 6.4 g of polyvinyl alcohol MP203 was added 250 g of water followed by thorough stirring, to thereby produce a slurry. Eight hundred grams of zirconia beads having a mean diameter of 0.5 mm were prepared and supplied to a vessel of a disperser (¼ G Sand Grinder Mill available from Aimex, Ltd.) together with the slurry, followed by dispersing for 25 hr and further addition of water such that a concentration of the pigment might be diluted to 5% by mass, whereby a dispersion of pigment-1 was obtained. Pigment particles contained in the thus obtained pigment dispersion had a mean particle diameter of 0.21 μm.

8) Preparation of Dispersion of Stearic Acid Amide

To 50 g of stearic acid amide and 5 g of DEMOL N (manufactured by Kao Corp.) was added 195 g of water followed by thoroughly stirring, to thereby produce a slurry. Eight hundred grams of zirconia beads having a mean diameter of 0.5 mm were prepared and charged in a vessel of a disperser (¼ G Sand Grinder Mill available from Aimex, Ltd.) together with the slurry, followed by dispersing for 25 hr and further addition of water such that a concentration of stearic acid amide might reach 5% by mass. Particles of stearic acid amide contained in the thus obtained dispersion had a mean particle diameter of 0.35 μm.

8′) Preparation of Dispersions of Development Accelerator and Toning Agent

Similarly to the preparation of a dispersion of reducing agent-2, a dispersion of 20% by mass of each of a development accelerator and a color tone controlling agent was prepared.

9) Preparation of SBR Latex Solution

An SBR latex was prepared as follows.

Into a polymerization vessel of a gas monomer reactor (TAS-2J Model manufactured by Taiatu Techno Corp.) were added 287 g of distilled water, 7.73 g of a surfactant (trade name: Pionin A-43-S manufactured by Takemoto Oil & Fat Co., Ltd.), 14.06 ml of an aqueous solution of 1 mol/L sodium hydroxide, 0.15 g of sodium ethylenediamine tetraacetate, 255 g of styrene, 11.25 g of acrylic acid and 3.0 g of tert-dodecylmercaptan, the reactor was sealed air-tightly and stirring was provided at 200 rpm. After air was evacuated using a vacuum pump and replaced with nitrogen gas which was repeated several times, 108.5 g of 1,3-butadiene was charged into the reactor, with elevating pressure and an inner temperature to 60° C. To the mixture was added a solution of 1.875 g of ammonium persulfate dissolved in 50 ml of water, followed by stirring as it is for 5 hours. The inner temperature was further raised to 90° C., followed by stirring for 3 hr. After the completion of the reaction, the inner temperature was lowered to room temperature, thereafter, 1 mol/L of sodium hydroxide and ammonium hydroxide each were added so that a molar ratio of Na⁺ ion to NH₄⁺ ion might be 1:5.3 (molar ratio), and thereby the pH was adjusted to 8.4. Thereafter, the solution was filtered through a polypropylene filter having a pore diameter of 1.0 μm to remove foreign matters followed by storing, whereby 774.7 g of the SBR latex was obtained. Measurement of the halogen ion concentration by an ion chromatography revealed that the concentration of chloride ion was 3 ppm. The concentration of a chelating agent was measured by high-speed liquid chromatography and found to be 145 ppm.

The latex had a mean particle diameter of 90 nm, a Tg of 17° C., the solids concentration of 44% by mass, an equilibrium moisture content of 0.6% by mass at 25° C. and 60 percent relative humidity, an ionic conductivity of 4.80 mS/cm (ionic conductivity was measured for a latex stock solution (44% by mass) with a Conductometer CM-30S manufactured by Toa Denpa Kogyo Co., at 25 degree centigrade), and pH of 8.4.

SBR latexes, that differed in the Tg by suitably altering a styrene/butadiene ratio, were similarly prepared.

3-2. Preparation of Coating Solution

Preparation of Coating Solution for Image-Forming Layer

(Preparation of Image-Forming Layer Coating Solution-1)

In 4300 ml of water was dissolved 360 g of polyvinyl alcohol PVA-205 (manufactured by Kuraray Corp.), to which was added succesively 1000 g of the above-obtained aliphatic silver dispersion A, 276 ml of water, 33 g of the pigment-1 dispersion, 21 g of the dispersion of organic polyhalogen compound-1, 58 g of the dispersion of organic polyhalogen compound-2, 173 g of the solution of phthalazine compound-1, 299 g of the dispersion of reducing agent complex-1, 76 g of the dispersion of stearic acid amide as a thermal solvent, 51 g of the dispersion of color tone controlling agent-1 and 273 g of SBR latex (Tg= 17° C.). Further, immediately before coating, 117 g of the silver halide mixture emulsion A was added thereto, followed by thoroughly mixing, poured as a coating solution for an image-forming layer into a coating die and then coated.

The pH of the image-forming layer coating solution was 6.0.

The content of zirconium in the coating solution was 0.38 mg per gram of silver.

(Preparation of Image-Forming Layer Coating Solution-2)

To 2760 ml of water was dissolved 360 g of inert gelatin, and thereto 1000 g of the above-obtained aliphatic silver dispersion B, 276 ml of water, 35 g of the dispersion of pigment-1, 32 g of the dispersion of organic polyhalogen compound-1, 46 g of the dispersion of organic polyhalogen compound-2, 173 g of the solution of phthalazine compound-1, 153 g of the dispersion of reducing agent-2, 72 g of the dispersion of hydrogen bond-forming compound-1, 76 g of the dispersion of stearic acid amide as a thermal solvent, 51 g of the dispersion of a color tone controlling agent-1 and 273 g of SBR latex (Tg=17° C.) were successively added. Further, immediately before coating, 140 g of silver halide mixture emulsion A was added thereto, followed by thoroughly mixing and poured as a coating solution for the image-forming layer into a coating die.

The pH of the coating solution of the image-forming layer was 6.5.

The content of zirconium in the coating solution was 0.25 mg per gram of silver.

2) Preparation of Coating Solution for Interlayer

To 1,000 g of polyvinyl alcohol PVA-205 (manufactured by Kuraray Corp.), 272 g of the dispersion of pigment-1, 250 g of the dispersion of stearic acid amide as a thermal solvent, and 4,200 ml of 19% by mass solution of methylmethacrylate/styrene/butylacrylate/hydroxyethyl-methacrylate/acrylic acid copolymer (copolymerization ratio by mass=64/9/20/5/2) latex were added 27 ml of an aqueous solution of 5% by mass Aerosol OT (manufactured by American Cyanamid Company), 135 ml of an aqueous solution of 20% by mass of diammonium phthalate and water to give 10,000 g in total, the pH was adjusted to 7.5 by adding NaOH and thereby an interlayer coating solution was obtained, and the coating solution was poured into a coating die at 9.1 ml/m².

The viscosity of the coating solution was 58 [mPa.s] when measured using a B type viscometer at 40° C. (No. 1 rotor and 60 rpm).

3) Preparation of Coating Solution for Surface Protective First Layer

Sixty four grams of inert gelatin were dissolved in water, to which were added 112 g of 19.0% by mass solution of methylmethacrylate/styrene/butylacrylate/hydroxyethylmethacrylate/a crylic acid copolymer (copolymerization ratio by mass=64/9/20/5/2) latex, 30 ml of a methanol solution of 15% by mass phthalic acid, 23 ml of an aqueous solution of 10% by mass 4-methylphthalic acid, 28 ml of 0.5 mol/L concentration sulfuric acid, 5 ml of an aqueous solution of 5% by mass Aerosol OT (manufactured by American Cyanamid Company), 0.5 g of phenoxy ethanol, 0.1 g of benzisothiazolinone and water to 750 g in total, to thereby prepare a coating solution. The coating solution was mixed with 26 ml of 4% by mass of chrome alum immediately before coating by use of a static mixer, and poured into a coating die at 18.6 ml/m².

The viscosity of the coating solution was measured using a B type viscometer at 40° C. (No. 1 rotor and 60 rpm) and found to be 20 [mPa.s].

4) Preparation of Coating Solution for Surface Protective Second Layer

Eighty grams of inert gelatin were dissolved in water, to which were added 102 g of 27.5% by mass solution of methylmethacrylate/styrene/butylacrylate/hydroxyethylmethacrylate/a crylic acid copolymer (copolymerization ratio by mass=64/9/20/5/2) latex, 5.4 ml of a 2% by mass solution of fluorinated surfactant (F-1), 5.4 ml of a 2% by mass solution of fluorinated surfactant (F-2), 23 ml of an aqueous solution of 5% by mass Aerosol OT (manufactured by American Cyanamid Company), 4 g of fine particles (mean particle diameter: 0.7 μm) of polymethylmethacrylate, 21 g of fine particles (mean particle diameter: 4.5 μm) of polymethylmethacrylate, 1.6 g of 4-methylphthalic acid, 4.8 g of phthalic acid, 6.0% by mass of a compound-V as a hardener relative to the gelatin, 10 mg of benzisothiazolinone and water to give 650 g in total, followed by further addition of 445 ml of an aqueous solution containing 0.67% by mass phthalic acid and then mixed by use of a static mixer immediately before the coating, whereby a coating solution of surface protective layer was prepared. The coating solution was poured into a coating die at 8.3 ml/m².

The viscosity of the coating solution was measured using a B type viscometer at 40° C. (No. 1 rotor and 60 rpm) and found to be 19 [mPa.s].

3-3. Preparation of Photothermographic Material

1) Preparation of Photothermographic Material-A

Onto a surface opposite to a back surface, successively from an undercoat surface, an image-forming layer, an interlayer, a surface protective first layer and a surface protective second layer were simultaneously applied in multi-layer employing a slide bead coating method, whereby a sample of a photothermographic material was prepared. For the image-forming layer, the coating solution-1 for the image-forming layer was used.

The coating solution-1 for the image-forming layer was applied to provide a coating amount of aliphatic silver at 5.58 g/m².

The coating and drying conditions were as follows.

When applying the coating, a coating speed was set at 160 m/min; a gap between a tip end of the coating die and the support from 0.10 to 0.30 mm; and a pressure of an evacuated chamber by 196 to 882 Pa lower than an atmospheric pressure. The support was destatized by means of an ion wind before the coating.

In the subsequent chilling zone, the coating solution, after cooled with a wind of from 10 to 20° C. of dry-bulb temperature, was poured by contact-less transferring followed by drying, in a helical spring type contact-less dryer, with a dry wind of from 23 to 45° C. of dry bulb temperature and from 15 to 21° C. of wet bulb temperature.

After dryed, humidity control was performed under the conditions of 25° C. and from 40 to 60% RH followed by heating so that a temperature at a film surface might be raised to 70-90° C. After heated, the film surface was cooled to 25° C.

The matte degree of the prepared photothermographic material with respect to Beck's smoothness was 450 seconds on the image-forming layer surface side and 130 seconds on the back surface side. The pH of the film surface on the image-forming layer surface side was measured and found to be 6.0.

2) Preparation of Photothermographic Material-B

A photothermographic material-B was prepared in the same manner as above for the photothermographic material-A, except that the coating solution-1 for the image-forming layer was changed to the coating solution-2 for the image-forming layer, the yellow dye compound-1 was removed from the anti-halation layer, and the fluorinated surfactants F-1 and F-2 were changed to F-3 and F-4, respectively, in the surface protective second layer.

The coating solution-2 for the image-forming layer was applied so that a coating amount of aliphatic silver might be 5.27 g/m².

In the following, chemical structures of the compounds used in the Examples will be shown.

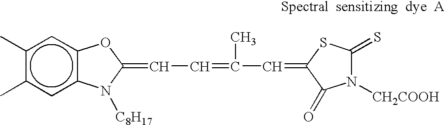

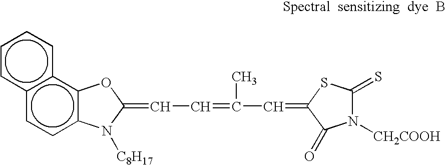

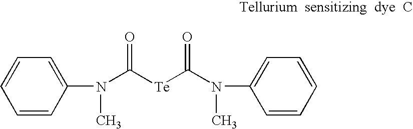

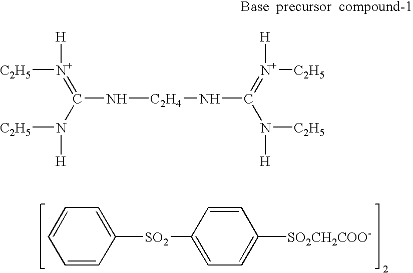

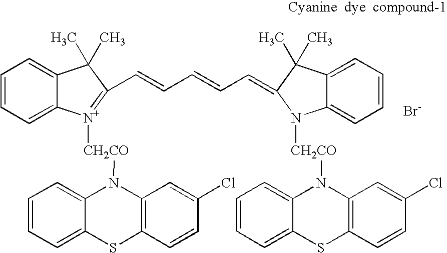

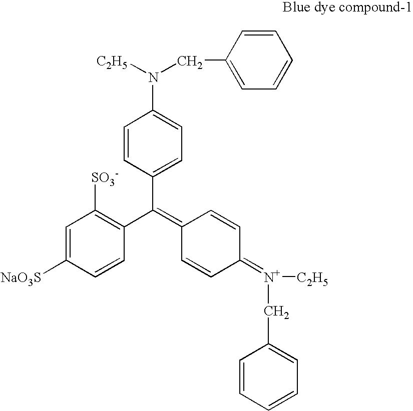

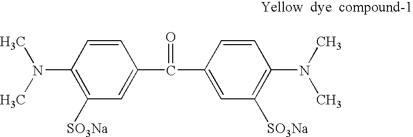

1:1 complex of

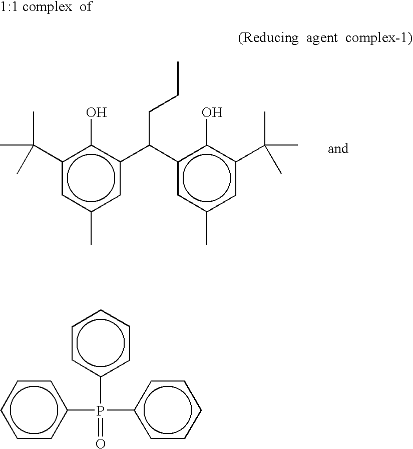

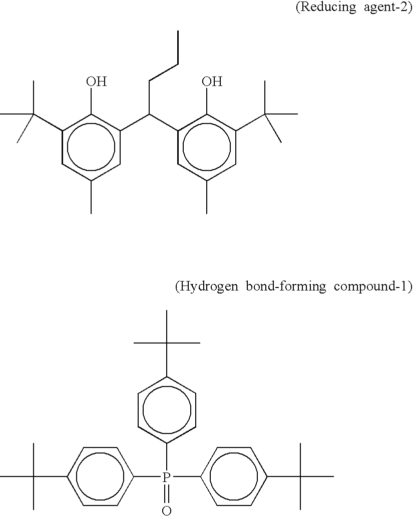

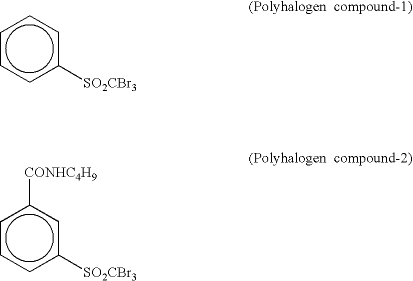

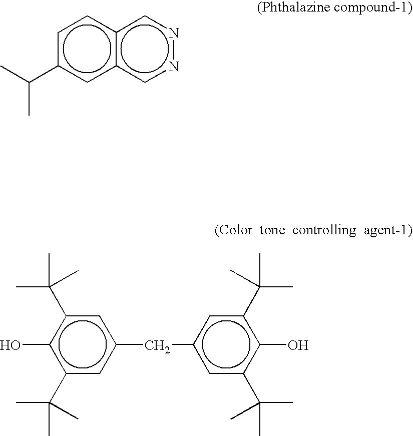

CF3(CF2)nCH2CH2SCH2CH2COOL i (F-1)

a mixture of n=5 to 11

CF3(CF2)nCH2CH20(CH2CH20) mH (F-2)

a mixture of n=5 to 11, and m=5 to 15

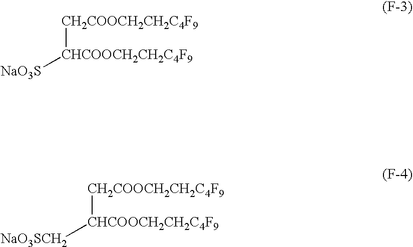

Compound V-1

CH₂═CHSO₂CH₂CONHCH₂CH₂NHCOCH₂SO₂CH═CH₂

3) Preparation of Photothermographic Materials-1 through -8

Photothermographic materials-1 through-8 were prepared as shown in Table 1, except that a dispersion of a development accelerator and a solution of a compound having a general formula (M) were added to the image-forming layer, similarly to the photothermographic material-A. The compound having the general formula (M) was added as a 5% by mass methanol solution. The development accelerator was added so as to give 8.0×10⁻⁶ mol/m² and the compound according to the general formula (M) was added so as to give 5.0×10⁻³ mol per mol of coated silver.

4) Preparation of Photothermographic Materials-9 through-19

Photothermographic materials-9 through-19 were prepared in the similar manner to the photothermographic materials-1 through-8, except for the addition of the dispersion of development accelerator and the compound represented by the general formula (M), as shown in Table 2. The development accelerator was added so as to give 5.0×10⁻⁵ mol/m² and the compound represented by the general formula (M) was added so as to give 5.0×10⁻³ mol per mol of coated silver.

TABLE 1

| | | Compound | | | |
|---|---|---|---|---|---|
| Sam- | Development | having | Photographic | | |
| ple | accelerator | general formula | performance | | |
| No. | No. | (M) No. | Fog | ΔDmax | Remarks |
| 1 | — | — | 0.16 | 1.00 | Comparative |
| | | | | | example |
| 2 | A-1 | — | 0.27 | 2.22 | Present invention |
| 3 | A-2 | — | 0.29 | 2.59 | Present invention |
| 4 | A-1 | 2-17 | 0.18 | 2.16 | Present invention |
| 5 | A-1 | 2-24 | 0.19 | 2.22 | Present invention |
| 6 | A-1 | 2-28 | 0.17 | 2.22 | Present invention |
| 7 | A-2 | 2-28 | 0.18 | 2.22 | Present invention |
| 8 | A-2 | 2-28 | 0.18 | 2.22 | Present invention |

TABLE 2

| | | Compound | | | |
|---|---|---|---|---|---|
| Sam- | Development | having | Photographic | | |
| ple | accelerator | general formula | performance | | |
| No. | No. | (M) No. | Fog | ΔDmax | Remarks |
| 9 | A-7 | — | 0.23 | 1.88 | Present invention |
| 10 | A-8 | — | 0.21 | 1.84 | Present invention |
| 11 | A-9 | — | 0.25 | 1.98 | Present invention |
| 12 | A-10 | — | 0.23 | 2.12 | Present invention |
| 13 | A-7 | 2-28 | 0.17 | 1.86 | Present invention |
| 14 | A-8 | 2-28 | 0.17 | 1.84 | Present invention |
| 15 | A-9 | 2-28 | 0.17 | 1.96 | Present invention |
| 16 | A-10 | 2-28 | 0.17 | 2.08 | Present invention |
| 17 | A-7 | 2-17 | 0.17 | 1.86 | Present invention |
| 18 | A-8 | 2-17 | 0.17 | 1.80 | Present invention |
| 19 | A-10 | 2-17 | 0.17 | 2.06 | Present invention |

4. Evaluation

1) Coated Surface Conditions

Neither the samples of Examples nor the comparative samples had defects such as the coating streak due to coagulated matters and foreign matters, thereby exhibiting an excellent surface state.

2) Evaluation of Photographic Performance

The obtained samples were cut into half-cut size, packaged in the following packaging material in an atmosphere of 25° C. and 50% RH, stored for two weeks at room temperature, and subjected to the following evaluation.

(Packaging Material)

PET 10 μm/PE 12 μm/Al foil 9 μm/Ny 15 μm/3% by mass carbon-containing polyethylene 50 μm (Oxygen permeability: 0.02 ml/atm·m²·25° C.·day, moisture permeability: 0.10 g/atm·m²·25° C.).

The samples were exposed to light and thermally developed (6 seconds each with four panel heaters each set at 112° C., 119° C., 121° C., and 121° C., in total 24 seconds) by use of a Fuji Medical Dry Laser Imager FM-DP L (equipped with a 660 nm semiconductor laser having a maximum output of 60 mW (IIIB)), and the obtained images were evaluated using a densitometer.

As typical values representing the photographic performance, fogging and the maximum image density (Dmax) were measured. In Tables 1 and 2 showing the sample results, as a relative value of the Dmax, ΔDmax was calculated and shown.

ΔDmax=(Dmax of each of the samples)/(Dmax of sample 1)

Relative to the comparative sample 1, samples 2 through 19 according to the invention exhibited higher Dmax values. In particular, the samples 5 through 8 and samples 14 through 19 were low in the fog and high in the Dmax value, namely, excellent.

These results were similar also in the evaluations of ones in which, in the photothermographic material-B, the dispersion of the development accelerator and the compound having the general formula (M) were changed. That is, it was found that irrespective of the binder which was polyvinyl alcohol or gelatin, the similar results were obtained.

### Example 2

1) Preparation of Comparative Sample A

Except that in sample 6 in Example 1, in place of the solid dispersion of development accelerator A-1, a methanol solution of 5% by mass development accelerator A-1 was prepared and added so as to give the same coating amount of the development accelerator A-1 as that of sample 6, similarly to the sample 6, a comparative sample A was prepared.

2) Evaluation of Performance

<Photographic Performance>

Similarly to Example 1, the photographic performance was evaluated. Results are shown in Table 3.

From the results in Table 3, it was found that the comparative sample A was lower in the Dmax and inferior to sample 6 of the present invention.

The same results were obtained even for the photothermographic material-B whose binder was gelatin-based.

TABLE 3

| Sample No. | Fog | ΔDmax | Remarks |
|---|---|---|---|
| Comparative sample A | 0.17 | 1.71 | Comparative sample |
| 6 | 0.17 | 2.22 | Present invention |

<Storability of Samples>

The coated sample was cut into a size of 30.5 cm×25.4 cm, left for one day in an atmosphere of 25° C. and 50% RH, sealed in a moisture-proof envelope similarly to Example 1 and stored at 50° C. for 4 days. Thereafter, the photographic performance was examined. Results thereof were shown in Table 4. Comparative sample A was larger in lowering of the Dmax and found to be inferior to sample 6 of the invention.

TABLE 4

| Sample No. | Fog | ΔDmax | Remarks |
|---|---|---|---|
| Comparative sample A | 0.17 | 1.41 | Comparative sample |
| 6 | 0.17 | 2.06 | Present invention |

### Example 3

1) Preparation of Photothermographic Materials-31 to-33

In sample 6 of Example 1, in place of stearic acid amide used as the thermal solvent, 1, 10-decanediol, salicylanilide, and o-hydroxybenzilalcohol, respectively, were used in the same amount, to thereby prepare samples 31, 32 and 33.

2) Evaluation of Performance

Similarly to Example 1, the photographic performance was examined, and the results are shown in Table 5. Similarly to Example 1, excellent results were obtained.

Even in the photothermographic material-B in which the binder was the gelatin based one, the similar results were obtained.

TABLE 5

| Sample No. | Fog | ΔDmax | Remarks |
|---|---|---|---|
| 31 | 0.18 | 2.25 | Present invention |
| 32 | 0.18 | 2.10 | Present invention |
| 33 | 0.18 | 2.22 | Present invention |

### Example 4

1) Perparation of Photothermographic Materials-41 to-43

There were prepared Samples 41, 42, and 43 using Compounds 2-8, 2-24, and 2-27 each in the same amount, respectively, in place of Compound 2-17 of Formula (M) in Sample 6 of Example 1.

2) Evaluation of Performance

The photographic performances were evaluated in the same manner as in Example 1. The results are shown in Table 6. The samples showed favorable results as with Example 1.

Even Photothermographic materials-B, in each of which the binder was a gelatin-based one, yielded the same results.

TABLE 6

| Sample No. | Fog | Δdmax | Remarks |
|---|---|---|---|
| 41 | 0.19 | 2.31 | Present Invention |
| 42 | 0.19 | 2.29 | Present Invention |
| 43 | 0.18 | 2.31 | Present Invention |

### Example 5

1. Preparation of Undercoated PET Support

Each undercoated PET support was prepared in the same manner as in Example 1.

2. Coating of Back Layer

A black layer was provided in the same manner as in Example 1.

3. Image Forming Layer and Surface Protective Layer

3-1. Preparation of Coating Solution

1) Preparation of Coating Solution for Image Forming Layer

(Image Forming Layer Coating Solution-3)

360 g of polyvinyl alcohol PVA-205 (produced by Kuraray Co., Ltd.) was dissolved in 4,300 ml of water. To the resulting solution were successively added 1,000 g of Aliphatic silver dispersion A, 276 ml of water, 33 g of Pigment-1 dispersion, 21 g of Organic polyhalogen compound-1 dispersion, 58 g of Organic polyhalogen compound-2 dispersion, an unsubstituted phthalazine solution in an amount, in terms of phthalazine, of 8.7×10⁻² mol per mole of silver, 299 g of Reducing agent complex-1 dispersion, 76 g of a stearic acid amide dispersion as a thermal solvent, 51 g of Color tone controlling agent-1 dispersion, 9 ml of Mercapto compound-1 aqueous solution, 27 ml of Mercapto compound-2 aqueous solution, and 273 g of SBR latex (Tg=17° C.). Thereto, immediately before coating, 117 g of Silver halide mixed emulsion A was added, and thoriughly mixed to prepare a coating solution for the image forming layer. The resulting solution was fed as it was into a coating die.

The pH of the coating solution for the image forming layer was 6.0.

The content of zirconium in the coating solution was 0.38 mg per gram of silver.

(Image Forming Layer Coating Solution-4)

360 g of inert gelatin was dissolved in 2760 ml of water. To the resulting solution were successively added 1000 g of Aliphatic silver dispersion B, 276 ml of water, 35 g of Pigment-i dispersion, 32 g of Organic polyhalogen compound-1 dispersion, 46 g of Organic polyhalogen compound-2 dispersion, an unsubstituted phthalazine solution in an amount, in terms of phthalazine, of 8.7×10⁻² mol per mole of silver, 153 g of Reducing agent-2 dispersion, 72 g of Hydrogen bond-forming compound-1 dispersion, 76 g of a stearic acid amide dispersion as a thermal solvent, 51 g of Color tone controlling agent-1 dispersion, 8 ml of Mercapto compound-2 aqueous solution, and 273 g of SBR latex (Tg=17° C.). Immediately before coating, 140 g of Silver halide mixed emulsion A was added thereto, and thoroughly mixed to prepare a coating solution for the image forming layer. The resulting solution was fed as it was into a coating die.

The pH of the coating solution for the image forming layer was 6.5.

The content of zirconium in the coating solution was 0.25 mg per gram of silver.

2) Intermediate Layer Coating Solution, Surface Protective First Layer Coating Solution, and Surface Protective Second Layer Coating Solution

The same coating solutions as those in Example 1 were used as the coating solutions of these layers, respectively.

3-3 Preparation of Photothermographic Materials

1) Preparation of Photothermographic Material-100

On the surface opposite to the back surface, the image forming layer, the intermediate layer, the surface protective first layer, and the surface protective second layer were applied by simultaneously coating in multilayer by a slide bead coating process in this order from the undercoated surface. Thus, a sample of a photothermographic material was prepared. Image forming layer coating solution-3 was used for the image forming layer.

Image forming layer coating solution-3 was coated so that the coating amount of aliphatic silver was 5.58 g/m².

The coating and drying conditions were the same as those in Example 1.

The prepared photothermographic material showed matting degrees of 450 seconds for the image forming layer surface side, and 130 seconds for the back surface side, in terms of Beck's smoothness. The pH of the film surface on the image forming layer surface side was determined and found to be 6.0.

2) Preparation of Photothermographic Material-110

Photothermographic material-110 was prepared in the same manner as Photothermographic material-100, except that Image forming layer coating solution-3 was changed to Image forming layer coating solution-4, further, that Yellow dye compound-1 was removed from the antihalation layer, and that the fluorine-containing surfactants of the surface protective second layer were changed from F-1 and F-2 to F-3 and F-4, respectively, in Photothermographic material-100.

Image forming layer coating solution-4 was coated so that the coating amount of aliphatic silver was 5.27 g/m².

3) Preparation of Photothermographic Materials-101 to-105

Each of Photothermographic materials-101 to-105 was prepared in the same manner as Photothermographic material-100, except that the unsubstituted phthalazine was changed to an equimolar amount of its corresponding Compound of Formula (I) of the invention as shown in Table 7 in Photothermographic material-100.

The dispersion or solution of Compound of Formula (I) was prepared in the following manner.

(Compound No. 1-7 Solution)

First, 8 kg of modified polyvinyl alcohol MP203 produced by Kuraray Co., Ltd., was dissolved in 174.57 kg of water. Then, to the resulting solution, 3.15 kg of a 20% by mass aqueous solution of sodium triisopropylnaphthalene sulfonate and 14.28 kg of a 70% by mass aqueous solution of 6-isopropyl phthalazine were added to prepare a 5% by mass solution of 6-isopropyl phthalazine (the solutions were also prepared in the same manner as conducted for Compounds Nos. I-2 and I-3).

(Compound No. I-12 Dispersion)

10 g of Compound No. I-12, 20 kg of a 10% by mass aqueous solution of modified polyvinyl alcohol (POVAL MP203 produced by Kuraray Co., Ltd.), and 0.4 kg of a 20% by mass aqueous solution of sodium triisopropylnaphthalene sulfonate were added and thoroughly mixed to give a slurry. The slurry was fed through a diaphragm pump into a sand mill of horizontal type (UVM-2, produced by Imex Co., Ltd.) filled with zirconia beads having a mean diameter of 0.5 mm, and dispersed therein for 5 hours. Then, 0.2 g of benzothiazolinone sodium salt and water were added thereto, so that the concentration of Compound No. I-12 was adjusted to 20% by mass. The resulting dispersion was heated at 60° C. for 2 hours, to obtain Compound No. I-12 dispersion. The Compound No. I-12 grains contained in Compound No. I-12 dispersion thus obtained had a median diameter of 0.55 μm and a maximum grain diameter of not more than 1.2 μm. Compound No. I-12 dispersion obtained was filtered through a filter made of polypropylene having a pore size of 3.0 μm to remove foreign matters such as dusts, and then stored.

(A Dispersion was also Prepared in the Same Manner for Compound I-20).

(Solution of Comparative Compound)

20 g of unsubstituted phthalazine was dissolved in 380 g of water to prepare a 5% by mass solution.

4. Evaluations

1) Coated Surface Conditions

Both the samples of the present invention and comparative samples had no defects such as coating streaks due to agglomerates, and granular structures due to foreign matters, and thus revealed good surface conditions.

2) Evaluation of Photographic Performances

Each of the obtained samples was cut into a half size, and respective cut samples were packaged in the following packaging material in an atmosphere of 25° C. and 50% RH, and stored at ordinary temperatures for 2 weeks. Then, evaluations were carried out as follows.

(Packaging Material)

PET 10 μ/PE 12 μ/aluminum foil 9 μ/Ny 15 μ/3% by mass carbon-containing polyethylene 50 μ (Oxygen permeability: 0.02 ml/atm·m²·25° C.·day, moisture permeability: 0.10 g/atm·m²·25° C.·day)

(Exposure and Development Processing)

An exposure apparatus was produced tentatively using a semiconductor laser capable of exhibiting a multi-longitudinal mode oscillation at a wavelength of 800 nm to 820 nm based on high-frequency superposition as an exposure light source. Using this exposure apparatus, exposure light was applied through laser scanning to each of the foregoing prepared samples from the image forming layer surface side. At this step, the angle of incidence of the scanning layer light on the surface to be exposed of the photothermographic material was set at 75 degrees, whereby an image was recorded. Then, heat development was carried out at 124° C. for 15 seconds using an automatic developing machine having a heat drum in such a manner that the protective layer of the photothermographic material and the drum surface were in contact with each other. The obtained image was evaluated by means of a densitometer.

(Density Measurement)

The evaluation of the image obtained was carried out by means of a densitometer.

As the representative values showing the photographic properties, the fog and the maximum image density (Dmax) were measured. Also, the image storability was evaluated in the following manner.

Each of the thermally developed samples was cut into a half size, and respective cut samples were stored in an atmosphere of 30° C. and 70% RH and under a fluorescent lamp having an illuminance of 1000 Lux for 24 hours. Then, an increase in fog density at the Dmin portion (ΔDmin) was evaluated.

ΔDmin=Dmin(after storage)−Dmin(immediately after development)

(Evaluation of Film Physical Properties)

The film strength of the image obtained by the thermal development processing was evaluated in the following manner.

On the surface of the photothermographic material, 100 μl of water was provided dropwise. After 1 minute, the surface was rubbed with a filter paper to remove water droplets. Thereafter, the residual water was completely dried, and how the mark of water droplets left was rated.

No marks left at all . . . ◯◯

Marks are slightly visible upon reflection and observation . . . ◯

Marks of rubbing are visible . . . Δ

The surface of coated film is peelable . . . x

(The Levels Indicated by ◯◯and◯are Practically Permissible)

The obtained results are shown in Table 7. The samples of the invention showed the following unexpected excellent effects: low fog, improved black color density, and in addition, good image storability of print-out performances which are characteristic of the photothermographic material. Further, it was confirmed that each sample of the invention is advantageously excellent in film strength, and less susceptible to scratching.

TABLE 7

| Sam- | | | | Image | | |
|---|---|---|---|---|---|---|
| ple | Compound | | | Storability | Film | |
| No. | of Formula (I) | Dmin | Dmax | (ΔDmin) | strength | Remarks |
| 100 | (Comparative | 0.18 | 0.75 | 0.24 | x | Comp. |
| | Compound) | | | | | Example |
| 101 | I-2 | 0.19 | 0.97 | 0.19 | ∘ | P.I. |
| 102 | I-3 | 0.19 | 1.03 | 0.17 | ∘ | P.I. |
| 103 | I-7 | 0.18 | 1.35 | 0.16 | ∘ | P.I. |
| 104 | I-12 | 0.19 | 1.34 | 0.18 | ∘∘ | P.I. |
| 105 | I-20 | 0.19 | 1.28 | 0.20 | ∘∘ | P.I. |

(P.I.: present invention)

### Example 6

1) Preparation of Photothermographic Materials-111 to-115

Each of Photothermographic materials-111 to-115 was prepared in the same manner as Photothermographic material-110, except that the unsubstituted phthalazine was changed to an equimolar amount of its corresponding Compound of Formula (I) of the invention as shown in Table 8 in Photothermographic material-110.

2) Heat Development Processing and Evaluation

The evaluations were carried out in the same manner as in Example 5. However, the heat development was carried out at 124° C. for 25 seconds. The results are shown in Table 8.

Like Example 5, each sample of the invention revealed unexpected excellent effects of low fog, improved black color density, and in addition, good image storability of print out performances that are characteristic of the photothermographic material, and also exhibited advantages of excellent film strength and low susceptibility of the surface to scratching.

TABLE 8

| | Compound | | | Image | | |
|---|---|---|---|---|---|---|
| Sample | of Formula | | | Storability | Film | |
| No. | (I) | Dmin | Dmax | (ΔDmin) | strength | Remarks |
| 110 | (Comp. | 0.17 | 0.73 | 0.21 | x | Comp. |
| | Compound) | | | | | Example |
| 111 | I-2 | 0.18 | 0.95 | 0.18 | ∘ | P.I. |
| 112 | I-3 | 0.18 | 1.00 | 0.17 | ∘ | P.I. |
| 113 | I-7 | 0.17 | 1.29 | 0.15 | ∘ | P.I. |
| 114 | I-12 | 0.17 | 1.27 | 0.16 | ∘∘ | P.I. |
| 115 | I-20 | 0.18 | 1.25 | 0.16 | ∘∘ | P.I. |

(P.I.: present invention)

### Example 7

Preparation of Photothermographic Materials-121 to -125

Each of Photothermographic materials-121 to -125 was prepared in the same manner as Photothermographic material-100, except that the vinyl sulfone hardner was changed to the equivalent amount of its corresponding compound shown in Table 9 in Photothermographic material-100.

2) Thermal Development Processing and Evaluations

The evaluations were carried out in the same manner as in Example 5. The results are shown in Table 9.

Like Eaxmple 5, the samples of the invention showed favorable results.

TABLE 9

| | Vinyl | | | Image | | |
|---|---|---|---|---|---|---|
| Sample | sulfone | | | Storability | Film | |
| No. | compound | Dmin | Dmax | (ΔDmin) | strength | Remarks |
| 121 | VS-8 | 0.18 | 1.41 | 0.16 | ∘ | P.I. |
| 122 | VS-9 | 0.18 | 1.30 | 0.16 | ∘ | P.I. |
| 123 | VS-16 | 0.18 | 1.38 | 0.16 | ∘ | P.I. |
| 124 | VS-23 | 0.19 | 1.27 | 0.17 | ∘ | P.I. |
| 125 | P-1 | 0.18 | 1.45 | 0.16 | ∘∘ | P.I. |

(P.I.: present invention)

### Example 8

1. Preparation of Undercoated PET Support

Each of undercoated supports was prepared in the same manner as in Example 1.

2. Coating of Back Layer

Respective back layers were provided in the same manner as in Example 1.

3. Image Forming Layer and Surface Protective Layer

3-1. Preparation of Coating Solution

(Preparation of Image Forming Layer Coating Solution-5)

360 g of polyvinyl alcohol PVA-205 (produced by Kuraray Co., Ltd.) was dissolved in 4300 ml of water. To the resulting solution were successively added 1000 g of Aliphatic silver dispersion A obtained above, 276 ml of water, 33 g of Pigment-1 dispersion, 21 g of Organic polyhalogen compound-1 dispersion, 58 g of Organic polyhalogen compound-2 dispersion, 173 g of Phthalazine compound-1 solution, 299 g of Reducing agent complex-1 dispersion, 76 g of a stearic acid amide dispersion as a thermal solvent, 51 g of Color tone controlling agent-1 dispersion, 5.7 g of Development accelerator disperion-1, and 273 g of SBR latex (Tg=17° C.). Immediately before coating, 117 g of Silver halide mixed emulsion A was added thereto and thoroughly mixed to prepare a coating solution for the image forming layer. The resulting solution was fed as it was into a coating die.

The pH of the image forming layer coating solution was 6.0.

The content of zirconium in the coating solution was 0.38 mg per gram of silver.

(Preparation of Image Forming Layer Coating Solution-6)

360 g of inert gelatin was dissolved in 2760 ml of water. To the resulting solution, were successively added 1000 g of Aliphatic silver dispersion B obtained above, 276 ml of water, 35 g of Pigment-1 dispersion, 32 g of Organic polyhalogen compound-1 dispersion, 46 g of Organic polyhalogen compound-2 dispersion, 173 g of Phthalazine compound-1 solution, 153 g of Reducing agent-2 dispersion, 72 g of Hydrogen bond-forming compound-1 dispersion, 76 g of a stearic acid amide dispersion as a thermal solvent, 51 g of Color tone controlling agent-1 dispersion, 4.8 g of Development accelerator dispersion-1, 5.2 g of Development accelerator dispersion-2, and 273 g of SBR latex (Tg=17° C.). Thereto, immediately before coating, 140 g of Silver halide mixed emulsion A was added, and well mixed to prepare an image forming layer coating solution. The resulting solution was fed as it was to a coating die.

The pH of the image forming layer coating solution was 6.5.

The content of zirconium in the coating solution was 0.25 mg per gram of silver.

2) Intermediate Layer Coating Solution, Surface Protective First Layer Coating Solution, and Surface Protective Second Layer Coating Solution

The same coating solutions as those in Example 1 were used as the coating solutions of these layers, respectively.

3-3 Preparation of Photothermographic Materials

1) Preparation of Photothermographic Material-200

Onto the surface opposite to the back surface, the image forming layer, the intermediate layer, the surface protective first layer, and the surface protective second layer were applied by coating simultaneously in multilayer by a slide bead coating process in this order from the undercoated surface. Thus, a sample of a photothermographic material was prepared. Image forming layer coating solution-5 was used for the image forming layer.

Image forming layer coating solution-5 was applied such that the coating amount of aliphatic silver was 5.58 g/m².

The coating and drying conditions were the same as in Example 1.

The prepared photothermographic material showed matting degrees of 450 seconds for the image forming layer surface side, and 130 seconds for the back surface side, in terms of Beck's smoothness. The pH of the film surface on the image forming layer surface side was determined and found to be 6.0.

2) Preparation of Photothermographic material-220

Photothermographic material-220 was prepared in the same manner as Photothermographic material-200, except that Image forming layer coating solution-5 was changed to Image forming layer coating solution-6, further, that Yellow dye compound-1 was removed from the antihalation layer, and that the fluorine-containing surfactants of the surface protective second layer were changed from F-1 and F-2 to F-3 and F-4, respectively, in Photothermographic material-200.

Image forming layer coating solution-6 was applied such that the coating amount of aliphatic silver was 5.27 g/m².

3) Preparation of Photothermographic Materials-201 to -216

Each of Photothermographic materials-201 to -216 was prepared in the same manner as Photothermographic material-200, except that a solution of Compound of its corresponding type of Type A and Types 1 to 4, and Compound of Formula (M) of the invention (the preparation process will be described later) was added to a coating solution of the image forming layer as shown in Table 10, in Photothermographic material-200. Each Compound of Type A, and Types 1 to 4 was added in an amount of 1.0×10⁻³ mol per mole of coated silver. Compound of Formula (M) was added in an amount of 5.0×10⁻³ mol per mole of coated silver.

Preparation of Solution of Compound of Formula (M): 5 g of Compound of Formula (M) was Dissolved in 95 g of Methanol to Prepare a 5% by Mass Solution.

Preparation of Solutions of Compounds of Type A, and Types 1 to 4:

2 g of these compounds were each dissolved in 98 g of methanol to prepare 2% by mass solutions.

TABLE 10

| | | | | | Print-out | |
|---|---|---|---|---|---|---|
| Sam- | Compound | Compound | | Sen- | per- | |
| ple | of Type A, | of Formula | | si- | formance | |
| No. | or Type 1-4 | (M) | Dmin | tivity | (ΔDmin) | Remarks |
| 200 | — | 2-19 | 0.19 | 100 | 0.14 | Comp. |
| | | | | | | Example |
| 201 | 1 | 2-19 | 0.19 | 225 | 0.14 | P.I. |
| 202 | 7 | 2-19 | 0.19 | 257 | 0.15 | P.I. |
| 203 | 8 | 2-19 | 0.20 | 283 | 0.16 | P.I. |
| 204 | 10 | 2-19 | 0.19 | 240 | 0.14 | P.I. |
| 205 | 11 | 2-19 | 0.19 | 218 | 0.14 | P.I. |
| 206 | 18 | 2-19 | 0.19 | 237 | 0.14 | P.I. |
| 207 | 19 | 2-19 | 0.20 | 297 | 0.16 | P.I. |
| 208 | 30 | 2-19 | 0.19 | 241 | 0.15 | P.I. |
| 209 | 31 | 2-19 | 0.20 | 285 | 0.17 | P.I. |
| 210 | 39 | 2-19 | 0.19 | 230 | 0.14 | P.I. |
| 211 | 45 | 2-19 | 0.20 | 295 | 0.17 | P.I. |
| 212 | 47 | 2-19 | 0.19 | 233 | 0.14 | P.I. |
| 213 | 49 | 2-19 | 0.20 | 288 | 0.16 | P.I. |
| 214 | 53 | 2-19 | 0.19 | 225 | 0.14 | P.I. |
| 215 | 55 | 2-19 | 0.19 | 230 | 0.15 | P.I. |
| 216 | 64 | 2-19 | 0.19 | 257 | 0.15 | P.I. |

(P.I.: present invention)

4. Evaluations

1) Coated Surface Conditions

Both the samples of the present invention and comparative samples showed no defects such as coating streaks due to agglomerates, and granular structures due to foreign matters, and thus revealed good surface conditions.

2) Evaluation of Photographic Performances

Like Example 1, each of the samples was cut, moisture conditioned, and stored in a moisture-proof bag.

(Exposure and Heat Development)

Each sample was exposed to light and subjected to heat development (using 4 panel heaters, respectively, set at 112° C.-119° C.-121° C.-121° C. each for 6 seconds, or for a total of 24 seconds) by means of FUJI Medical Dry Laser Imager FM-DPL (equipped with a 660-nm semiconductor laser having a maximum output of 60 mW (IIIB)). Each of the resulting images was evaluated by means of a densitometer.

As the values representing the photographic properties, the fog and the sensitivity were measured.

(Sensitivity)

The sensitivity, expressed by the reciprocal of the exposure necessary to obtain the black color density of fog +1.0, is indicated as a relative value, by taking the sensitivity of Sample No. 1 as 100.

(Fog (Dₘᵢₙ))

The density of the non-image part was measured by means of a Macbeth densitometer.

3) Evaluation of Print Out Performance

Each of the thermally developed samples was cut into a half size, and respective cut samples were stored under a fluorescent lamp having an illuminance of 1000 Lux for 24 hours in an atmosphere of 30° C. and 70% RH. Then, the increase in fog density at the Dmin portion (ΔDₘᵢₙ) was evaluated.

ΔDₘᵢₙ=Dmin (after storage)−Dmin (immediately after development)

4) Results

The obtained results are shown in Table 10. Samples Nos. 201 to 216 of the invention exhibited high sensitivity and showed a slight reduction in print-out performance.

### Example 9

Each of Photothermographic materials-221 to 236 was prepared in the same manner as Photothermographic material-220, except that a solution of Compound of its corresponding type of Type A and Types 1 to 4, and Compound of Formula (M) of the invention was added to the image forming layer as shown in Table 11 in Photothermographic material 220. Each compound of Type A, and Types 1 to 4 was added in an amount of 1.0×10⁻³ mol per mole of coated silver. Compound of Formula (M) was added in an amount of 5.0×10⁻³ mol per mol of coated silver.

2) Evaluation of Performances

The photographic performances and the print-out performances were evaluated in the same manner as in Example 8. The results are summarized in Table 11. Like Example 8, the samples of the invention showed good results.

TABLE 11

| | | | | | Print-out | |
|---|---|---|---|---|---|---|
| Sam- | Compound | Compound | | Sen- | per- | |
| ple | of Type A, | of Formula | | si- | formance | |
| No. | or Type 1-4 | (M) | Dmin | tivity | (ΔDmin) | Remarks |
| 220 | — | 2-28 | 0.15 | 100 | 0.08 | Comp. |
| | | | | | | Example |
| 221 | 1 | 2-28 | 0.16 | 225 | 0.08 | P.I. |
| 222 | 7 | 2-28 | 0.17 | 257 | 0.10 | P.I. |
| 223 | 8 | 2-28 | 0.18 | 283 | 0.11 | P.I. |
| 224 | 10 | 2-28 | 0.16 | 240 | 0.08 | P.I. |
| 225 | 11 | 2-28 | 0.15 | 218 | 0.08 | P.I. |
| 226 | 18 | 2-28 | 0.16 | 237 | 0.08 | P.I. |
| 227 | 19 | 2-28 | 0.18 | 297 | 0.10 | P.I. |
| 228 | 30 | 2-28 | 0.15 | 241 | 0.09 | P.I. |
| 229 | 31 | 2-28 | 0.18 | 285 | 0.10 | P.I. |
| 230 | 39 | 2-28 | 0.16 | 230 | 0.08 | P.I. |
| 231 | 45 | 2-28 | 0.18 | 295 | 0.11 | P.I. |
| 232 | 47 | 2-28 | 0.16 | 233 | 0.08 | P.I. |
| 233 | 49 | 2-28 | 0.17 | 288 | 0.09 | P.I. |
| 234 | 53 | 2-28 | 0.15 | 225 | 0.08 | P.I. |
| 235 | 55 | 2-28 | 0.19 | 230 | 0.08 | P.I. |
| 236 | 64 | 2-28 | 0.16 | 257 | 0.09 | P.I. |

(P.I.: present invention)

### Example 10

Preparation of Photothermographic Materials-240 to -245

Each of Photothermographic materials-241 to -245 was prepared in the same manner as Photothermographic material-207, except that its corresponding compound shown in Table 12 was used in place of Compound No. 2-19 as Compound of Formula (M) in Photothermographic material-207 of Example 8. Sample-240 not containing Compound of Formula (M) was prepared as a comparative example.

2) Evaluation of Performances

The photographic performances were evaluated in the same manner as in Example 8. The results are shown in Table 12. Like Example 8, the samples showed good results.

TABLE 12

| | | | | | Print-out | |
|---|---|---|---|---|---|---|
| Sam- | Compound | Compound | | Sen- | per- | |
| ple | of Type A, | of Formula | | si- | formance | |
| No. | or Type 1-4 | (M) | Dmin | tivity | (ΔDmin) | Remarks |
| 240 | 19 | — | 0.25 | 61 | 0.18 | Comp. |
| | | | | | | Example |
| 241 | 19 | 2-10 | 0.16 | 280 | 0.15 | P.I. |
| 242 | 19 | 2-27 | 0.17 | 268 | 0.15 | P.I. |
| 243 | 19 | 2-28 | 0.18 | 322 | 0.16 | P.I. |
| 244 | 19 | 2-44 | 0.16 | 205 | 0.16 | P.I. |
| 245 | 19 | 2-51 | 0.15 | 230 | 0.16 | P.I. |

(P.I.: present invention)

### Example 11

Sample 241 was prepared in the same manner as Sample 207, except that Compound No. 19 of any of Types 1 to 4 was added in the same amount not during the preparation of the image forming layer coating solution, but during the preparation of the silver halide mixed emulsion in Sample 207 of Example 8. The evaluation was carried out in the same manner as in Example 8. The same good results as with Sample 207 were obtained.

### Example 12

1. Preparation of Undercoated PET Support

Each of undercoated PET supports was prepared in the same manner as in Example 1.

2. Coating of Back Layer

Each back layer was provided in the same manner as in Example 1.

3. Image Forming Layer and Surface Protective Layer

3-1. Preparation of Coating Solution

(Preparation of Image Forming Layer Coating Solution-7)

1,000 g of Aliphatic silver dispersion A, 276 ml of water, 33 g of Pigment-1 dispersion, 21 g of Organic polyhalogen compound-1 dispersion, 58 g of Organic polyhalogen compound-2 dispersion, 173 g of Phthalazine compound-1 solution, 1082 g of SBR latex (Tg: 17° C.), 299 g of Reducing agent complex-1 dispersion, 5.7 g of Development accelerator-1 dispersion, 9 ml of Mercapto compound-1 aqueous solution, and 27 ml of Mercapto compound-2 aqueous solution were successively added. Immediately before coating, 117 g of Silver halide mixed emulsion A was added to the resulting mixture and thoroughly mixed to prepare an image forming layer coating solution. The resulting solution was fed as it was into a coating die.

The viscosity of the image forming layer coating solution was determined using a B-model viscometer (manufactured by Tokyo Instrument Co., Ltd.) and found to be 25 mPa.s at 40° C. (No. 1 rotor, 60 rpm).

The viscosities of the coating solution at 25° C. determined by means of a RFS fluid spectrometer (manufactured by Rheometrics Far East Co., Ltd.) were 230, 60, 46, 24, and 18 mPa.s at shear rates of 0.1, 1, 10, 100, and 1000 [1/sec], respectively.

The content of zirconium in the coating solution was 0.38 mg per gram of silver.

(Preparation of Image Forming Layer Coating Solution-8)

1000 g of Aliphatic silver dispersion B, 276 ml of water, 35 g of Pigment-1 dispersion, 32 g of Organic polyhalogen compound-1 dispersion, 46 g of Organic polyhalogen compound-2 dispersion, 173 g of Phthalazine compound-1 solution, 1082 g of a SBR latex (Tg: 17° C.), 153 g of Reducing agent-2 dispersion, 55 g of Hydrogen bond-forming compound-1 dispersion, 4.8 g of Development accelerator-1 dispersion, 5.2 g of Development accelerator-2 dispersion, 2.1 g of Color tone controlling agent-1 dispersion, and 8 ml of Mercapto compound-2 aqueous solution were successively added. Immediately before coating, 140 g of Silver halide mixed emulsion A was added to the resulting mixture and thoroughly mixed to prepare an image forming layer coating solution. The resulting solution was fed as it was to a coating die.

The viscosity of the image forming layer coating solution was determined by means of a B-model viscometer (manufactured by Tokyo Instrument Co., Ltd.) and found to be 40 mPa.s at 40° C. (No. 1 rotor, 60 rpm).

The viscosities of the coating solution at 25° C. determined by means of a RFS fluid spectrometer (produced by Rheometrics Far East Co., Ltd.) were 530, 144, 96, 51, and 28 mPa.s at shear rates of 0.1, 1, 10, 100, and 1000 [1/sec], respectively.

The content of zirconium in the coating solution was 0.25 mg per gram of silver.

(Preparation of Image Forming Layer Coating Solution-9)

480 g of polyvinyl alcohol PVA-205 (produced by Kuraray Co., Ltd.) was dissolved in 4300 ml of water. To the resulting solution were successively added 1000 g of Aliphatic silver dispersion C obtained above, 35 g of Pigment-1 dispersion, 32 g of Organic polyhalogen compound-1 dispersion, 46 g of Organic polyhalogen compound-2 dispersion, 173 g of Phthalazine compound-1 solution, 153 g of Reducing agent-2 dispersion, 55 g of Hydrogen bond-forming compound-1 dispersion, 4.8 g of Development accelerator-1 dispersion, 5.2 g of Development accelerator-2 dispersion, 2.1 g of Color tone controlling agent-1 dispersion, 8 ml of Mercapto compound-2 aqueous solution, 15 ml of Compound B (3% aqueous solution), and 1600 ml of a 19% by mass solution of methyl methacrylate/styrene/butyl acrylate/hydroxyethyl methacrylate/acrylic acid copolymer (copolymerization weight ratio 64/9/20/5/2) latex. Immediately before coating, 140 g of Silver halide mixed emulsion A was added to the resulting mixture and thoroughly mixed to prepare an image forming layer coating solution. The obtained solution was fed as it was into a coating die.

The viscosity of the coating solution for the image forming layer was determined using a B-model viscometer (manufactured by Tokyo Instrument Co., Ltd.) and found to be 51 mPa.s at 40° C. (No. 1 rotor, 60 rpm).

The viscosities of the coating solution at 25° C. determined by means of a RFS fluid spectrometer produced by Rheometrics Far East Co., Ltd., were 610, 153, 109, 55, and 31 mPa.s at shear rates of 0.1, 1, 10, 100, and 1000 [1/sec], respectively.

The content of zirconium in the coating solution was 0.25 mg per gram of silver.

(Preparation of Image Forming Layer Coating Solution-10)

480 g of inert gelatin was dissolved in 2760 ml of water. To the resulting solution were successively added 1000 g of Aliphatic silver dispersion C to be described below, 35 g of Pigment-1 dispersion, 32 g of Organic polyhalogen compound-1 dispersion, 46 g of Organic polyhalogen compound-2 dispersion, 173 g of Phthalazine compound-1 solution, 153 g of Reducing agent-2 dispersion, 55 g of Hydrogen bond-forming compound-1 dispersion, 4.8 g of Development accelerator-1 dispersion, 5.2 g of Development accelerator-2 dispersion, 2.1 g of Color tone controlling agent-1 dispersion, 8 ml of Mercapto compound-2 aqueous solution, 50 ml of Compound B-1 (3% aqueous solution), and 840 ml of Latex A. Immediately before coating, 140 g of Silver halide mixed emulsion A was added to the resultant mixture and thoroughly mixed to prepare an image forming layer coating solution. The resulting solution was fed as it was into a coating die.

The viscosity of the coating solution of the image forming layer was determined using a B-model viscometer (manufactured by Tokyo Instrument Co., Ltd.) found to be 62 mPa.s at 40° C. (No. 1 rotor, 60 rpm).

The viscosity of the respective coating solutions at 25° C. determined using an RFS fluid spectrometer (produced by Rheometrics Far East Co., Ltd.) were 720, 205, 116, 65, and 35 mPa.s at shear rates of 0.1, 1, 10, 100, and 1000 [1/sec], respectively.

The content of zirconium in the coating solution was 0.25 mg per gram of silver.

(Preparation of Aliphatic Silver Dispersion C)

To the obtained wet cake corresponding to 260 kg of the dry solid content of Aliphatic silver dispersion B were added 4.8 kg of inert gelatin in place of polyvinyl alcohol, 53.1 kg of a surfactant (PAIONIN A-43-S (produced by TAKEMOTO Oil & Fat Co., Ltd.): solid content 48.5% by mass) and water to give a total amount of 1,000 kg. Then, the resulting mixture was formed into a slurry by means of a dissolver blade, and further pre-dispersed by means of a pipeline mixer (PM-10 model: produced by MIZUHO Industrial Co., Ltd.).

Then, the pre-dispersed stock dispersion was treated three times using a dispersing machine (trade name: Microfluidizer-M-610, produced by Microfluidex International Corporation, with a Z model interaction chamber) applying a pressure controlled to be 1150 kg/cm² to thereby obtain a silver behenate dispersion. During the cooling operation, the dispersion temperature was set at 18° C. by providing coiled heat exchangers fixed before and after the interaction chamber, and controlling the temperature of the refrigerant.

(Preparation of Development Accelerator Dispersion)

1) Preparation of Development Accelerator-1 Dispersion

To 10 kg of Development accelerator-1 and 20 kg of a 10% by mass aqueous solution of modified polyvinyl alcohol (POVAL MP203 produced by Kuraray Co., Ltd.) was added 10 kg of water and thoroughly mixed to obtain a slurry. The slurry was poured through a diaphragm pump to a sand mill of horizontal type (UVM-2, produced by Imex Co., Ltd.) that was filled with zirconia beads having a mean diameter of 0.5 mm, and dispersed for 3 hours and 30 minutes. Then, 0.2 g of benzothiazolinone sodium salt and water were added thereto so that the concentration of the development accelerator was 20% by mass, thus preparing a Development-1 dispersion. The development accelerator grains contained in the development accelerator dispersion thus prepared had a median diameter of 0.48 μm and a maximum grain diameter of not more than 1.4 μm. The development accelerator dispersion obtained was filtered through a filter made of polypropylene having a pore size of 3.0 μm to remove foreign matters such as dusts, and then stored.

2) Preparation of Solid Dispersions of Development Accelerator-2 and Color Tone Controlling Agent-1

The solid dispersions of Development accelerator-2 and Color tone controlling agent-1 were obtained by carrying out dispersing operation in the same manner as conducted for Development accelerator-1 to obtain 20% by mass dispersions.

(Preparation of Mercapto Compound)

1) Preparation of Mercapto Compound-1 Aqueous Solution

7 g of Mercapto compound-1 (1-(3-sulfophenyl)-5-mercaptotetrazole sodium salt) was dissolved in 993 g of water, to give a 0.7% by mass aqueous solution.

2) Preparation of Mercapto Compound-2 Aqueous Solution

20 g of Mercapto Compound-2 (1-(3-methylureide)-5-mercaptotetrazole sodium salt) was dissolved in 980 g of water, to produce a 2.0% by mass aqueous solution.

3) Intermediate Layer Coating Solution, Surface Protective First Layer Coating Solution, and Surface Protective Second Layer Coating Solution

The same coating solutions as those in Example 1 were used as the coating solutions for these layers, respectively.

3-2 Preparation of Photothermographic Materials

1) Preparation of Photothermographic Material-301

Onto the surface opposite to the back surface, Image forming layer-7, the intermediate layer, the surface protective first layer, and the surface protective second layer were applied by coating simultaneously in multilayer in this order from the undercoated surface so that the coating amount of aliphatic silver was 5.58 g/m²; the coating amount of PVA 205, 0.95 g/m²; the coating amount of gelatin, 1.50 g/m²; and the coating amount of gelatin, 0.60 g/m², respectively. Thus, a sample of a photothermographic material was prepared.

The coating and drying conditions were the same as in Example 1.

The prepared photothermographic material had matting degrees of 550 seconds for the image forming layer surface side, and 130 seconds for the back surface side, in terms of Beck's smoothness. The pH of the film surface on the image forming layer surface side was determined and found to be 6.0.

2) Preparation of Photothermographic Material-302

Photothermographic material-302 was prepared in the same manner as Photothermographic material-301, except that Image forming layer coating solution-7 was changed to Image forming layer coating solution-8, further, that Yellow dye compound-1 was removed from the antihalation layer, and that the fluorine-containing surfactants of the back surface protective layer and the surface protective layer were changed from F-1 and F-2 to F-3 and F-4, respectively, in Photothermographic material-301.

The image forming layer, the intermediate layer, the surface protective first layer, and the surface protective second layer were simultaneously applied in multilayer by a slide bead coating process such that the coating amount of aliphatic silver was 5.27 g/m²; the coating amount of PVA205 was 0.95 g/m²; the coating amount of gelatin was 1.95 g/m²; and the coating amount of gelatin was 0.60 g/m², respectively. Thus, a sample of a photothermographic material was prepared.

3) Preparation of Photothermographic Material-303

Photothermographic material-303 was prepared in the same manner as Photothermographic material-302, except that Image forming layer coating solution-8 was changed to Image forming layer coating solution-9 in Photothermographic material-302. The coating amount of Image forming layer coating solution-9 was adjusted such that the coating amount of aliphatic silver was 1.95 g/m².

4) Preparation of Photothermographic Material-304

Photothermographic material-304 was prepared in the same manner as Photothermographic material-302, except that Image forming layer coating solution-8 was changed to Image forming layer coating solution-10 in Photothermographic material-302. The coating amount of Image forming layer coating solution-10 was adjusted such that the coating amount of aliphatic silver was 1.95 g/m².

5) Preparation of Photothermographic Material-305

Photothermographic material-305 was prepared by removing the chromium alum in the surface protective first layer, and adding Compound V-1 in aqueous solution form in an amount of 3% by mass based on the total amount of gelatin on the image forming layer surface side in Photothermographic material-304.

6) Preparation of Photothermographic Materials-306 to -313

Each of Photothermographic materials-306 to -313 was prepared by changing Development accelerator-2 in the image forming layer as shown in Table 13 in Photothermographic material-305.

7) Preparation of Photothermographic Materials-314 to -319

Each of Photothermographic materials-314 to -319 was prepared by adding its corresponding thermal solvent in each image forming layer as shown in Table 13 in Photothermographic material-305. Incidentally, each of these thermal solvents was added by being formulated into a solid dispersion in the same manner as the Hydrogen bond-forming compound-1 dispersion.

The thermal solvents used for the evaluations were as follows:

| | |
|---|---|
| m-1: | Behenic acid |
| m-2: | 1,10-Decane diol |
| m-3: | Stearylanilide |
| m-4: | Salicylanilide |
| m-5: | o-Hydroxybenzyl alcohol |
| m-6: | 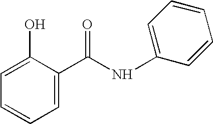 |

8) Preparation of Photothermographic Material-320

Photothermographic material-320 was prepared by removing the phthalic acid from the surface protective first layer and the surface protective second layer in Photothermographic material-314, and adding phthalic acid into the image forming layer such that the total coating amount of phthalic acid was the same as with Photothermographic material-314.

The chemical structures of the compounds used in the examples of the invention will be shown below.

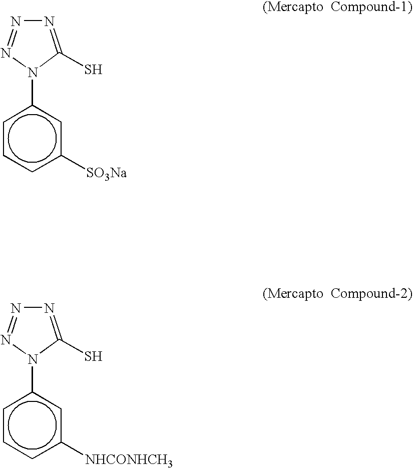

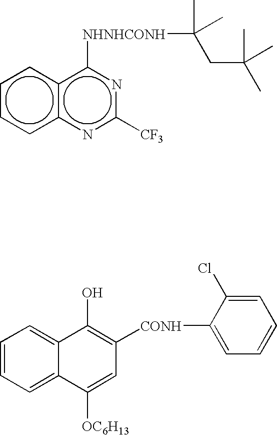

3-3 Evaluation of Photographic Performances

Each of the obtained samples was cut, moisture conditioned, and stored in a moisture-proof bag in the same manner as in Example 1.

(Exposure and Thermal Development)

Each sample was exposed to light and thermally developed (using 4 panel heaters respectively set at 112° C.-119° C.-121° C.-121° C. for a total of 24 seconds for Photothermographic material-301, and for a total of 14 seconds for Photothermographic materials-302 to 320) by FUJI Medical Dry Laser Imager FM-DPL (equipped with a 660-nm semiconductor laser having a maximum output of 60 mW (IIIB)). Each of resulting images was evaluated based on the image density measured using a densitometer.

(Maximum Image Density)

The maximum image density of each photothermographic material was evaluated based on the results obtained.

(Coated Surface Conditions)

Each sample was exposed to light and subjected to thermal development processing to give a density=1.5, and the coated surface conditions were rated based on the number of coating streaks per unit coating width (a photothermographic material with less coating streaks is more excellent in coatability).

The evaluation criteria were as follows:

∘∘: Almost no coating streaks occurred;
∘: Small number of low-density coating streaks occurred;
Δ: Small number of high-density coating streaks occurred; and
x: Coating streaks occurred on the entire surface

The results are shown in Table 13.

It is indicated that the photothermographic materials containing a water-soluble binder of the invention were excellent in image density and excellent in coatability.

TABLE 13

| | Image | Binder in | Additive of | | | Maximum | | |
|---|---|---|---|---|---|---|---|---|
| | forming layer | Image forming | Protective | | | color | Coated | |
| Photothermographic | coating | layer coating | layer first | Development | Thermal | development | surface | |
| material | solution | solution | layer | accelator | solvent | density | conditions | Remarks |
| 301 | 1 | SBR latex | Chrome alum | DA-1 | None | 100 | Δ | Comp. Ex. |
| 302 | 2 | SBR latex | Chrome alum | DA-1/2 | None | 105 | Δ | Comp. Ex. |
| 303 | 3 | PVA | Chrome alum | DA-1/2 | None | 108 | ∘ | P.I. |
| 304 | 4 | Gelatin | Chrome alum | DA-1/2 | None | 99 | ∘∘ | P.I. |
| 305 | 4 | Gelatin | H-1 | DA-1/2 | None | 102 | ∘∘ | P.I. |
| 306 | 4 | Gelatin | H-1 | DA-1/1-1 | None | 101 | ∘∘ | P.I. |
| 307 | 4 | Gelatin | H-1 | DA-1/1-12 | None | 100 | ∘∘ | P.I. |
| 308 | 4 | Gelatin | H-1 | DA-1/1-47 | None | 99 | ∘∘ | P.I. |
| 309 | 4 | Gelatin | H-1 | DA-1/6-8 | None | 103 | ∘∘ | P.I. |
| 310 | 4 | Gelatin | H-1 | DA-1/2-60 | None | 104 | ∘∘ | P.I. |
| 311 | 4 | Gelatin | H-1 | DA-1/3-3 | None | 100 | ∘∘ | P.I. |
| 312 | 4 | Gelatin | H-1 | DA-1/4-7 | None | 102 | ∘∘ | P.I. |
| 313 | 4 | Gelatin | H-1 | DA-1/4-39 | None | 100 | ∘∘ | P.I. |
| 314 | 4 | Gelatin | H-1 | DA-1/2 | m-1 | 112 | ∘∘ | P.I. |
| 315 | 4 | Gelatin | H-1 | DA-1/2 | m-2 | 110 | ∘∘ | P.I. |
| 316 | 4 | Gelatin | H-1 | DA-1/2 | m-3 | 111 | ∘∘ | P.I. |
| 317 | 4 | Gelatin | H-1 | DA-1/2 | m-4 | 108 | ∘∘ | P.I. |
| 318 | 4 | Gelatin | H-1 | DA-1/2 | m-5 | 109 | ∘∘ | P.I. |
| 319 | 4 | Gelatin | H-1 | DA-1/2 | m-6 | 113 | ∘∘ | P.I. |
| 320 | 4 | Gelatin | H-1 | DA-1/2 | m-1 | 115 | ∘∘ | P.I. |

### Example 13

Each of Photothermographic materials 321 to 325 was prepared by replacing its corresponding polymer latex shown in Table 14 with 40% by mass of the binder (SBR latex) in the image forming layer in Photothermographic material-301 prepared in Example 12.

Then, similarly to the above, each of Photothermographic materials 326 to 330 was prepared by replacing its corresponding polymer latex shown in Table 14 with 40% by mass of the binder (SBR latex) in the image forming layer in Photothermographic material-320.

The adhesion strength of the image forming layer in each of these photothermographic materials was evaluated according to the T type peel testing method of JIS K 6854 described in JP-A No. 2001-133929.

The adhesion strength ratio with respect to Photothermographic-301 was determined for each of Photothermographic materials 321 to 325. Whereas, the adhesion strength ratio with respect to Photothermographic material-320 was determined for each of Photothermographic materials 326 to 330.

The results are shown in Table 14.

It was revealed that the adhesion strength is remarkably improved by adding each polymer latex to the water-soluble binder of the invention.

TABLE 14

| Photothermographic | Polymer | Adhesion strength | |
|---|---|---|---|
| material | latex | ratio *1 | Remarks |
| 321 | P-1 | 95 | Comp. Example |
| 322 | P-5 | 102 | Comp. Example |
| 323 | P-10 | 96 | Comp. Example |
| 324 | P-12 | 85 | Comp. Example |
| 325 | P-14 | 90 | Comp. Example |
| 326 | P-1 | 260 | Present Invention |
| 327 | P-5 | 220 | Present Invention |
| 328 | P-10 | 190 | Present Invention |
| 329 | P-12 | 180 | Present Invention |
| 330 | P-14 | 230 | Present Invention |

The adhesion strength ratio *1 was a relative value with respect to the adhesion strength prior to addition of the polymer latex taken as 100.

### Example 14

1. Preparation of PET Support, and Undercoating Thereof

The same procedures as in Example 1 were followed.

2. Back Layer

2-1. Preparation of Back Layer Coating Solution

1) Preparation of Solutions of Compounds Belonging to Formulae (1) to (5) of the Invention

Each of 3% by mass methanol solution of Compound No. 10 was prepared.

2) Preparation of Solid Dispersions of Compounds Belonging to Formulae (1) to (5) of the Invention

To 60 g of Compound No. 10 and 96 g of a 10% by mass aqueous solution of modified polyvinyl alcohol (POVAL MP203 produced by kuraray Co., Ltd.) was added 60 g of water and thoroughly mixed, to give a slurry. The slurry was dispersed using a 1/4G sand grinder mill (produced by IMEX Co., Ltd.) that was filled with zirconia beads having a mean diameter of 0.5 mm, for 5 hours. Then, 1.2 mg of sodium benzoisothiazolinate and water were added thereto, such that the concentration of the reducing agent was adjusted to 20% by mass. As for the mean grain size of the dispersion thus obtained, the median diameter was 0.40 μm and the maximum grain diameter was not more than 1.5 μm.

3) Preparation of Emulsion Dispersion of Compound having the Formulae (1) to (5) of the Invention

17.5 g of Compound No. 10 and 15 cc of tricresyl phosphate were added to 100 cc of ethyl acetate with heating to 40° C., and completely dissolved therein. The resulting ethyl acetate solution was mixed with 400 g of a 13% gelatin aqueous solution containing 7.0 g of Surfactant (W-4), and the resultant mixture was subjected to emulsifying-dispersing operation using a homo-blender. The emulsified dispersion thus obtained was added to the intended layer.

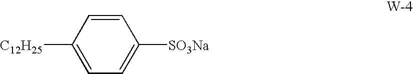

4) Preparation of Antihalation Layer Coating Solutions-1 to -3

30 g of gelatin, 24.5 g of polyacrylamide, 2.2 g of caustic soda having a concentration of 1 mol/L, 2.4 g of monodisperse polymethyl methacrylate fine grains (mean grain size: 8 μm, grain diameter standard deviation: 0.4), 0.08 g of benzothiazolinone were mixed. A solution of Compound of any of Formulae (1) to (3), or a solid dispersion thereof or an emulsified dispersion thereof was added thereto in an amount such that the amount of Compound was 9 g. Then, 0.6 g of sodium polyethylene sulfonate, 8.3 g of acrylic acid/ethyl acrylate copolymer latex (copolymerization ratio: 5/95) and water were mixed therewith to make the total amount of 818 mL. As a result, Antihalation layer coating solution-1 (in which the solution was used), Antihalation layer coating solution-2 (in which the solid dispersion was used), and Antihalation layer coating solution-3 (in which the emulsified dispersion was used) were prepared.

5) Preparation of Back Surface Protective Layer Coating Solution

Into a vessel kept at 40° C. were poured 40 g of gelatin, a liquid paraffin emulsion in an amount of 1.5 g in terms of liquid paraffin, 35 mg of benzoisothiazolinone, 6.8 g of caustic soda having a concentration of 1 mol/L, 0.5 g of sodium t-octylphenoxyethoxyethanesulfonate, 0.27 g of sodium polystyrenesulfonate, 2.0 g f N,N-ethylenebis(vinyl sulfonacetamide), 37 mg of Fluorine-containing surfactant (F-1), 150 mg of Fluorine-containing surfactant (F-2), 64 mg of Fluorine-containing surfactant (F-3), 32 mg of Fluorine-containing surfactant (F-4), 6.0 g of acrylic acid/ethyl acrylate copolymer (copolymerization weight ratio: 5/95), and 2.0 g of N,N-ethylenebis(vinyl sulfonamide) and mxed therein. The resulting mixture was diluted to 1000 ml with water, to prepare a back surface protective layer coating solution.

2-2. Coating of Back Layers-1 to -3

Onto the back surface side of the undercoated support, Antihalation layer coating solutions-1 to -3 were applied such that the respective coating amounts of gelatin were 0.44 g/m², and the back surface protective layer coating solution was applied simultaneously by coating in multilayer such that the coating amount of gelatin was 1.7 g/m², and then dried to dispose Back layers-1 to -3.

3. Image Forming Layer and Surface Protective Layer

3-1. Preparation of Materials for Coating

1) Silver Halide Emulsion

(Preparation of Silver Halide Emulsion 4)

To 1421 ml of distilled water were added 3.1 ml of a 1% by mass potassium bromide solution, followed by further addition of 3.5 ml of sulfuric acid having a concentration of 0.5 mol/L and 31.7 g of phthalated gelatin. The resulting solution was kept at 30° C. with stirring in a reaction jar made of stainless steel. Solution A was prepared by diluting 2222 g of silver nitrate with the added distilled water to 95.4 ml, and Solution B was prepared by diluting 15.3 g of potassium bromide and 0.8 g of potassium iodide with the added distilled water to a volume of 97.4 ml. The whole amount of Solutions A and B were added thereto at a constant flow rate over 45 seconds. Then, 10 ml of a 3.5% by mass hydrogen peroxide aqueous solution was added thereto, and further, 10.8 ml of a 10% by mass aqueous solution of benzimidazole was added thereto.

Further, Solution C was prepared by diluting 51.86 g of silver nitrate with the addition of distilled water to 317.5 ml, and Solution D was prepared by diluting 44.2 g of potassium bromide and 2.2 g of potassium iodide to a volume of 400 ml with distilled water. The whole amount of Solution C was added at a given flow rate over 20 minutes. Whereas, Solution D was added while keeping the pAg at 8.1 using a controlled double jet method. Potassium hexachloroiridate (III) was added in an amount of 1×10⁻⁴ mol per mole of silver, all at once after 10 minutes from the start of addition of Solutions C and D. Whereas, an aqueous solution of potassium iron (II) hexacyanide was wholly added in an amount of 3×10⁻⁴ mol per mole of silver after 5 seconds from the completion of addition of Solution C. The pH was adjusted to 3.8 using sulfuric acid having a concentration of 0.5 mol/L, and stirring was halted. Then, steps of sedimentation/desalting/washing with water were carried out. The resulting mixture was adjusted to pH 5.9 with sodium hydroxide with a concentration of 1 mol/L. Thus, a silver halide dispersion with a pAg 8.0 was prepared.

The silver halide dispersion was kept at 38° C. with stirring, to which was added 5 ml of a 0.34% by mass methanol solution of 1,2-benzoisothiazolin-3-one. After 40 minutes, the mixture was heated to 47° C. After 20 minutes from the heating, sodium benzenethiosulfonate was added in an amount of 7.6×10⁻⁵ mol per mole of silver in the form of a methanol solution. Further, after 5 minutes, Tellurium sensitizer C was added thereto in an amount of 2.9×10⁻⁴ mol per mole of silver in the form of a methanol solution, followed by ripening for 91 minutes. Then, 1.3 ml of a 0.8% by mass methanol solution of N,N′-dihydroxy-N″-diethylmelamine was added thereto, and after additional 4 minutes, thereto were added 5-methyl-2-mercaptobenzimidazole in the form of a methanol solution in an amount of 4.8×10⁻³ mol per mole of silver, 1-phenyl-2-heptyl-5-mercapto-1,3,4-triazole in the form of a methanol solution in an amount of 5.4×10⁻³ mol per mole of silver, and 1-(3-methylureido)-5-mercaptotetrazole sodium salt in the form of an aqueous solution in an amount of 8.5×10⁻³ mol per mole of silver. Thus, Silver halide emulsion 4 was prepared.

The grains present in the prepared silver halide emulsion were silver iodobromide grains uniformly containing iodine in an amount of 3.5 mol % and having a mean sphere equivalent diameter of 0.042 μm, and a variation coefficient of sphere equivalent diameter of 20%. The grain size was determined from the average of 1000 grains using an electron microscope. The {100} plane proportion of these grains was determined to be 80% by employing the Kubelka-Munk method.

(Preparation of Silver Halide Emulsion 5)

A silver halide emulsion was prepared in the same manner as Silver halide emulsion 4, except that the solution temperature of 30° C. during grain formation was changed to 47° C., that Solution B was prepared by diluting 15.9 g of potassium bromide to 97.4 ml with distilled water, that Solution D was prepared by diluting 45.8 g of potassium bromide to 400 ml with distilled water, that the time duration over which Solution C was added was changed to 30 minutes, and that the potassium iron (II) hexacyanide was removed in the preparation of Silver halide emulsion 4.

The steps of grain formation/sedimentation/washing with water/dispersing were carried out as for Silver halide emulsion 4. Further, Silver halide emulsion 5 was obtained in the same manner as Emulsion 1, except that the amount of Tellurium sensitizer C added was changed to 5.1×10⁻⁵ mol per mole of silver, that the amount of 1-phenyl-2-heptyl-5-mercapto-1,3,4-triazole added in the form of methanol solution was changed to 3.3×10⁻³ mol per mole of silver, and that the amount of 1-(3-methylureido)-5-mercaptotetrazole sodium salt added in the form of aqueous solution was changed to 4.7×10⁻³ mol per mole of silver. The emulsion grains of Silver halide emulsion 5 were pure silver bromide cubic grains having a mean sphere equivalent diameter of 80 nm and a variation coefficient of sphere equivalent diameter of 20%.

(Preparation of Silver Halide Emulsion 6)

Silver halide emulsion 6 was prepared in the same manner as Silver halide emulsion 4, except that the solution temperature of 30° C. during grain formation was changed to 27° C. in the preparation of Silver halide emulsion 4. Further, the steps of sedimentation/desalting/washing with water/dispersing were carried out as for Silver halide emulsion 4. Further, Silver halide emulsion 6 was obtained in the same manner as Emulsion 4, except that the addition amount of Tellurium sensitizer C was changed to 5.2×10⁻⁴ mol per mole of silver, and that after 3 minutes from the addition of the Tellurium sensitizer, auric bromide in an amount of 5×10⁻⁴ mol per mole of silver, and potassium thiocyanate in an amount of 2×10⁻³ mol per mole of silver were added. The grains present in Silver halide emulsion 6 were silver iodobromide grains uniformly containing iodine in an amount of 3.5 mol % and having a mean sphere equivalent diameter of 0.034 μm, and a variation coefficient of sphere equivalent diameter of 20%. (Preparation of Mixed Emulsion B for Coating Solution)

Silver halide emulsion 4 in an amount of 70% by mass, silver halide emulsion 5 in an amount of 15% by mass, and Silver halide emulsion 6 in an amount of 15% by mass were mixed and dissolved together. Thereto, benzothiazolium iodide was added in the form of a 1% by mass aqueous solution in amount of 7×10⁻³ mol per mole of silver. Further, water was added such that the silver halide content per kilogram of the mixed emulsion for coating solution calculated in terms of silver was 38.2 g, and 1-(3-methylureido)-5-mercaptotetrazole sodium salt was added in an amount of 0.34 g per kilogram of the mixed emulsion for the coating solution.

3-2 Preparation of Coating Solution

1) Preparation of Coating Solution for Image Forming Layer

(Preparation of Image Forming Layer Coating Solution-11)

360 g of polyvinyl alcohol PVA-205 (produced by Kuraray Co., Ltd.) was dissolved in 4300 ml of water. To the resulting solution were successively added 1000 g of Fatty acid dispersion A, 276 ml of water, 33 g of Pigment-1 dispersion, 21 g of Organic polyhalogen compound-1 dispersion, 58 g of Organic polyhalogen compound-2 dispersion, 173 g of Phthalazine compound-1 solution, 299 g of Reducing agent complex-1 dispersion, 76 g of a stearic acid anilide dispersion as a thermal solvent, 51 g of Color tone controlling agent-1 dispersion, 273 g of SBR latex (Tg=17° C.), Sensitizing dye-1 in an amount of 5.0×10⁻⁴ mol per mole of silver, 9 ml of Mercapto compound-1 aqueous solution, and 27 ml of Mercapto compound-2 aqueous solution. Immediately before coating, 117 g of Silver halide mixed emulsion B was added to the resulting mixture and thoroughly mixed to prepare a coating solution for the image forming layer. The resulting solution was fed as it was into a coating die.

The pH of the coating solution of the image forming layer was 6.0.

The content of zirconium in the coating solution was 0.38 mg per gram of silver.

(Preparation of Image Forming Layer Coating Solution-12)

360 g of inert gelatin was dissolved in 2760 ml of water. To the resulting solution were successively added 1000 g of Aliphatic silver dispersion B, 276 ml of water, 35 g of Pigment-1 dispersion, 32 g of Organic polyhalogen compound-1 dispersion, 46 g of Organic polyhalogen compound-2 dispersion, 173 g of Phthalazine compound-1 solution, 153 g of Reducing agent-2 dispersion, 72 g of Hydrogen bond-forming compound-1 dispersion, 76 g of a stearic acid anilide dispersion as a thermal solvent, 4.8 g of Development accelerator-1 dispersion, 5.2 g of Development accelerator-2 dispersion, Sensitizing Dye-1 in an amount of 5.0×10⁻⁴ mol per mole of silver, 8 ml of Mercapto compound-2 aqueous solution, 51 g of Color tone controlling agent-1 dispersion, and 273 g of SBR latex (Tg=17° C.). Immediately before coating, 140 g of Silver halide mixed emulsion B was added thereto and thoroughly mixed to prepare a coating solution for the image forming layer. The resulting solution was fed as it was into a coating die.

2) Intermediate Layer Coating Solution, Surface Protective First Layer Coating Solution, and Surface Protective Second Layer Coating Solution

The same coating solutions as those in Example 1 were used as the coating solutions of these layers, respectively.

3-3 Preparation of Photothermographic Materials-401 to 403

Onto the surface opposite to each back surface, the image forming layer using Image forming layer coating solution-11, the intermediate layer, the surface protective first layer, and the surface protective second layer were applied by coating simultaneously in multilayer by a slide bead coating process in this order from the undercoated surface. Thus, samples of photothermographic materials were prepared. The one using Back layer-1 was Sample-401, the one using Back layer-2 was Sample-402, and the one using Back layer-3 was Sample-403.

The coating amount (g/m²) of respective compounds for the image forming layer was as follows:

| | |
|---|---|
| Aliphatic silver A | 5.58 |
| Pigment-1 (C. I. Pigment Blue 60) | 0.036 |
| Polyhalogen compound-1 | 0.12 |
| Polyhalogen compound-2 | 0.37 |
| 6-Isopropylphthalazine | 0.19 |
| PVA-205 | 7.5 |
| SBR latex | 2.4 |
| Reducing agent complex-1 | 1.41 |
| Development accelerator-1 | 0.024 |
| Stearic acid anilide dispersion | 0.33 |
| Color tone controlling agent-1 | 0.22 |
| Sensitizing dye-1 | (5.0 × 10⁻⁴ mol per mole of silver) |
| Mercapto compound-1 | 0.002 |
| Mercapto compound-2 | 0.012 |
| Compound of Formula (M) | (5.0 × 10⁻³ mol per mole of silver) |
| Silver halide (in terms of Ag) | 0.091 |

3-4 Preparation of Photothermographic Materials-404 to -406

Photothermographic materials-404 to -406 were prepared in the same manner as Photothermographic materials 401 to 403, except that Image forming layer coating solution-11 was changed to Image forming layer coating solution-12, and further that the fluorine-containing surfactants of the surface protective first layer were changed from F-1 and F-2 to F-3 to F-4, respectively, in Photothermographic materials 401 to 403.

The coating amount (g/m²) of respective compounds of the image forming layer at this step is as follows:

| | |
|---|---|
| Aliphatic silver B | 5.27 |
| Pigment-1 (C. I. Pigment Blue 60) | 0.036 |
| Polyhalogen compound-1 | 0.17 |
| Polyhalogen compound-2 | 0.28 |
| 6-Isopropylphthalazine | 0.18 |
| Gelatin | 7.5 |
| SBR latex | 1.9 |
| Reducing agent-2 | 0.77 |
| Stearic acid anilide dispersion | 0.31 |
| Color tone controlling agent-1 | 0.21 |
| Hydrogen bond-forming compound-1 | 0.28 |
| Development accelerator-1 | 0.019 |
| Development accelerator-2 | 0.020 |
| Mercapto compound-2 | 0.003 |
| Silver halide (in terms of Ag) | 0.091 |

The chemical structure of each compound used in Examples of the invention will be shown below.

(Sensitizing dye-1)

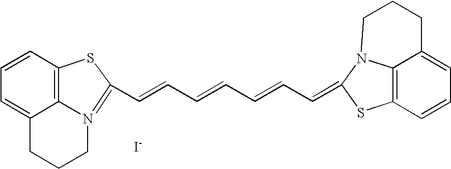

4. Evaluations

1) Evaluation of Photographic Performances

Like Example 1, each of the obtained samples was cut, moisture conditioned, and stored in a moisture-proof bag. Then, the following evaluations were carried out.

(Sensitometry Exposure and Development Processing)

An exposure apparatus was produced tentatively using a semiconductor laser capable of exhibiting a multi-longitudinal mode oscillation at a wavelength of 800 nm to 820 nm based on high-frequency superposition as an exposure light source. Using the exposure apparatus, an exposure light was applied through laser scanning to the foregoing prepared samples from the image forming layer surface side. At this step, the angle of incidence of the scanning layer light on the surface to be exposed of the photothermographic material was set at 75 degrees, whereby an image was recorded. Then, heat development was carried out at 124° C. for 15 seconds using an automatic developing machine having a heat drum in such a manner that the protective layer of the photothermographic material and the drum surface were in contact with each other.

(Evaluation of Sharpness)

Each sample was exposed, through a 830-nm interference filter, to white light of 2856° K., and the exposed sample was thermally developed under the foregoing conditions. The image obtained was evaluated for the sharpness using an MTF value at an optical density of 1.0 and 3 lines/mm.

(Evaluation of Color Tint)

The samples which had not been exposed to light, and had been subjected to thermal development processing were prepared, and their color tints were rated by visual inspection as follows:

∘: Favorable;
Δ: Annoying tint; and
x: Inferior tint;

(Raw Storability)

Undeveloped samples were stored in an atmosphere of 50° C. and 70% RH for 3 days. Then, each spectral absorption density (D) at 830 nm was determined. The same measurement was carried out for the cold stored samples (D₀). Each sample was evaluated as the value of D/D₀×100.

The obtained results are shown in Table 15. The samples of the invention achieved high-quality images excellent in sharpness and also preferable in terms of color tints. Further, unexpected effects of improvement in raw storability were exerted.

TABLE 15

| Sample | | | | |
|---|---|---|---|---|
| No. | Dye | Sharpness | Color tint | Raw storability |
| 41 | Solution added | 83 | Δ | 63% |
| 42 | Solid fine grains added | 94 | ∘ | 96% |
| 43 | Emulsion dispersion | 91 | ∘ | 91% |
| | added | | | |
| 44 | Solution added | 85 | Δ | 70% |
| 45 | Solid fine grains added | 94 | ∘ | 97% |
| 46 | Emulsion dispersion | 92 | ∘ | 93% |
| | added | | | |

### Example 15

Each of Samples 411 to 428 was prepared using its corresponding compound shown in Table 16, in place of Compound No. 10 as Compound of any of Formulae (1) to (5) in Example 14. The resulting samples were evaluated in the same manner as in Example 14. The results are shown in Table 16. The samples of the invention showed excellent performances as with Example 1.

TABLE 16

| Sample | Kind of | | | Color | Raw |
|---|---|---|---|---|---|
| No. | dye | Adding method of Dye | Sharpness | tint | storability |
| 411 | 12 | Solution added | 80 | Δ | 65% |
| 412 | 12 | Solid fine grains added | 93 | ∘ | 95% |
| 413 | 12 | Emulsion dispersion | 91 | ∘ | 91% |
| | | added | | | |
| 414 | 21 | Solution added | 81 | Δ | 70% |
| 415 | 21 | Solid fine grains added | 94 | ∘ | 92% |
| 416 | 21 | Emulsion dispersion | 94 | ∘ | 90% |
| | | added | | | |
| 417 | 26 | Solution added | 79 | Δ | 71% |
| 418 | 26 | Solid fine grains added | 93 | ∘ | 93% |
| 419 | 26 | Emulsion dispersion | 92 | ∘ | 90% |
| | | added | | | |
| 420 | 37 | Solution added | 77 | x | 70% |
| 421 | 37 | Solid fine grains added | 92 | ∘ | 95% |
| 422 | 37 | Emulsion dispersion | 90 | ∘ | 93% |
| | | added | | | |
| 423 | 51 | Solution added | 79 | x | 72% |
| 424 | 51 | Solid fine grains added | 95 | ∘ | 94% |
| 425 | 51 | Emulsion dispersion | 93 | ∘ | 92% |
| | | added | | | |
| 426 | 60 | Solution added | 74 | x | 72% |
| 427 | 60 | Solid fine grains added | 94 | ∘ | 93% |
| 428 | 60 | Emulsion dispersion | 91 | ∘ | 90% |
| | | added | | | |

### Example 16

Each back layer in which the compound belonging to any of Formulae (1) to (5) had been removed from the back layer in Example 14 was applied. A layer having the same composition as that of the antihalation layer of Example 14 was disposed between the support and the image forming layer. The image forming layer, the intermediate layer, and the surface protective first and second layers were provided in the same manner as in Example 14. The Evaluation of performances were carried out for the obtained samples in the same manner as in Example 1. As a consequence, like Example 14, the samples of the invention achieved high-quality images excellent in sharpness and also preferable in terms of color tints. Further, unexpected effects of improvement in raw storability were exerted.

### Example 17

1. Preparation of PET Support and Undercoating

The same procedures as in Example 1 were followed.

2. Back Layer

The same procedures were repeated as in Example 1.

3. Image Forming Layer and Surface Protective Layer

3-1. Preparation of Coating Solution for Image Forming Layer

(Image Forming Layer Coating Solution-13)

360 g of polyvinyl alcohol PVA-205 (produced by Kuraray Co., Ltd.) was dissolved in 4300 ml of water. To the resulting solution were successively added 1000 g of Aliphatic silver dispersion A, 276 ml of water, 33 g of Pigment-1 dispersion, 21 g of Organic polyhalogen compound-1 dispersion, 58 g of Organic polyhalogen compound-2 dispersion, 173 g of Phthalazine compound-1 solution, 299 g of Reducing agent complex-1 dispersion, 76 g of a stearic acid amide dispersion as a thermal solvent, 51 g of Color tone controlling agent-1 dispersion, 273 g of a SBR latex (Tg=17° C.), Sensitizing Dye-1 (comparative sensitizing dye) in an amount of 5.0×10⁻⁴ mol per mole of silver, 9 ml of Mercapto compound-1 aqueous solution, and 27 ml of Mercapto compound-2 aqueous solution. Immediately before coating, to the resulting mixture, 117 g of Silver halide mixed emulsion B was added and thoroughly mixed to prepare an image forming layer coating solution. The resulting solution was fed as it was into a coating die.

(Preparation of Image Forming Layer Coating Solution-14)

360 g of inert gelatin was dissolved in 2,760 ml of water. To the resulting solution were successively added 1,000 g of Aliphatic silver dispersion B, 276 ml of water, 35 g of Pigment-1 dispersion, 32 g of Organic polyhalogen compound-1 dispersion, 46 g of Organic polyhalogen compound-2 dispersion, 173 g of Phthalazine compound-1 solution, 153 g of Reducing agent-2 dispersion, 72 g of Hydrogen bond-forming compound-1 dispersion, 76 g of a stearic acid amide dispersion as a thermal solvent, 4.8 of Development accelerator-1 dispersion, 5.2 of Development accelerator-2 dispersion, Sensitizing Dye-1 (comparative sensitizing dye) in an amount of 5.0×10⁻⁴ mol per mole of silver, 8 ml of Mercapto compound-2 aqueous solution, 51 of Color tone controlling agent-1 dispersion, and 273 g of SBR latex (Tg=17° C.). Immediately before coating, to the resulting mixture, 140 g of Silver halide mixed emulsion B was added and well mixed to prepare an image forming layer coating solution. The resulting solution was fed as it was into a coating die.

The pH of the coating solution for the image forming layer was 6.0.

The content of zirconium in the coating solution was 0.38 mg per gram of silver.

2) Intermediate Layer Coating Solution, Surface Protective First Layer Coating Solution, and Surface Protective Second Layer Coating Solution

The same coating solutions as those in Example 1 were used as the coating solutions of these layers, respectively.

3-2. Preparation of Photothermographic material-500

Onto the surface opposite to the back surface, the image forming layer using Image forming layer coating solution-13, the intermediate layer, the surface protective first layer, and the surface protective second layer were applied by coating simultaneously in multilayer by a slide bead coating process in this order from the undercoated surface. Thus, a sample of a photothermographic material was prepared.

The coating solution for the image forming layer was applied such that the coating amount of aliphatic silver was 5.58 g/m².

The coating and drying conditions were the same as in Example 1.

The prepared photothermographic material showed matting degrees of 450 seconds for the image forming layer surface side, and 130 seconds for the back surface side, in terms of Beck's smoothness. The pH of the film surface on the image forming layer surface side was determined and found to be 6.0.

3-3. Preparation of Photothermographic material-520

Photothermographic material-520 was prepared in the same manner as Photothermographic material-500, except that Image forming layer coating solution-13 was changed to Image forming layer coating solution-14, and that the fluorine-containing surfactants of the surface protective first layer were changed from F-1 and F-2 to F-3 and F-4, respectively, in Photothermographic material-500.

The image forming layer coating solution was applied so that the coating amount of aliphatic silver was 5.27 g/m².

3-4. Preparation of Photothermographic Materials-501 to -517

Each of Photothermographic materials-501 to -517 was prepared in the same manner as Photothermographic material-500, except that Sensitizing dye-1 was changed to its corresponding spectral sensitizing dye of the invention shown in Table 17, and that each corresponding compound of Formula (T) of the invention and each corresponding heteroatom containing macrocyclic compound were used, in Photothermographic material-500. There were added the spectral sensitizing dye of the invention in an amount equimolar with the amount of Sensitizing dye-1; Compound of Formula (T) of the invention in an amount of 2×10⁻² mol per mole of silver halide; and the heteroatom containing macrocyclic compound in an amount of 1×10⁻¹ mol.

TABLE 17

| | | Compound | | | | | |
|---|---|---|---|---|---|---|---|
| Sample | Sensitizing | of Formula | Macrocyclic | | | Print-out | |
| No. | dye | (T) | Compound | Dmin | Sensitivity | (Δmin) | Remarks |
| 500 | SD-1 | — | — | 0.21 | 100 | 0.19 | Comp. Ex. |
| 501 | SD-1 | 1-23 | S-19 | 0.20 | 190 | 0.18 | Comp. Ex. |
| 502 | SD-1 | 1-26 | S-19 | 0.21 | 175 | 0.18 | Comp. Ex. |
| 503 | SD-1 | — | S-19 | 0.22 | 165 | 0.20 | Comp. Ex. |
| 504 | SD-1 | 1-23 | — | 0.23 | 170 | 0.19 | Comp. Ex. |
| 505 | No. 5 | — | — | 0.24 | 180 | 0.22 | Comp. Ex. |
| 506 | No. 20 | — | — | 0.23 | 162 | 0.24 | Comp. Ex. |
| 507 | No. 41 | — | — | 0.23 | 170 | 0.23 | Comp. Ex. |
| 508 | No. 5 | — | S-19 | 0.20 | 266 | 0.15 | P.I. |
| 509 | No. 5 | 1-23 | — | 0.20 | 273 | 0.14 | P.I. |
| 510 | No. 5 | 1-23 | S-19 | 0.20 | 320 | 0.11 | P.I. |
| 511 | No. 5 | 1-26 | S-19 | 0.20 | 305 | 0.13 | P.I. |
| 512 | No. 20 | 1-23 | S-19 | 0.19 | 286 | 0.12 | P.I. |
| 513 | No. 20 | 1-26 | S-19 | 0.20 | 279 | 0.15 | P.I. |
| 514 | No. 41 | 1-23 | S-19 | 0.19 | 303 | 0.10 | P.I. |
| 515 | No. 41 | 1-26 | S-19 | 0.19 | 310 | 0.11 | P.I. |
| 516 | No. 5 | 1-23 | S-32 | 0.20 | 268 | 0.14 | P.I. |
| 517 | No. 5 | 1-26 | S-32 | 0.20 | 264 | 0.15 | P.I. |

(P.I.: present invention)

4. Evaluations

1) Coated Surface Conditions

Both the samples of the invention and the comparative samples showed no defects such as coating streaks due to agglomerates, and granular structures due to foreign matters, and thus revealed good surface conditions.

2) Evaluation of Photographic Performances

Like Example 1, each of the obtained samples was cut, moisture conditioned, and stored in a moisture-proof bag, and the following evaluations were carried out.

(Exposure and Development Processing)

An exposure apparatus was tentatively produced using a semiconductor laser capable of exhibiting a multi-longitudinal mode oscillation at a wavelength of 800 nm to 820 nm based on high-frequency superposition as an exposure light source. Using the exposure apparatus, an exposure light was applied through laser scanning to the foregoing prepared sample from the image forming layer surface side. At this step, the angle of incidence of the scanning layer light on the surface to be exposed of the photothermographic material was set at 75 degrees, whereby an image was recorded. Then, thermal development was carried out at 124° C. for 15 seconds using an automatic developing machine having a heat drum in such a manner that the protective layer of the photothermographic material and the drum surface were in contact with each other. The evaluation of the image obtained was carried out by means of a densitometer.

(Sensitivity)

The sensitivity, expressed by the reciprocal of the exposure necessary to obtain the blackening density of fog +1.0, was indicated as a relative value by taking the sensitivity of Sample No. 500 as 100.

(Dₘᵢₙ)

The density of the non-image part was measured by means of a Macbeth densitometer.

(Image Storability)

Each of the thermally developed samples was cut into a half size, and respective cut samples were stored under a fluorescent lamp having an illuminance of 1000 Lux for 24 hours in an atmosphere of 30° C. and 70% RH. Then, an increase in fog density at the Dmin portion (ΔDₘᵢₙ) was evaluated.

ΔDₘᵢₙ=Dmin (after storage)−Dmin (immediately after development)

The results obtained are shown in Table 17. The samples of the invention exhibited unexpected excellent effects of low fog and high sensitivity and good image storage stability of print-out performances that are characteristic of the phtotothermographic materials.

### Example 18

1) Preparation of Photothermographic Materials-521 to -537

Each of Photothermographic materials-521 to -537 was prepared in the same manner as Photothermographic material-520, except that Sensitizing dye-1 was changed to its corresponding spectral sensitizing dye of the invention shown in Table 18, and that its corresponding Compound of Formula (T) and its corresponding heteroatom containing macrocyclic compound of the invention were used in Phtotothermographic material-520. The spectral sensitizing dye of the invention was added in an amount equimolar with the amount of Sensitizing dye-1; Compound of Formula (T) of the invention, in an amount of 2×10⁻² mol per mole of silver halide; and the hetero atom-containing macrocyclic compound, in an amount of 1×10⁻¹ mol per mole of silver halide.

2) Evaluations

The evaluations were carried out in the same manner as in Example 17. However, thermal development was carried out at 124° C. for 25 seconds. The results are shown in Table 18.

Like Example 17, the samples of the invention exhibited unexpected preferable results of low fog and high sensitivity, and low susceptibility to print-out.

TABLE 18

| | | Compound | | | | | |
|---|---|---|---|---|---|---|---|
| Sample | Sensitizing | of Formula | Macrocyclic | | | Print-out | |
| No. | dye | (T) | Compound | Dmin | Sensitivity | (Δmin) | Remarks |
| 520 | SD-1 | — | — | 0.22 | 100 | 0.20 | Comp. Ex. |
| 521 | SD-1 | 1-23 | S-19 | 0.21 | 175 | 0.19 | Comp. Ex. |
| 522 | SD-1 | 1-26 | S-19 | 0.22 | 180 | 0.18 | Comp. Ex. |
| 523 | SD-1 | — | S-19 | 0.21 | 170 | 0.19 | Comp. Ex. |
| 524 | SD-1 | 1-23 | — | 0.22 | 166 | 0.19 | Comp. Ex. |
| 525 | No. 5 | — | — | 0.24 | 175 | 0.23 | Comp. Ex. |
| 526 | No. 20 | — | — | 0.24 | 170 | 0.23 | Comp. Ex. |
| 527 | No. 41 | — | — | 0.24 | 175 | 0.23 | Comp. Ex. |
| 528 | No. 5 | — | S-19 | 0.21 | 281 | 0.14 | P.I. |
| 529 | No. 5 | 1-23 | — | 0.20 | 270 | 0.15 | P.I. |
| 530 | No. 5 | 1-23 | S-19 | 0.20 | 332 | 0.12 | P.I. |
| 531 | No. 5 | 1-26 | S-19 | 0.21 | 316 | 0.12 | P.I. |
| 532 | No. 20 | 1-23 | S-19 | 0.20 | 296 | 0.13 | P.I. |
| 533 | No. 20 | 1-26 | S-19 | 0.20 | 287 | 0.16 | P.I. |
| 534 | No. 41 | 1-23 | S-19 | 0.19 | 310 | 0.11 | P.I. |
| 535 | No. 41 | 1-26 | S-19 | 0.20 | 317 | 0.12 | P.I. |
| 536 | No. 5 | 1-23 | S-32 | 0.20 | 281 | 0.14 | P.I. |
| 537 | No. 5 | 1-26 | S-32 | 0.21 | 276 | 0.15 | P.I. |

(P.I.: present invention)

### Example 19

1. Preparation of PET Support, and Undercoating

The same procedures as in Example 1 were followed.

2. Back Layer

A back layer and a back protective layer were provided in the same manner as in Example 1.

3. Image Forming Layer and Surface Protective Layer

3-1. Preparation of Coating Solution

(Preparation of Image Forming Layer Coating Solutions-15 to -30)

360 g of polyvinyl alcohol PVA-205 (produced by Kuraray Co., Ltd.) was dissolved in 4,300 ml of water. To the resulting solution were successively added 1,000 g of Aliphatic silver dispersion A, 276 ml of water, 33 g of Pigment-1 dispersion, 21 g of Organic polyhalogen compound-1 dispersion, 58 g of Organic polyhalogen compound-2 dispersion, 173 g of Phthalazine compound-1 solution, 299 g of Reducing agent complex-1 dispersion, 76 g of a stearic acid anilide dispersion as a thermal solvent, 51 g of Color tone controlling agent-1 dispersion, 273 g of SBR latex (Tg=17° C.), Sensitizing Dye-1 (shown in Table 19) in an amount of 5.0×10⁻⁴ mol per mole of silver, and Compound of Formula (M) (shown in Table 19) in an amount of 5.0×10⁻³ mol per mole of silver. Immediately before coating, 117 g of Silver halide mixed emulsion B was added to the resultant mixture and thoroughly mixed to prepare an image forming layer coating solution. The resulting solution was fed as it was into a coating die.

The pH of the coating solution for the image forming layer was 6.0.

The content of zirconium in the coating solution was 0.38 mg per gram of silver.

(Intermediate Layer Coating Solution, Surface Protective First Layer Coating Solution, and Surface Protective Second Layer Coating Solution)

The same coating solutions as those in Example 1 were used as the coating solutions for these layers, respectively.

3-2. Preparation of Photothermographic materials-601 to -616

Onto the surface opposite to each back surface, the image forming layer, the intermediate layer, the surface protective first layer, and the surface protective second layer were applied by coating simultaneously in multilayer by a slide bead coating process in this order from the undercoated surface. Thus, samples-601 to -616 of photothermographic materials were prepared. The coating solution for the image forming layer was coated such that the coating amount of aliphatic silver was 5.58 g/m².

The coating and drying conditions were the same as in Example 1.

Each of the prepared photothermographic materials had matting degrees of 450 seconds for the image forming layer surface side, and 130 seconds for the back surface side, in terms of Beck's smoothness. The pH of the film surface on the image forming layer surface side was determined and found to be 6.0.

The chemical structure of each compound used in Examples of the invention will be shown below.

TABLE 19

| Sam- | Sensitizing | Compound | | Sen- | | |
|---|---|---|---|---|---|---|
| ple | dye of D-a | of Formula | | si- | Image | |
| No. | to D-d | (M) | Dmin | tivity | storability | Remarks |
| 601 | 1 | — | 0.22 | 185 | 0.15 | P.I. |
| 602 | 5 | 2-17 | 0.18 | 180 | 0.09 | P.I. |
| 603 | 5 | 2-24 | 0.17 | 180 | 0.08 | P.I. |
| 604 | 5 | 2-28 | 0.17 | 183 | 0.09 | P.I. |
| 605 | 20 | — | 0.23 | 197 | 0.16 | P.I. |
| 606 | 20 | 2-17 | 0.18 | 188 | 0.09 | P.I. |
| 607 | 20 | 2-24 | 0.18 | 191 | 0.09 | P.I. |
| 608 | 20 | 2-28 | 0.17 | 195 | 0.08 | P.I. |
| 609 | 41 | — | 0.24 | 203 | 0.17 | P.I. |
| 610 | 41 | 2-17 | 0.16 | 194 | 0.08 | P.I. |
| 611 | 41 | 2-24 | 0.17 | 197 | 0.07 | P.I. |
| 612 | 41 | 2-28 | 0.18 | 200 | 0.06 | P.I. |
| 613 | SD-1 | — | 0.26 | 100 | 0.21 | Comp. Ex. |
| 614 | SD-1 | 2-17 | 0.19 | 85 | 0.19 | Comp. Ex. |
| 615 | SD-1 | 2-24 | 0.19 | 90 | 0.17 | Comp. Ex. |
| 616 | SD-1 | 2-28 | 0.18 | 93 | 0.17 | Comp. Ex. |

(P.I.: present invention)

4. Evaluations

1) Coated Surface Conditions

Both the samples of the invention and the comparative samples had no defects such as coating streaks due to agglomerates, and granular structures due to foreign matters, and thus revealed good surface conditions.

2) Evaluation of Photographic Performances

Like Example 1, each of the obtained samples was cut, moisture conditioned, and stored in a moisture-proof bag. Then, the following evaluations were carried out.

(Exposure and Development Processing)

An exposure apparatus was tentatively produced using a semiconductor laser capable of exhibiting a multi-longitudinal mode oscillation at a wavelength of 800 nm to 820 nm based on high-frequency superposition as an exposure light source. Using the exposure apparatus, an exposure light was applied through laser scanning to the foregoing prepared samples from the image forming layer surface side. At this step, the angle of incidence of the scanning layer light on the surface to be exposed of the photothermographic material was set at 75 degrees, whereby an image was recorded. Then, thermal development was carried out at 124° C. for 15 seconds using an automatic developing machine having a heat drum, in such a manner that the protective layer of the photothermographic material and the drum surface were in contact with each other. The obtained image was evaluated by means of a densitometer.

(Sensitivity)

The sensitivity, expressed by the reciprocal of the exposure necessary to obtain the blackening density of fog +1.0, was indicated as a relative value by taking the sensitivity of Sample No. 613 as 100.

(Dₘᵢₙ)

The density of the non-image portion was measured by means of a Macbeth densitometer.

(Image Storability)

Each of the thermally developed samples was cut into a half size, and respective cut samples were stored under a fluorescent lamp with an illuminance of 1,000 Lux in an atmosphere of 30° C. and 70% RH for 24 hours. Then, an increase in fog density at the Dmin portion (ΔDₘᵢₙ) was evaluated.

The results obtained are shown in Table 19. The samples of the invention exhibited unexpected excellent effects of low fog and high sensitivity, and good image storability of print-out performances that are characteristic of the phtotothermographic materials.

### Example 20

1) Preparation of Image Forming Layer Coating Solutions-31 to -46

360 g of inert gelatin was dissolved in 2760 ml of water. To the resulting solution were successively added 1000 g of Aliphatic silver dispersion B, 276 ml of water, 35 g of Pigment-1 dispersion, 32 g of Organic polyhalogen compound-1 dispersion, 46 g of Organic polyhalogen compound-2 dispersion, 173 g of Phthalazine compound-1 solution, 153 g of Reducing agent-2 dispersion, 72 g of Hydrogen bond-forming compound-1 dispersion, 76 g of a stearic acid anilide dispersion as a thermal solvent, 51 g of Color tone controlling agent-1 dispersion, 273 g of SBR latex (Tg=17° C.), Sensitizing Dye-1 (shown in Table 20) in an amount of 5.0×10⁻⁴ mol per mole of silver, and Compound of Formula (M) (shown in Table 20) in an amount of 5.0×10⁻³ mol per mole of silver. Immediately before coating, 140 g of Silver halide mixed emulsion B was added to the resultant mixture and thoroughly mixed to prepare an image forming layer coating solution. The resulting solution was fed as it was into a coating die.

2) Preparation of Photothermographic materials-621 to -636

Photothermographic materials-621 to -636 were prepared in the same manner as in Example 19, except that Image forming layer coating solutions-15 to -30 were changed to Image forming layer coating solutions-31 to -46, respectively, further that Yellow dye compound-1 was removed from the antihalation layer, and that the fluorine-containing surfactants of the surface protective second layer were changed from F-1 and F-2 to F-3 and F-4, respectively. Each of the coating solutions for the image forming layer at this step was coated such that the coating amount of aliphatic silver was 5.27 g/m².

3) Evaluation

The evaluation was carried out in the same manner as in Example 19. The results are shown in Table 20.

Like Example 19, the samples of the invention exhibited excellent results of low fog and high sensitivity, and further good print-out performances.

TABLE 20

| Sam- | Sensitizing | Compound | | Sen- | | |
|---|---|---|---|---|---|---|
| ple | dye of D-a | of Formula | | si- | Image | |
| No. | to D-d | (M) | Dmin | tivity | storability | Remarks |
| 621 | 1 | — | 0.20 | 180 | 0.14 | P.I. |
| 622 | 5 | 2-17 | 0.17 | 176 | 0.08 | P.I. |
| 623 | 5 | 2-24 | 0.16 | 179 | 0.07 | P.I. |
| 624 | 5 | 2-28 | 0.17 | 180 | 0.08 | P.I. |
| 625 | 20 | — | 0.16 | 194 | 0.15 | P.I. |
| 626 | 20 | 2-17 | 0.17 | 184 | 0.08 | P.I. |
| 627 | 20 | 2-24 | 0.16 | 187 | 0.08 | P.I. |
| 628 | 20 | 2-28 | 0.16 | 191 | 0.07 | P.I. |
| 629 | 41 | — | 0.22 | 199 | 0.15 | P.I. |
| 630 | 41 | 2-17 | 0.15 | 191 | 0.07 | P.I. |
| 631 | 41 | 2-24 | 0.16 | 193 | 0.06 | P.I. |
| 632 | 41 | 2-28 | 0.17 | 195 | 0.06 | P.I. |
| 633 | SD-1 | — | 0.24 | 100 | 0.19 | Comp. Ex. |
| 634 | SD-1 | 2-17 | 0.18 | 83 | 0.15 | Comp. Ex. |
| 635 | SD-1 | 2-24 | 0.17 | 88 | 0.15 | Comp. Ex. |
| 636 | SD-1 | 2-28 | 0.17 | 90 | 0.14 | Comp. Ex. |

(P.I.: present invention)

### Example 21

1) Preparation of Photothermographic Materials-641 to -643

Photothermographic materials-641 to -643 were prepared using 1,10-decanediol, salicylanilide, and o-hydroxybenzylalcohol, respectively, in the same amount, as a thermal solvent in place of stearic acid anilide of the thermal solvent in Sample No. 604 of Example 19.

2) Evaluation of Performance

The photographic performances were assesses in the same manner as in Example 19. The results are shown in Table 21. Like Example 19, the samples of the invention exhibited good results.

TABLE 21

| Sample No. | Dmin | Sensitivity | Image storability | Remarks |
|---|---|---|---|---|
| 641 | 0.18 | 175 | 0.10 | P.I. |
| 642 | 0.18 | 180 | 0.11 | P.I. |
| 643 | 0.17 | 172 | 0.10 | P.I. |

(P.I.: present invention)

### Example 22

1) Preparation of Photothermographic Materials-651 to -655

There were prepared Photothermographic materials-651 to -655 using Compounds 2-8, 2-24, 2-27, and 2-44, respectively, in the same amount, in place of Compound 2-17 of Formula (M) in Sample-604 of Example 19. Also, there was prepared Sample-655 using Compounds 2-8 and 2-28 in a molar ratio of 1:1.

2) Evaluation of Performance

The photographic performances were assessed in the same manner as in Example 19. The results are shown in Table 22. Like Example 19, the samples of the invention showed good results.

TABLE 22

| Sample No. | Dmin | Sensitivity | Image storability | Remarks |
|---|---|---|---|---|
| 651 | 0.18 | 180 | 0.10 | P.I. |
| 652 | 0.18 | 175 | 0.11 | P.I. |
| 653 | 0.17 | 183 | 0.10 | P.I. |
| 654 | 0.17 | 180 | 0.10 | P.I. |
| 655 | 0.17 | 175 | 0.09 | P.I. |

(P.I.: present invention)

What is claimed is:

1. A photothermographic material comprising a support having disposed on one surface thereof, an image forming layer containing a photosensitive silver halide, a non-photosensitive organic silver salt, a reducing agent and a binder, and at least one protective layer, wherein a development accelerator is contained in a later at a side of the support at which the image forming layer is disposed, 50% by mass or more of the binder contained in the image forming layer is a water soluble binder, and the reducing agent is contained as a solid dispersion.

2. The photothermographic material according to claim 1, further containing a thermal solvent.

3. The photothermographic material according to claim 1, further containing a compound represented by the following general formula (I): 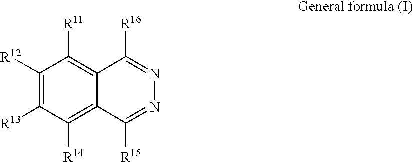
wherein R¹¹, R¹², R¹³, R¹⁴, R¹⁵ and R¹⁶ each independently represent a hydrogen atom or a monovalent substituent; the substituents may be bonded with each other to form a ring; and R¹¹ to R¹⁶ are not all hydrogen atoms simultaneously.

4. The photothermographic material according to claim 3, further containing a thermal solvent.

5. The photothermographic material according to claim 3, further containing a hardener which is incorporated in a layer other than the image forming layer at a side of the support at which the image forming layer is disposed.

6. The photothermographic material according to claim 5, wherein the hardener is a vinylsulfone-based, β-halosulfone-based or triazine-based compound.

7. The photothermographic material according to claim 6, wherein the hardener is a vinylsulfone-based compound.

8. The photothermographic material according to claim 7, wherein the vinylsulfone-based compound is a compound represented by one of the following general formula (B) and (C):
(CH₂═CH—SO₂)ₙ-L General formula (B)
(X—CH₂—CH₂—SO₂)ₙ-L General formula (C)
wherein, in the formulae, X represents a halogen atom, L represents an n-valent organic linking group, and n represents an integer of 1 to 4 in a case where the compound of the formula (B) or (C) is a low molecular weight compound; or L represents an organic linking group containing a polymer chain in a case where the compound is a high molecular weight compound, and n is within a range from 10 to 1,000.

9. The photothermographic material according to claim 5, wherein the hardener is a non-diffusing hardener.

10. The photothermographic material according to claim 5, wherein the hardener is a high molecular weight hardener.

11. The photothermographic material according to claim 1, further containing a compound selected from compounds of the following types A and 1 to 4:
(Type A)
a compound represented by X—Y, in which X represents a reducing group and Y represents a leaving group, wherein the reducing group X can be one-electron oxidized to produce a one-electron oxidation product, which leaves Y to produce X radical through the following X—Y bond cleaving reaction, followed by releasing one more electron from the X radical;
(Type 1)
a compound that can be one-electron oxidized to produce a one-electron oxidation product, which releases two or more electrons through the following bond cleaving reaction;
(Type 2)
a compound that has two or more adsorbable groups to the silver halide in the same molecular structure and can be one-electron oxidized to produce a one-electron oxidation product which further releases one electron through the following carbon-carbon bond cleaving reaction;
(Type 3)
a compound that can be one-electron oxidized to produce a one-electron oxidation product, which releases additional one or more electrons after the following bond forming process;
(Type 4)
a compound that can be one-electron oxidized to produce a one-electron oxidation product, which releases additional one or more electrons after the following intra-molecular ring opening reaction.

12. The photothermographic material according to claim 11, wherein the development accelerator is contained as a solid dispersion.

13. The photothermographic material according to claim 11, further containing a thermal solvent.

14. A photothermographic material comprising a support having disposed on one surface thereof, at least one image forming layer containing a photosensitive silver halide, a non-photosensitive organic silver salt, a reducing agent and a binder, and at least one protective layer, wherein a development accelerator is contained in a layer at a side of the support at which the image forming layer is disposed, and 50% by mass or more of the binder contained in the image forming layer is a water soluble binder.

15. The photothermographic material according to claim 14, which is produced by applying a coating liquid for the image forming layer and a coating liquid for the protective layer simultaneously.

16. The photothermographic material according to claim 15, which is produced by applying a coating liquid for the image forming layer prepared by separately adding the photosensitive silver halide and the non-photosensitive organic silver salt to a mixing vessel.

17. The photothermographic material according to claim 14, wherein the development accelerator is contained in the image forming layer.

18. The photothermographic material according to claim 14, wherein at least one of the development accelerator is a compound selected from the compounds of the following general formula (1), (5) and (6):
Q¹-NHNH—R¹ General formula (1)
wherein Q¹ represents a 5 to 7-membered unsaturated ring linked via a carbon atom to NHNH—R¹, and R¹ represents a carbamoyl group, an acyl group, an alkoxycarbonyl group, an aryloxycarbonyl group, a sulfonyl group or a sulfamoyl group; 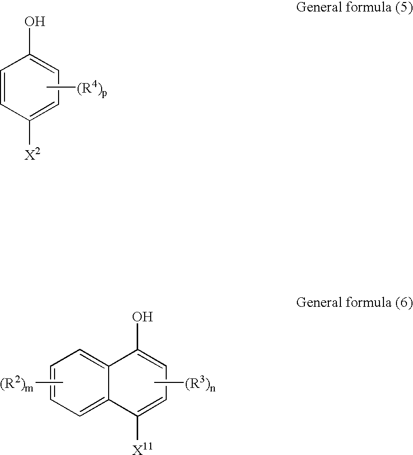
wherein X¹¹ and X² each independently represent a hydrogen atom or a substituent, R² to R⁴ each independently represent a hydrogen atom or a substituent, m and p each independently represent an integer from 0 to 4, and n represents an integer from 0 to 2.

19. The photothermographic material according to claim 14, wherein the water soluble binder is polyvinyl alcohol or gelatin.

20. The photothermographic material according to claim 14, wherein a polymer latex is contained in the image forming layer.

21. The photothermographic material according to claim 14, wherein a thermal solvent is contained in the image forming layer.

22. A photothermographic material comprising a support having disposed on one surface thereof, an image forming layer containing a photosensitive silver halide, a non-photosensitive organic silver salt, a reducing agent and a binder, and at least one protective layer, wherein 50% by mass or more of the binder contained in the image forming layer is a water soluble binder, and wherein the material contains at least one of spectral sensitizing dyes represented by the following general formulae (D-a)-(D-d): 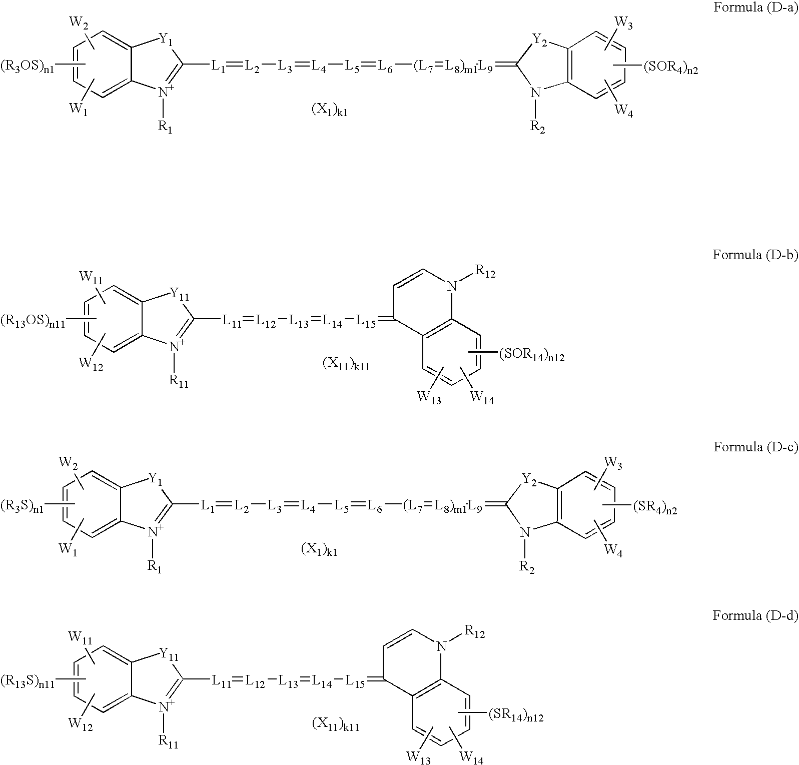
wherein, in the formulae, Y₁, Y₂ and Y₁₁ each represent an oxygen atom, a sulfur atom, a selenium atom or a group —CH═CH—; L₁-L₉ and L₁₁-L₁₅ each represent a methine group; R₁, R₂, R₁₁ and R₁₂ each represent an aliphatic group; R₃, R₄, R₁₃ and R₁₄ each represent a lower alkyl group, a cycloalkyl group, an alkenyl group, an aralkyl group, an aryl group or a heterocyclic group; W₁, W₂, W₃, W₄, W₁₁, W₁₂, W₁₃ and W₁₄ each represent a hydrogen atom or a substituent, represents a group of non-metal atoms necessary to form a condensed ring by linking between W₁ and W₂, W₃ and W₄, W₁₁ and W₁₂ or W₁₃ and W₁₄, or represents a group of non-metal atoms necessary to form a 5-membered or 6-membered condensed ring by linking between R₃ and W₁, R₃ and W₂, R₁₃ and W₁₁, R₁₃ and W₁₂, R₄ and W₃, R₄ and W₄, R₁₄ and W₁₃ or R₁₄ and W₁₄; X₁ and X₁₁ each represent an ion necessary to balance the charge in the molecule, k₁ and k₁₁ each represent the number of ions necessary to balance the charge in the molecule; m₁ represents 0 or 1; and n₁ and n₂, or n₁₁ and n₁₂ each represent 0, 1 or 2; and n₁ and n₂, or n₁₁ and n₁₂ do not all simultaneously represent 0.

23. The photothermographic material according to claim 22, further containing a compound represented by the following general formula (PR) and containing the reducing agent as a solid dispersion: 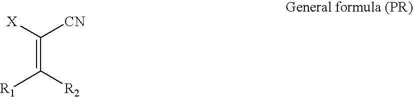
wherein R₁ represents a hydroxyl group or a metal salt of the hydroxyl group; R₂ represents an alkyl group or an aryl group; X represents an electron attractive group; and R₂ and X may form a ring containing an electron attractive group.

24. The photothermographic material according to claim 22, further containing a development accelerator.

25. The photothermographic material according to claim 22, further containing a thermal solvent.

26. The photothermographic material according to claim 22, further containing a compound represented by the following general formula (T): 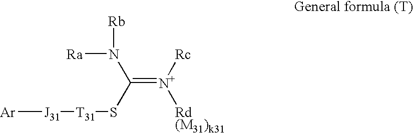
wherein Ar represents an aromatic hydrocarbon group or an aromatic heterocyclic group; T₃₁ represents a divalent linking group containing an aliphatic hydrocarbon group or a bond; J₃₁ represents a divalent linking group containing one or more oxygen atom, sulfur atom or nitrogen atom or a bond; Ra, Rb, Rc and Rd each represent a hydrogen atom, an acyl group, an aliphatic hydrocarbon group, an aryl group or a heterocyclic group, or Ra and Rb, Rc and Rd, Ra and Rc or Rb and Rd may be bonded with each other to form a nitrogen-containing heterocyclic group; M₃₁ represents an ion necessary to balance the charge in the molecule; and k₃₁ represents the number of ions necessary to balance the charge in the molecule.

27. The photothermographic material according to claim 22, further containing a large ring compound containing a hetero atom.

28. The photothermographic material according to claim 26, further containing a development accelerator.

29. The photothermographic material according to claim 26, further containing a thermal solvent.

30. The photothermographic material according to claim 22, further containing at least one dye represented by the following general formulae (1) to (5): 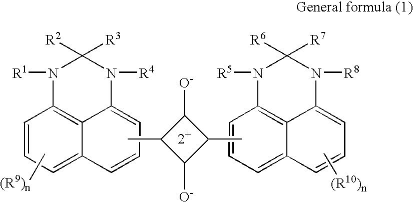
wherein R¹, R⁴, R⁵ and R⁸ each represent a hydrogen atom or an alkyl group; R², R³, R⁶ and R⁷ each represent a hydrogen atom, an alkyl group, a cycloalkyl group, an aryl group, an aralkyl group or a heterocyclic group; at least one of R¹ and R², R³ and R⁴, R⁵ and R⁶, R⁷ and R⁸, R² and R³, and R⁶ and R⁷ may be bonded with each other to form a 5- or 6-membered ring; R⁹ and R¹⁰ each represent a monovalent group; and n represents an integer of 1 to 3, with a proviso that all of R⁹ and R¹⁰ may be a hydrogen atom in a case where R², R³, R⁶ or R⁷ is a heterocyclic group: 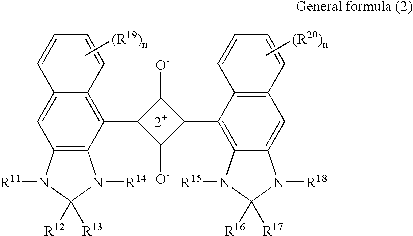
wherein R¹¹, R¹², R¹³, R¹⁴, R¹⁵, R¹⁶, R¹⁷ and R¹⁸ each represent a hydrogen atom, an alkyl group, a cycloalkyl group, an aryl group, an aralkyl group, or a heterocyclic group; R¹¹ and R¹², R¹³ and R¹⁴, R¹⁵ and R¹⁶, R¹⁷ and R¹⁸, R¹² and R¹³, and R¹⁶ and R¹⁷ may be bonded with each other to form an 5- or 6-membered ring; R¹⁹ and R²⁰ each represent a hydrogen atom or a nomovalent group; and n represents an integer of 1 to 3; 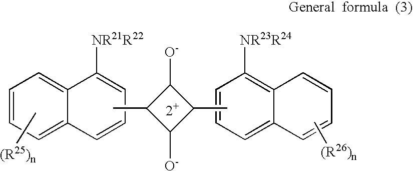
wherein R²¹, R²², R²³ and R²⁴ each represent a hydrogen atom, an alkyl group, a cycloalkyl group, an aryl group, an aralkyl group or a heterocyclic group; R²⁵ and R²⁶ each represent a hydrogen atom or a monovalent group; and n represents an integer of 1 to 3: 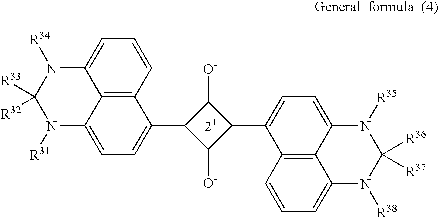
wherein R³¹, R³⁴, R³⁵ and R³⁸ each independently represent a hydrogen atom, an alkyl group having 1 to 20 carbon atoms, a cycloalkyl group having 1 to 20 carbon atoms, an aryl group or aralkyl group having up to 14 carbon atoms; R³², R³³, R³⁶ and R³⁷ are each independently selected from the group consisting of a hydrogen atom, an alkyl group having 1 to 20 carbon atoms, a cycloalkyl group having 1 to 20 carbon atoms, an aryl group or an aralkyl group having up to 14 carbon atoms or —CH₂OR³⁹ (in which R³⁹ is an alkylacyl group), —C(═O)R (in which R is an alkyl group having 1 to 20 carbon atoms), —SiR′R″R′″ (in which R′, R″ and R′″ each independently represent an alkyl group having 1 to 20 carbon atoms) and —SO₂R⁴⁰ (in which R⁴⁰ is an alkyl group having 1 to 20 carbon atoms); or at least one of R³¹ and R³², R³³ and R³⁴, R³⁵ and R³⁶, R³⁷ and R³⁸, R³² and R³³, and R³⁶ and R³⁷ may be bonded with each other to form a 5-, 6-, or 7-membered ring: 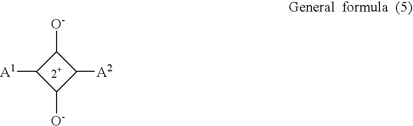
wherein at least one of A¹ and A² represents a 5-membered or 6-membered nitrogen-containing heterocyclic aromatic ring.

31. The photothermographic material according to claim 30, further containing a development accelerator.

32. The photothermographic material according to claim 30, further containing a compound represented by the general formula (H):
Q-(Y)ₙ—C(Z₁)(Z₂)X General formula (H)
wherein Q represents an alkyl group, an aryl group or a hetercyclic group; Y represents a divalent linking group; n represents 0 or 1; Z₁ and Z₂ each represent a halogen atom; and X represents a hydrogen atom or an electron attractive group.

33. The photothermographic material according to claim 30, further containing the compound represented by the following general formula (M): 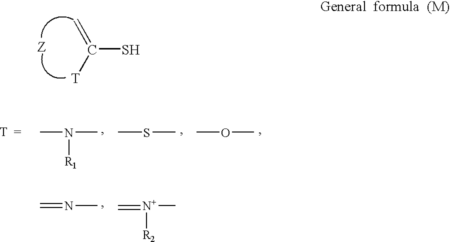
wherein Z represents an atomic group selected from carbon, oxygen, nitrogen, sulfur, selenium and tellurium to form a 5-membered or 6-membered aromatic heterocyclic ring; Z may have substituents which may be bonded with each other to have a cyclic structure and form a condensed ring together with the cyclic structure formed by Z; R₁ and R₂ may be the same or different from each other and each represent a hydrogen atom, an alkyl group, an aralkyl group, an alkoxy group and an aryl group.

34. The photothermographic material according to claim 30, wherein the water soluble binder is selected from gelatin, polyvinyl alcohol, modified polyvinyl alcohol, polyacrylamide, polysaccharides, and water soluble cellulose derivatives.

35. The photothermographic material according to claim 34, wherein the water soluble binder is gelatin.

36. The photothermographic material according to claim 31, wherein the development accelerator is a compound selected from hydrazine compounds, and phenol compounds or naphthol compounds.

37. The photothermographic material according to claim 30, further containing polymer latex in an amount of 10 to 70% by mass relative to the water soluble binder.

38. The photothermographic material according to claim 30, further containing a thermal solvent.

39. The photothermographic material according to claim 38, wherein the thermal solvent is a compound having a melting point of from 50° C. to 200° C. and having at least one group selected from a hydroxyl group, a carboxy group, an amino group, an amide group, a sulfoneamide group, a cyano group, an imide group, an ureido group, a sulfoxide group, a solfone group, a phosphinic group, a phosphineoxide group and a nitrogen-containing heterocyclic group.

40. The photothermographic material according to claim 30, wherein at least one of dye represented by general formulae (1) to (5) is contained in a back layer.

41. The photothermographic material according to claim 30, wherein at least one of the dyes represented by the general formulae (1) to (5) is contained in the image forming layer.

42. The photothermographic material according to claim 30, wherein at least one of the dye represented by the general formulae (1) to (5) is contained in an anti-halation layer disposed between the image forming layer and the support.
